(19) United States
(12) Patent Application Publication
(10) Pub. No.: US 2023/0339025 A1
(43) Pub. Date: Oct. 26, 2023

(54) A LOCKING MECHANISM AND MANUFACTURE THEREOF

(71) Applicant: Mario SCARAMUZZA, Telopea, New South Wales (AU)

(72) Inventor: Mario SCARAMUZZA, Telopea, New South Wales (AU)

(21) Appl. No.: 18/030,121

(22) PCT Filed: Nov. 22, 2021
(86) PCT No.: PCT/AU2021/051388

§ 371 Date: Apr. 4, 2023

(30) Foreign Application Priority Data
Nov. 24, 2020 (AU) 2020904347

(51) Int. Cl. B23B 31/107; B23B 31/22; B23B 31/06; F16B 21/16

(52) U.S. Cl. CPC B23B 31/1071; B23B 31/22; B23B 31/06; F16B 21/165; B23B 2260/136

(57) ABSTRACT

A device adapted to releasably lock with a bolt, the device comprising a front cover having a cavity which extends from the front cover to a rear portion of the device, wherein the cavity is adapted to receive the bolt with mounting concave portions for mounting the bolt in the cavity; a locking mechanism comprising a first group of locking shape, wherein the first group of locking shapes is moveable between a first position and a second position, wherein the first position is in the cavity, and the second position is in a corresponding first group of locking shape recesses. A moveable block comprising the first group of locking shape recesses; wherein disengagement of the first group of locking shapes is activated by movement of a release plate thereby allowing the first group of locking shapes to retract from the cavity into the first group of locking shape recesses.

### TECHNICAL FIELD

The present invention relates to providing an improved self-release device for securing a tool implement which is useful for connecting a number of different tool implements to the device and is also useful in providing a quick release to the secured different tool implements without any additional equipment.

### BACKGROUND

Conventional chuck assembly for a tool bit, for example, as discussed in U.S. Pat. No. 4,900,202 and similar ones is that the sole purpose of those previous inventions are to be used for a chuck set up that would hold a hex bit within its cavity for the purpose of rotating on for example a drill. The present invention is an improvement as it is not only capable of performing the same applications as the conventional devices but also can be used for multiple other usages for example within a rail track system to hold any external device that is inserted with a hex or similar bit shank and can be locked in position. Other conventional chuck assemblies cannot currently do that.

Any discussion of the prior art throughout the specification should in no way be considered as an admission that such prior art is widely known or forms part of common general knowledge in the field.

### SUMMARY

### Problems to be Solved

It may be an advantage to provide a device adapted for connecting various tool implements or tool bodies provided that the various tool implements or tool bodies have the bespoke bolt which is adapted to secure and lock with the device when inserted.

It may be an advantage to provide a quick self-release device in which the device is self-securing and self-releasable so that no extra external equipment has to work with the device to operate or remove it from service. The self-release device may provide quick and simple means for removably securing tool implements to the device.

It may be an advantage to provide a device with external ribs to the exterior housing to slidably use with a rail apparatus.

It may be an advantage to provide a device with a moveable front cover having teeth portions to engage with the complementary teeth portions of a rail apparatus to fix the position of the device in the rail, or a device with extending arm portions for securing the device with or without the need of external equipment or a rail.

It may be an advantage securing the device in a rail with or without a bespoke bolt or with or without a tool or various apparatuses engaged in the device. Once the bespoke bolt is engaged in the device, the front cover interlocks with the complementary teeth portions so that device and the tool or various apparatuses will not slide along the rail apparatus.

It may be an advantage to provide at least one bolt disengagement mechanism from the device for user versatility and convenience depending on how the device may be used or positioned, wherein the positioning of the device may not be desirable or allowable to use a specific disengagement mechanism.

It may be an advantage to provide an aperture of the front cover with a bespoke cross-section so that the matching cross-section of the bolt can be used specifically with the device.

It may be an advantage to provide a device that will self-engage when pressed down or safely collapse to a closed or engaged position without the need of inserting a bolt or external device.

It may be an advantage to provide a bolt disengagement mechanism by pulling the front cover away from the exterior housing, and another bolt disengagement mechanism by pushing the cover flanking sides or the side plates or the external top plate so that if pulling is not desirable or allowable, then pushing to release may be a useful alternative and vice versa.

It may be an advantage to provide a device that will not disengage the front cover or bolt by pulling the front cover.

It may be an advantage to provide a device adapted for using a detachable front centre face button or push-able button or turn-able, rotatable button, without an aperture, or with an aperture so to receive a bespoke bolt or similar.

It might be an advantage to provide a device with a self-engaging and a self-disengaging front centre face button that will retain a bespoke bolt or not, and without the need of the internal mechanism portion of the device to engage or disengage the front centre face button.

It is an object of the present invention to overcome or ameliorate at least one of the disadvantages of the prior art, or to provide a useful alternative.

### Means for Solving the Problem

A first aspect of the present invention may relate to a device adapted to releasably lock with a bolt and or lock/engage the front cover without the need of an external device. The device comprising: a front cover having a cavity which extends from the front cover to a rear portion of the device, wherein the cavity is adapted to receive the bolt with mounting concave portions for securing the bolt in the cavity; a locking mechanism comprising a first group of locking shapes, wherein the first group of locking shapes is moveable between a first position and a second position, wherein the first position is in the cavity, and the second position is in a corresponding first group of locking shape recesses, wherein the first group of locking shape recesses surrounds laterally away from the cavity. Wherein a moveable block, or a moveable sleeve housing, or alternatively a moveable locking shape release block may be covering the cavity, wherein the moveable sleeve housing or an inner-side concave portion of a moveable left and right ball-bearing release blocks comprises the first group of locking shape recesses, wherein the sleeve housing and the release blocks are moveable parallel to the longitudinal axis of the cavity; wherein the first group of locking shape recesses is closed, the first group of locking shapes is in engagement with the mounting concave portion of the bolt, which locks the bolt in the cavity; wherein disengagement of the first group of locking shapes from the mounting concave portions of the bolt is activated by movement of a release plate which expands the cavity and activates opening of the first group of locking shape recesses thereby allowing the first group of locking shapes to retract from the cavity into the first group of locking shape recesses, thereby releasing the bolt. The locking shape may be at least one selected from the group of: ball shape, acorn shape, and peanut shape. The device may also comprise a second group of locking shapes, wherein the second group of locking shapes behave similar. It may be appreciated that the shape of the first group of locking shapes may be same or different to the shape of the second group of locking shapes. It may also be appreciated that when ball bearings or locking ball are mentioned, it can be a locking shape from the group described above or used interchangeably from the shapes described above. Wherein the second group of locking shapes are moveable between a first position and a second position, wherein the first position is in a recessed cavity on the left and right outer flanks of the sleeve housing, and the second position is in a corresponding second group of locking shape recesses, wherein the second group of locking shape recesses surrounds laterally away from the cavity. Wherein the moveable sleeve housing may be covering the cavity, wherein an outer-side concave portion of the moveable left and right locking shape release blocks comprises the second group of locking shape recesses, wherein the sleeve housing and the release blocks are moveable parallel to the longitudinal axis of the cavity; wherein the second group of locking shape recesses is closed, the second group of locking shapes is in engagement with the recessed portions of the sleeve housing, which locks the sleeve housing in the body of the device; wherein disengagement of the second group of locking shapes from the recessed portions of the sleeve housing is activated by movement of a release plate which expands the cavity and activates opening of the second group of locking shape recesses thereby allowing the second group of locking shapes to retract from the cavity into the second group of locking shape recesses, thereby releasing the sleeve housing. Alternatively if the bolt or a bespoke device was not occupying the cavity, it would then be occupied by a cylinder shaft piston, wherein the first group of locking shapes would not be in engagement with the mounting concave portion of the bolt, wherein the first group of locking shapes would be engagement with the left and right front corner flanks of the cylinder shaft piston, whereby locking the cylinder shaft piston in the cavity; wherein disengagement of the first group of locking shapes from the left and right front corner flanks of the cylinder shaft piston and the disengagement of the second group of locking shapes from the recessed portions of the sleeve housing is activated by movement of a release plate which expands the cavities and activates opening of the first group of locking shape recesses and the second group of locking shape recesses, thereby allowing the first group of locking shapes and the second group of locking shapes to retract from the cavities into the first group of locking shape recesses and the second group of locking shape recesses, whereby releasing the cylinder shaft piston and the sleeve housing.

Preferably, the locking mechanism further comprises a second group of locking shapes, wherein the moveable block is positioned between the first group of locking shapes and the second group of locking shapes; a sleeve housing having recessed portions for engaging with a second group of locking shapes, wherein the sleeve housing covers the block and the cavity; wherein the block comprises a second group of locking shape recesses; wherein when the second group of locking shape recesses is in a closed configuration, the second group of locking shapes is in engagement with recessed portions of a sleeve housing; and wherein disengagement of the second group of locking shapes from the recessed portions of the sleeve housing is activated by movement of the release plate which expands the cavity and activates opening of the second group of locking shape recesses of the block thereby releases the sleeve housing.

Preferably, the front cover comprises a centred lateral slot, wherein the lateral slot is adapted to receive a locking rod assembly with a rod; wherein the locking rod assembly biases the rod to be within a lateral side of the front cover such that the front cover can move longitudinally.

Preferably, the bolt comprises a flanged portion at diametrically opposite sides, laterally away from the longitudinal axis of the bolt.

Preferably, the front cover comprises a front rotatable button with the cavity having a bolt retention groove for receiving the flanged bolt, wherein the front button has protruding portions at diametrically opposite sides for actuating the rod to extend out of the lateral sides of the front cover for locking the longitude movement of the front cover, when the front button is rotated by the flanged bolt.

Preferably, the cavity having the bolt retention groove having a first internal cross-sectional shape for receiving the flanged bolt, and a second internal cross-sectional shape for retaining the flanged bolt; wherein the rotation of the front button changes between the first internal cross-sectional shape and the second internal cross-sectional shape.

Preferably, the device further comprising a first spring and a piston, wherein the first spring is in connection between the base of the cavity and a rear end of the piston, and wherein the piston having a piston aperture at the front end, wherein the piston aperture is adapted for receiving a cup and a piston spring.

Preferably, the first spring is larger than the piston spring.

Preferably, the cup has a base and an open end having an inner rim, wherein the base is in connection with the inner surface of the piston, and wherein the open end is adapted to receive a rear end of a connecting rod with an inner rim engagement means.

Preferably, a front end of the connecting rod is in connection with a rear end of a cap, wherein a front end of the cap is adapted to engage with the head of the bolt.

Preferably, the front cover comprises a centred lateral slot, wherein the lateral slot is adapted to receive a pin, a locking rod assembly, a rod that will extend out on the lateral sides of the front cover to lock the longitude movement off the front cover on the device. The locking rod assembly may comprise of, a tubular base with an aperture, a spring, and a rod; the front portion of the rod shaft having a flanged portion extending away from the outer surface of the rod, in which the flanged portion is engageable with the spring; the other end of the spring engages with the non-moveable tubular base; preceding the rods flanged portion is a pin or dome shape end; the rod inserted within the aperture of the spring and the base. With the locking rod assembly inserted within the lateral slot of the front cover, and the dome having a biasing means towards the centre of the front cover; whereby the base part of the locking rod assembly is nested within the cavity at the outer flanks of the lateral slot. When the pins or the rod end portion of the locking rod assembly is protruding out of the side lateral flanks of the front cover, the locking rod assembly is considered to be in a locked or engaged position. There may be a slot or an aperture at the front flanks on the exterior of the main device, adapted for receiving the rod end portion, such that when received, the end portion of the rod will lock the movement of the front cover. By preventing the longitudinal movement of the front cover, the release mechanism cannot be set off. Whereby having the device front cover now in a locked state. The front cover may be locked in an engaged closed position or it may be locked with the front cover moved out in the disengaged, open position.

Preferably, the front centre face button or more preferably referred to as the front button, may be rotated a predetermined distance clockwise or counterclockwise along the longitudinal axis of the main body of the device. With an aperture of a distinctive shape running along the longitude length of the button; with a bolt retention cavity or grooves to allow passage or not, for a complimentary bespoke device. The front button may have a protrusion, a lip extending laterally out at the perimeter of the base, or rim. Whereby the lip protrusion may extend out greater laterally at the flanks and when rotated a predetermined distance, the lip protrusion may be at their narrowest laterally at the flanks. When the lip protrusions are at their greatest at the flanks, the button is considered to be in a locked position; when the lip protrusion are at their narrowest at the flanks, the button is considered to be in an unlocked, open position. The front cover may have a complementary cavity adapted to receive the rotatable lip protrusion or lip of the front button. Whereby rotating the front button, the lip will force the dome portion of the locking rod assembly laterally out, moving the rods within the front cover laterally out towards the flanks; whereby the rod end portion, or pins extend out at the side lateral flanks of the front cover and engage a slot or an aperture at the front flanks on the exterior of the main device, Whereby now having the device, the front button, and front cover in a locked state.

Preferably, furthermore the front button can be off a unique shape that is adapted to receive a bespoke bolt with flange productions. Furthermore, the front button can be rotated along the longitude access, clockwise or counterclockwise a predetermined distance to lock the bespoke bolt with the flange productions.

Preferably, instead of engaging with the head of a bolt the device may be adapted to suit a solid bespoke button, a unique shaped button, or external entity to form part of the device.

Preferably, the piston further comprises a notched portion at the outer surface, wherein the notched portion is adapted to engage with a flange from a middle arm portion of a cylinder rod.

Preferably, the front end of the cylinder rod is in connection with the front button, and wherein the rear end of the cylinder rod is in connection with a cylinder rod rear cup housing, wherein the rear of the cylinder rod cup housing is in connection with a rear plate, wherein the rear plate is in connection with the base of the cavity.

Preferably, the outer surface of the piston further comprises a locking shape engagement surface adapted for receiving the first group of locking shapes when a bolt is not occupying the cavity.

Preferably, the inner surface of the sleeve housing may comprise a locking shape engagement surface on its left and right outer flanks, adapted for receiving the second group of locking shapes either when the device is in an engaged or disengaged position.

Preferably, the device further comprises dowel pins, grub screw or similar fastening devices, wherein the fastening devices connect the front of the sleeve housing to the rear of the front cover.

Preferably, the device further comprises a washer part positioned between the first group of locking shape recesses and the front cover, wherein the washer part is connected to the front end of the sleeve housing spring, and wherein the rear end of the sleeve housing spring is connected to the sleeve housing.

Preferably, moving the front cover longitudinally away from the rear portion of the device is a front cover release mechanism, which also effects the movement of the sleeve housing in the same direction thereby compressing the sleeve housing spring and activating opening of the first group of locking shape recesses, which allows for the disengagement of the first group of locking shapes from the mounting concave portion of the bolt, such that the bolt disengages from the device.

Preferably, the device may further comprise sleeve housing springs on either side of the cylindrical tube housing, the front side connected to the moveable front cover and the rear of the springs residing and connected to the fixed locking shape release lever housing.

Preferably, the device comprising at least one further front cover release mechanism, wherein the further release mechanism is actuated by pressing a release plate selected from at least one of: a left side plate, a right side plate, a first plate, a second plate, and an external top plate. The front cover is positioned between the first plate and the second plate, wherein the faces of the front cover, the first plate and the second plate are flush with each other and all facing in the same direction, the devices with these covers would preferably be referred to as a Standard Front Cover configuration. Whereby the external top plate, which is a full top cover actuating plate; may be integrally united, connected with the first plate and the second plate and above and covering the front cover, this type of configuration is preferably referred to as an External Top Plate configuration.

Preferably by pressing any of the front or side release mechanisms plates, it will force the front cover to elevate, which also effects the movement of the sleeve housing in the same direction. Thereby putting the sleeve housing springs in an extended position and activating, opening of the first group of locking shape recesses and the second group of locking shape recesses. The second group of locking shapes will allow the disengagement of the sleeve housing and the first group of locking shapes allows for the disengagement of the mounting concave portion of a bolt or a front button or an attached entity.

Preferably, the movement of a first predetermined distance of the first plate or the movement of a second predetermined distance of the second plate or the movement of a predetermined distance of the external top plate towards the rear portion of the device actuates locking shape release levers, which move the locking shape release blocks relative towards the front portion of the sleeve housing, such that the first group of locking shapes moves laterally from the first position to the second position; the second group of locking shapes may move laterally from the first position to the second position as well.

Preferably, the locking shape release levers each have an upper arm and a lower arm, wherein the upper arm and the lower arm moves via a scissor mechanism.

Preferably, the rear plate comprises a lateral slot, wherein the lateral slot is adapted to receive both an upper plank and a lower plank, wherein the upper plank and the lower plank is laterally moveable with respect to each other.

Preferably, the upper plank comprises lower apertures and the lower plank comprises upper apertures, meaning the apertures are centralised along the latitude of the two planks and where the two planks meet each other, wherein the lower apertures of the upper plank are each adapted to receive the upper arms of the locking shape release lever, and wherein the upper apertures of the lower plank are each adapted to receive the lower arms of the locking shape release lever.

Preferably, the first plate moves the first predetermined distance, a left first plate rod connected to the first plate, travels a distinctive distance to connect to a first rear rod, the first rear rod actuates a first rod engaging arm of a first rear outer lever, wherein longitudinal movement of the first rod engaging arm pivotally effects a lateral movement to an upper plank engaging arm of the first rear outer lever, which laterally moves the upper plank; wherein the second plate moves the second predetermined distance, a second plate rod in connected to the second plate, travels a distinctive distance to connect to a second rear rod, the second rear rod actuates a second rod engaging arm of a second rear right lever, wherein longitudinal movement of the second rod engaging arm pivotally effects a lateral movement to a lower plank engaging arm of the second rear right lever, which laterally moves the lower plank.

Preferably, the left lever and the right lever are each tilted relative to the longitudinal axis of the cavity and inclined slightly whereby the levers engaging arm engages with the upper plank and lower plank, respectively.

Preferably, the lateral movement of the left plate towards the right side of the device connects with a lower plank engagement arm and actuates the lower plank engaging arm, which laterally moves the lower plank; and wherein the lateral movement of the right plate towards the left side of the device connects with a upper plank engagement arm and actuates the upper plank engaging arm, which laterally moves the upper plank, such that the locking shape release blocks relative move towards the front portion of the sleeve housing, such that the first group of locking shapes moves laterally from the first position to the second position, and whereby the second group of locking shapes may move laterally from the first position to the second position.

Preferably, the back of the front cover comprises an upper and lower rack with teeth, wherein each of the upper and lower rack have a corrugated profile or a square wave profile. Whereby the back upper and lower rack of the front cover may be of a unique or distinctive shaped extending arm portion of the front cover for securing to an external device.

Preferably, the device is adapted to be mounted to a track having an upper and lower rack with complementary teeth, wherein the complementary teeth is adapted to engage with the teeth of the front cover such that the device is fixedly mounted to the track when the front cover is flush with the first plate and the second plate. Whereby the device may be adapted to be mounted to an external device that complements the unique or distinctive shaped extending arm portion of the device.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1A illustrates a perspective view of the device engaged with a bolt in accordance with a preferred embodiment of the present invention.

FIG. 1B illustrates a top cross-section view of FIG. 1A, where the device is in an unreleased configuration and the front cover is, engaged in an IN position. Whereby the first set of ball-bearings are engaging with the non-recessed portion of the sleeve housing, and the first group of locking balls are in there first position.

FIG. 1C to FIG. 1E illustrates a perspective view showing a partially assembled internal mechanism of FIG. 1A.

FIG. 1F illustrates a perspective view of FIG. 1A when disengaged with a bolt in accordance with a preferred embodiment of the present invention.

FIG. 1G illustrates a top cross-section view of FIG. 1F, where the device now is in a released configuration with the front cover in an, disengaged Out position. Whereby the first set of ball-bearings are retained within the concave surfaces of the sleeve housing, and the first group of locking balls are in there second position.

FIG. 1H to FIG. 1I illustrates a perspective view of a partially assembled internal mechanism of FIG. 1F.

FIG. 1J illustrates a top cross-section view of the device with the front cover in an engaging movement in, where it shown here just before reaching its final engaged, collapsed in position.

FIG. 1K illustrates an exploded view of FIG. 1A.

FIG. 2A illustrates a perspective view of the device engaged with a bolt in accordance with another preferred embodiment of the present invention.

FIG. 2B illustrates a top cross-section view of FIG. 2A, where the device is in an unreleased configuration and the front cover is, engaged in an IN position. Whereby the first set of ball-bearings are engaging with the non-recessed portion of the sleeve housing, and the first group of locking balls are in the first position.

FIG. 2C to FIG. 2E illustrates a perspective view of the device showing a partially assembled internal mechanism of FIG. 2A.

FIG. 2F illustrates a perspective view of FIG. 2A when disengaged with a bolt in accordance with a preferred embodiment of the present invention.

FIG. 2G illustrates a top cross-section view of FIG. 2F, where the device now is in a released configuration with the front cover, disengaged in an Out position. Whereby the first set of ball-bearings are retained within the concave surfaces of the sleeve housing, and the first group of locking balls are in the second position.

FIG. 2H to FIG. 2J illustrates a perspective view showing a partially assembled internal mechanism of FIG. 2F.

FIG. 2K illustrates an exploded view of FIG. 2F.

FIG. 3A illustrates a perspective view of the device engaged with a bolt in accordance with another preferred embodiment of the present invention.

FIG. 3B illustrates a top cross-section view of FIG. 3A.

FIG. 3C to FIG. 3E illustrates a perspective view showing a partially assembled internal mechanism of FIG. 3A.

FIG. 3F illustrates a perspective view of FIG. 3A when disengaged with a bolt in accordance with a preferred embodiment of the present invention.

FIG. 3G illustrates a top cross-section view of FIG. 3F.

FIG. 3H to FIG. 3J illustrates a perspective view showing a partially assembled internal mechanism of FIG. 3F.

FIG. 3K illustrates an exploded view of FIG. 3A.

FIG. 4A illustrates a perspective view of the device engaged with a bolt in accordance with another preferred embodiment of the present invention.

FIG. 4B illustrates a perspective view of FIG. 4A when disengaged with a bolt in accordance with a preferred embodiment of the present invention.

FIG. 4C illustrates a top cross-section view of FIG. 4A.

FIG. 4D to FIG. 4I illustrates a perspective view of FIG. 4A showing a partially assembled internal mechanism of FIG. 4A.

FIG. 4J illustrates a top cross-section view of FIG. 4B.

FIG. 4K to FIG. 4P illustrates a perspective view of FIG. 4B showing a partially assembled internal mechanism of FIG. 4B.

FIG. 4Q illustrates an exploded view of FIG. 4B.

FIG. 5A illustrates a perspective view of an embodiment that shows a device with a front cover with engaging teeth and a rotatable solid front button with a tool placement cavity.

FIG. 5B illustrates a perspective view of an embodiment that shows a device with a front cover and non-rotatable front button with a bolt receiving cavity. Shown with the front cover in a disengaged and out position and all the release plates pressed down.

FIG. 5C illustrates a perspective view of an embodiment that shows a device with a front cover with engaging teeth and a rotatable solid front button.

FIG. 5D illustrates a perspective view of an embodiment that shows a device with a front cover with engaging square teeth and a rotatable front button with a bolt flange retention cavity.

FIG. 5E illustrates a perspective view of an embodiment showing a device with a rotatable front button with a tool placement cavity. The button is shown pressed down a predetermined distance into the device so to allow the front cover and cylinder shaft piston to engage and lock.

FIG. 5F illustrate a perspective view of an embodiment showing a device with a front cover in a disengaged, out position and the front button, a flush groove type with a bolt receiving cavity.

FIG. 6A illustrates a perspective view of an embodiment showing a device with a front cover with engaging teeth, an external top plate, and a front button with a bolt receiving cavity. The device is showing the front cover and button in an engaged closed configuration, whereby the front button is flush with the external top plate.

FIG. 6B illustrates a perspective view of FIG. 6A, whereby the device is now shown with the front cover in a disengaged out configuration and the front button extending out away from the external top plate.

FIG. 6C illustrates a perspective view of an embodiment where the device is configured with an external top plate with a front button that has an external cavity to accept a tool placement. The device is shown with the front cover in a disengaged position and the front button not extending out but flush with the external top plate. Meaning when the device is in an engaged position the front button would be sitting slightly further in then the external top plate.

FIG. 6D illustrates a perspective view of an embodiment where the device is shown with an external top plate and a front button that protrudes out slightly. The device is shown in a disengaged configuration, with a detachable groove type non-rotating solid button attached to a grooved type rear button guide, as in the illustration in FIG. 12G.

FIG. 6E illustrates a perspective view of a preferred embodiment where the device is shown with an external top plate, a front cover with engaging teeth rack, and the front button being a rotatable, detachable groove type and with a bolt flange retention/receiving cavity. The illustration is showing the device in an engaged closed configuration with the front button in an unlocked position, similar to the illustration in FIG. 21B.

FIG. 6F illustrates a perspective view of FIG. 6E whereby the device is now shown in a disengaged, out position and the front button extending out and rotated clockwise to its further most position, whereby the front button and locking rod assembly are in a locked, engaged position, as in the illustration in FIG. 21D.

FIG. 7A illustrates a top cross-section view of FIG. 5F, where it shows a Standard Front Cover configuration with a groove type flush front button, and with the front cover IN/engaged or closed position.

FIG. 7B illustrates a top-cross section view of FIG. 5F, and the front cover is in a disengaged, out configuration.

FIG. 7C illustrates a top cross-sectional view of FIG. 6A, but where the front button has now been pressed down a predetermined distance towards the rear of the device so to engage the first group of balls first and then to engage the second group of balls, where the cylinder shaft piston and the sleeve housing are IN/engaged. FIGS. 7C to 7H are all External Top Plate configurations.

FIG. 7D illustrates a top cross-sectional view of FIG. 6A but where the front cover on this illustration is in a disengaged, out position. A perspective view illustration of FIG. 7D can be seen on FIG. 6B.

FIG. 7E illustrates a top cross-sectional view of FIG. 6E, however the front section of the front button does not protrude as much as in FIG. 6E.

FIG. 7F illustrates a top cross-sectional view of FIG. 6F, but with a shorter front section of the front button.

FIG. 7G illustrates a top cross-sectional view of a preferred embodiment, shown with all the assemblies pushed down, that is, the External-Top-Plate the Left-Side-Plate and the Right-Side-Plate. With device now in a disengaging movement out, whereby ejecting the bolt.

FIG. 7H illustrates a top cross-sectional view of FIG. 7G, but where the internal mechanism of the device has been pressed down a predetermined distance to engage and lock the bespoke bolt in the device using the bolt flange protrusions of the bolt to do the locking.

FIG. 8A to FIG. 8B illustrates a perspective view of a preferred embodiment of the front cover with engaging teeth for interlocking with a rail with engageable complementary teeth portions; generally seen on, for example FIG. 1F devices.

FIG. 9A to FIG. 9B illustrates a perspective view of another preferred embodiment of the front cover with engaging teeth for interlocking with a rail with engageable complementary teeth portions, FIG. 9B also shows a front button; generally seen on, for example FIG. 3F devices.

FIG. 10A to FIG. 10D illustrates a perspective view of another preferred embodiment of the front cover for a non-rotatable type front button, shown with and without the interlocking engaging teeth portions; generally seen on, for example FIG. 5B and FIG. 5F devices.

FIG. 10E to FIG. 10G illustrates a perspective view of another preferred embodiment of the front cover for a non-rotatable type front button, shown with the interlocking engaging teeth portions; generally seen on, for example FIG. 6B devices.

FIG. 10H to FIG. 10K illustrates a perspective view of another preferred embodiment of the front cover for a rotatable type front button, shown with and without the interlocking engaging teeth portions, generally seen on for example FIG. 5A and FIG. 5C to FIG. 5E devices. With the front button having the bolt flange cross-section aperture.

FIG. 10L to FIG. 10R illustrates a perspective view of another preferred embodiment of the front cover for a rotatable type front button, shown with the interlocking engaging teeth portions; generally seen on, for example FIG. 6C to FIG. 5F devices.

FIG. 11A illustrates a perspective view of the front button shown in FIG. 10M, show here in an unlocked configuration, whereby the locking rod assembly is engaged with the narrowest part of the front buttons lip protrusions.

FIG. 11B illustrates a perspective view of FIG. 11A, show here in a locked configuration, whereby the locking rod assembly is engaged with the widest part of the front buttons lip protrusions. The button assembly configuration shown here and in FIG. 11A can be seen on FIG. 21A to FIG. 21I illustrations.

FIG. 11C illustrates a perspective view of another preferred embodiment of a front button shown in FIG. 10K, show here in an unlocked configuration, whereby the locking rod assembly is engaged with the narrowest part of the front buttons lip protrusions.

FIG. 11D illustrates a perspective view of FIG. 11C and FIG. 10P, show here in a locked configuration, whereby the locking rod assembly is engaged with the widest part of the front buttons lip protrusions.

FIG. 11E illustrates a perspective view of another preferred embodiment of a front button shown in FIG. 10Q, show here in an unlocked configuration, whereby the locking rod assembly is engaged with the narrowest part of the middle button guide lip protrusions.

FIG. 11F illustrates a perspective view of FIG. 11E and FIG. 10R, show here in a locked configuration, whereby the locking rod assembly is engaged with the widest part of the middle button guide lip protrusions.

FIG. 12A illustrates a perspective view showing a partially assembled internal mechanism of FIG. 5D and FIG. 7H. Even though the outside front appearance of FIG. 5D and FIG. 5H are different, the internal mechanism is the same. Showing the partial device in a closed, engaged position.

FIG. 12B illustrates a perspective view showing a partially assembled internal mechanism of FIG. 12A and FIG. 7G. Showing the partial device in a disengaging movement outward, and to an out position.

FIG. 12C illustrates a perspective view showing a partially assembled internal mechanism of FIG. 12A, with a side cross-sectional view of the rear button guide, showing the rear sleeve section sliding along the front of the cylindrical tube housing. The advantage of doing this is that it stabilizes the connected front button within the device and eliminates the need to have the bit cylinder rods attached, as opposed to being inserted into the front button or the rear button guide.

FIG. 12D illustrates a perspective view showing a partially assembled internal mechanism of FIG. 6E and FIG. 7E. Showing the partial device in a closed, engaged position. Showing a rear button guide interacting with the release block when the locking ball are in the first position.

FIG. 12E illustrates a perspective view showing a partially assembled internal mechanism of FIG. 6F and FIG. 7F. Showing the partial device in a disengaged, out position. Showing a rear button guide interacting with the release block when the locking ball are in the second position.

FIG. 12F illustrates a perspective view showing a partially assembled internal mechanism of FIG. 12D, with a side cross-sectional view of the rear button guide and showing the rear sleeve section sliding along the front of the cylindrical tube housing and showing the bit cylinder rods diametrically opposed, resting behind the button, not inserted into the front button or the rear button guide.

FIG. 12G illustrates a perspective view showing a partially assembled internal mechanism of FIG. 6D and FIG. 7C to FIG. 7D. Showing the partial device in a closed or engaged position. Even though the outside front button appearance of FIG. 7C and FIG. 7D are different to FIG. 12G, the internal mechanism is the same.

FIG. 12H illustrates a perspective view showing a partially assembled internal mechanism of FIG. 12G, with a side cross-sectional view of the rear button guide showing the external grooves of the front button retained within the complementary, internal grooves of the rear button guide. Showing the first and second group locking balls are in the first position.

FIG. 12I illustrates a perspective view showing a partially assembled internal mechanism of FIG. 7F and FIGS. 6E, with a side cross-sectional view of the rear button guide and the middle grooved button guide. The front grooved button attachment, as can be seen on FIGS. 11E and 11F, may have a recessed surface, indentation along its longitudinal axis from the snap ring to the front, to accommodate an elongated mound of a front button, as in FIG. 22A. Showing the first and second group locking balls are in the second position. Showing a partially wireframe view of a rear outer lever, tilted relative to the longitudinal axis of the cavity and inclined slightly, where its pivoted from a centred longitudinal rod and where the movement of the rod's direction effect a lateral upper or lower movement of a plank. The advantage of inclining the first rear lever and the second rear lever is to save space in the device.

FIG. 13A to FIG. 13G illustrates a Standard Front Cover configuration perspective view showing a partially assembled internal mechanism of FIG. 7A and FIG. 7B.

FIG. 14A to FIG. 14H illustrates a perspective cross-sectional and partial view of FIG. 12A to FIG. 12C, showing a cutaway of the rear button guide and front button. The illustrations are showing a bespoke bolt with flange protrusions, exiting the cavity of the front portion of the button; or whereby its retained in the buttons cavity if the rear button guide and the front buttons aperture, flanged cross-sections are not-aligned to allow the flanged bespoke bolt free passage. On FIG. 7G and FIG. 7H you can see a top cross-section view however on 7G, 7H the front section of the front button does not protrude as much.

FIG. 14I illustrates a clear perspective view of the bespoke bolts rear body section with the concave portion that engages with the ball-bearings and the tubular front section with the flanged protrusions. Whereby the aperture of the tubular part slides over the stem portion of the bolts rear body section and freely able to rotate around the stem.

Similar to FIG. 14A, FIG. 14J to FIG. 14L illustrates a perspective view of another preferred embodiment of the device, showing a bespoke bolt with the flange protrusions engaging, whereby the front face/surface of the flange protrusions are making contact with the rear button guide, as opposed to FIG. 14A showing the rear face/surface of the flange protrusions are making contact with the rear button guide.

FIG. 14M to FIG. 14P illustrates a perspective view of FIG. 14J to FIG. 14L, showing a side cross-sectional view, illustrating a bespoke bolt with flange protrusions, exiting the cavity of the rear button guide and the front button; or whereby its retained if the flange protrusions are not-aligned with the complementary cavity of the rear button guide.

FIG. 15A to FIG. 15C illustrates a perspective side cross-sectional view of the partially assembled internal mechanism of FIG. 12D to FIG. 12F. The sequence of illustrations is showing a solid front button having a helical ridge running around the outside perimeter of the base of the button. The base is attached to a bespoke bolt and at the furthest end towards the cylinder shaft piston, attached to the button is a cylinder shaft piston substitute. When finally threatened onto the complimentary, internal grooves of the device the substitute piston takes the place of the internal piston. Together when attached they may be considered as one whole device.

FIG. 15D illustrates a close-up perspective view of the cylinder shaft piston abut with the substitute piston that is attached to the rear of the solid front button.

FIG. 15E illustrates a rear perspective view of the substitute piston and the attached front button or solid front button.

FIG. 16A illustrates a perspective cross-sectional view of a preferred embodiment of a device with a preferred embodiment of a front button in an unreleased configuration, in which the first set of ball-bearings and the second set of ball-bearings are not retained in the concave surfaces of the ball-bearing release block.

FIG. 16B illustrates FIG. 16A in a released configuration, in which the first set of ball-bearings and the second set of ball-bearings are retained in the concave surfaces of the ball-bearing release block. FIG. 16B is a perspective cross-sectional view of FIG. 5B.

FIG. 16C illustrates a perspective cross-sectional view of a preferred embodiment of a device with a solid front button. Whereby the lip protrusions of the button are in an engaged position and the locking rod assembly pins are extended out, as such locking the front cover, the face of the device. Also, this configuration has a ball plunger in the front section of the rear button guide aiding in securing the front button in a first position and a second position by creating a resistance between them.

FIG. 16D illustrates a perspective cross-sectional view of FIG. 5A, shown with a rotatable solid front button with a tool placement cavity. In this illustration the buttons lip protrusions are not in an engaged but in a disengaged position, whereby the locking rod assembly pins are disengaged from the device.

FIG. 16E illustrates perspective cross-sectional view of FIG. 5E, showing a device with a rotatable front button with a tool placement cavity, illustrating that the front button can be moved a predetermined distance into a preferred embodiment of the device so that the front button is not flush with the front cover, thereby allowing the sleeve housing and cylinder shaft piston to engage and lock.

FIG. 16F illustrates perspective cross-sectional view of FIG. 16E and similar to any of these other Standard Front Cover configurations as shown in FIG. 16A to FIG. 16D, showing the embodiment in a released disengaged configuration and the lip protrusions of the front button are not engaged with the front cover locking rod assembly.

FIG. 17A illustrates a perspective cross-sectional view of another preferred embodiment of a device with another preferred embodiment of a front button in an unreleased configuration, in which the front button extends beyond the external top plate and that the front button has an aperture and bolt flange retention cavity for receiving a bolt within the rear button guide and the front button. The lip protrusions of the front button are engaging with a button tensioner, similar to the locking rod assembly but where the base section is sealed at the outer lateral flanks of the front cover. An advantage of using a tensioner is when there is limited space, and the ball plunger is not able to be used within the front button configuration. FIG. 17A shows the button assembly in a locked configuration meaning a flange type bespoke bolt cannot exit or enter; whereby a hex bolt without a flange has free passage.

FIG. 17B illustrates FIG. 17A, show here in an unlocked configuration, whereby the locking rod assembly is engaged with the narrowest part of the rear button guide lip protrusions. Whereby now a flange type bespoke bolt can exit or enter the cavity; whereby a hex bolt without a flange has free passage.

FIG. 17C illustrates a perspective view of FIG. 17B, in an unlocked configuration as well. With a standard hex bolt inserted within the cavity of the device the hex bolt having a round smooth front section whereby allows for the button to be rotated without any restrictions.

FIG. 17D illustrates a perspective view of FIG. 17A, the front button has been rotated clockwise to a locked position; with the release mechanism triggered, and the ejected bolt still retained in the cavity of the rear button guide; whereby the bolt flanges or the protrusions are retained in the buttons cavity when the rear button guide and the front buttons, aperture cross-sections are not-aligned to allow the flanges or the protrusions to exit the device. An advantage of having a tensioner opposed to having a locking rod assembly is that even though the front button has been rotated to put the tensioner in a locked position there are no pins protruding out of the front cover flank sides, whereby not locking the external top plate and still allowing the release mechanism to triggered.

FIG. 17E illustrates a perspective view of FIG. 17B, with the front button in a unlocked position and the release mechanism triggered, the ejected bolt can now exit the cavity of the button assembly; whereby the bolt flanges or the protrusions are aligned with the rear button guide and the front button and allowing unrestricted passage. On the above illustrations FIG. 17A to 17E, on this preferred embodiment, there is a radial bearing positioned between the rear button guide and the front button. The radial bearing is to allow the front button to rotate freely against the internally fixed rear button guide.

FIG. 18A to FIG. 18D illustrates a Standard Front Cover configuration, where FIG. 18A illustrates a perspective cross-sectional view of a preferred embodiment, where the device is in an unreleased configuration, in which the first set of ball-bearings and the second set of ball-bearings are not retained in the concave surfaces of the ball-bearing release block. With the front button unlocked and the narrowest part of the rear button guide lip protrusions at the flanks; using a ball plunger to aid in securing the front button in a first position and a second position.

FIG. 18B illustrates 18A with the release mechanism triggered and the front cover ejected out in which the first set of ball-bearings and the second set of ball-bearings now are retained in the concave surface of the ball-bearing release block; the front button has been rotator a predetermined distance where now the lip extrusions are at their widest at the flanks; the device now disengaged and the button in a locked configuration.

FIG. 18C illustrates 18B where the front button has been rotated counterclockwise and a bespoke bolt has been inserted into the cavity of the device by using one of three different methods to engage the bolt: By pushing down on the front cover will simultaneously engage the first set of ball-bearings and the second set of ball-bearings; By pressing down on the front button where it will press against the sleeve housing forcing the first set of ball-bearings and then followed by the second set of ball-bearings; Or by using a bespoke bolt with flange protrusions where the front rotatable section of the bespoke bold will rest on an internal part of the rear button guide and then slide down on the bolt stem pushing down against the rear button guide forcing the button assembly down a predetermined distance where the lip protrusions of the front button will hit against the sleeve housing where it will now engaged the first set of ball-bearings followed by the second set of ball-bearings. In which now the first set of ball-bearings and the second set of ball-bearings are retained in the non-recessed portions of the ball-bearing release blocks and the second set of ball-bearings are retained in the recessed cavity on the left and right outer flanks of the sleeve housing; locking the device in an engaged configuration.

FIG. 18D illustrates 18C whereby the button assembly has been pushed back up, forced up by the bit cylinder rod assembly; the bespoke bolt flanged front portion has now travelled back up on the bolt stem, and a narrow gap present between the main rear body of the bolt and the flanged portion of the front bolt tubular part. where now the lip protrusions of the front button are resting on the inside complementary cavity of the front cover; there is now a narrow gap between the lip protrusions of the front button and the sleeve housing. Note: the button assembly is any part that is directly connected to the front button, for example in this configuration the rear button guide, the snap ring the ball plunger and the front button itself.

FIG. 19A to FIG. 19I illustrates an External Top Plate configuration, where FIG. 19A illustrates a perspective cross-section view of a another preferred embodiment showing the device the front cover is out and in a disengaged configuration, and the front button lip protrusions are at their widest at the flanks, whereby pushing the locking rod assembly into an aperture on the inside flanks of the external top plate, and the main body, putting the device in a locked position. The external top plate cannot be pressed down now.

FIG. 19B illustrates FIG. 19A where the lip protrusions of the front button are at their narrowest and the button is in an aligned position with the rear button guide, a bespoke bolt has been inserted into the cavity of the device and the front button assembly has been pressed down either by the button or the bolt.

FIG. 19C illustrates FIG. 19B where the front cover is down and engaged the button and locking rod assemblies in a locked position; the bolt tubular flanged portion has travelled back up the bolt stem; the external top plate is locked in by the locking rod assembly, therefore, cannot be pressed down.

FIG. 19D illustrates 19C whereby the front button has been rotated counterclockwise and the lip protrusions are at their narrowest whereby forcing the springs of the locking rod assembly to push against the flanged portion of the rod and the dome section travelling laterally inward towards the centre of the button cavity intern releasing the external top plate from its locked position, therefore, it can be pressed down.

FIG. 19E illustrates 19D wherein a standard hex bolt has been inserted into the cavity of the device; the lateral cross-section of the bolt is all equal along it's longitudinal axis and with a concave portion at the base to accept the first set of ball-bearings. As such with a standard hex bolt inserted and engaged within the body of the device the front button assembly cannot be rotated along it's longitudinal axis, restricted by the shape of the bolt complementing the main aperture of the button assembly. Therefore, by having a standard hex bolt inserted you cannot rotate and lock the front Button and in turn front cover.

FIG. 19F illustrates a partial side cross-sectional perspective view of FIG. 7G and any of FIGS. 19A to 19I showing the device where the external top plate has been pushed down and the device is in a disengaging movement out. The front button in a locked position; the locking rod extended out laterally; the front cover in its outermost position; and showing a cutaway of the sleeve housing held within the body of the device by the ball release lever housing retaining C-clip.

FIG. 19G illustrates 19E whereby the release mechanism has been triggered and the hex bolt is ejected out of the device. The illustration is showing how the external top plate has been pushed down to disengage the device.

FIG. 19H illustrates 19E whereby the release mechanism has been triggered and the hex bolt is rejected out of the device. Now the illustration is showing that the left side plate or the right side plate was used to disengage the device.

FIG. 19I illustrates 19A showing that the front cover now is in and the device is in an unreleased, engaged configuration, and like FIG. 19A the front button is in a locked position whereby the widest part of the lip protrusions are extended out laterally and the locking rod assembly engaged and putting main body of the device in a locked position, and the external top plate cannot be pressed down.

Similar to FIG. 6B, FIG. 20A illustrates another preferred embodiment of a device, shown here in a disengaged configuration and a rotatable front button with a tool placement cavity. Showing that the front button is extended out beyond the top external plate when disengaged.

FIG. 20B illustrates 20A whereby the device is in a closed, engaged configuration and the front button with the tool placement cavity is now flush with the outside top external plate.

FIG. 20C illustrates FIG. 6C another preferred embodiment of a device, shown here in a disengaged configuration and a front button that has an external cavity to accept a tool placement, the face of the button is flush with the top external plate. As opposed to FIG. 20A where the front button is extended out beyond the top external plate.

FIG. 20D illustrates 20C where that the device is in a closed engaged configuration and the front button with the external tool placement cavity is recessed in, sitting within not flush with the outside top external plate.

FIG. 21A illustrates FIG. 6E, an External Top Plate in an unreleased configuration. The button assembly comprising of: a rear button guide, a first snap ring, a middle grooved button guide, a front grooved button attachment with a recessed surface as in FIG. 12I, a second snap ring, a ball plunger, and a front button with an elongated mound on the inside rear of button cavity as in FIG. 22A. Where the button assembly cross-section apertures are aligned and with the locking rod assembly in an open position.

FIG. 21B illustrates a partial perspective view, where the front button of the button assembly has been pushed down, and the middle button guide abuts and resting on the sleeve housing; while held down, the lip protrusions of the middle button guide are at their narrowest at the flanks and engages with the button retention pins located on the sleeve housing, as such, the middle button guide cannot rotate. As with FIG. 21A the button attachment and the front button flanged cross-section apertures are aligned; with the elongated mound of the front button resting on a first position of the front button attachment and with the locking rod assembly in an open position.

FIG. 21C illustrates FIG. 21B, while the middle button guide is held down, and still engaged with the button retention pins, the front button can be rotated a predetermined distance clockwise to a locked position, wherein the front button rotates along its central longitude axis and the elongated mound moves within the front attachments recessed surface from the first position to a second position. Wherein the button attachment and the front button, flanged cross-section apertures are now not-aligned, and with the locking rod assembly still in the open position.

FIG. 21D illustrates FIG. 21C, where the button assembly has now moved back up, forced up by the bit cylinder rod assembly. While the rear button guide stays stationary and the elongated mount resting on the second position of the recessed surface of the front button attachment, the button assembly has once again been turned a predetermined distance clockwise, wherein the middle button guide lip protrusions now are at their widest at the flanks, and the locking rod assembly is now in a locked position, and the button attachment and the front button, flanged cross-section apertures remain the same, not-aligned.

FIG. 21E illustrates, showing a full perspective view of the front buttons position as it is in FIG. 21D.

FIG. 21F illustrates, a perspective view of FIG. 21D, with the button assembly now pushed down once again, and with the middle button guide resting on the sleeve housing, as the middle button guide has not been rotated the lip protrusions are still widest at the flanks, where now a notched section of the lip protrusions engages with the retention pins.

FIG. 21G illustrates FIG. 21F, while the button assembly is held down the front button is rotated counterclockwise. Because the rear or internal parts of the button assembly cannot rotate with the front button, because the notched section is engaged with the retention pins, as such, the buttons elongated mount moves along the recessed surface back to the first position of the button attachment. With the locking rod assembly remaining in the locked position, and the button attachment and the front button flanged cross-section apertures once again realigned.

FIG. 21H illustrates a full perspective view of the front buttons position as it is in FIG. 21G, showing the button assembly has now moved back up, where it has been forced up by the bit cylinder rod assembly. With the middle button guide moved up, the notched section of the lip protrusions are no longer engaged with the retention pins.

FIG. 21I illustrates FIG. 21H, with the rear button guide staying stationary and the elongated mount resting on the first position of the recessed surface of the front button attachment; the button assembly has once again been turned a predetermined distance counterclockwise, wherein the middle button guide lip protrusions once again are at their narrowest at the flanks, and the locking rod assembly is now in an open position. And with the button attachment and the front button, flanged cross-section apertures remain the same, aligned as in FIGS. 21H and 21A. The main difference between this button assembly configuration and the one on, for example FIG. 19A is that on this button assembly the lip protrusions rear section and the front section of the front button are a separate part, as such, rotate independently, thereby having more options on how to place the alignment of the flanged cross-section apertures within the button assembly and the positioning of the locking rod assembly.

FIG. 22A illustrates a rear perspective view of the front button embodiment used in FIG. 11E and in FIG. 21A, where on the rear sleeve section of the button there is an semi circumference elongated mount that works in combination with the recessed surface found on the front button attachment as in FIG. 12I. Also, a clear view of the bolt flange retention/receiving cavity within the button aperture, and a guide groove for the ball plungers allocated desired position.

FIG. 22B illustrates FIG. 22A where, attached to the rear of the rotatable front button, via a snap ring, is the button attachment. The button attachment having external grooves around the outer perimeter, and with a circle aperture cut into the rear part of the cross-section aperture at a predetermined distance to accommodate the bit shank ram cup.

FIG. 22C illustrate FIG. 22B where you can see the circle aperture at the rear of the front button attachment.

FIG. 22D illustrates a rear two-dimensional view of FIG. 22B where you can see the bit shank ramp cup resting within the circle aperture and on the top right and bottom left are the flanged cavity protrusions for receiving the complementary bespoke bolt flange protrusions e.g. FIG. 14I.

FIG. 22E illustrates FIG. 22D showing, that when the button assembly has rotated the predetermined distance, its movement does not interfere with the function of the bit shank ram cup.

FIG. 23A illustrates a partially assembled right front perspective view, similar to FIG. 21B, showing the button assembly pushed down, where the middle button guide is resting on the sleeve housing, with the cross-section apertures aligned and the locking rod assembly in an open position. A bolt swivel with the protruding flanges, the front part of the bespoke bolt is now used to push in the button assembly and engage the bolt.

FIG. 23B illustrates FIG. 23A, and similar to FIG. 21C, with the middle button guide held down and engaged with the retention pins, the front button is rotated clockwise using the flanged swivel of the bespoke bolt to do the rotating, now the cross-section apertures are not-aligned and the locking rod assembly is in the open position.

FIG. 23C illustrates FIG. 23B, and similar to FIG. 21D, with the bolt swivel released the button assembly moves back up. The button assembly has been once again rotated clockwise either using the front button, or by using the bolt swivel that is engaged with the button attachment to do the rotating. With the cross-section apertures not-aligned, and the locking rod assembly in the locked position, as such, the external top plate is locked and cannot be pushed down, and the bespoke bolt, or a hex bolt cannot be ejected.

FIG. 23D illustrates FIG. 23C, and similar to FIG. 21H, shown here with the button attachment and the front button flanged cross-section apertures aligned with the bespoke bolt flange protrusions. To have put it in this position, you could have either, 1) used the description mentioned in FIGS. 21F and 21G, or 2) while holding the bolt swivel, and with the flange protrusions engaging with the button attachment, so that way it cannot move, then rotate the front button counterclockwise. With the locking rod assembly still in a locked position, like FIG. 23C, nothing can be ejected.

FIG. 23E illustrates FIG. 23D, and similar to FIG. 21I, with the middle button guide lip protrusions now narrowest at the flanks and away from the retention pins, and with the button assembly turned counterclockwise either by using the front button, or the bolt swivel. With the button attachment and the front button flanged cross-section apertures aligned, and the locking rod assembly in the open position, the bespoke bolt with flange protrusions can be ejected. If you were to turn the front button clockwise, similar to FIG. 23B or 23F, where then the locking rod assembly would still be in the open position, but the cross-section apertures would not be aligned, you would not be able to eject a bespoke bolt, but you would still be able to ejected a hex bolt.

FIG. 23F illustrates a perspective view of FIG. 24J and similar to FIG. 23B, while in a disengaged configuration the button assembly may be pushed down, where the middle button guide is resting on the sleeve housing, and the lip protrusions engaging surface is in contact with the retention pin. Whereby, allowing the front button to turn clockwise so the flanged cross-section apertures are not-aligned, and preventing the locking rod assembly going into a locked position.

FIG. 24A illustrates a top cross-sectional view of FIGS. 21B and 23A, where in this top view you can see the first set ball-bearings engaging within the concave portion of the bespoke bolts rear shank stem, and the button assembly getting pushing back by the flanged protrusions of the flanged swivel.

FIG. 24B illustrates a top cross-sectional view of FIGS. 21C and 23B, as with FIG. 24A you can see here the locking rod assembly engaging with the flange lip protrusions of the front button.

FIG. 24C illustrates a top cross-sectional view of FIGS. 21D and 23C, where in this top view you can see that the bolts flanged swivel and the button assembly moved away in a longitudinal direction towards the front of the device.

FIG. 24D illustrates a top cross-sectional view of FIGS. 21H and 23D, showing a top view of the button attachment and the front button flanged cross-section apertures aligned with the bespoke bolt flange protrusions.

FIG. 24E and FIG. 24F illustrates a top cross-sectional view, and similar to FIG. 23F, showing the device where the External-Top-Plate assembly has been pushed down and disengaged the device, where now it's in a forward movement out. With the bolt not exiting the cavity, the lip protrusions of the bolt are stopped by the cross-section apertures that are not-aligned.

FIG. 24G illustrates a top cross-sectional view, and similar to FIG. 23D, shown here with the device in an out, disengaged position, and the locking rod assembly in a locked position, with the cross-sectional apertures aligned. Shown with a bespoke bolt inserted within the cavity, where it cannot be engaged while the external top plate is in a locked position. If the bespoke bolt or a hex bolt is inserted, and while within the body of the button assembly its rotated counter-clockwise, it would then unlock the external top plate, where then the device and bolt may be engaged.

FIG. 24H illustrates a top cross-sectional view of FIGS. 21A and 23E, showing a top view of the device in an engaged configuration, with the first group of ball-bearings engaging with the side front corner flanks of the cylinder shaft pistons engagement surface.

FIG. 24I illustrates FIG. 24A, and similar to FIG. 24H, showing the button assembly has been pushed down, engaging with the sleeve housing, in turn pushing down the cylinder shaft piston where its flange engages with the notched cut-out of the cylinder shaft piston, where it moves away from the first group of ball bearings.

FIG. 24J illustrates a top cross-sectional view of FIG. 23F, and similar to FIG. 24H, showing a top view of the device in a disengaged configuration, with the first group of ball-bearings engaging with the side walls of the cylinder shaft pistons engagement surface

FIG. 25A to FIG. 25D illustrates partially assembled perspective views of preferred embodiments, where the device can be suited to work with many different variations of bespoke bolts or hex bolts and with or without a bespoke flange protrusion.

FIGS. 26A to 26E each illustrates a perspective cross-sectional view of another preferred embodiment of a device, which in these cross-section views, show that the bit cylinder rods are diametrically opposed as well as being inserted into the rear of the front button or resting behind the rear button guide but not inserted into the rear button guide. These illustrations all show non-rotating button configurations. Also FIGS. 26C, 26D and 26E each have a solid button assembly showing that the cylinder shaft piston can be inserted into the rear of the button or where it can be Incorporated as one unit, the button and cylinder piston as one.

FIG. 26F illustrates a perspective side cross-sectional view of the partially assembled internal mechanism of a non-rotating button configuration. Similar to FIG. 15A to FIG. 15E; the solid front button having an external groove at the rear of the button to mate with the complementary, internal groove of the embodiment device.

FIG. 27A to FIG. 27C each illustrates a perspective cross-sectional view of another preferred embodiment of a device with another preferred embodiment of a button assembly, in which in these cross-section views, show that the bit cylinder rods are diametrically opposed as well as it being possible either as resting behind the rear button guide but not inserted into the rear button guide or the bit cylinder rods are inserted into the rear button guide. The front cover having the complementary teeth portions that are adapted to engage and interlock with the teeth of the upper surface and the lower surface of a beam or rail apparatus, and with the external top plate surrounding and enclosing the front and sides of the front cover, where the front cover will slide within the external top plate. Also shown here is the radial bearing, positioned between the front button and the rear button guide. The purpose of the radial bearing is to allow the front button to rotate against the internal sections of the button assembly. FIGS. 27A and 27B having a front type button guide, platform so its a First-Type bolt flange cavity, with FIG. 27C having the platform at the rear, making it a Second-Type bolt flange cavity.

FIG. 28A to FIG. 28E each illustrates a perspective cross-sectional view of another preferred embodiment of a device with another preferred embodiment of a button assembly, in which in these cross-section views, show that the cylinder shaft piston can be diametrically opposed or not, as in inserted into. Whereby it can be either as: 1) Resting behind and not inserted into or 2) Inserted within the front button or the button assembly or 3) The front button or the button assembly can be inserted into cylinder shaft piston assembly or 4) The cylinder shaft piston assembly can go through the aperture of the front button or the button assembly.

FIG. 29A to FIG. 29F each illustrates a perspective cross-sectional view of another preferred embodiment of a device with another preferred embodiment of a button assembly, in which in these cross-section views are showing where the device may use a, detachable; rotatable; groove type front button, having an external groove or helical ridge/thread running around the outside perimeter of the base of the front button; with/without a bolt flange retention/receiving cavity, or may use a solid front button having a bolt attachment with the concave recesses and a substitute piston. With these types the user can change the button assembly at any time, as the main body of the embodiment is adapted with a rear button guide or button attachment with complementary, internal groove, or internal helical ridge/thread so to receive these types of button assemblies or any other customised buttons with external grooves. Together when attached they may be considered as one whole device.

FIG. 30A illustrates an exploded view of FIG. 6E and FIG. 7E.

FIG. 30B illustrates an exploded view of FIG. 5F and FIG. 7A.

FIG. 31A illustrates a side cross-sectional view of the type of cylinder shaft piston and bit cylinder rod embodiment that may be seen on for example, FIG. 5A thru to FIG. 30B and similar to the once used in FIG. 2A, FIG. 3A and FIG. 4A.

FIG. 31B illustrates a side cross-sectional view of the type of cylinder shaft piston and bit cylinder rod embodiment generally seen on for example, FIG. 1A and FIG. 1H.

FIG. 31C illustrates a side cross-sectional view of FIG. 31B when the cylinder shaft piston has contracted in, or when engaged with a bolt.

FIG. 31D illustrates a side cross-sectional view of FIG. 31A when the cylinder shaft piston has contracted in, or if it was engaged with a bolt.

FIG. 32A illustrates a generic side cross-sectional view of a Standard Front Cover configuration mounted to a rail with complementary teeth portions engaged with a front cover with teeth portions for fixedly positioning the device to the rail at a desired location or position.

FIG. 32B illustrates FIG. 32A a generic side cross-sectional view of a Standard Front Cover configuration mounted to a rail with complementary teeth portions, showing the front cover with teeth portions disengaged so to allowing the device to slide across the rail tracks.

FIG. 32C illustrates a generic side cross-sectional view of an External Top Plate configuration mounted to a rail with complementary teeth portions engaged with a front cover with teeth portions for fixedly positioning the device to the rail at a desired location or position.

FIG. 32D illustrates FIG. 32C a generic side cross-sectional view of an External Top Plate configuration mounted to a rail with complementary teeth portions, showing the front cover with teeth portions disengaged so to allowing the device to slide across the rail tracks.

FIG. 33A to FIG. 33E illustrates a perspective view of the different type of device embodiments, positioned in the preferred rail embodiments.

FIG. 33F illustrates a perspective view of a front cover with a corrugated like profile, engaged with the complementary teeth portions of the preferred rail embodiments.

FIG. 33G illustrates a perspective view of the front cover of FIG. 33F, in which the teeth portions are disengaged with the preferred rail embodiments.

FIG. 33H illustrates a perspective view of a front cover with a square wavy teeth like profile, engaged with the complementary teeth portions of the preferred rail embodiments.

FIG. 33I illustrates a perspective view of the front cover of FIG. 33H, in which the teeth portions are disengaged with the preferred rail embodiments.

FIGS. 34a to 39a, illustrates the parts of another preferred embodiment/device 700. Description of these figures are found in the detailed description of the invention section below.

FIGS. 40a to 45a illustrates the parts of another preferred embodiment/device 800. Description of these figures are found in the detailed description of the invention section below.

FIGS. 46a to 58a illustrates the parts of another preferred embodiment/device 900. Description of these figures are found in the detailed description of the invention section below.

### DESCRIPTION OF THE INVENTION

Preferred embodiments of the invention will now be described with reference to the accompanying drawings and non-limiting examples. [insert embodiment discussion]

The device 100 may have an exterior housing 101. The exterior housing 101 may be a box of six sides, in which one of the front side 102 is coverable by a moveable front cover 103. The exterior housing 101 may have a side profile shape similar to a H-Beam. The exterior housing 101 may have front legs 104, 105 mounted to the front of the exterior housing, in which the front legs flank the moveable front cover 103. The front legs 104, 105 may each have a top portion 106 and a bottom portion 107, in which the top portion 106 is higher than the top side of the exterior housing, and the bottom portion 107 is lower than the bottom side of the exterior housing. The back side of the exterior housing 108 may be covered with a top rail portion 109 and a bottom rail portion 110 mounted to the back side 108. The top rail portion 109 may be higher than the top side of the exterior housing 101, and the bottom rail portion 110 may be lower than the bottom side of the exterior housing 101. For extra structural support, the H-beam like exterior housing may have an upper and lower Rib/middle rail portion 111, 112 running along the middle of the top and/or bottom side of the exterior housing respectively, in which the Rib may be running parallel relative to the back side rail portion. The exterior housing 101 can be in any form or size to suit.

The internal surface of the back side 108 may be in connection with a cylindrical tube rear plate 113. This cylindrical tube rear plate 113 may be between the internal surface of the back side 108 and the cylindrical tube housing 114. The cylindrical tube housing 114 may be a stationary part, which may be uniquely shaped to fit tightly in the interior of the external housing 101. The cylindrical tube housing 114 may have a lumen or a central cavity 115 with a cross-section suited for receiving a shank or a bolt 10 with the same cross-section. The cylindrical tube housing 114 may house the following parts: bit cylinder rod shaft rear cup housing 116, bit cylinder rods 117, bit cylinder springs 118, first spring 123, cylinder shaft piston 119, piston springs 120, tubular shank ram cup 126, ram rod shaft 127 and bit shank ram cup 128. The cylindrical tube housing 114 may have a hole 121 on either side of the cylindrical tube housing 114 to allow the ball-bearings 122 to move into the central cavity or out of the central cavity 115. The outer surface of the cylindrical tube housing 114 may be stepped towards the lumen or central cavity 115.

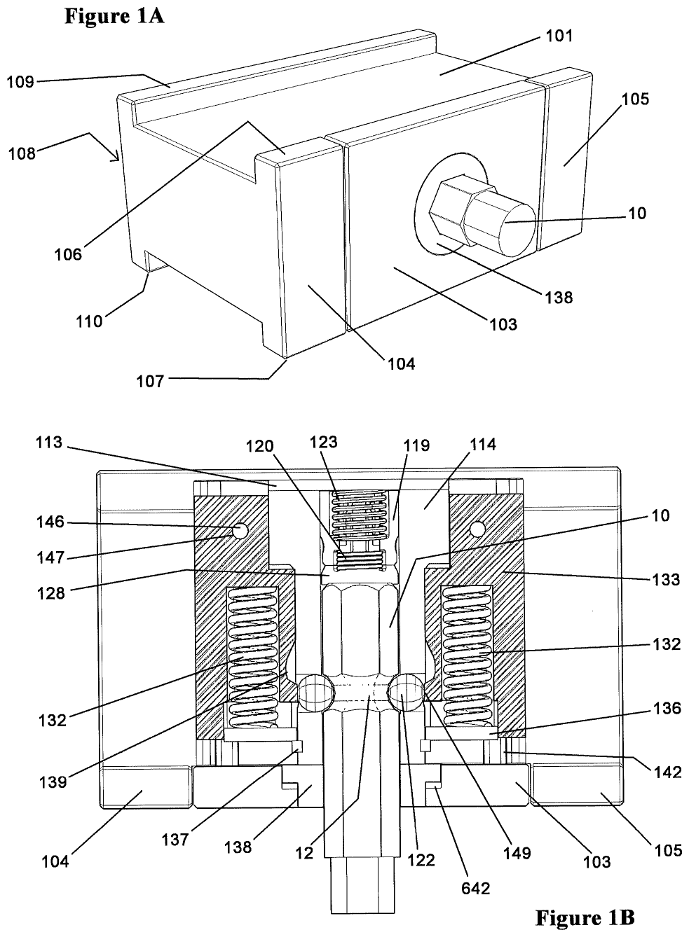

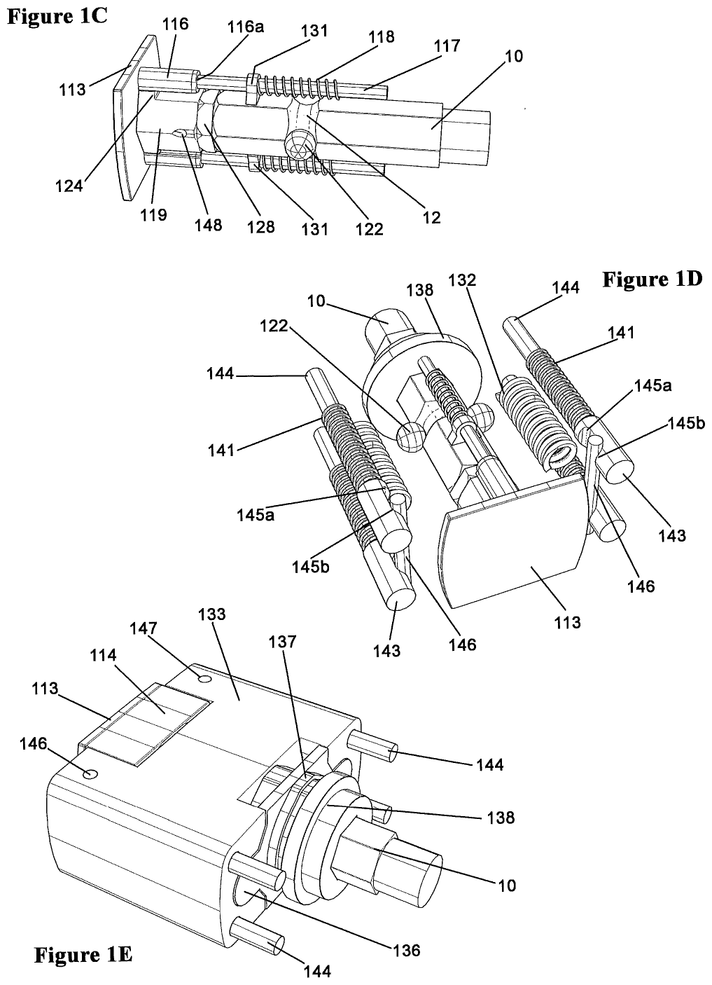

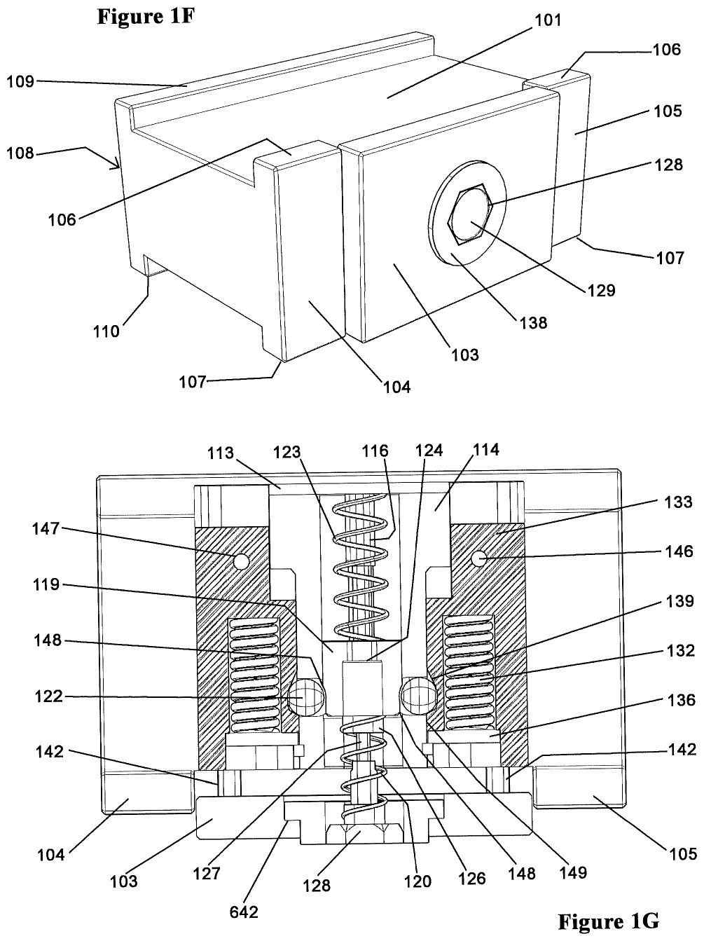

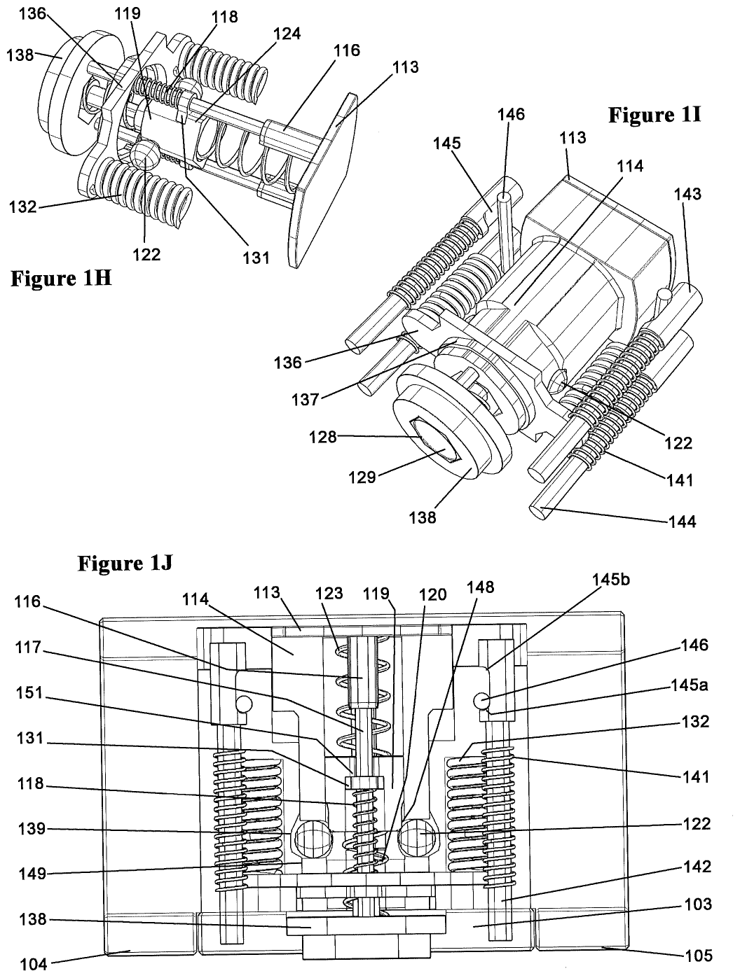

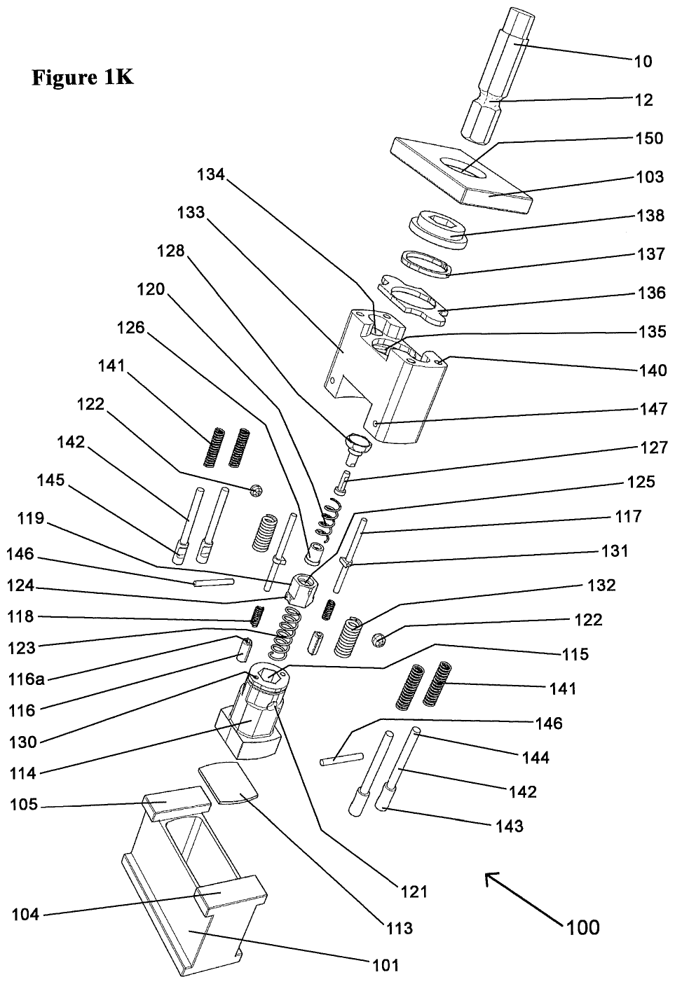

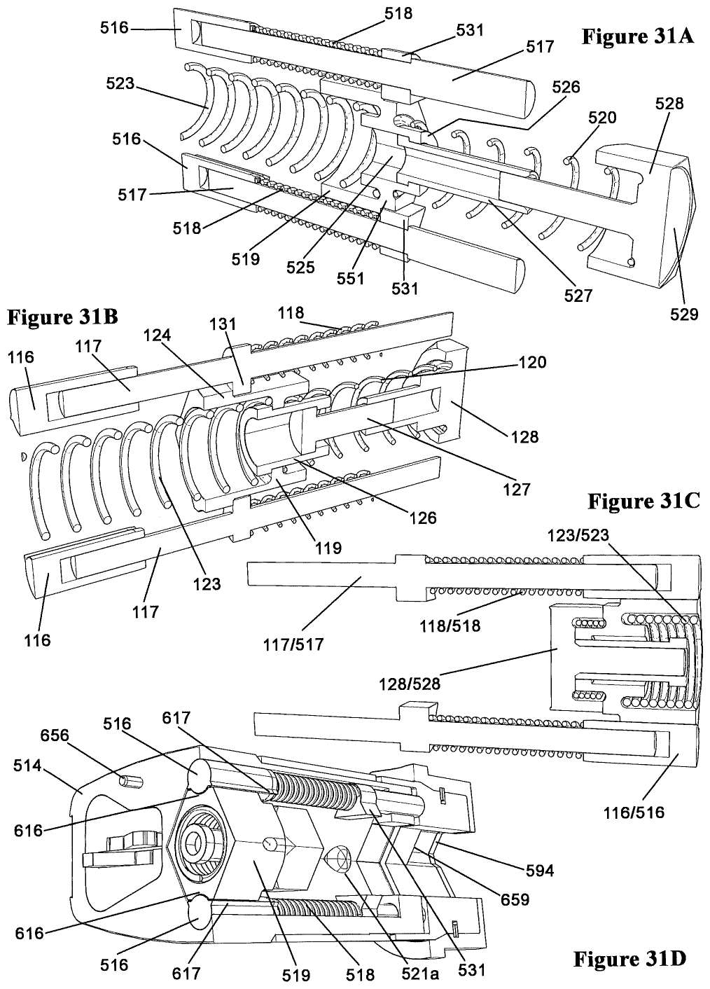

As can be seen in FIGS. 31B and 31C and in FIGS. 1A to 1K, a cylinder shaft piston 119 may have a rear end and a front end. The cylinder shaft piston 119 may be housed above and below the cylinder rod assembly, 116, 117, 118. The piston 119 is adapted with a concave cavity 616 to not obstruct its function. A first spring 123 may be in connection between the rear plate 113 and a rear end of a cylinder shaft piston 119. The rear end of the cylinder shaft piston 119 may have a flanged end portion 124. The first spring 123 may be housed in the cylindrical tube housing 114. The front end of the cylinder shaft piston 119 may have an aperture 125 of a unique shape so it can receive a second spring or a piston spring 120 and a tubular shank ram cup 126 within the piston 119. The tubular shank ram cup 126 may have a rear end and a front end, wherein the tubular shank ram cup 126 defines a lumen along its length. The tubular shank ram cup 126 may be mounted against the inner flange rear surface of the piston 119, while the rear end of the tubular shank ram cup 126 may have a flange extending partially into the piston aperture 125. A rear portion of a ram rod shaft 127 may have a flanged portion extending away from the outer surface of the ram rod shaft, in which the flanged portion is engageable with an inner flange of the tubular shank ram cup 126. The front portion of the ram rod shaft 127 may have a flange extending outward on the left and right flanks, while extending partially into the aperture of a rear narrow portion of the bit shank ram cup 128, the narrow rear portion of 128 having an inner flange on the flanks which engages with the front portion of the ram rod shaft 127 and securing the two together. The second spring or a piston spring 120 rests on the front portion of the inner flange of the cylinder shaft piston 119 the other end of the second/piston spring 120 rests in a recessed portion on the rear side of the bit shank ram cup 128. The spring 120 is around and received in the combined elongated assembly 119, 126, 127, 120 and 128. The front end of the bit shank ram cup 128 may have a surface or a platform 129 at which a shank or a bolt 10 may be adapted to push or engage the surface or platform 129, which pushes the piston 119 towards the rear plate 113, thereby compressing both the first spring 123 and the piston spring 120, and also contract the combined assembly 123, 119, 126, 127, 120 and 128.

The cylindrical tube housing 114 may have apertures 130 between the central cavity 115 and the outer surface of the cylindrical tube housing 114. The apertures 130 may each be parallel to relative to the central cavity 115. Each of the apertures 130 are adapted to receive a bit cylinder rod 117. The embodiment having two bit cylinder rods 117, the bit cylinder rods 117 may be mounted diametrically opposite relative to each other inside the cylindrical tube housing 114. It may be appreciated that the bit cylinder rods may be positioned equidistant relative to each other surrounding the central cavity 115. A rear cup housing 116 may be present at the rear between the rear plate 113, the rear cup 116 holds the end of the cylinder rod 117, the rear cup 116 having an aperture 116a where the end of the cylinder rod shaft extends partially into. A flange arm 131 may extend perpendicularly from a middle portion of each cylinder rod 117. The flange arm 131 may be positioned between a rear portion of the bit cylinder rod and the front portion of the bit cylinder rod. The piston 119 may be moveable between the rear portion and the flange arm 131 of the cylinder rod. The cylinder rod 117 is secured at the back of the front button 138 when the front button is moved from an Out, disengaged position to an IN, engaged position the cylinder rod 117 and the connected flange arm 131 will move in and engage with the piston end portion 124, whereby pushing the piston 119 back a predetermined distance where the engagement surface 148 of the piston will move away from the ball-bearings 122. A bit cylinder spring 118 may be resting on the flange arm 131 and the bit cylinder spring 118 may be mounted on the front portion of the bit cylinder rod 117 the other end of the spring rests on an inner portion within the cylindrical tube housing 114. The cylinder springs 118 may force or bias against the cylindrical tube housing 114 to keep the flange arm 131 and cylinder rods 117 back which in turn will keep the cylinder shaft piston 119 pushed back.

As shown in e.g. FIG. 31D for reference, illustrates the rear cup housing 116, positioned at the rear of the device having a tubular like shape running parallel with the longitude axis of the cavity 115. Having a flange 617 like protrusion extending out along the length on either side of the flanks of the tubular shape, with the flanges 617 positioned away from the equatorial plane, and perpendicular north or south of the longitude axis of the tubular shape. The rear housing cup 116 having an aperture 116a within the tubular portion and extending partially into the aperture 116a is the end shaft part of the cylinder rod 117, whereby the end shaft part will reciprocate within the aperture 116a. With the rear bit cylinder rod cavity 130 of the cylindrical tube housing 114, adapted to receive the rear cup housing 116, where at the top and bottom of the cavity 115 there is a circumference like shape extending along the longitude axis of cavity that compliments the outside tubular shape and flange protrusion of the rear cup housing 116. Whereby once inserted, and because of its unique shape and tight fit it cannot fall into the centre of the cavity, and thereby not obstructing with the moving cylinder piston assembly.

The sleeve housing 133 may have at least two further apertures 134, wherein the central cavity 135 is between each of the apertures 134 in which each of the apertures 134 are adapted for receiving a sleeve housing spring 132. The front end of the sleeve housing spring 132 is in engagement with a cylinder washer 136. There may be a cylinder washer 136 to keep the sleeve housing springs 132 secured and there may be a C-shaped cylinder clip 137 for holding the cylinder washer 136 in place while it is uniquely shaped to mount over the cylindrical tube housing 114. The front button 138 may form the front section of the device 100. The inner aperture of the front button 138 may be the same cross-sectional shape as the bit shank ram cups 128 platform 129. The front button 138 may be connected to the cylinder rods 117 which are secured into the back of the front button 138.

The cylindrical tube housing 114 may have an outer sleeve housing 133, which may be axially moveable relative to the longitudinal axis of the cylindrical tube housing 114. The outer sleeve housing 133 may have channels or recesses 139 adapted for receiving or retaining ball-bearings 122. The channels or recesses 139 may be exposed or open when the outer sleeve housing 133 has moved forward, away from the rear portion of the cylindrical tube housing 114. The channels or recesses 139 may be closed when the outer sleeve housing 133 is closer to the cylindrical tube housing 114 rear portion. The outer sleeve housing 133 may have apertures 140 surrounding the cylindrical tube housing 114, wherein each of the apertures 140 of the outer sleeve housing 133 are parallel to the cylindrical tube housing 114. Preferably, there are four apertures, one for each outer corner of the sleeve housing 133. The apertures 140 are each adapted to receive both a sleeve face spring 141 and a sleeve face rod 142, wherein the sleeve face spring 141 is mounted on the sleeve face rod 142. Wherein the sleeve face rods 142 and sleeve face springs 141 are mounted and slide within the sleeve housing, the sleeve face rods 142 are in engagement with the front cover 103. The front cover 103 is at a predetermined distance in front of the sleeve housing 133 and resting on the exterior housing 101 wherein the front cover 103 can move away from the exterior housing 101 relative to the longitudinal axis of the central cavity 115.

Each of the sleeve face rods 142 may have a rear portion 143 and a front portion 144, wherein the front portion 144 is in engagement with the front cover 103. The rear portion of the sleeve face rod 143 may have a recess or a sleeve housing pin recess 145 for receiving and engaging with a sleeve housing pin 146. The rear portion of the sleeve housing 133 may have sleeve housing pin aperture 147, wherein each of the aperture 147 is perpendicular to the longitudinal axis of the cavity 115 of the cylindrical tube housing 114. Each of the apertures 147 at the rear of the sleeve housing 133 may be adapted to each receive a sleeve housing pin 146. The sleeve housing pin 146 may be received in the sleeve housing pin recess 145 of the sleeve face rod 142.

The front portion of the cylinder shaft piston 119 may have a ball-bearing or locking ball engagement surface 148 for receiving a ball-bearing 122. When there is no bolt 10 in the cavity 115, and with the device 100 in an Unreleased configuration, the ball-bearings engagement surface 148 may be in front of the cylinder shaft piston 119 where with a portion or a third of the ball-bearing 122 may be overlapping the cylinder shaft piston 119, whereby the engagement surface 148 is at the side front corner flanks of the cylinder shaft piston 119, and with the ball-bearings furthest side from the cavity 115 is in engagement with the non-recessed portion 149 of the sleeve housing 133, whereby when in a Unreleased configuration the ball-bearings are unable to exit the cavity 115. When the device 100 is in a disengaged configuration, the ball-bearings engagement surface 148 may be on the side walls of the cylinder shaft piston 119, whereby the side walls are parallel to the longitudinal axis of the cavity 115, and with the recess 139 channels on the opposite side of the ball-bearings 122, which is the concave retention cavity 139 within the sleeve housing 133. When in this position the front cover 103 is in an out, disengaged configuration. The cylinder shaft piston 119 may also have a concave cavity 616 at its top and bottom, so that when reciprocating within the cavity it does not interfere or obstruct the function of the cylinder rod assembly above and below it.

The sleeve housing pin recess 145, is located on the rear portion of the sleeve face rods 143 and it is an elongated recess, whereby the pin recess, rear engaging surface is 145b which is closer to the back of the device 108 and the pin recess, front engaging surface is 145a which is closer to the front of the device 102.

The springs for this embodiment 100 may be an elastic object in which the extended springs will want to contract and return to the original spring shape or which the contracted springs will want to expand and return to the original spring shape. In the return to the original spring state, for example, the contracted springs 132 may expand and provide an axial force to the sleeve housing 133 from the front to the rear, which in turn moves the sleeve housing 133 back, closer to the cylindrical tube housing 114 rear section. This action moves the sleeve housings 133, non-recess 149 back, and the channels 139 concave shape pushes the ball-bearings 222 back into the cavity 115 so to allow the retention of the ball-bearings 122, whereby moving them laterally from the second position to the first position. The first group of locking balls now in the first position and out of the second position, wherein the first position is in the cavity 115, and the second position is in a corresponding first group of locking ball recesses, wherein the sleeve housing 133 comprises the first group of locking ball recesses.

In this embodiment, to disengage the device 100, a user can pull the front cover 103 away from the exterior housing 101. Pulling the front cover 103 away from the exterior housing 101 also moves the connected sleeve face rods 142 in the same direction. The pin recess rear 145b is engaging with the sleeve housing pins 146, when the front cover 103 starts to move away, the engaging pins 146 that are resting on the pin recess rear 145b in turn start to move the sleeve housing 133 forward. While the front cover 103 and the sleeve housing 133 are moving forward, the distance between them and the state of the spring 141 relatively stays the same. Whereby at this stage, the sleeve housing springs 132 are starting to compress. The movement of the sleeve housing 133 moving forward towards the front portion of the cylindrical tube housing 114 expands the cavity and activates opening of the ball-bearings recess 139, thereby allowing the first group of locking balls 122 to move laterally from the first position to the second position, whereby retracting from the central cavity 115 into the recess 139. While leaving the cavity 115 the ball-bearings are moving away, disengaging with the pistons side front corners of the engagement surface 148, the first spring 123 now starts to expand up. With the piston 119 moving out, and the piston 119 pushing out the preceding, expanded front portion of the piston assembly 120, 126, 127, 128, and at the same time, the expanding first spring 123 also pushing the piston flanged end portion 124 of the piston and the engaged flange arm 131 of the bit cylinder rod 117 out, the connected button has now exited out. With the front cover 103 now in its outer most position held in place by the pin recess rear 145b that are engaging with the sleeve housing pins 146. A front lip extending laterally out at the front of the sleeve housing 133 spring apertures 134 is in engagement with the secured cylinder washer 136, whereby preventing the sleeve housing 133 exiting the exterior housing 101. With the device 100 now disengaged, and in an Out configuration.

While in the out position, the front button 138 extends out partially above the front cover 103. The flanged portion of the front button 138 is resting on the inside centre complementary button cavity of the front cover 103. And with the cylinder piston assembly forced out by the expansion of the first spring 123 and the piston springs 120, which in turn is forcing the pistons 119 flanged end portions 124 to push on the flanged arm 131 of the connected bit cylinder rods 117 out, and with the front button 138 connected to the cylinder rods, the button is kept pushed out. At the same time, the flanged part of the front button 138 is preventing the front cover 103 moving back down.

To re-engage the device 100 and put the front cover 103 back to a closed position, on this embodiment a user can push down on the front cover 103 or alternatively an exterior force can be pushing down on the front cover 103. With a force pushing down on the face of the combined front button 138 and front cover 103, they start to go back in towards the rear of the device. At the same time, the connected sleeve face rods 142 move in, with the springs 141 expanding inside the cavity 140, and with the sleeve housing still in its out position, held in place by the ball-bearings 122 that are between the recess 139 and the pistons side walls, the engagement surface 148. With the combined button and cover continuing to go down, the flange arm 131 starts to force against the engaged flanged end portions 124 whereby forcing the combined cylinder piston assembly to move back down as well. With the ball-bearings 122 now starting to return to their first position within the cavity 115, the sleeve housing springs 132 start to expand by pushing against the static washer 136, where now the sleeve housing 133 starts to go back in towards the rear of the device. With the pin recess front 145a now starting to make contact with the housing pins 146 which will assist in pushing the sleeve housing 133 to its final position down towards the rear of the device, e.g. on FIG. 1J. With the ball-bearings 122 now well out of the recess 139 the sleeve housing 133 snaps back down, forced down by the sleeve housing springs 132, we're now the ball-bearings have returned back to their first position locking the sleeve housing in. With the pins 146 now engaged with the pin recess rear 145b, and holding the front cover 103 in. And with the flange arm 131 holding the piston flanged end 124 down, and keeping the bit cylinder rods 117 down, the front button 138 now is flush with the front cover 103. With the front button kept pushed down the flange of the button has now moved away from the front cover 103, where there is now a narrow gap 642 present. The device 100 is now in engaged and an, IN position.

For locking a bolt or a shaft 10, in a device 100, the bolt or shaft 10 is suitably sized with at least one concave mounting portion 12 for receiving the first group of locking balls or ball-bearings 122. With the device in a disengaged, and Out position, the bolt or shaft 10 may be inserted into the device 100 via the aperture or cavity 150 at the front. Once the bolt or shaft 10 has engaged with the platform 129, the bit shank ram cup 128 and the combined piston assembly 120, 127, 126, 119, 123, start to contract and move towards the rear of the cylindrical tube housing 114. As the piston 119 is moved back, and the first spring 123 is compressed the pistons side walls, the engagement surface 148 disengages with the ball-bearings 122. Because the side walls of the bolt or shaft 10 occupy the cavity 115 the ball-bearings 122 cannot yet return back to the first position. With the bolts concave portion 12 now reaching, and in line laterally with the ball-bearings 122, the concave recess 139 starts to open, where they then fall into the cavity of the concave portion 12 of the bolt. As the ball-bearings 122 enters the cavity 115 the sleeve housing springs 132 start expanding, and forces the sleeve housing 133 to snap back down towards the rear of the device, the sleeve housing pins 146 then engage with the pin recess rear 145b, whereby holding down and engaging the front cover 103. The expansion force of the bit cylinder rod springs 118 pushing between a front inside wall of the cylindrical tube housing 114 and the flange arm 131, forces the front button 138 to stay down and flush with the front cover 103. Now, the bolt and the device 100 are in an engaged configuration.

In this embodiment, to disengage the bolt 10 from the device 100, a user can pull the front cover 103 away from the exterior housing 101. Pulling the front cover 103 away from the exterior housing 101 also moves the connected sleeve face rods 142 in the same direction. With the pin recess rear 145b engaging with the sleeve housing pins 146 and as the front cover 103 starts to move forward, the pin recess rear 145b starts to pull on the sleeve housing pins 146, that are retained in the sleeve housing pin aperture 147, the pulling force then causes the sleeve housing 133 to move forward. Because the distance between the front cover 103 and the sleeve housing 133 stay relatively the same the state of the sleeve face spring 141 does not change. As the sleeve housing 133 is moving forward, the sleeve housing springs 132 are getting compressed. With the movement of the sleeve housing 133 continuing towards the front, it expands the cavity and activates opening of the ball-bearings recess 139 thereby allowing the first group of locking balls 122 to retract, moving laterally away from the central cavity 115 into the recess 139. As the ball-bearings 122 retract from the cavity 115 into the recess 139, the ball-bearings 122 no longer engage with the concave mounting portion 12 of the bolt 10 and thereby having no resisting bolt retention force. With no resisting bolt retention force, the first spring 123 expands back to the original shape which pushes the piston 119 towards the aperture or opening 150. As the bolt 10 continues to travel out the piston springs 120 expands and elongates the front part of the piston assembly, which is 126, 127, and 128, and at the same time bit cylinder rod assembly is pushing out and holding the front button 138 out. With the bolt 10 now ejected out of the aperture 150, the device 100 is now disengaged.

The difference between this embodiment and other inventions is that other inventions uses one thick spring that wraps over the cavity. In this embodiment, the whole apparatus or device which uses two parallel sleeve housing springs allows the device to be as small or compact as possible as opposed to using the one thick spring.

In this embodiment, if this device 100 was needing to have a force pushed down on the front 102 and/or on the back 108 at any given time, such as a clamping device, or a clamp that was pushing the front cover down. The front cover may be pushed into its furthest position in, that is, resting on the H-beam exterior housing. While in a disengaged position, the device may have an exterior force pushing down on it, the front cover and button can be collapsed by means of the sleeve face rods and the cylinder rods which then may release the ball-bearings. The housing springs may force the housing to retract in, to its final position which then makes the face secured in its locked in position. By using this method, the face cannot be damaged by having an external force on it. This embodiment and method do not use the bolt or a hex bit to force the face back, which differentiates from other conventional apparatuses that require the use of a hex bit to force the face back.

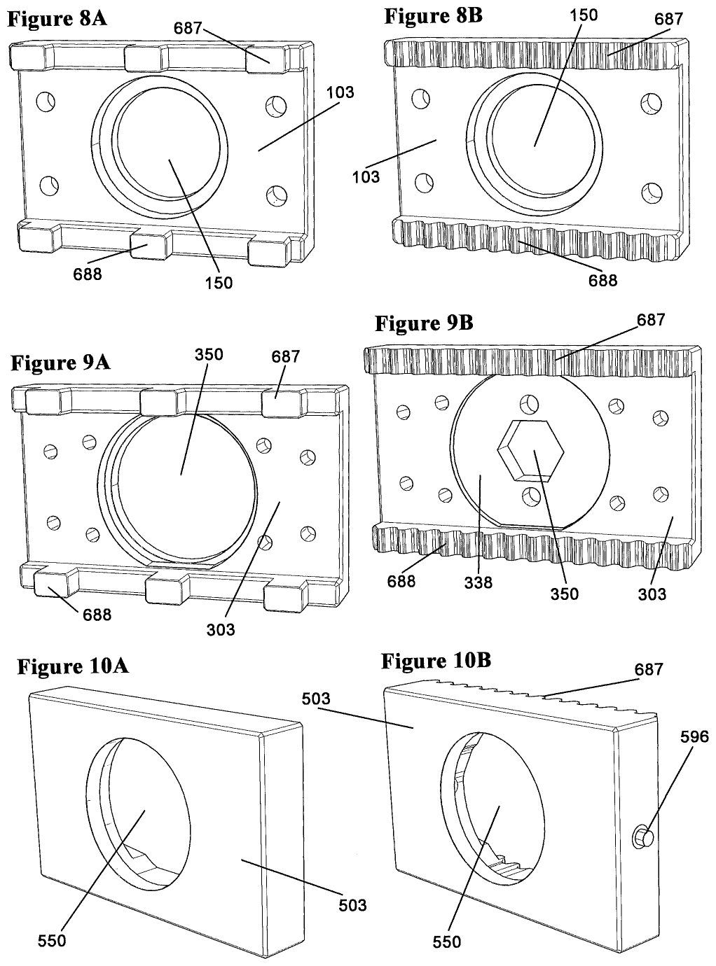

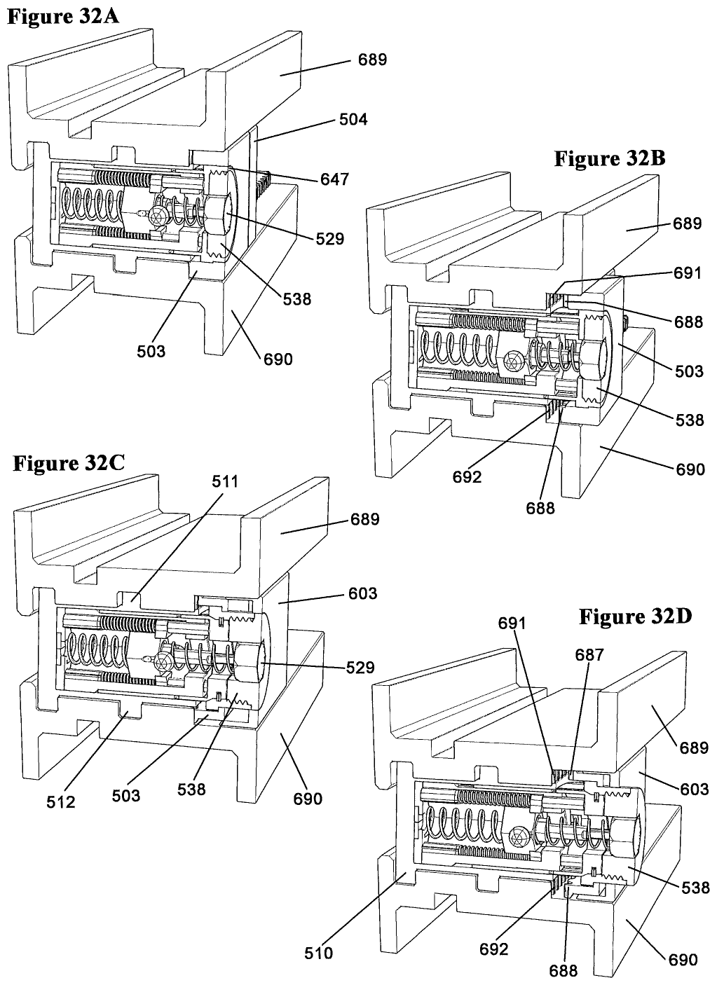

In this embodiment, a hex bit or a bolt is not necessarily needed to move the front cover down nor the front button. This embodiment can be inserted into a rail system in which the ribbings on the top and bottom side of the exterior housing may be engaging with the rail tracks in the rail system. This mechanism can be used to lock it into place to prevent it from moving by means of a different adapted face FIGS. 8A and 8B. Or a rail system for example, which may be seen in FIGS. 31A to 32I embodiments. It may be appreciated that this device can be used in many applications.

In another preferred embodiment of the invention, the device 200 may have an exterior housing 201. The exterior housing 201 may be a box of six sides, in which one of the front sides 202 is coverable by a moveable front cover 203. The exterior housing 201 may have a side profile shape similar to a H-Beam. The exterior housing 201 may have front legs 204, 205 mounted to the front of the exterior housing, in which the front legs flank the moveable front cover 203. The front legs 204, 205 may each have a top portion 206 and a bottom portion 207, in which the top portion 206 is higher than the top side of the exterior housing, and the bottom portion 207 is lower than the bottom side of the exterior housing. The back side of the exterior housing 208 may be covered with a top rail portion 209 and a bottom rail portion 210 mounted to the back side 208. For extra structural support, the H-beam like exterior housing may have an upper and lower Rib/middle rail portion 211, 212 running along the middle of the top and/or bottom side of the exterior housing respectively, in which the Rib may be running parallel relative to the back side rail portion. The exterior housing 201 can be in any form or size to suit.

The internal surface of the back side 208 may be in connection with a cylindrical tube rear plate 213. This cylindrical tube rear plate 213 may be between the internal surface of the back side 208 and the cylindrical tube housing 214. The cylindrical tube housing 214 may be a stationary part, which may be uniquely shaped to fit tightly in the interior of the external housing 201. The cylindrical tube housing 214 may have a lumen or a central cavity 215 with a cross-section suited for receiving a shank or a bolt 20 with the same cross-section. The cylindrical tube housing 214 may house the following parts: bit cylinder rod shaft rear cup housing 216, bit cylinder rods 217, bit cylinder springs 218, first spring 223, cylinder shaft piston 219, piston springs 220, ram rod shaft 227 and bit shank ram cup 228. The cylindrical tube housing 214 may have a hole 221 on either side of the cylindrical tube housing 214 to allow the ball-bearings 222 to move into the central cavity or out of the central cavity 215. The outer surface of the cylindrical tube housing 214 may be stepped towards the lumen or central cavity 215.

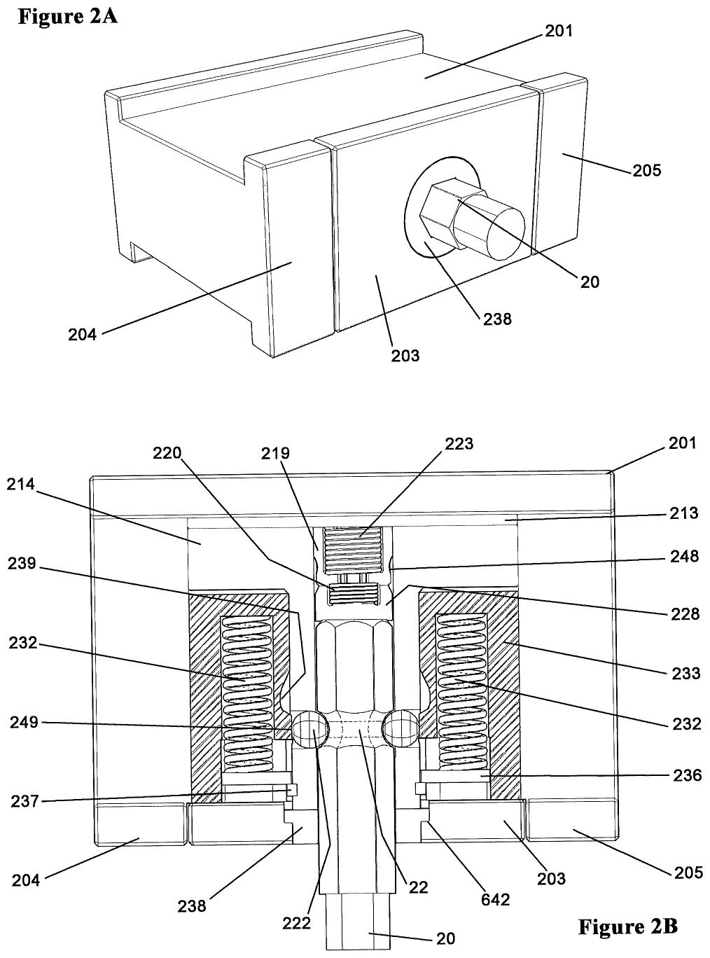

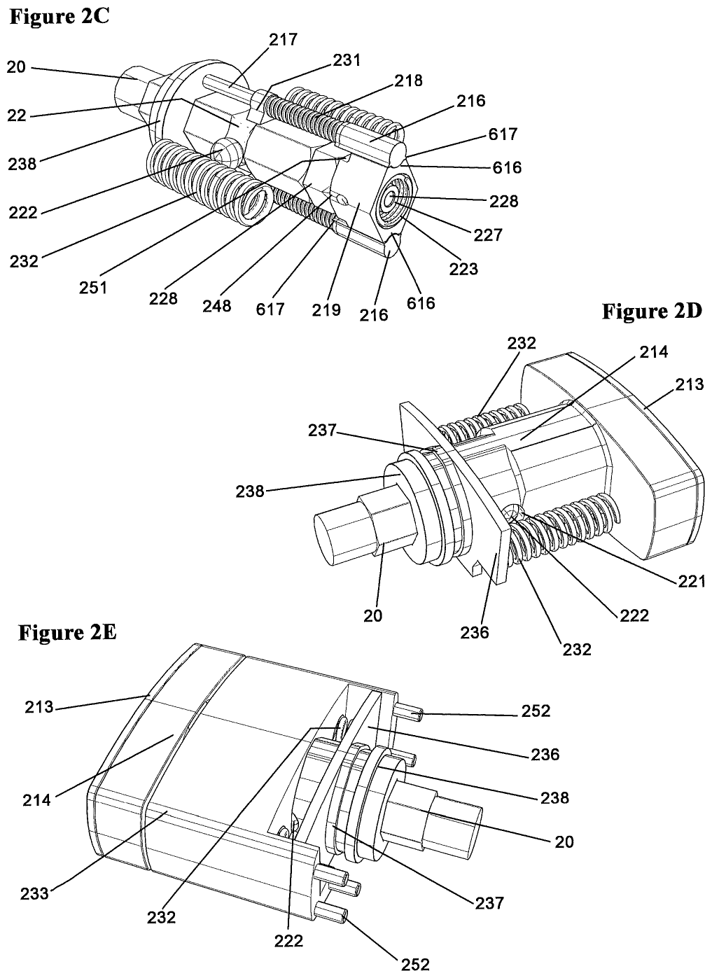

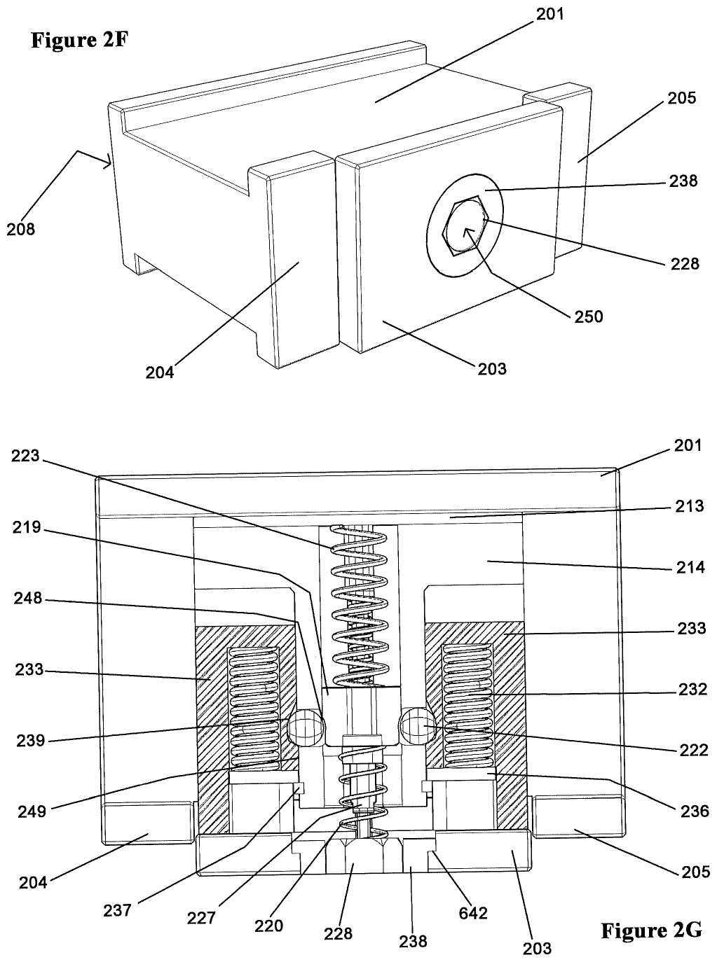

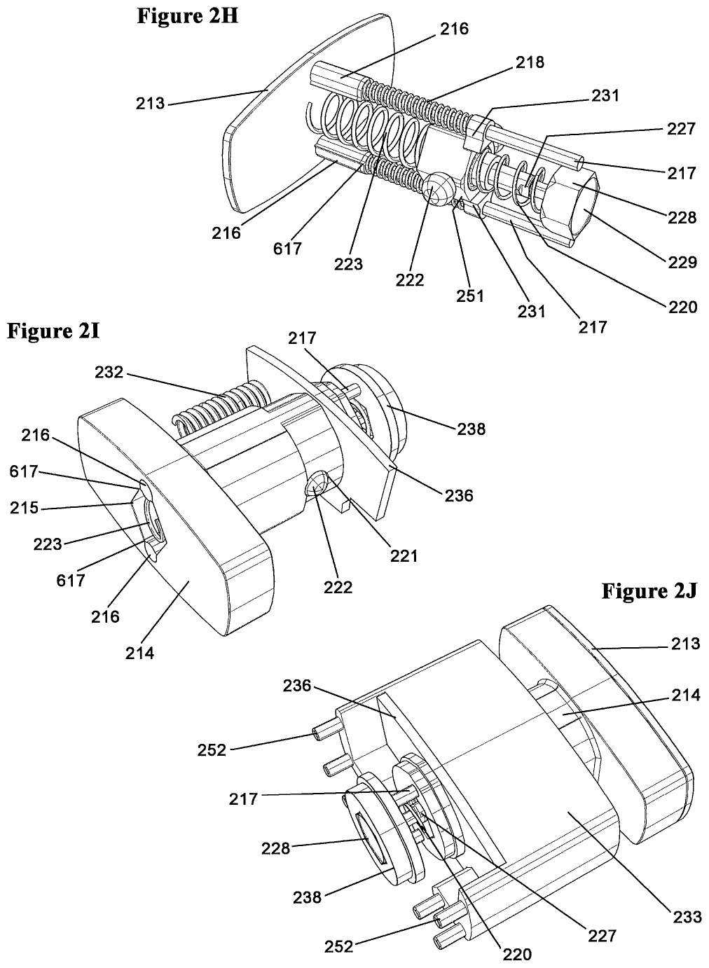

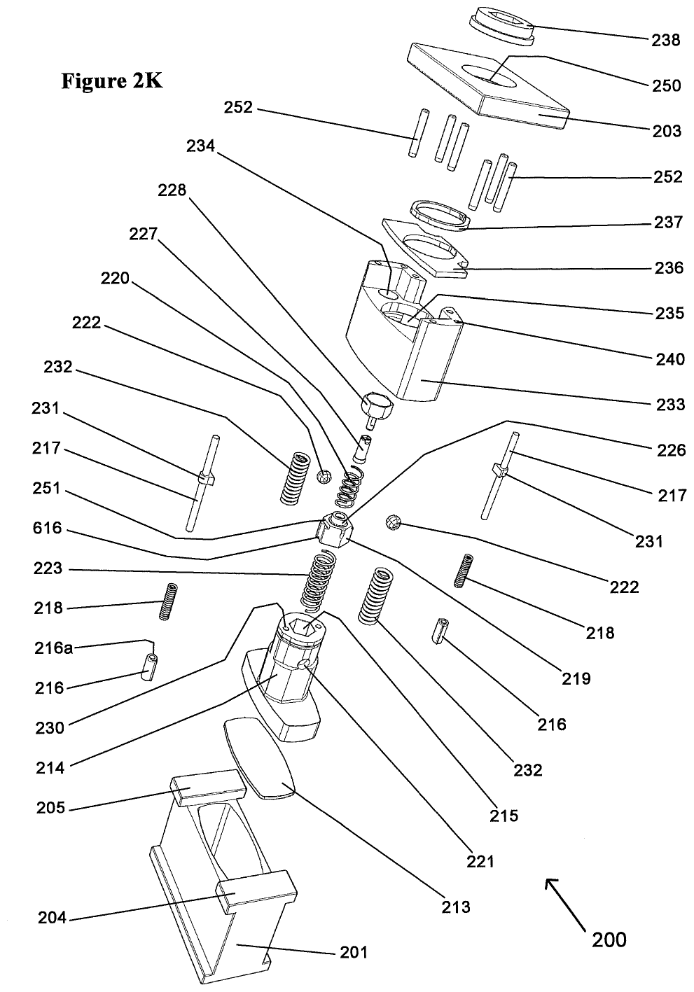

As can be seen in FIGS. 2A to 2K and with a similar piston assembly on FIG. 31A, a cylinder shaft piston 219 may have a rear end and a front end. The cylinder shaft piston 219 may be housed above and below the cylinder rod assembly, 216, 217, 218. The piston 219 is adapted with a concave cavity 616 to not obstruct its function. A first spring 223 may be in connection between the rear plate 213 and the rear end of a cylinder shaft piston 219. The front end of the outer surface of the cylinder shaft piston 219 may have a notched cut-out portion 251. The first spring 223 may be housed in the cylindrical tube housing 214. The front end of the cylinder shaft piston 219 may have an aperture 225 of a unique shape so it can receive a second spring or a piston spring 220 and a tubular shank ram cup 226 within the piston 219. Preferably, the piston 219 is integrally joined with the tubular shank ram cup 226 such that it is one whole part. An advantage of this integrally joined parts is that it decreases the number of moving parts in this device, which may contribute to minimising wear and tear. The integrated tubular shank ram cup 226 may have a rear end and a front end, wherein the tubular shank ram cup 226 defines a lumen along its length. The tubular shank ram cup 226 is centrality integrally joined against the inner flange surface of the piston 219, while the front end of the tubular shank ram cup 226 may have a flange extending partially into the piston aperture 225. A rear portion of a tubular ram rod shaft 227 may have a flanged portion extending away from the outer surface of the tubular ram rod shaft 227, in which the flanged portion is engageable with an inner flange of the integrated tubular shank ram cup 226. Also, the tubular ram rod shaft 227 defines a lumen along its length. A front portion of the tubular ram rod shaft 227 may have a flange extending inward on the left and right flanks, a rear narrow rod portion of the bit shank ram cup 228 may have a flange extending outward on the left and right flanks, the rear rod portion of 228 is extended partially into the aperture of the tubular ram rod shaft 227, in which then is engaged with the inward flange of the tubular ram rod shaft 227 thereby securing the two together. The second spring or a piston spring 220 rests on the front recessed portion of the inner flange of the cylinder shaft piston 219 the other end of the second/piston spring 220 rests in a recessed portion on the rear side of the bit shank ram cup 228. The spring 220 is around and received in the combined elongated assembly 219, 227, 220 and 228. The front end of the tubular shank ram cup 228 may have a surface or a platform 229 at which a shank or a bolt 20 may be adapted to push or engage the surface or platform 219, which pushes the piston 219 towards the rear plate 213, thereby compressing both the first spring 223 and the piston spring 220, and also contract the combined assembly 223, 219, 227, 220 and 228.

The cylindrical tube housing 214 may have apertures 230 between the central cavity 215 and the outer surface of the cylindrical tube housing 214. The apertures 230 may each be parallel to relative to the central cavity 215. Each of the apertures 230 are adapted to receive a bit cylinder rod 217. The embodiment having two bit cylinder rods 217, the bit cylinder rods 217 may be mounted diametrically opposite relative to each other inside the cylindrical tube housing 214. It may be appreciated that the bit cylinder rods 217 may be positioned equidistant relative to each other surrounding the central cavity 215. A rear cup housing 216 may be present at the rear between the rear plate 213, the rear cup 216 holds the end of the cylinder rod 217, the rear cup 216 having an aperture 216a where the end of the cylinder rod shaft extends partially into. A flange arm 231 may extend perpendicularly from a middle portion of each cylinder rod 217. The flange arm 231 may be positioned between a rear portion of the bit cylinder rod and the front portion of the bit cylinder rod. The piston 219 may be moveable between the rear portion and the flange arm 231 of the cylinder rod. The cylinder rod 217 is secured at the back of the front button 238 when the front button is moved from an Out, disengaged position to an IN, engaged position the cylinder rod 217 and the connected flange arm 231 will move in and engage with the notched cut-out portion 251 at the front end of the piston, whereby pushing the piston 219 back a predetermined distance where the engagement surface 248 of the piston will move away from the ball-bearings 222. A bit cylinder spring 218 may be resting on the flange arm 231 and the bit cylinder spring 218 may be mounted on the rear portion of the bit cylinder rod 217 the other end of the spring rests on the rear cup housing 216. The cylinder Springs 218 may force against the rear cup housing 216 with the other side of the spring forcing against flange arm 231, whereby keeping the bit cylinders rods 217 pushed out and at the same time keeps the cylinder shaft piston 219 at a predetermined distance from the front of the device.

As shown in e.g. FIG. 31D for reference, illustrates the rear cup housing 216, positioned at the rear of the device having a tubular like shape running parallel with the longitude axis of the cavity 215. Having a flange 617 like protrusion extending out along the length on either side of the flanks of the tubular shape, with the flanges 617 positioned away from the equatorial plane, and perpendicular north or south of the longitude axis of the tubular shape. The rear housing cup 216 having an aperture 216a within the tubular portion and extending partially into the aperture 216a is the end shaft part of the cylinder rod 217, whereby the end shaft part will reciprocate within the aperture 216a. With the rear bit cylinder rod cavity 230 of the cylindrical tube housing 214, adapted to receive the rear cup housing 216, where at the top and bottom of the cavity 215 there is a circumference like shape extending along the longitude axis of cavity that compliments the outside tubular shape and flange protrusion of the rear cup housing 216. Whereby once inserted, and because of its unique shape and tight fit it cannot fall into the centre of the cavity, and thereby not obstructing with the moving cylinder piston assembly.

The sleeve housing 233 may have at least two further apertures 234, wherein the central cavity 235 is between each of the apertures 234 in which each of the apertures 234 are adapted for receiving a sleeve housing spring 232. The front end of the sleeve housing spring 232 is in engagement with a cylinder washer 236. There may be a cylinder washer 236 to keep the sleeve housing springs 232 secured and there may be a C-shaped cylinder clip 237 for holding the cylinder washer 236 in place while it is uniquely shaped to mount over the cylindrical tube housing 214. The front button 238 may form the front section of the device 200. The inner aperture of the front button 238 may be the same cross-sectional shape as the bit shank ram cups 228 platform 229. The front button 238 may be connected to the cylinder rods 217 which are secured into the back of the front button 238.

The cylindrical tube housing 214 may have an outer sleeve housing 233, which may be axially moveable relative to the longitudinal axis of the cylindrical tube housing 214. The outer sleeve housing 233 may have channels or recesses 239 adapted for receiving or retaining ball-bearings 222. The channels or recesses 239 may be exposed or open when the outer sleeve housing 233 has moved forward, away from the rear portion of the cylindrical tube housing 214. The channels or recesses 239 may be closed when the outer sleeve housing 233 is closer to the cylindrical tube housing 214 rear portion. The outer sleeve housing 233 may have apertures 240 surrounding the cylindrical tube housing 214, wherein each of the apertures 240 of the outer sleeve housing 233 may be parallel to the cylindrical tube housing 214. The apertures are each adapted to receive a dowel pin, grub screw or similar fastening device 252, wherein the fastening device 252 may connect the sleeve housing 233 with the front cover 203. The exterior housing 201 may cover the sleeve housing 233 and the sleeve housing 233 in connection with the front cover 203 can move away from the exterior housing 201 relative to the longitudinal axis of the central cavity 215.

The springs for this embodiment 200 may be an elastic object in which the extended springs will want to contract and return to the original spring shape or which the contracted springs will want to expand and return to the original spring shape. In the return to the original spring state, for example, the contracted springs 232 may expand and provide an axial force to the sleeve housing 233 from the front to the rear, which in turn moves the sleeve housing 233 back, closer to the cylindrical tube housing 214 rear section. This action moves the sleeve housings 233, non-recess 249 back, and the channels 239 concave shape pushes the ball-bearings 222 back into the cavity 215 so to allow the retention of the ball-bearings 222, whereby moving them laterally from the second position to the first position. The first group of locking balls now in the first position and out of the second position, wherein the first position is in the cavity 215, and the second position is in a corresponding first group of locking ball recesses, wherein the sleeve housing 233 comprises the first group of locking ball recesses.

The front portion of the cylinder shaft piston 219 may have a ball-bearing or locking ball engagement surface 248 for receiving a ball-bearing 222. When there is no bolt 20 in the cavity 215, and with the device 200 in an Unreleased configuration, the ball-bearings engagement surface 248 may be in front of the cylinder shaft piston 219 where ⅓ of the ball-bearing 222 may be overlapping the cylinder shaft piston 219, whereby the engagement surface 248 is at the side front corner flanks of the cylinder shaft piston 219, and with the ball-bearings furthest side from the cavity 215 is in engagement with the non-recessed portion 249 of the sleeve housing 233, whereby when in a Unreleased configuration the ball-bearings are unable to exit the cavity 215. When the device 200 is in a disengaged configuration, the ball-bearings engagement surface 248 may be on the side walls of the cylinder shaft piston 219, whereby the side walls are parallel to the longitudinal axis of the cavity 215, and with the recess 239 channels on the opposite side of the ball-bearings 222, which is the concave retention cavity 239 within the sleeve housing 233. When in this position, the front cover 203 is locked, in an out, disengaged configuration. The cylinder shaft piston 219 may also have a concave cavity 616 at its top and bottom, so that when reciprocating within the cavity it does not interfere or obstruct the function of the cylinder rod assembly above and below it.

In this embodiment 200, to disengage the device, a user can pull the front cover 203 away from the exterior housing 201. While the front cover 203 and the sleeve housing 233 are moving out, the sleeve housing springs 232 are compressing. The movement of the sleeve housing 233 moving away towards the front portion of the cylindrical tube housing 214, expands the cavity and activates opening of the ball-bearings recess 239, thereby allowing the first group of locking balls 222 to start moving laterally away from the first position to the second position, whereby retracting from the central cavity 215 into the recess 239. With the front cover 203 moving out the bit cylinder spring 218 expands and forces against the flange arm 231, whereby forcing the connected bit cylinder rod 217 and the front button 238, to both start moving outward. With the ball-bearings 222 moving laterally away from the pistons side front corners of the engagement surface 248, the first spring 223 now can start to expand up. With the piston 219 moving out, and the piston 219 pushing out the preceding, expanded front portion of the piston assembly 220, 227, 228, and at the same time the expanding first spring also pushing the notched cut-out 251 of the piston and the engaged flange arm 231 of the bit cylinder rod 217 out, the connected button has now exited out. Now with the first group of locking balls 222 in the second position, and the front cover 203 and the sleeve housing 233 now in there outer most position, held in by a front lip extending laterally out at the front of the sleeve housing 233 spring apertures 234 which is in engagement with the secured cylinder washer 236, whereby preventing the sleeve housing 233 exiting the exterior housing 201. The device 200 is now disengaged and in an Out configuration.

To re-engage the device and put the front cover 203 back to a closed position, in this embodiment, a user can push down on the front button 238, or use an external force to push down on the front button, wherein it starts to go back in towards the rear of the device. The connected bit cylinder rods 217 and the flange arm 231 start to force the engaging notched cut-out portion 251 of the cylinder shaft piston 219 to move back down. With the cylinder shaft piston 219 moving back down, the pistons side walls, the engagement surface 248 starts to move away from the ball-bearings 222. At the same time the sleeve housing springs 232 continue to expand, by pushing against the static washer 236. The sleeve housing 233 reaching its final position down towards the rear of the device, and with the ball-bearings 222 now well out of the recess 239, where now the sleeve housing 233 snaps back down, forced down by the sleeve housing springs 232, with the ball-bearings returned back to their first position within the cavity 215, and locking the sleeve housing in. With the expansion force of the sleeve housing springs 232 against the static washer 236, forcing the sleeve housing 233 and the connected front cover 203 down. The ball-bearings 222 cannot escape out of the first position within the cavity 215, and with the ball-bearings 222 engaging with the pistons side front corners of the engagement surface 248 preventing the piston 219 from moving forward. The rear flange of the front button 238 engaging with the internal complementary button cavity of the front cover 203 is now preventing the diametrically opposite force of the bit cylinder springs 218 against the flange arm 231, as such keeping the front button 238 flush with the front cover 203. The device 200 is now in engaged and an, IN position.

For locking a bolt or a shaft 20, in a device 200, the bolt or shaft 20 is suitably sized with at least one concave mounting portion 22 for receiving the first group of locking balls or ball-bearings 222. With the device in a disengaged, and Out position, the bolt or shaft 20 may be inserted into the device 200 via the aperture or cavity 250 at the front. Once the bolt or shaft 20 has engaged with the platform 229, the bit shank ram cup 228 and the combined piston assembly 220, 227, 219, 223, start to contract and move towards the rear of the cylindrical tube housing 214. As the piston 219 is moved back, and the first spring 223 is compressed, the pistons side front corners of the engagement surface 248 disengages with the ball-bearings 222. Because the side walls of the bolt or shaft 20 occupy the cavity 215, the ball-bearings 222 cannot yet return back to the first position within the cavity 215. With the bolts concave portion 22 now reaching, and in line laterally with the ball-bearings 222, the concave recess 239 starts to open, where they then fall into the cavity of the concave portion 22 of the bolt. With the ball-bearings 222 entering the cavity 215 and the sleeve housing springs 232 continue expanding, pushing against the static washer 236, and forcing the sleeve housing 233 and the connected front button 238 to snap back down towards the rear of the device. With the rear flange of the front button 238 now held down by the complementary button cavity of the front cover 203 now, the bolt and the device 200 are in an engaged configuration.

In this embodiment, to disengage the bolt 20 from the device 200, a user can pull the front cover 203 away from the exterior housing 201. With the front cover 203 and the sleeve housing 233 moving forward, the sleeve housing springs 232 are getting compressed. With the bit cylinder spring 218 forcing against the flange arm 231, the connected bit cylinder rod 217 and the front button 238, both are moved outward. With the movement of the sleeve housing 233 continuing towards the front, it expands the cavity and activates opening of the ball-bearings recess 239 thereby allowing the first group of locking balls 222 to retract, moving laterally away from the central cavity 215 into the recess 239. As the ball-bearings 222 retract from the cavity 215 into the recess 239, the ball-bearings 222 no longer engage with the concave mounting portion 22 of the bolt 20 and thereby having no resisting bolt retention force. With no resisting bolt retention force, the first spring 223 expands back to the original shape which pushes the piston 219 towards the aperture or opening 250. As the bolt 20 continues to travel out, the piston springs 220 expands and elongates the front part of the piston assembly, the ram rod shaft 227, and the bit shank ram cup 228. At the same time, the bit cylinder rod assembly is pushing out and holding the front button 238 out. With the bolt 20 now ejected out of the aperture 250, the device 200 is now disengaged.

In another preferred embodiment of the invention, the device 300 may have an exterior housing 301 similar to the device 200 with an organized symmetrical layout, whereby the top half and the bottom half of the sleeve housing 333 are similar. There may be an advantage of having a more balanced layout, also the assembling of the device may be more efficient. The fastener apertures 352 in a symmetrical layout, and the shape of the washer 336 are modified to fit uniformly. As well the front button 338 has also been redesigned in a more ergonomic shape so to accommodate the fingers of an individual or person. While the layout of the device is different, the first group of locking balls engagement and disengagement mechanism is similar to the 200 device.

The exterior housing 301 may be a box of six sides, in which one of the front sides 302 is coverable by a moveable front cover 303. The exterior housing 301 may have a side profile shape similar to a H-Beam. The exterior housing 301 may have front legs 304, 305 mounted to the front of the exterior housing, in which the front legs flank the moveable front cover 303. The front legs 304, 305 may each have a top portion 306 and a bottom portion 307, in which the top portion 306 is higher than the top side of the exterior housing, and the bottom portion 307 is lower than the bottom side of the exterior housing. The back side of the exterior housing 308 may be covered with a top rail portion 309 and a bottom rail portion 310 mounted to the back side 308. For extra structural support, the H-beam like exterior housing may have an upper and lower Rib/middle rail portion 311, 312 running along the middle of the top and/or bottom side of the exterior housing respectively, in which the Rib may be running parallel relative to the back side rail portion. The exterior housing 301 can be in any form or size to suit.

The internal surface of the back side 308 may be in connection with a cylindrical tube rear plate 313. This cylindrical tube rear plate 313 may be between the internal surface of the back side 308 and the cylindrical tube housing 314. The cylindrical tube housing 314 may be a stationary part, which may be uniquely shaped to fit tightly in the interior of the external housing 301. The cylindrical tube housing 314 may have a lumen or a central cavity 315 with a cross-section suited for receiving a shank or a bolt 30 with the same cross-section. The cylindrical tube housing 314 may house the following parts: bit cylinder rod shaft rear cup housing 316, bit cylinder rods 317, bit cylinder springs 318, first spring 323, cylinder shaft piston 319, piston springs 320, ram rod shaft 327 and bit shank ram cup 328. The cylindrical tube housing 314 may have a hole 321 on either side of the cylindrical tube housing 314 to allow the ball-bearings 322 to move into the central cavity or out of the central cavity 315. The outer surface of the cylindrical tube housing 314 may be stepped towards the lumen or central cavity 315.

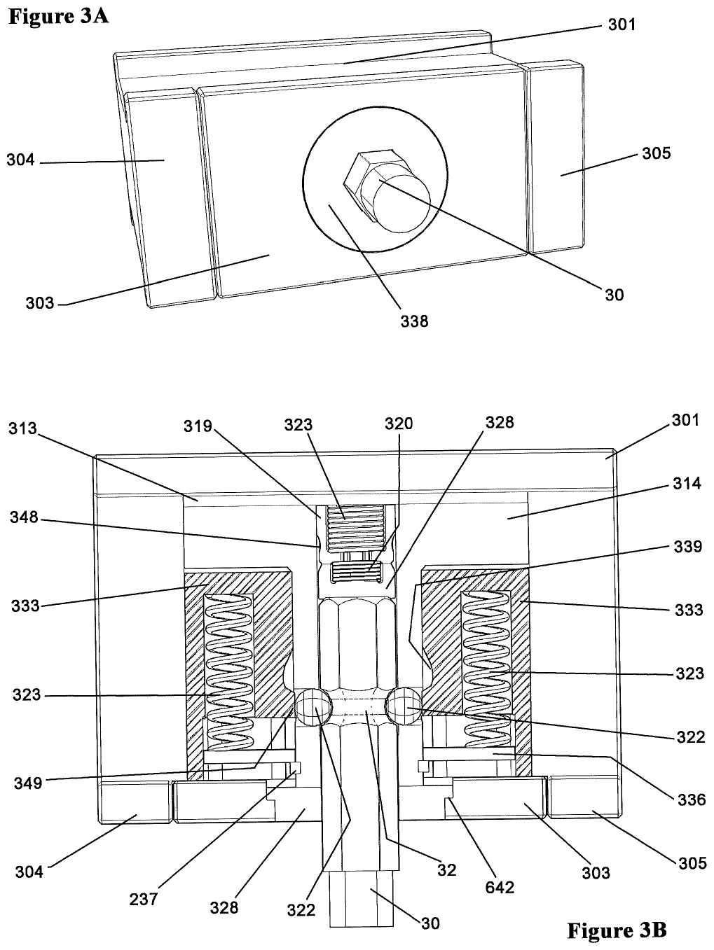

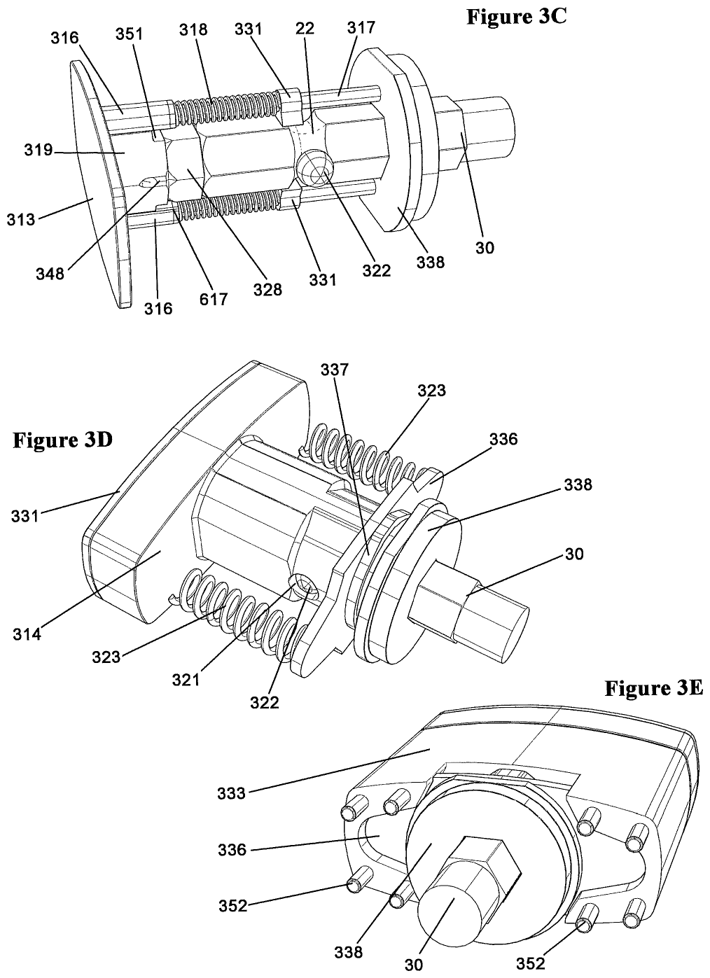

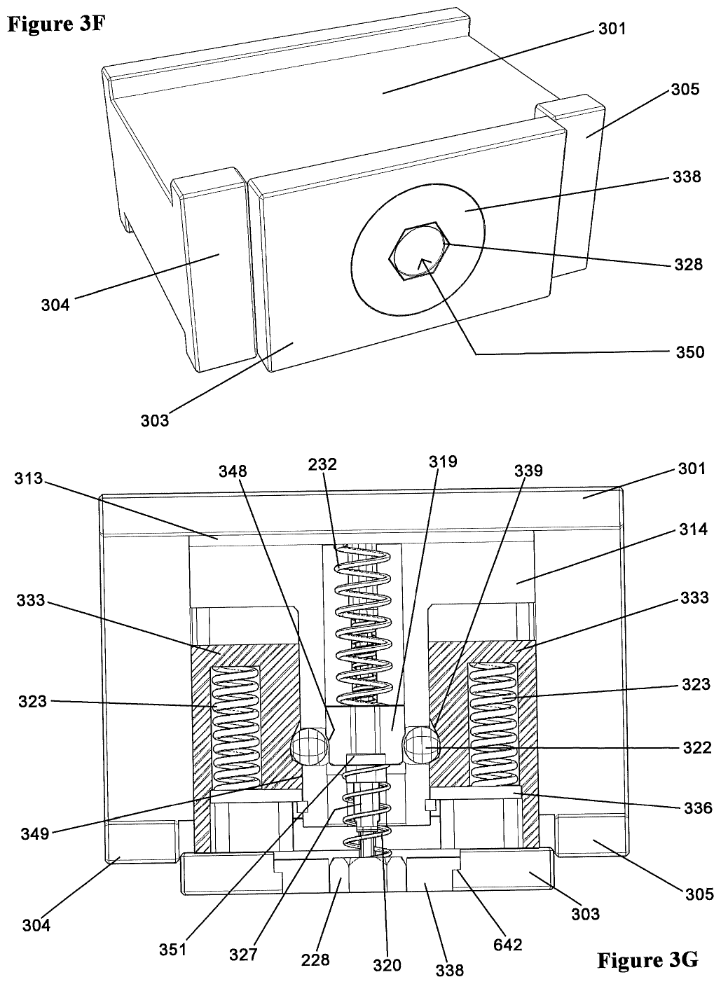

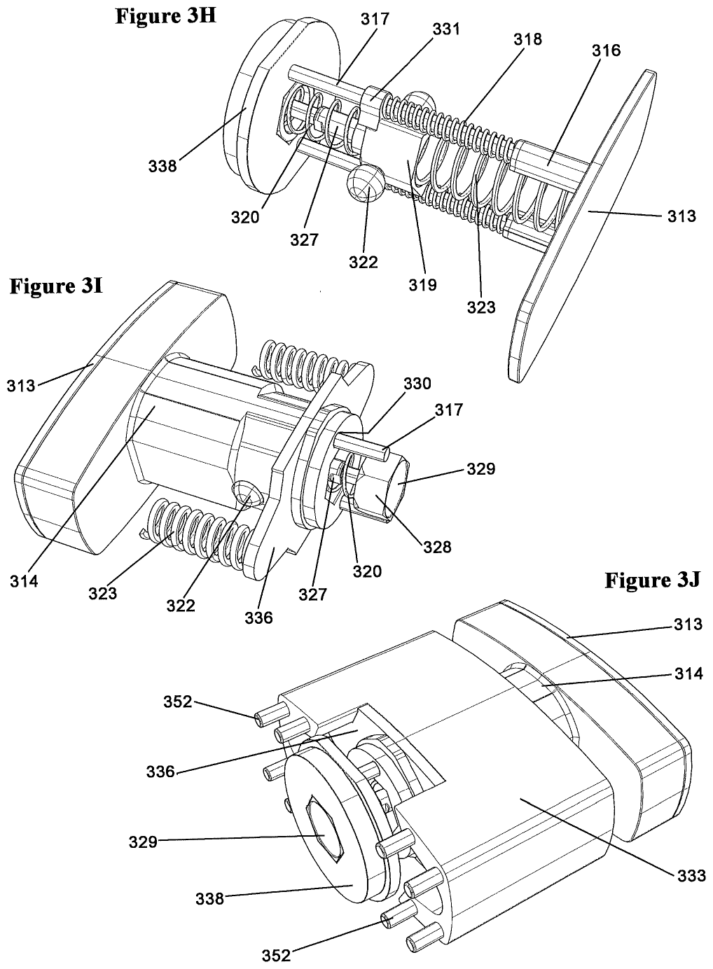

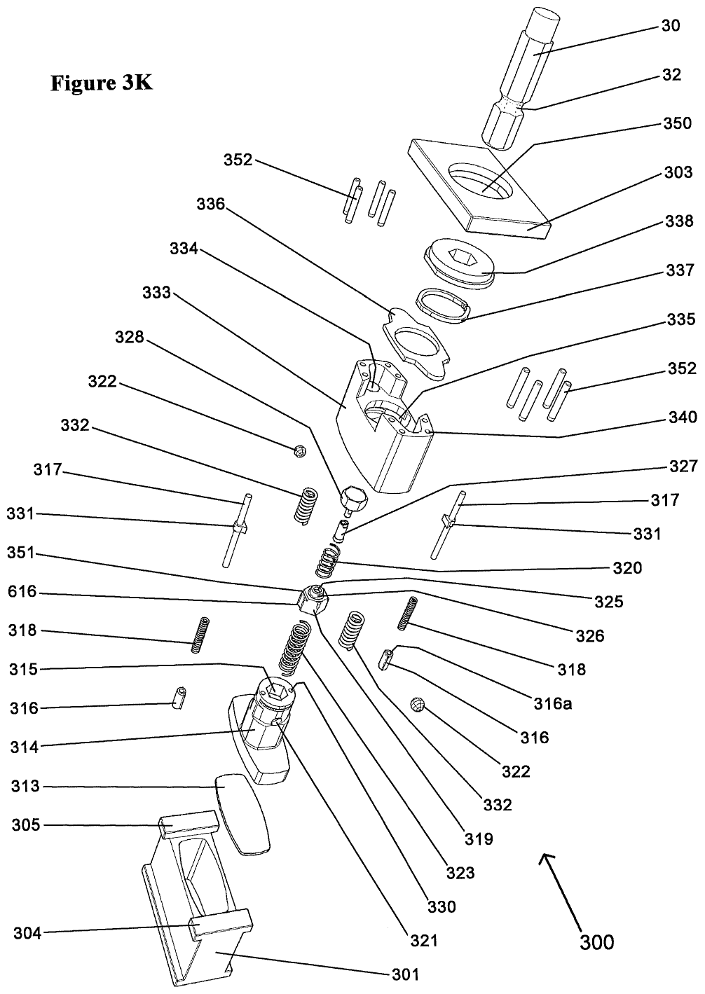

As can be seen in FIGS. 3A to 3K and with a similar piston assembly on FIG. 31A, a cylinder shaft piston 319 may have a rear end and a front end. The cylinder shaft piston 319 may be housed above and below the cylinder rod assembly, 316, 317, 318. The piston 319 is adapted with a concave cavity 616 to not obstruct its function. A first spring 323 may be in connection between the rear plate 313 and the rear end of a cylinder shaft piston 319. The front end of the outer surface of the cylinder shaft piston 319 may have a notched cut-out portion 351. The first spring 323 may be housed in the cylindrical tube housing 314. The front end of the cylinder shaft piston 319 may have an aperture 325 of a unique shape so it can receive a second spring or a piston spring 320 and a tubular shank ram cup 326 within the piston 319. Preferably, the piston 319 is integrally joined with the tubular shank ram cup 326 such that it is one whole part. An advantage of this integrally joined parts is that it decreases the number of moving parts in this device, which may contribute to minimising wear and tear. The integrated tubular shank ram cup 326 may have a rear end and a front end, wherein the tubular shank ram cup 326 defines a lumen along its length. The tubular shank ram cup 326 is centrality integrally joined against the inner flange surface of the piston 319, while the front end of the tubular shank ram cup 326 may have a flange extending partially into the piston aperture 325. A rear portion of a tubular ram rod shaft 327 may have a flanged portion extending away from the outer surface of the tubular ram rod shaft 327, in which the flanged portion is engageable with an inner flange of the integrated tubular shank ram cup 326. Also, the tubular ram rod shaft 327 defines a lumen along its length. A front portion of the tubular ram rod shaft 327 may have a flange extending inward on the left and right flanks, a rear narrow rod portion of the bit shank ram cup 328 may have a flange extending outward on the left and right flanks, the rear rod portion of 328 is extended partially into the aperture of the tubular ram rod shaft 327, in which then is engaged with the inward flange of the tubular ram rod shaft 327 thereby securing the two together. The second spring or a piston spring 320 rests on the front recessed portion of the inner flange of the cylinder shaft piston 319 the other end of the second/piston spring 320 rests in a recessed portion on the rear side of the bit shank ram cup 328. The spring 320 is around and received in the combined elongated assembly 319, 327, 320 and 328. The front end of the tubular shank ram cup 328 may have a surface or a platform 329 at which a shank or a bolt 30 may be adapted to push or engage the surface or platform 319, which pushes the piston 319 towards the rear plate 313, thereby compressing both the first spring 323 and the piston spring 320, and also contract the combined assembly 323, 319, 327, 320 and 328.

The cylindrical tube housing 314 may have apertures 330 between the central cavity 315 and the outer surface of the cylindrical tube housing 314. The apertures 330 may each be parallel to relative to the central cavity 315. Each of the apertures 330 are adapted to receive a bit cylinder rod 317. The embodiment having two bit cylinder rods 317, the bit cylinder rods 317 may be mounted diametrically opposite relative to each other inside the cylindrical tube housing 314. It may be appreciated that the bit cylinder rods 317 may be positioned equidistant relative to each other surrounding the central cavity 315. A rear cup housing 316 may be present at the rear between the rear plate 313. The rear cup 316 holds the end of the cylinder rod 317, the rear cup 316 having an aperture 316a where the end of the cylinder rod shaft extends partially into. A flange arm 331 may extend perpendicularly from a middle portion of each cylinder rod 317. The flange arm 331 may be positioned between a rear portion of the bit cylinder rod and the front portion of the bit cylinder rod. The piston 319 may be moveable between the rear portion and the flange arm 331 of the cylinder rod. The cylinder rod 317 is secured at the back of the front button 338 when the front button is moved from an Out, disengaged position to an IN, engaged position the cylinder rod 317 and the connected flange arm 331 will move in and engage with the notched cut-out portion 351 at the front end of the piston, whereby pushing the piston 319 back a predetermined distance where the engagement surface 348 of the piston will move away from the ball-bearings 322. A bit cylinder spring 318 may be resting on the flange arm 331 and the bit cylinder spring 318 may be mounted on the rear portion of the bit cylinder rod 317. The cylinder Springs 318 may force against the rear cup housing 316 with the other side of the spring forcing against flange arm 331, whereby keeping the bit cylinders rods 317 pushed out and at the same time keeps the cylinder shaft piston 319 at a predetermined distance from the front of the device.

As shown in e.g. FIG. 31D for reference, illustrates the rear cup housing 316, positioned at the rear of the device having a tubular like shape running parallel with the longitude axis of the cavity 315. Having a flange 617 like protrusion extending out along the length on either side of the flanks of the tubular shape, with the flanges 617 positioned away from the equatorial plane, and perpendicular north or south of the longitude axis of the tubular shape. The rear housing cup 316 having an aperture 316a within the tubular portion and extending partially into the aperture 316a is the end shaft part of the cylinder rod 317, whereby the end shaft part will reciprocate within the aperture 316a. With the rear bit cylinder rod cavity 330 of the cylindrical tube housing 314, adapted to receive the rear cup housing 316, where at the top and bottom of the cavity 315 there is a circumference like shape extending along the longitude axis of cavity that compliments the outside tubular shape and flange protrusion of the rear cup housing 316. Whereby once inserted, and because of its unique shape and tight fit it cannot fall into the centre of the cavity, and thereby not obstructing with the moving cylinder piston assembly.

The sleeve housing 333 may have at least two further apertures 334, wherein the central cavity 335 is between each of the apertures 334 in which each of the apertures 334 are adapted for receiving a sleeve housing spring 332. The front end of the sleeve housing spring 332 is in engagement with a cylinder washer 336. There may be a cylinder washer 336 to keep the sleeve housing springs 332 secured and there may be a C-shaped cylinder clip 337 for holding the cylinder washer 336 in place while it is uniquely shaped to mount over the cylindrical tube housing 314. The front button 338 may form the front section of the device 300. The inner aperture of the front button 338 may be the same cross-sectional shape as the bit shank ram cups 328 platform 329. The front button 338 may be secured to the cylinder rods 317 which are then secured into the back of the front button 338.

The cylindrical tube housing 314 may have an outer sleeve housing 333, which may be axially moveable relative to the longitudinal axis of the cylindrical tube housing 314. The outer sleeve housing 333 may have channels or recesses 339 adapted for receiving or retaining ball-bearings 322. The channels or recesses 339 may be exposed or open when the outer sleeve housing 333 has moved forward, away from the rear portion of the cylindrical tube housing 314. The channels or recesses 339 may be closed when the outer sleeve housing 333 is closer to the cylindrical tube housing 314 rear portion. The outer sleeve housing 333 may have apertures 340 surrounding the cylindrical tube housing 314, wherein each of the apertures 340 of the outer sleeve housing 333 are parallel to the cylindrical tube housing 314. The apertures are each adapted to receive a dowel pin, grub screw or similar fastening device 352, wherein the fastening device 352 may connect the sleeve housing 333 with the front cover 303. The exterior housing 301 may cover the sleeve housing 333 and the sleeve housing 333 in connection with the front cover 303 can move away from the exterior housing 301 relative to the longitudinal axis of the central cavity 315.

The springs for this embodiment 300 may be an elastic object in which the extended springs will want to contract and return to the original spring shape or which the contracted springs will want to expand and return to the original spring shape. In the return to the original spring state, for example the contracted springs 332 may expand and provide an axial force to the sleeve housing 333 from the front to the rear, which in turn moves the sleeve housing 333 back, closer to the cylindrical tube housing 314 rear section. This action moves the sleeve housings 333, non-recess 349 back, and the channels 339 concave shape pushes the ball-bearings 322 back into the cavity 315 so to allow the retention of the ball-bearings 322, whereby moving them laterally from the second position to the first position. The first group of locking balls now in the first position and out of the second position, wherein the first position is in the cavity 315, and the second position is in a corresponding first group of locking ball recesses, wherein the sleeve housing 333 comprises the first group of locking ball recesses.

The front portion of the cylinder shaft piston 319 may have a ball-bearing or locking ball engagement surface 348 for receiving a ball-bearing 322. When there is no bolt 30 in the cavity 315, and with the device 300 in an Unreleased configuration, the ball-bearings engagement surface 348 may be in front of the cylinder shaft piston 319 where ⅓ of the ball-bearing 322 may be overlapping the cylinder shaft piston 319, whereby the engagement surface 348 is at the side front corner flanks of the cylinder shaft piston 319, and with the ball-bearings furthest side from the cavity 315 is in engagement with the non-recessed portion 349 of the sleeve housing 333, whereby when in a Unreleased configuration the ball-bearings are unable to exit the cavity 315. When the device 300 is in a disengaged configuration, the ball-bearings engagement surface 348 may be on the side walls of the cylinder shaft piston 319, whereby the side walls are parallel to the longitudinal axis of the cavity 315, and with the recess 339 channels on the opposite side of the ball-bearings 322, which is the concave retention cavity 339 within the sleeve housing 333. When in this position the front cover 303 is locked, in an out, disengaged configuration. The cylinder shaft piston 319 may also have a concave cavity 616 at its top and bottom, so that when reciprocating within the cavity it does not interfere or obstruct the function of the cylinder rod assembly above and below it.

In this embodiment 300, to disengage the device a user can pull the front cover 303 away from the exterior housing 301. While the front cover 303 and the sleeve housing 333 are moving out, the sleeve housing springs 332 are compressing. The movement of the sleeve housing 333 moving away towards the front portion of the cylindrical tube housing 314, expands the cavity and activates opening of the ball-bearings recess 339, thereby allowing the first group of locking balls 322 to start moving laterally away from the first position to the second position, whereby retracting from the central cavity 315 into the recess 339. With the front cover 303 moving out the bit cylinder spring 318 expands and forces against the flange arm 331, whereby forcing the connected bit cylinder rod 317 and the front button 338, to both start moving outward. With the ball-bearings 322 moving laterally away from the pistons side front corners of the engagement surface 348, the first spring 323 now can start to expand up. With the piston 319 moving out, and the piston 319 pushing out the preceding, expanded front portion of the piston assembly 320, 327, 328, and at the same time the expanding first spring also pushing the notched cut-out 351 of the piston and the engaged flange arm 331 of the bit cylinder rod 317 out, the connected button has now exited out. Now with the first group of locking balls 322 in the second position, and the front cover 303 and the sleeve housing 333 now in there outer most position, held in by a front lip extending laterally out at the front of the sleeve housing 333 spring apertures 334 which is in engagement with the secured cylinder washer 336, whereby preventing the sleeve housing 333 exiting the exterior housing 301. The device 300 is now disengaged and in an Out configuration.

To re-engage the device and put the front cover 303 back to a closed position, on this embodiment a user can push down on the front button 338, or use an external force to push down on the front button, wherein it starts to go back in towards the rear of the device. The connected bit cylinder rods 317 and the flange arm 331 start to force the engaging notched cut-out portion 351 of the cylinder shaft piston 319 to move back down. With the cylinder shaft piston 319 moving back down, the pistons side walls, the engagement surface 348 starts to move away from the ball-bearings 322. At the same time the sleeve housing springs 332 continue to expand, by pushing against the static washer 336. The sleeve housing 333 reaching its final position down towards the rear of the device, and with the ball-bearings 322 now well out of the recess 339, where now the sleeve housing 333 snaps back down, forced down by the sleeve housing springs 332, with the ball-bearings returned back to their first position within the cavity 315, and locking the sleeve housing in. With the expansion force of the sleeve housing springs 332 against the static washer 336, forcing the sleeve housing 333 and the connected front cover 303 down. The ball-bearings 322 cannot escape out of the first position within the cavity 315, and with the ball-bearings 322 engaging with the pistons side front corners of the engagement surface 348 preventing the piston 319 from moving forward. The rear flange of the front button 338 engaging with the internal complementary button cavity of the front cover 303 is now preventing the diametrically opposite force of the bit cylinder springs 318 against the flange arm 331, as such keeping the front button 338 flush with the front cover 303. The device 300 is now in engaged and an, IN position.

For locking a bolt or a shaft 30, in a device 300, the bolt or shaft 30 is suitably sized with at least one concave mounting portion 32 for receiving the first group of locking balls or ball-bearings 322. With the device in a disengaged, and Out position, the bolt or shaft 30 may be inserted into the device 300 via the aperture or cavity 350 at the front. Once the bolt or shaft 30 has engaged with the platform 329, the bit shank ram cup 328 and the combined piston assembly 320, 327, 319, 323, start to contract and move towards the rear of the cylindrical tube housing 314. As the piston 319 is moved back, and the first spring 323 is compressed the pistons side front corners of the engagement surface 348 disengages with the ball-bearings 322. Because the side walls of the bolt or shaft 30 occupy the cavity 315 the ball-bearings 322 cannot yet return back to the first position within the cavity 315. With the bolts concave portion 32 now reaching, and in line laterally with the ball-bearings 322, the concave recess 339 starts to open, where they then fall into the cavity of the concave portion 32 of the bolt. With the ball-bearings 322 entering the cavity 315 and the sleeve housing springs 332 continue expanding, pushing against the static washer 336, and forcing the sleeve housing 333 and the connected front button 338 to snap back down towards the rear of the device. With the rear flange of the front button 338 now held down by the complementary button cavity of the front cover 303. Now, the bolt and the device 300 are in an engaged configuration.

In this embodiment, to disengage the bolt 30 from the device 300, a user can pull the front cover 303 away from the exterior housing 301. With the front cover 303 and the sleeve housing 333 moving forward, the sleeve housing springs 332 are getting compressed. With the bit cylinder spring 318 forcing against the flange arm 331, the connected bit cylinder rod 317 and the front button 338, both are moved outward. With the movement of the sleeve housing 333 continuing towards the front, it expands the cavity and activates opening of the ball-bearings recess 339 thereby allowing the first group of locking balls 322 to retract, moving laterally away from the central cavity 315 into the recess 339. As the ball-bearings 322 retract from the cavity 315 into the recess 339, the ball-bearings 322 no longer engage with the concave mounting portion 32 of the bolt 30 and thereby having no resisting bolt retention force. With no resisting bolt retention force, the first spring 323 expands back to the original shape which pushes the piston 319 towards the aperture or opening 350. As the bolt 30 continues to travel out the piston springs 320 expands and elongates the front part of the piston assembly, the ram rod shaft 327, and the bit shank ram cup 328. At the same time the bit cylinder rod assembly is pushing out and holding the front button 338 out. With the bolt 30 now ejected out of the aperture 350 the device 300 is now disengaged.

In this embodiment, a hex bit or a bolt is not necessarily needed to move the front cover down nor the front button. This embodiment can be inserted into a rail system in which the ribbings on the top and bottom side of the exterior housing may be engaging with the rail tracks in the rail system. This mechanism can be used to lock it into place to prevent it from moving by means of a different adapted face FIGS. 9A and 9B. Or a rail system for example, which may be seen in FIGS. 31A thru to 32I embodiments. It may be appreciated that this device can be used in many applications.

In another preferred embodiment of the invention, the device 400 may have an exterior housing 401. The exterior housing 401 may be a box of six sides, in which one of the front sides 402 is coverable by a moveable front cover 403. The left and right sides of the exterior housing 401 may also be coverable by a moveable left cover 453 and a moveable right cover 454, respectively. The exterior housing 401 may have a side profile shape similar to a H-Beam. The exterior housing 401 may have front legs 404, 405 mounted to the front of the exterior housing, in which the front legs flank the moveable front cover 403. The front legs 404, 405 are also moveable. The front legs 404, 405 may each have a top portion 406 and a bottom portion 407, in which the top portion 406 is higher than the top side of the exterior housing, and the bottom portion 407 is lower than the bottom side of the exterior housing. The back side of the exterior housing 408 may be covered with a top rail portion 409 and a bottom rail portion 410 mounted to the back side 408. For extra structural support, the H-beam like exterior housing may have an upper and lower Rib/middle rail portion 411, 412 running along the middle of the top and/or bottom side of the exterior housing respectively, in which the Rib may be running parallel relative to the back side rail portion. The exterior housing 401 can be in any form or size to suit.

The internal surface of the back side 408 may be in connection with a cylindrical tube rear plate 413. The cylindrical tube rear plate 413 may have two apertures 455, and the cylindrical tube housing 414 may also have two apertures 455a that are inline and directly in front of the two apertures of the rear plate 413. The two apertures of the cylindrical tube housing 414 may house the first & second ball release lever housing 490. The ball release lever housing 490 are positioned on either side of the cavity 415 and are equidistant from the centre axes of the cavity 415. With each of the cylindrical tube rear plate apertures 455 adapted to receive a release lever having an upper plank rear engaging arm 457 and a lower plank rear engaging arm 458. The cylindrical tube rear plate 413 may have a slot 459 extending along the length of the cylindrical tube rear plate 413, wherein the slot 459 is positioned between the inner surface of the back side of the exterior housing 408 and the rear end of the cylindrical tube housing 414. The slot 459 may be adapted to receive an upper release plank 460 and lower release plank 461, wherein the upper release plank 460 is in engagement with an upper rear engaging arm 457 of the first and second upper release lever 481. The lower release plank 461 may be in engagement with the lower rear engaging arm 458 of the first and second lower release lever 481.

The cylindrical tube housing 414 may be a stationary part, which may be uniquely shaped to fit tightly in the interior of the exterior housing 401. The cylindrical tube housing 414 may have a lumen or a central cavity 415 with a cross-section suited for receiving a shank or a bolt 40 with the same cross-section. The cylindrical tube housing 414 may house the following parts: bit cylinder rod shaft rear cup housing 416, bit cylinder rods 417, bit cylinder springs 418, first spring 423, cylinder shaft piston 419, piston springs 420, ram rod shaft 427 and bit shank ram cup 428. The cylindrical tube housing 414 may have a hole 421 on either side of the cylindrical tube housing 414 to allow the ball-bearings 422 to move into the central cavity 415 or out of the central cavity 415. The outer cylindrical tube housing 414 may be stepped towards the lumen or central cavity 415. With the outer rear stepped portion, or the flange part that is mainly protruding out laterally at the rear flanks of the cylindrical tube housing 414 having two apertures 455a that may house the first & second ball release lever housing 490, the ball release lever housing 490 are positioned on either side of the cavity 415 and are equidistant from the centre axes of the cavity 415.

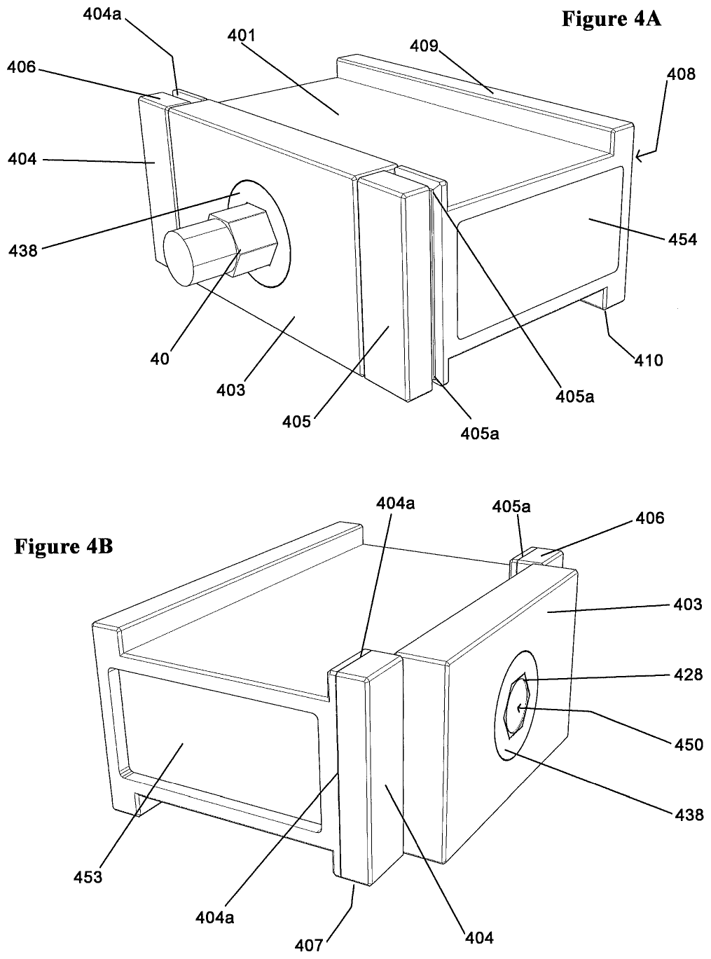

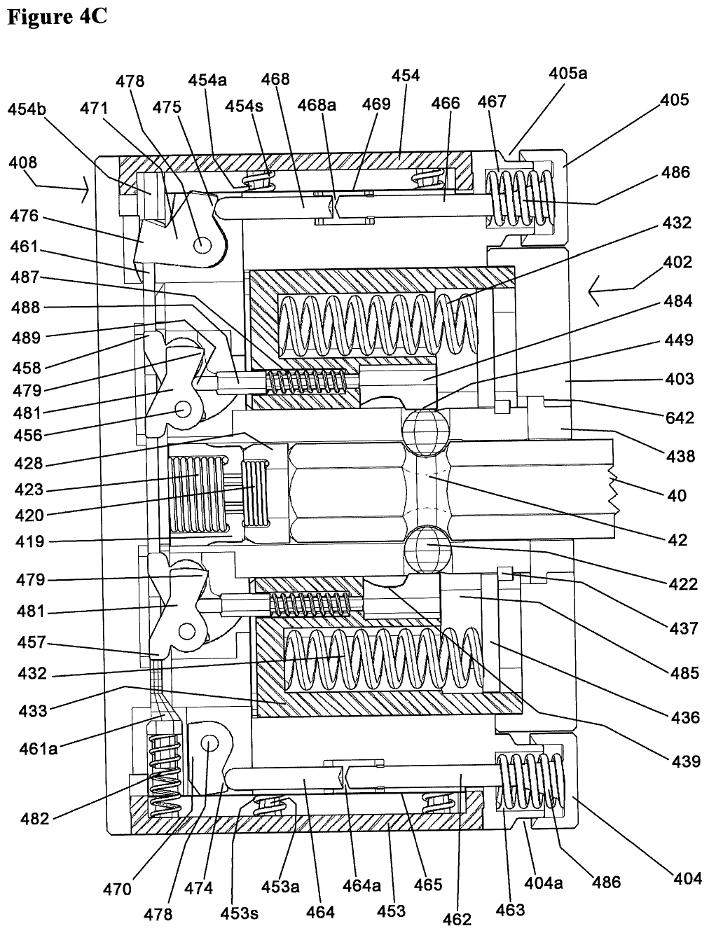

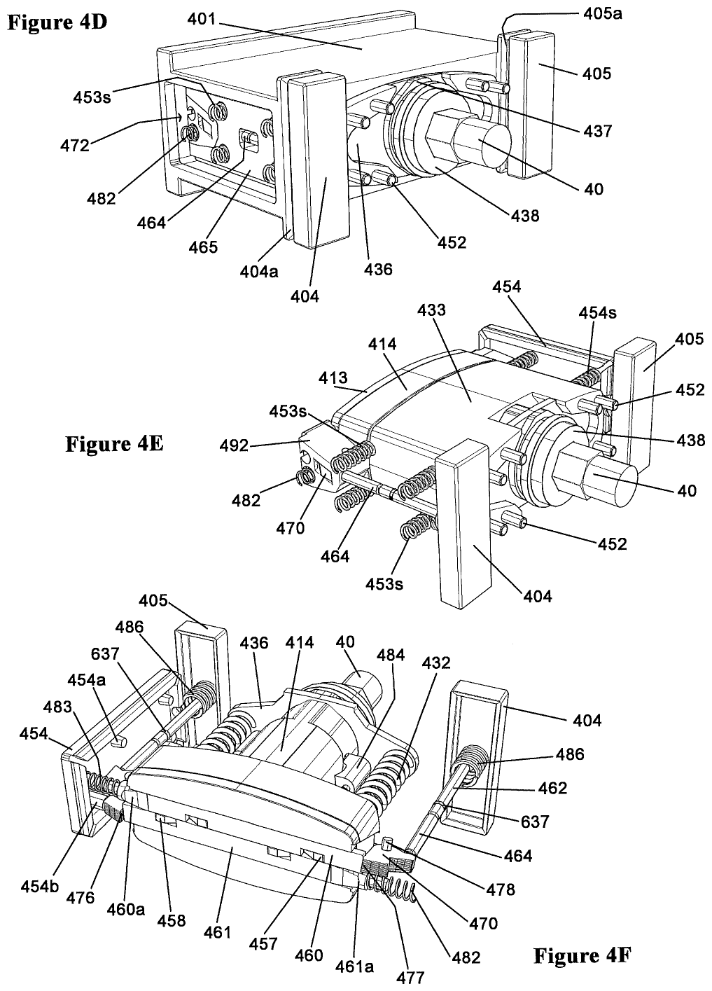

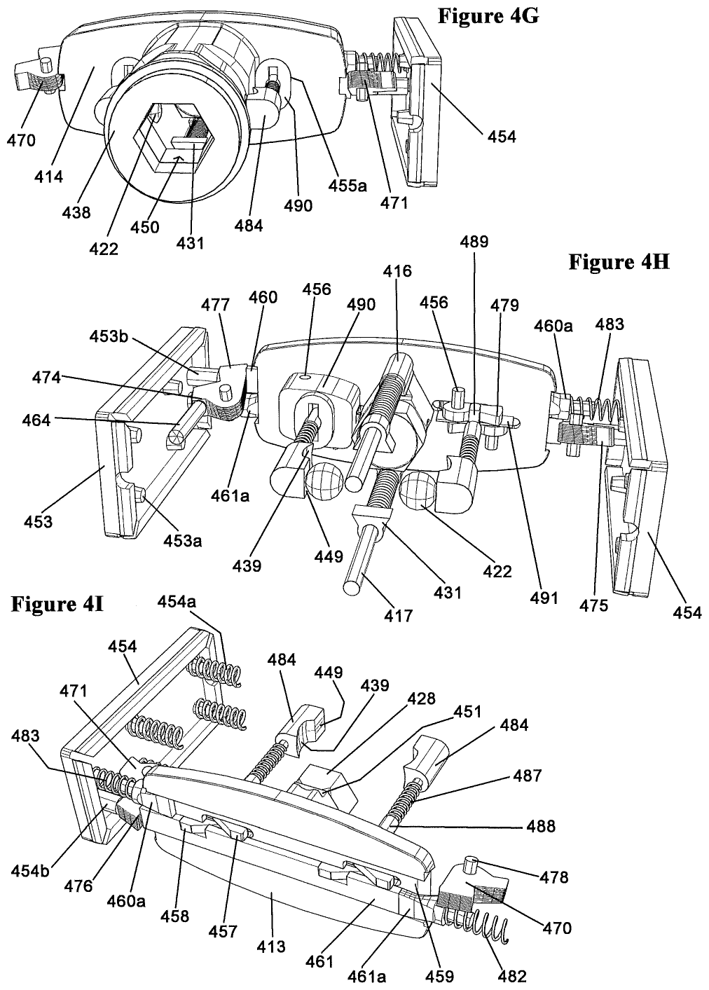

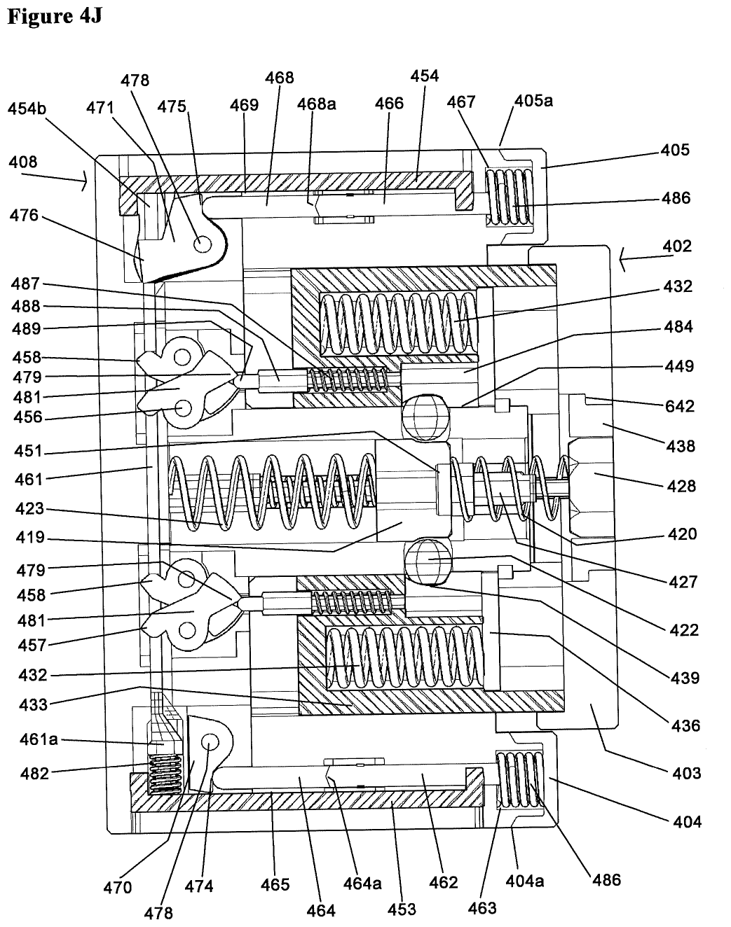

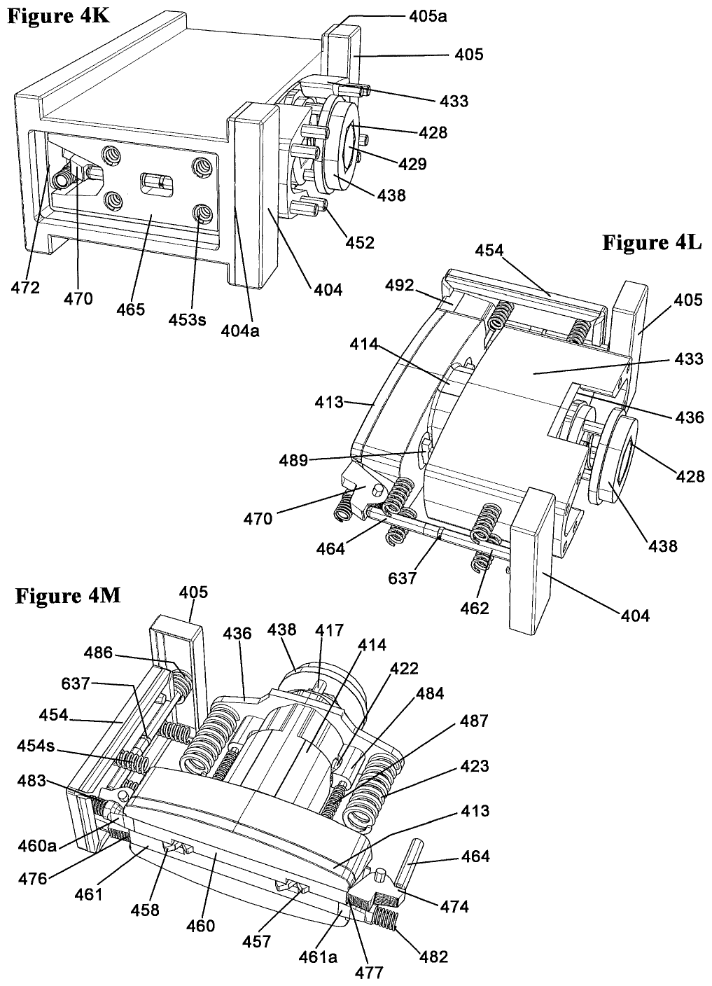

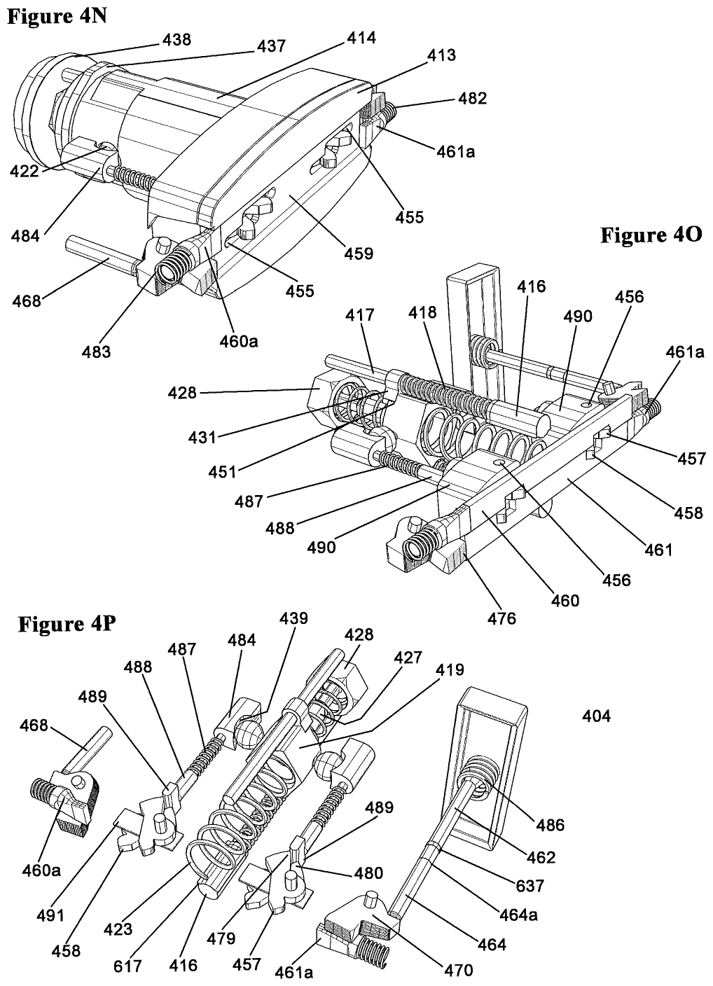

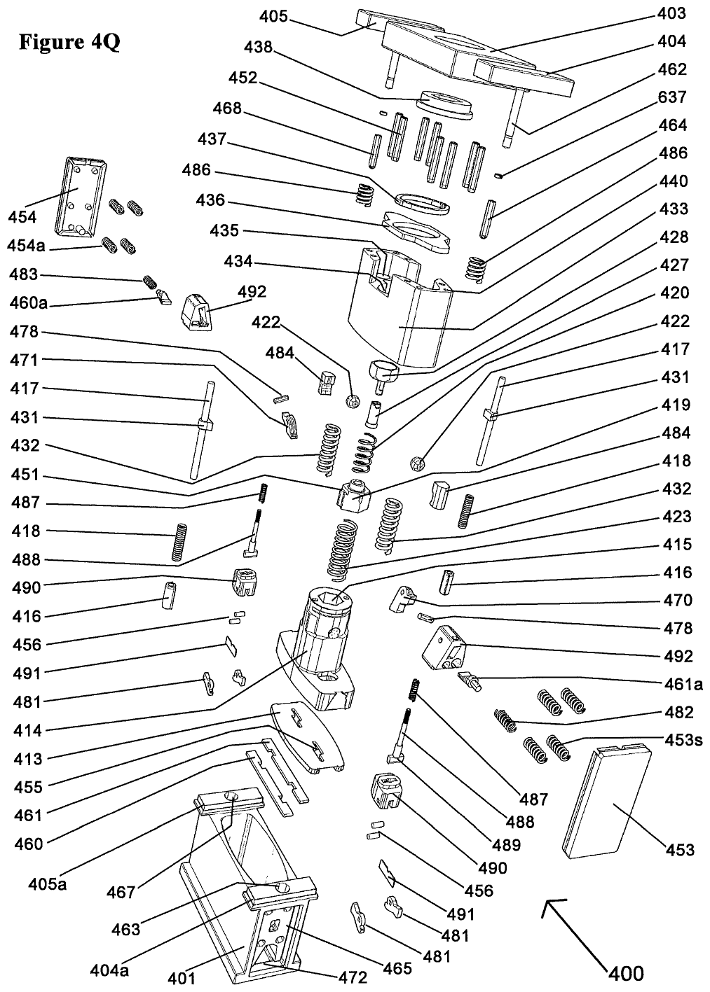

As can be seen in FIGS. 4A to 4Q and with a similar piston assembly on FIG. 31A. A cylinder shaft piston 419 may have a rear end and a front end. The cylinder shaft piston 419 may be housed above and below the cylinder rod assembly, 416, 417, 418. The piston 419 is adapted with a concave cavity 616 to not obstruct its function. A first spring 423 may be in connection between the rear plate 413 and the rear end of a cylinder shaft piston 419. The front end of the outer surface of the cylinder shaft piston 419 may have a notched cut-out portion 451. The first spring 423 may be housed in the cylindrical tube housing 414. The front end of the cylinder shaft piston 419 may have an aperture 425 of a unique shape so it can receive a second spring or a piston spring 420 and a tubular shank ram cup 426 within the piston 419. Preferably, the piston 419 is integrally joined with the tubular shank ram cup 426 such that it is one whole part. An advantage of this integrally joined parts is that it decreases the number of moving parts in this device, which may contribute to minimising wear and tear. The integrated tubular shank ram cup 426 may have a rear end and a front end, wherein the tubular shank ram cup 426 defines a lumen along its length. The tubular shank ram cup 426 is centrality integrally joined against the inner flange surface of the piston 419, while the front end of the tubular shank ram cup 426 may have a flange extending partially into the piston aperture 425. A rear portion of a tubular ram rod shaft 427 may have a flanged portion extending away from the outer surface of the tubular ram rod shaft 427, in which the flanged portion is engageable with an inner flange of the integrated tubular shank ram cup 426. Also, the tubular ram rod shaft 427 defines a lumen along its length. A front portion of the tubular ram rod shaft 427 may have a flange extending inward on the left and right flanks, a rear narrow rod portion of the bit shank ram cup 428 may have a flange extending outward on the left and right flanks, the rear rod portion of 428 is extended partially into the aperture of the tubular ram rod shaft 427, in which then is engaged with the inward flange of the tubular ram rod shaft 427 thereby securing the two together. The second spring or a piston spring 420 rests on the front recessed portion of the inner flange of the cylinder shaft piston 419 the other end of the second/piston spring 420 rests in a recessed portion on the rear side of the bit shank ram cup 428. The spring 420 is around and received in the combined elongated assembly 419, 427, 420 and 428. The front end of the tubular shank ram cup 428 may have a surface or a platform 429 at which a shank or a bolt 40 may be adapted to push or engage the surface or platform 419, which pushes the piston 419 towards the rear plate 413, thereby compressing both the first spring 423 and the piston spring 420, and also contract the combined assembly 423, 419, 427, 420 and 428.

The cylindrical tube housing 414 may have apertures 430 between the central cavity 415 and the outer surface of the cylindrical tube housing 414. The apertures 430 may each be parallel to relative to the central cavity 415. Each of the apertures 430 are adapted to receive a bit cylinder rod 417. For the embodiment having two bit cylinder rods 417, the bit cylinder rods 417 may be mounted diametrically opposite relative to each other inside the cylindrical tube housing 414. It may be appreciated that the bit cylinder rods 417 may be positioned equidistant relative to each other surrounding the central cavity 415. A rear cup housing 416 may be present at the rear between the rear plate 413, the rear cup 416 holds the end of the cylinder rod 417, the rear cup 416 having an aperture 416a where the end of the cylinder rod shaft extends partially into. A flange arm 431 may extend perpendicularly from a middle portion of each cylinder rod 417. The flange arm 431 may be positioned between a rear portion of the bit cylinder rod and the front portion of the bit cylinder rod. The piston 419 may be moveable between the rear portion and the flange arm 431 of the cylinder rod. The cylinder rod 417 is secured at the back of the front button 438 when the front button is moved from an Out, disengaged position to an IN, engaged position the cylinder rod 417 and the connected flange arm 431 will move in and engage with the notched cut-out portion 451 at the front end of the piston, whereby pushing the piston 419 back a predetermined distance where the engagement surface 448 of the piston will move away from the ball-bearings 422. A bit cylinder spring 418 may be resting on the flange arm 431 and the bit cylinder spring 418 may be mounted on the rear portion of the bit cylinder rod 417. The cylinder Springs 418 may force against the rear cup housing 416 with the other side of the spring forcing against flange arm 431, whereby keeping the bit cylinders rods 417 pushed out and at the same time keeps the cylinder shaft piston 419 at a predetermined distance from the front of the device.

As shown in e.g. FIG. 31D for reference, illustrates the rear cup housing 416, positioned at the rear of the device having a tubular like shape running parallel with the longitude axis of the cavity 415. Having a flange 617 like protrusion extending out along the length on either side of the flanks of the tubular shape, with the flanges 617 positioned away from the equatorial plane, and perpendicular north or south of the longitude axis of the tubular shape. The rear housing cup 416 having an aperture 416a within the tubular portion and extending partially into the aperture 416a is the end shaft part of the cylinder rod 417, whereby the end shaft part will reciprocate within the aperture 416a. With the rear bit cylinder rod cavity 430 of the cylindrical tube housing 414, adapted to receive the rear cup housing 416, where at the top and bottom of the cavity 415 there is a circumference like shape extending along the longitude axis of cavity that compliments the outside tubular shape and flange protrusion of the rear cup housing 416. Whereby once inserted, and because of its unique shape and tight fit, it cannot fall into the centre of the cavity, and thereby not obstructing with the moving cylinder piston assembly.

The sleeve housing 433 may have at least two further apertures 434, wherein the central cavity 435 is between each of the apertures 434 in which each of the apertures 434 are adapted for receiving a sleeve housing spring 432. The front end of the sleeve housing spring 432 is in engagement with a cylinder washer 436. There may be a cylinder washer 436 to keep the sleeve housing springs 432 secured and there may be a C-shaped cylinder clip 437 for holding the cylinder washer 436 in place while it is uniquely shaped to mount over the cylindrical tube housing 414. The front button 438 may form the front section of the device 400. The inner aperture of the front button 438 may be the same cross-sectional shape as the bit shank ram cups 428 platform 429. The front button 438 may be secured to the cylinder rods 417 which are then secured into the back of the front button 438.

The cylindrical tube housing 414 may have an outer sleeve housing 433, which may be axially moveable relative to the longitudinal axis of the cylindrical tube housing 414. The outer sleeve housing 433 may be adapted to receive within its central cavity a left ball-bearing release block and a right ball-bearing release block, wherein the cavities for the left and right ball-bearing release blocks 484 are between the central cavity/aperture 435 and the sleeve housing spring apertures 434. The cavities for the release blocks 484 are of a rectangular shape and positioned towards the front of the sleeve housings 433, and at the flanks of the central cavity 435; behind each rectangular shaped cavity, is a round aperture that extends longitudinally towards the rear of the sleeve housing 433, and with a small, flanged section immediately behind the rectangular shaped cavity. Where the rectangular shape cavity holds the release block 484, and the small flanged section retains the ball release rod 488 in place, the larger round aperture is occupied by the ball release rod spring 487. With the ball release rod spring 487 forcing against the stationary flanged section and mounted over the ball release rod 488, with the other side against the rods rear flanged part 489, whereby the release block 484 connected to the rod, is retained towards the rear wall of the rectangular shaped cavity 485. With the left and right release blocks 484 having a concave recess 439 and a non-recessed portion 449 adapted for receiving or retaining ball-bearings 422. Where the release blocks 484 may be able to move independently in the longitudinal direction within their rectangular shaped cavity. The space 485 may be longer and extended further forward then the release blocks 484, so to allow the ball-bearing release blocks 484 to move into. The channels or recesses 439 may be exposed or open when the outer sleeve housing 433 has moved forward, away from rear portion of the cylindrical tube housing 414. The channels or recesses 439 may be closed when the outer sleeve housing 433 is closer to the cylindrical tube housing 414 rear portion. The outer sleeve housing may have apertures 440 surrounding the cylindrical tube housing 414, wherein each of the apertures 440 of the outer sleeve housing 433 are parallel to the cylindrical tube housing 414. The apertures are each adapted to receive a dowel pin, grub screw or similar fastening device 452, wherein the fastening device 452 may connect the sleeve housing 433 with the front cover 403. The exterior housing 401 may cover the sleeve housing 433 and the sleeve housing 433 in connection with the front cover 403 can move away from the exterior housing 401 relative to the longitudinal axis of the central cavity 415.

The springs for this embodiment 400 may be an elastic object in which the extended springs will want to contract and return to the original spring shape or which the contracted springs will want to expand and return to the original spring shape. In the return to the original spring state, for example the contracted springs 432 may expand and provide an axial force to the sleeve housing 433 from the front to the rear, which in turn moves the sleeve housing 433 back, closer to the cylindrical tube housing 414 rear section. This action may move the left and right release blocks 484, non-recess 449 back, and the channels 439 concave shape pushes the ball-bearings 422 back into the cavity 415 so to allow the retention of the ball-bearings 422, whereby moving them laterally from the second position to the first position. The first group of locking balls now in the first position and out of the second position, wherein the first position is in the cavity 415, and the second position is in a corresponding first group of locking ball recesses, wherein the left and right release blocks 484, inner-side concave recess 439 comprises the first group of locking ball recesses.

The front portion of the cylinder shaft piston 419 may have a ball-bearing or locking ball engagement surface 448 for receiving the first group of locking balls. When there is no bolt 40 in the cavity 415, and with the device 400 in an unreleased configuration, the ball-bearings engagement surface 448 maybe in front of the cylinder shaft piston 419 where ⅓ of the ball-bearing 422 maybe overlapping the cylinder shaft piston 419, whereby the engagement surface 448 is at the side front corner flanks of the cylinder shaft piston 419, and with the ball-bearings 422 furthest side from the cavity 415 is in engagement with the non-recessed portion 449 of the left and right release blocks 484, whereby when in a unreleased configuration the ball-bearings 422 are unable to exit the cavity 415. When the device 400 is in a disengaged configuration, the ball-bearings engagement surface 448 maybe on the side walls of the cylinder shaft piston 419, whereby the side walls are parallel to the longitudinal axis of the cavity 415, and with the ball-bearings 422 furthest side from the cavity 415 is now engaged with the concave recess 449 of the left and right release blocks 484. When in this position the front cover 403 is in an out/released configuration. The cylinder shaft piston 419 may also have a concave cavity 616 at its top and bottom, so that when reciprocating within the cavity it does not interfere or obstruct the function of the cylinder rod assembly above and below it.

In this embodiment 400 of the invention, to effect the movement of the front cover 403, the left and right ball-bearing release blocks 484 may have an inner-side concave ball-bearing recess 439 and an inner-side non-recessed portion 449. Whereby, inner-side meaning that the inner part is facing the central cavity aperture 435 of the sleeve housing 433. The inner-side of the left ball-bearing release block 484 may receive a left ball-bearing or locking ball, of the first group of locking balls, wherein the left ball-bearing 422 may engage with the left release blocks concave recessed 439 portion. The left release block 484 may be retained within a left inner side release block cavity of the sleeve housing 433. The inner-side of the right ball-bearing release block 484 may receive a right ball-bearing or locking ball, of the first group of locking balls, wherein the right ball-bearing may engage with the right release blocks concave recessed 439 portion. The right release block 484 may be retained within a right inner side release block cavity of the sleeve housing 433

When the front cover 403 is flush with the first and second plate 404, 405, the sleeve housing springs 432 may be expanded. The left concave recessed portion of the left release block 484 and the right concave recessed portion of the right release block 484 within the sleeve housing 433 maybe in engagement with the left and right ball-bearing, respectively. This may provide a resisting force to keep the sleeve housing 433 towards the rear portion of the cylindrical tube housing 414. Upon movement of the left and right ball-bearing release blocks 484 towards the ball-bearing release block space 485 of the front of the sleeve housing, the ball-bearings 422 move laterally into the recesses of the ball-bearing release blocks 484. Since the sleeve housing spring is in connection with a stationary washer, as there is no longer a retention force to maintain the sleeve housing's position at the rear portion of the cylindrical tube housing, the expanded sleeve housing spring moves the sleeve housing 433 longitudinally towards the front the exterior housing. As the fastener 452 are in connection between the front of the sleeve housing 433 and the rear of the front cover 403, the front cover 403 also moves in the same longitudinal direction, such that the front cover 403 is no longer flush with the first and second plate 404, 405.

In this embodiment 400, to disengage the device, a user can pull the front cover 403 away from the exterior housing 401. While the front cover 403 and the sleeve housing 433 are moving out, the sleeve housing springs 432 are compressing. The movement of the sleeve housing 433 moving away towards the front portion of the cylindrical tube housing 414, expands the cavity and activates opening of the ball-bearings recess 439, thereby allowing the first group of locking balls 422 to start moving laterally away from the first position to the second position, whereby retracting from the central cavity 415 into the recess 439 of the left or right release block 484. With the front cover 403 moving out the bit cylinder spring 418 expands and forces against the flange arm 431, whereby forcing the connected bit cylinder rod 417 and the front button 438, to both start moving outward. With the ball-bearings 422 moving laterally away from the pistons side front corners of the engagement surface 448, the first spring 423 now can start to expand up. With the piston 419 moving out, and the piston 419 pushing out the preceding, expanded front portion of the piston assembly 420, 427, 428, and at the same time the expanding first spring also pushing the notched cut-out 451 of the piston and the engaged flange arm 431 of the bit cylinder rod 417 out, the connected button has now exited out. Now with the first group of locking balls 422 in the second position, and the front cover 403 and the sleeve housing 433 now in there outer most position, held in by a front lip extending laterally out at the front of the sleeve housing 433 spring apertures 434 which is in engagement with the secured cylinder washer 436, whereby preventing the sleeve housing 433 exiting the exterior housing 401. The device 400 is now disengaged and in an Out configuration.

To re-engage the device and put the front cover 403 back to a closed position, in this embodiment, a user can push down on the front button 438, or use an external force to push down on the front button, wherein it starts to go back in towards the rear of the device. The connected bit cylinder rods 417 and the flange arm 431 start to force the engaging notched cut-out portion 451 of the cylinder shaft piston 419 to move back down. With the cylinder shaft piston 419 moving back down, the pistons side walls, and the engagement surface 448 starts to move away from the ball-bearings 422. At the same time, the sleeve housing springs 432 continue to expand, by pushing against the static washer 436. The sleeve housing 433 reaching its final position down towards the rear of the device, and the first group of locking balls move laterally away from the left and right release block 484 concave recess 439, back to the first position, where now the sleeve housing 433 snaps back down. The re-engagement of the sleeve housing 433 and the expansion force of the sleeve housing springs 432 against the static washer 436, prevents the first group of locking balls from exiting the first position within the cavity 415, with the ball-bearings 422 now engaging with the pistons side front corners of the engagement surface 448 and restricting the piston 419 from moving forward. The rear flange of the front button 438 engaging with the internal complementary button cavity of the front cover 403 is now preventing the diametrically opposite force of the bit cylinder springs 418 against the flange arm 431, as such keeping the front button 438 flush with the front cover 403. The device 400 is now in engaged and an, IN position.

The device 400 may have a Rear-Lever and Plank-Release-Mechanisms assembly. A first rear outer lever 470 and a second rear lever outer 471, the rear outer lever 470/471 is housed within a first/second outer rear lever housing 492. The first rear outer lever 470 may be positioned at the exterior housings left corner or a first corner 472 and the second rear outer lever 471 may be positioned at the exterior housings right corner or a second corner 473. The first and second rear outer levers 470, 471 may each have a first/second rod engaging arm 474/475 and an upper/lower plank engaging arm 477/476 wherein the rod engaging arm 474, 475 and the plank engaging arm 477, 476 is pivotable about a pivot point 478. The first/second rod engaging arm 474/475 and an upper/lower plank engaging arm 477/476 are integrally connected such that the movement of the rod engaging arm 474, 475 at a longitudinal direction effects a lateral movement in the direction of movement to the upper/lower plank engaging arm 477/476. The movement of the upper release plank 460 effects the movement of the upper plank rear engaging arms 457 of the upper first and second ball release levers 481 towards the right, and movement of the lower release plank 461 effects the movement of the lower plank rear engaging arms 458 of the lower first and second ball release levers 481 towards the left. The first and second ball release levers 481 may each have a upper/lower plank rear engaging arm 457/458 and a ball release rod flange 489, upper/lower front engaging arm 479/480 wherein the rear engaging arm 457, 458 and the front engaging arm 479, 480 is pivotable about a pivot point 456. The upper/lower rear engaging arm 457/458 and an upper/lower front engaging arm 479/480 are integrally connected such that the movement of the rear engaging arm 457/458 at a lateral direction effects the movement in a longitude direction of the front engaging arm 479/480. The upper and lower release levers 481 may have a divider 491 in between them, thereby separating them. They are housed within a first & second ball release lever housing 490, where each housing holds, an upper and a lower release lever 481, a divider 491 and two pivot pins 456. The upper and the lower release lever 481 within the housing 490 may have a scissors mechanism in which as the upper rear arm 457 and the lower rear arm 458 are moved relatively towards each other, the upper and lower lever 481 are pivoted on their pivot point 456, which then effects the movement in a longitude direction of the front engaging arms 479, 480. Whereby the levers front engaging arm 479, 480 are moved relatively towards each other, pushing against the ball release rod flange 489, whereby the connected rod 488 moves the ball-bearing release block 484 longitudinally away from the rear of cylindrical tube housing 414. The left ball-bearing release block 484 may be positioned within the central cavity of the sleeve housing 433 and the left side of the central cavity 435; and the right ball-bearing release block 484 may be positioned within the central cavity of the sleeve housing 433 and the right side of the central cavity 435. The left ball-bearing release block 484 and the right ball-bearing release block 484 may move independently relative to the sleeve housing parallel to the longitudinal axis of the central cavity 435. The left and right ball-bearing release blocks 484 may each comprise a ball-bearing recess 439 and the non-recessed portion 449. The sleeve housing 433 may comprise a ball-bearing release block rectangular shaped space 485 for receiving the left and right ball-bearing release blocks 484. The space 585 may be longer and extended further forward than the release blocks 584, so to allow the ball-bearing release blocks 584 to move into so as to allow the ball-bearings 422 to move laterally from the blocks non-recessed portion 449 to the blocks recess 439 concave portion. Forcing the first group of locking balls 422 to retract, moving laterally away from the central cavity 415 into the recess 439. Once the ball-bearings 422 have moved into the blocks recess 439, and have vacated the cavity 415, whereby allowing the bolt 40 to be ejected out of central cavity 415 of the cylindrical tube housing 414, forced out by the elastic expanded springs 423 and 420 and exits the aperture 450. Or the bolt 40 or a bespoke object with a shaft 40 attached, can be taken out of the device 400 while holding down/in, any/all of the following assemblies: First-Top-Plate, Second-Top-Plate, Left-Side-Plate, Right-Side-Plate.

The device 400 may have a First-Top-Plate assembly and a Second-Top-Plate assembly. The top release plates 404, 405 of the exterior housing 401 that flanks the front cover 403 may be moveable from the front end towards the rear end of the exterior housing 401 or moveable with respect to the longitudinal axis of the central cavity 415. Moving at least one of the top release plates 404, 405 from the front to the rear end of the exterior housing 401 may operate as a release plate for the sleeve housing 433, which in turn ejects the engaged bolt 40 out of the aperture 450 of the front cover 403. The First-Top-Plate assembly may comprise of the following components, a first plate 404, whereby the first plate may be made up of four walls extending down with an internal aperture, within the inside aperture having a cone like shape that tapers down and connects to the first plate rod 462, at the end of the rod is a cone shape that tapers to an apex. The first plate 404 covers the top left recess of the main exterior 404a, within the centre of 404a is a first top spring aperture 463, which is adapted to receiving a first top plate rod spring 486, the first plate 404 and rod 462 inserted into the spring 486 and aperture 463 then connected to a rod retaining clip 637, that holds the top release plate 404 and rod 462 within a first interior side of the exterior housing 465. Between the rod 462 and a first rear rod 464 is a small narrow gap, a rod span 464a. The cone like shape at the bottom of the first rod 462 is adapted to mate with a complementary shape of the of the first rear rod 464 and with the other end having a round dome, where the dome of the first rear rod 464 engages with the first rod engaging arm 474 of the first rear outer lever 470. The Second-Top-Plate assembly may be a minor duplication of the First, whereby it may comprise of the following components, the second plate 405 may also be made up of four walls extending down with an internal aperture, within the inside aperture having a cone like shape that tapers down and connects to a second plate rod 466, at the end of the rod is a cone shape that tapers to an apex. The second plate 405 covers the top right recess of the main exterior 405a, within the centre of 405a is a second top spring aperture 467, which is adapted to receiving a second top plate rod spring 486, the second plate 405 and rod 466 inserted into the spring 486 and aperture 467 then connected to a rod retaining clip 637, that holds the top release plate 405 and rod 466 within a second interior side of the exterior housing 469. Between the rod 466 and a second rear rod 468 is a small narrow gap, a rod span 468a. The cone like shape at the bottom of the second rod 466 is adapted to mate with the complementary shape of the of the second rear rod 468 and with the other end having a round dome, where the dome of the second rear rod 468 engages with the second rod engaging arm 475 of the second rear outer lever 471. The first plate rod 462 may be parallel to the second plate rod 466, wherein the first plate rod 462 may be positioned between the left interior side or first interior side of the exterior housing 465 and the first side of the sleeve housing 433. The second plate rod 466 may be positioned between the right interior side or second interior side of the exterior housing 469 and the second side of the sleeve housing 433.

The device 400 may have a Left-Side plate assembly and/or a Right-Side-Plate assembly on the lateral sides. The side release plates 453, 454 of the exterior housing 401 are on the flank side walls, and parallel to the longitudinal axis of the cavity 415. By pushing the side laterally of at least one of the side release plates 453, 454 IN, effects the lateral movement in the direction of movement. Whereby it may operate as a release plate for the sleeve housing 433, which in turn ejects the engaged bolt 40 out of the aperture 450 of the front cover 403. The Left-Side plate assembly may comprise of the following components, a left side plate 453, whereby the back of the side plate may have, stud like protrusions 453a for retaining the left return springs 453s, also a lever pushing rod 453b, a protrusion that extends out of the back of the side plate so to engage with the upper plank engaging arm 477, also a small protrusion that retains a lower left plank arm lateral spring 482, and within the aperture of the arm spring 482 on the other side is the rod portion of the lower plank left side arm 461a, whereby the left side arm 461a engages with the left side of the lower plank 461. The Right-Side-Plate assembly may comprise of the following components, a right side plate 454, whereby the back of the side plate may have, stud like protrusions 454a for retaining the right return springs 454s, also a lever pushing rod 454b, a protrusion that extends out of the back of the side plate so to engage with the lower plank engaging arm 476, also a small protrusion that retains a upper right plank arm lateral spring 483, and within the aperture of the arm spring 483 on the other side is the rod portion of the upper plank right side arm 460a, whereby the right side arm 460a engages with the right side of the upper plank 460. The lower/upper plank side arm 461a/460a, the lower/upper plank arm spring 482/483, the first/second outer levers 470/471, and a pivot pin 478 are all combined within the first/second outer rear lever housing 492, where the whole combined assembly slides into the cavity of the exterior housings left/right rear corner 472/471 aperture. The below example demonstrates that by pressing one or both side release plates 453/454 does not affect the position or the function of the other as they are both independent. When a left/right side release plate 453/454 is pressed in, the left/right lever pushing rod 453b/454b engages with upper/lower plank engaging arm 477/476, were it then engages with the upper/lower plank 460/461, were the upper/lower plank 460/461 engages with the two upper/lower plank rear engaging arms 457/458, whereby the end of the upper/lower plank 460/461 on the opposite side of the pressed side release plate 453/454, pushes against the upper/lower plank side arm 460a/461a, were then the upper/lower plank arm spring 483/482 compressors and the upper/lower plank side arm 460a/461a engages with the right/left side release plate 454/453. Once the pressure has been taken off, on the left/right side release plate 453/454 that was pushed in, the upper/lower plank arm spring 483/482 then expands back forcing the upper/lower plank side arm 460a/461a in a lateral direction towards the left/right side release plate 453/454 that was pushed in, pushing against the upper/lower plank 460/461, whereby the upper/lower plank 460/461 returns to its normal position, the compressed ball release rod springs 487 that now have re-expanded, forcing down on the ball release rods 488, and the rods rear engagement flanges 489, where they engage and push down the upper/lower front engaging arms 479/480 and with the upper/lower plank rear engaging arms 457/458 pushed back down, the upper/lower plank engaging arm 477/476 returns back to its normal position, and the left/right side release plate 453/454 that was pressed, now returns to its released position.

In this embodiment, to disengage the bolt 40 from the device 400, a user can pull the front cover 403 away from the exterior housing 401. With the front cover 403 and the sleeve housing 433 moving forward, the sleeve housing springs 432 are getting compressed. With the bit cylinder spring 418 forcing against the flange arm 431, the connected bit cylinder rod 417 and the front button 438, both are moved outward. With the sleeve housing 433 continuing forward, the left and right release block 484, and the connected ball release rod 488 and spring 487 are pushed along with the sleeve housing 433, whereby expanding the cavity and activate opening of the ball-bearings recess 439, with the concave portion of the release blocks 484 now reaching, and in line laterally with the ball-bearings 422, whereby allowing the first group of locking balls 422 to retract, moving laterally away from the central cavity 415 into the recess 439. As the ball-bearings 422 retract from the cavity 415 into the recess 439, the ball-bearings 422 no longer engage with the concave mounting portion 42 of the bolt 40 and thereby having no resisting bolt retention force. With no resisting bolt retention force, the first spring 423 expands back to the original shape which pushes the piston 419 towards the aperture or opening 450. As the bolt 40 continues to travel out the piston springs 420 expands and elongates the front part of the piston assembly, the ram rod shaft 427, and the bit shank ram cup 428. At the same time the bit cylinder rod assembly is pushing out and holding the front button 438 out. With the bolt 40 now ejected out of the aperture 450 the device 400 is now disengaged.

Another method of disengaging the bolt 40 from the device 400 may be by pressing the first or second plate 404/405 assemblies, meaning by pressing the First-Top-Plate assembly or Second-Top-Plate assembly. By pressing the first or second plate 404/405, longitudinally from the front end of the exterior housing towards the rear end of the exterior housing, when pressed, the top plate rod spring 486 in the left and right recessed portion of the exterior housing 404a, 405a within the left and right top spring aperture 463/467 will compress in, whereby the right or left plate 404/405 and the connected first/second plate rod 462/466 will move a predetermined distance 464a towards the first/second rear rod 464/468, whereby it engages with the first or second rear outer levers 470/471 flange of the levers rod engaging arm 474/475. The left or right rear outer lever 470/471 needs to pivot a predetermined distance to move longitudinally the left or right rod engaging arm 474/475 so to move laterally the left or right plank engaging arm 477/476. The length of the device 400 in a longitude direction can be of any length and not limited, and the distance that the first or second plate 404/405 may need to travel down so the connected first or second plate rod 462/466 can engage with the bottom first or second rear rod 464/468 is not limited and can be of any length. Thereby the rod span 464a/468a is determined by how far the top plate 404/405 needs to travel down and the outer levers 470/471 predetermined distance to pivot and engage the plank 460/461. Once the rear rods 464/468 dome portion has engaged with the rod engaging arm 474/475, it then actuates the Rear-Lever and Plank-Release-Mechanisms assembly. When the user or an external apparatus is no longer pressing the first or second top plate 404/405 down, the elastic springs 486 will force the top plate to return back to its original location.

A further method of disengaging the bolt 40 from the device 400 may be by pressing the left or right side of exterior the housing release assemblies. Meaning by pressing the Left-Side-Plate assembly or Right-Side-Plate assembly. Pressing one or both side release plates 453/454 laterally towards the side of the sleeve housing 433 may provide a lateral force on either: one or both side release plates 453/454 of the exterior housing 401. Once the side release plate 453/454 has travelled a predetermined distance IN, the connected left or right lever pushing rod 453b/454b engages with the upper/lower plank engaging arm 477/476 whereby it then actuates the Rear-Lever and Plank-Release-Mechanisms assembly. At the back of each side release plate 453/454 are stud like protrusions 453a/454a where they engage with the return springs 453s/454s for the side release plate 453/454 the other side of the return springs are within an aperture on the outer lateral side-walls of the exterior housings 401 within a first/second interior side 465/469, where the side-wall may be parallel with the longitude axis of cavity 415, and with the return springs 453s/454s apertures may be perpendicular to the side-wall. When a side release plate 453/454 has been pushed IN, and when released the return springs 453s/454s assist in pushing the side plate back to its normal position.

For locking a bolt or a shaft 40, in a device 400. The bolt or shaft 40 is suitably sized with at least one concave mounting portion 42 for receiving the first group of locking balls or ball-bearings 422. With the device in a disengaged, and Out position, the bolt or shaft 40 may be inserted into the device 400 via the aperture or cavity 450 at the front. Once the bolt or shaft 40 has engaged with the platform 429, the bit shank ram cup 428 and the combined piston assembly 420, 427, 419, 423, start to contract and move towards the rear of the cylindrical tube housing 414. As the piston 419 is moved back, and the first spring 423 is compressed the pistons side front corners of the engagement surface 448 disengages with the ball-bearings 422. Because the side walls of the bolt or shaft 40 occupy the cavity 415 the ball-bearings 422 cannot yet return back to the first position within the cavity 415. With the bolt's concave portion 42 now reaching, and in line laterally with the ball-bearings 422, the concave recess 439 starts to open, where they then fall into the cavity of the concave portion 42 of the bolt. With the ball-bearings 422 entering the cavity 415 and the sleeve housing springs 432 continue expanding, pushing against the static washer 436, at the same time the ball release rod springs pushing against the rod engagement flange 489 and an internal wall of the sleeve housing 433, forcing the left and right release block 484 to stay down, attached to the rear of the inside cavity of the sleeve housing 433, meanwhile the expanding springs 432 continue forcing the sleeve housing 433 and the connected front button 438 to snap back down towards the rear of the device. With the rear flange of the front button 438 now held down by the complementary button cavity of the front cover 403, now, the bolt and the device 400 are in an engaged configuration.

An advantage of having three different release methods in the one device, that is, 1) releasing via pulling the front cover 403 out, or 2) pushing longitudinally at least one of the top plates 404/405 flanking the front cover 403, or 3) pushing laterally at least one of the left or right side plates 453/454 of the external housing 401; is that depending on the orientation and placement of the device 400, there is a convenient and accessible way for which a user can release the front cover 403 out. And an advantage of having three different methods to engage a bolt 40 or a bespoke bolt with a concave 42 mount, in the one device, that is, 1) engaging the bolt 40 while the front cover 403 is out where then the front retracts in triggered by the internal mechanism, or 2) with the front cover already engaged press one/both of the flanking top plates 404/405, while holding the top plate down insert the bolt 40, because the ball-bearings 422 are relaxed within the blocks 484, the bolt is able to be inserted all the way in, then release the top plate 404/405 and the bolt is engaged, 3) similar to #2 above but using the left or right side plates 453/454 to disengage the ball-bearings within the cavity 415 then insert the bolt 40, once the bolt is all the way in, release the side plates 453, 454 or side plate 453/454 and the bolt is engaged; this may be an advantage on a device 400, in occasions when the front cover cannot be lifted, or you may need to use a third party apparatus to do the insertion of the bolt.

It may be a safety mechanism that the flange rod may not be a continuous rod but a divided rod system, wherein a gap is present between the front flange rod and the rear flange rod. The gap may be of a length that may correspond to the predetermined distance that the right or left flanking side may have moved towards the rear end such that when the flanking side have moved the predetermined distance, the front flange rod then longitudinally moves the rear flange rod, which in turn provides a longitudinal force to the flange engaging arm of the rear lever, which in turn moves the release rod engaging arm laterally. This safety mechanism is to prevent accidentally activating the release system when the flanking side may have been bumped or pressed into.

In another preferred embodiment of the invention, the device 500 may have an exterior housing 501. The exterior housing 501 may be a box of six sides, in which one of the front sides 502 is coverable by a moveable front cover 503/603. The left and right sides of the exterior housing 501 may also be coverable by a moveable left cover 553 and a moveable right cover 554, respectively. The exterior housing 501 may have a side profile shape similar to a H-Beam. The exterior housing 501 may have front legs 504, 505 mounted to the front of the exterior housing, in which the front legs flank the moveable front cover 503. The front legs 504, 505 are also moveable. The front legs 504, 505 may each have a top portion 506 and a bottom portion 507, in which the top portion 506 is higher than the top side of the exterior housing, and the bottom portion 507 is lower than the bottom side of the exterior housing. The back side of the exterior housing 508 may be covered with a top rail portion 509 and a bottom rail portion 510 mounted to the back side 508. For extra structural support, the H-beam like exterior housing may have an upper and lower Rib/middle rail portion 511, 512 running along the middle of the top and/or bottom side of the exterior housing respectively, in which the Rib may be running parallel relative to the back side rail portion. The exterior housing 501 may be in any form or size to suit.

The internal surface of the back side 508 may be in connection with a cylindrical tube rear plate 513. The cylindrical tube rear plate 513 may have two apertures 555, and the cylindrical tube housing 514 may also have two apertures 555a that are inline and directly in front of the two apertures of the rear plate 513. The two apertures of the cylindrical tube housing 514 may house the first & second ball release lever housing 590, the ball release lever housing 590 are positioned on either side of the cavity 515 and are equidistant from the centre axes of the cavity 515. Within each of the ball release lever housings 590, having an aperture at the rear to receive an upper & lower ball release lever 581 with a pivot pin 556 for each lever, and the front portion adapted to receive a ball-bearing 522b of the second group of locking balls within an aperture 521b, also may house four sleeve housing springs 532 at the front. With each of the cylindrical tube rear plate apertures 555 adapted to receive a release lever having an upper plank rear engaging arm 557 and a lower plank rear engaging arm 558 of the ball release levers 581. The cylindrical tube rear plate 513 may have a slot 559 extending along the length of the cylindrical tube rear plate 513, wherein the slot 559 is positioned between the inner surface of the back side of the exterior housing 508 and the rear end of the cylindrical tube housing 514. The slot 559 may be adapted to receive an upper release plank 560 and lower release plank 561, wherein the upper release plank 560 is in engagement with an upper rear engaging arm 557 of the first and second upper release lever 581. The lower release plank 561 may be in engagement with the lower rear engaging arm 558 of the first and second lower release lever 581.

The cylindrical tube housing 514 may be a stationary part, which may be uniquely shaped to fit tightly in the interior of the exterior housing 501. The cylindrical tube housing 514 may have a lumen or a central cavity 515 with a cross-section suited for receiving a shank or a bolt 50 or bespoke with the same cross-section. The cylindrical tube housing 514 may house the following parts: bit cylinder rod shaft rear cup housing 516, bit cylinder rods 517, flange/push arm 531, bit cylinder springs 518, first spring 523, cylinder shaft piston 519, piston springs 520, ram rod shaft 527 and bit shank ram cup 528. The cylindrical tube housing 514 may have a hole 521a on either side of the cylindrical tube housing 514 to allow the ball-bearings 522a of the first group of locking balls to move into the central cavity 515 or out of the central cavity 515. The outer cylindrical tube housing 514 may be stepped towards the lumen or central cavity 515. With the outer rear stepped portion, or the flange part that is mainly protruding out laterally at the rear flanks of the cylindrical tube housing 514 having two apertures 555a that are adapted to house the first & second ball release lever housing 590, the ball release lever housing 590 are positioned on either side of the cavity 515 and are equidistant from the centre axes of the cavity 515.

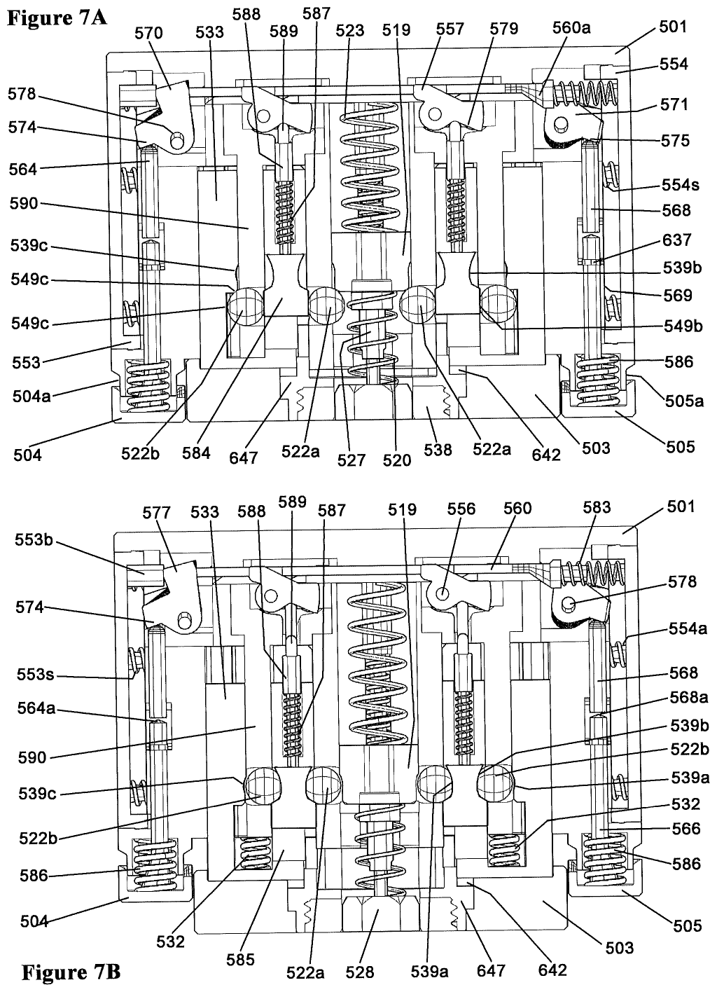

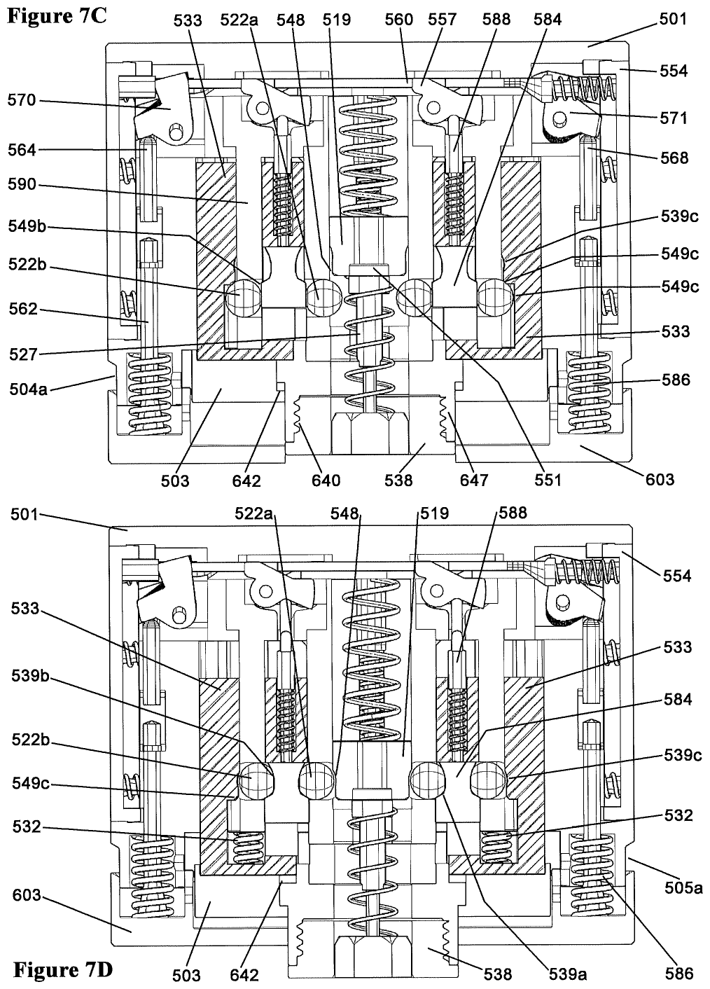

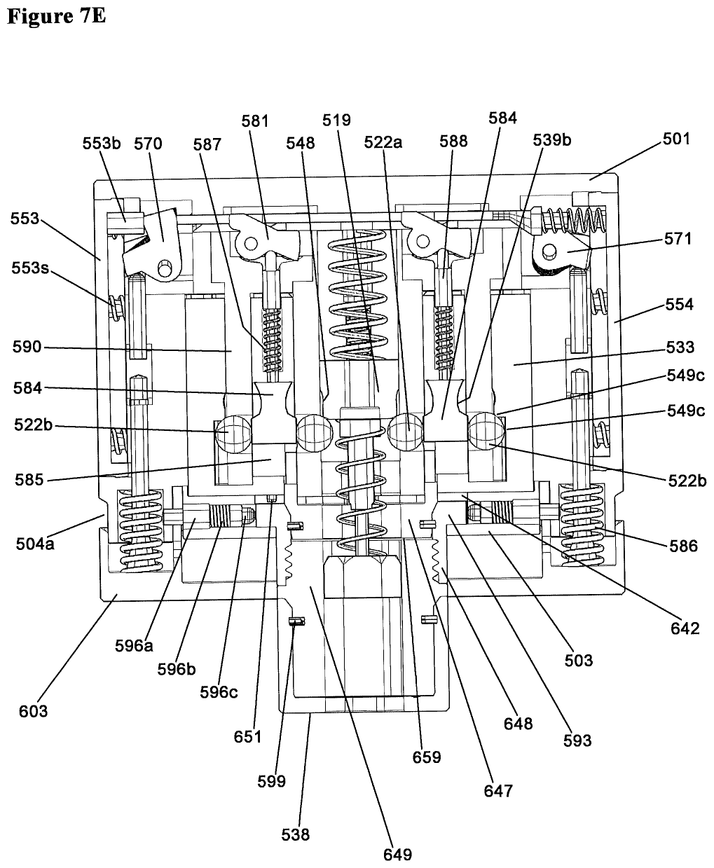

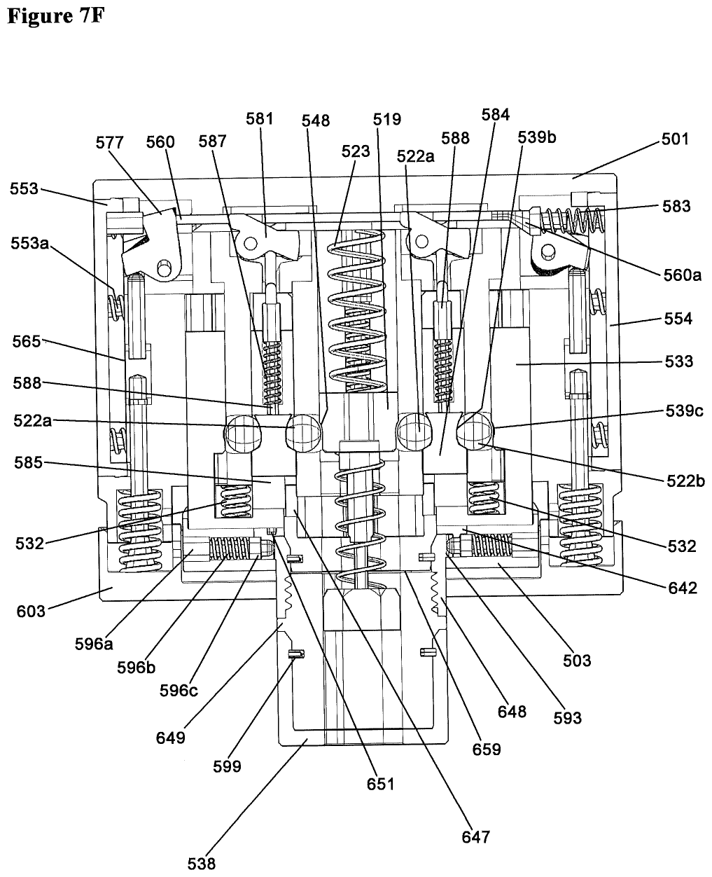

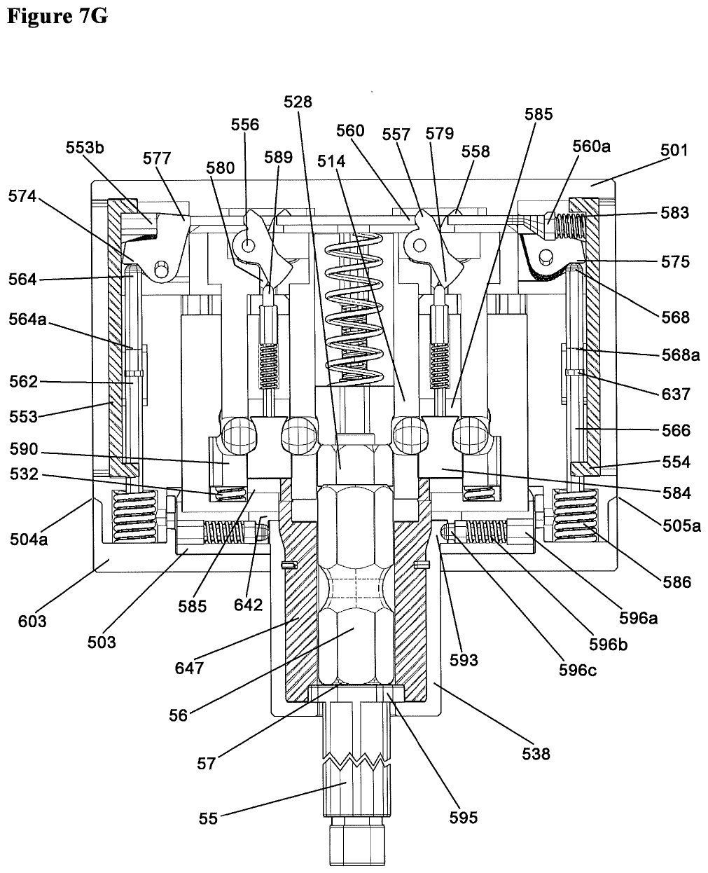

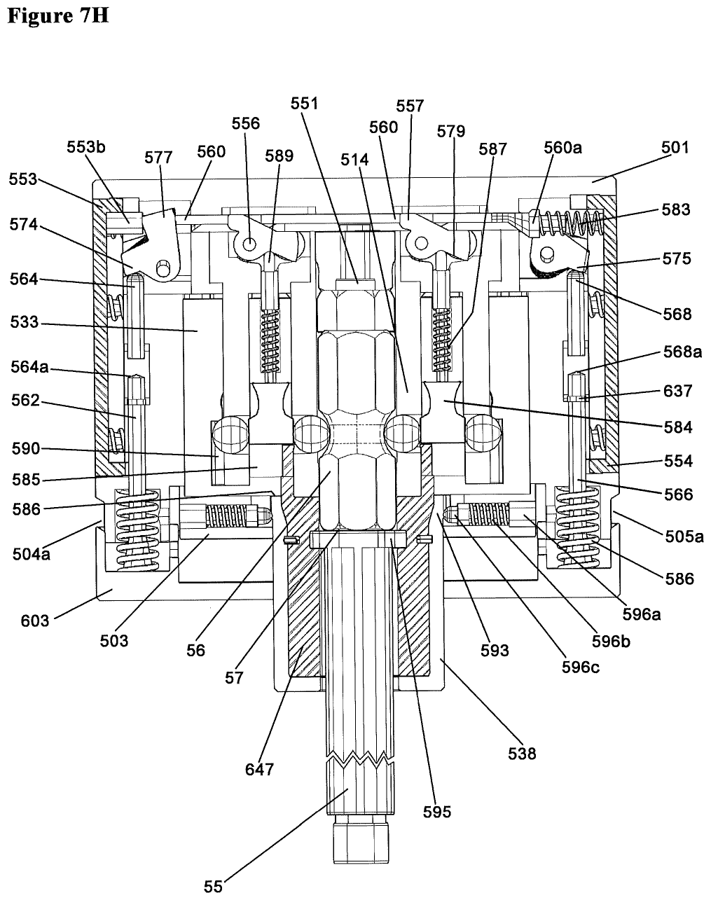

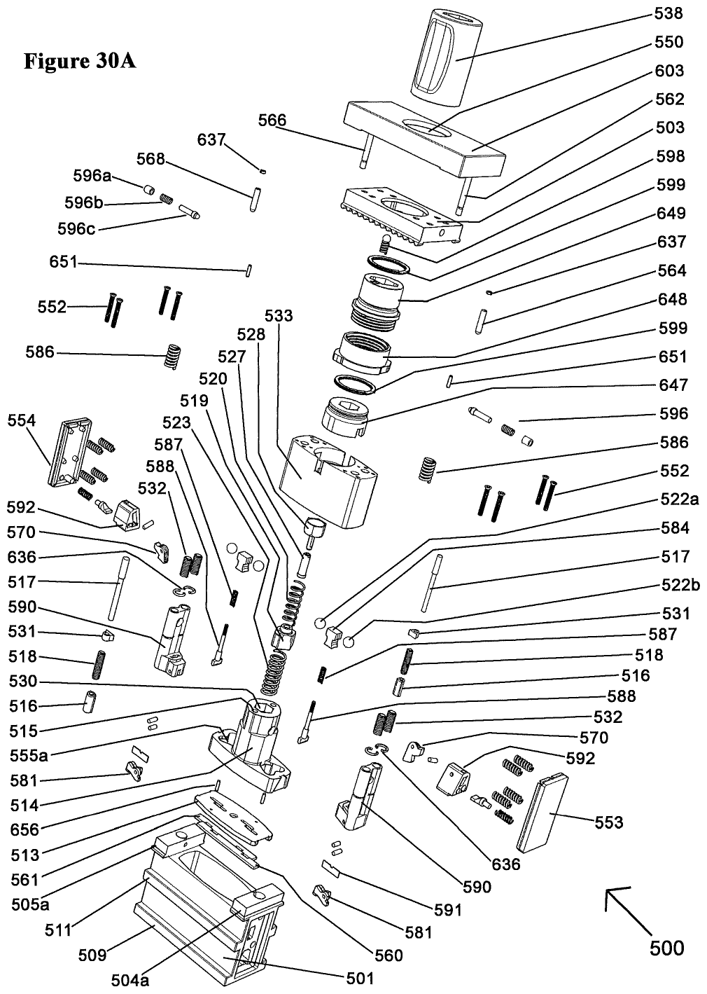

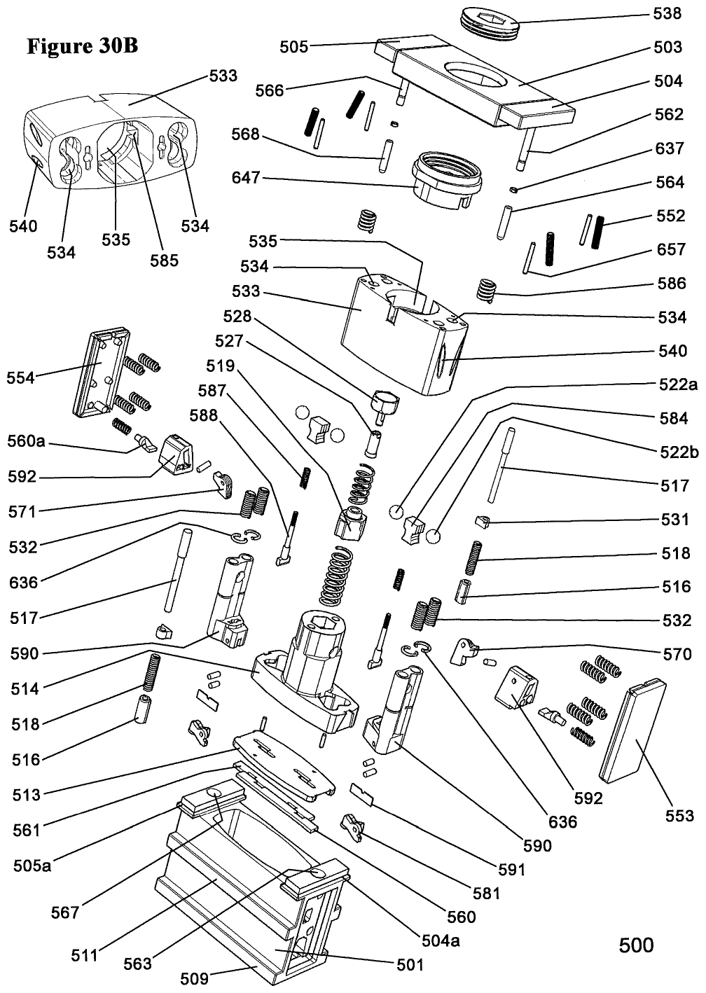

As shown in FIG. 7A to FIG. 7H and with a cross-sectional perspective view in FIG. 30A. A cylinder shaft piston 519 may have a rear end and a front end. The cylinder shaft piston 519 may be housed above and below the cylinder rod assembly, 516, 517, 531, 518. The piston 519 is adapted with a concave cavity 616 to not obstruct the function of the cylinder rod assembly. A first spring 523 may be in connection between the rear plate 513 and the rear end of a cylinder shaft piston 519. The front end of the outer surface of the cylinder shaft piston 519 may have a notched cut-out portion 551. The first spring 523 may be housed in the cylindrical tube housing 514. The front end of the cylinder shaft piston 519 may have an aperture 525 of a unique shape so it can receive a second spring or a piston spring 520 and a tubular shank ram cup 526 within the piston 519. Preferably, the piston 519 is integrally joined with the tubular shank ram cup 526 such that it is one whole part. An advantage of this integrally joined parts is that it decreases the number of moving parts in this device, which may contribute to minimising wear and tear. The integrated tubular shank ram cup 526 may have a rear end and a front end, wherein the tubular shank ram cup 526 defines a lumen along its length. The tubular shank ram cup 526 is centrality integrally joined against the inner flange surface of the piston 519, while the front end of the tubular shank ram cup 526 may have a flange extending partially into the piston aperture 525. A rear portion of a tubular ram rod shaft 527 may have a flanged portion extending away from the outer surface of the tubular ram rod shaft 527, in which the flanged portion is engageable with an inner flange of the integrated tubular shank ram cup 526. Also, the tubular ram rod shaft 527 defines a lumen along its length. A front portion of the tubular ram rod shaft 527 may have a flange extending inward on the left and right flanks, a rear narrow rod portion of the bit shank ram cup 528 may have a flange extending outward on the left and right flanks, the rear rod portion of 528 is extended partially into the aperture of the tubular ram rod shaft 527, in which then is engaged with the inward flange of the tubular ram rod shaft 527 thereby securing the two together. The second spring or a piston spring 520 rests on the front recessed portion of the inner flange of the cylinder shaft piston 519 the other end of the second/piston spring 520 rests in a recessed portion on the rear side of the bit shank ram cup 528. The spring 520 is around and received in the combined elongated assembly 519, 527, 520 and 528. The front end of the tubular shank ram cup 528 may have a surface or a platform 529 at which a shank or a bolt 50 may be adapted to push or engage the surface or platform 519, which pushes the piston 519 towards the rear plate 513, thereby compressing both the first spring 523 and the piston spring 520, and also contract the combined assembly 523, 519, 527, 520 and 528.

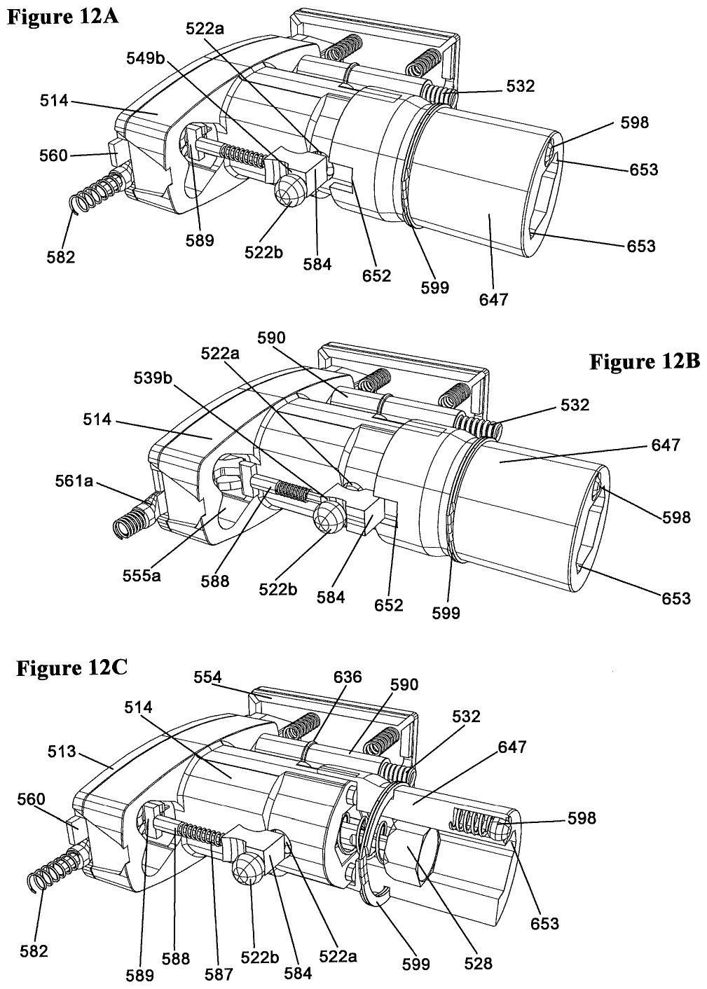

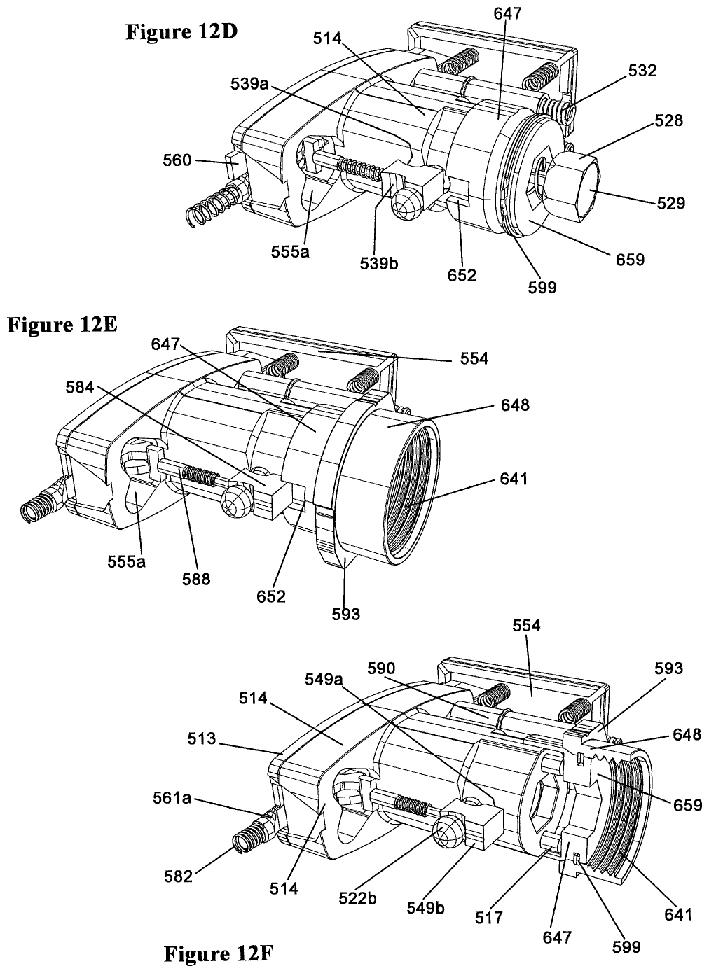

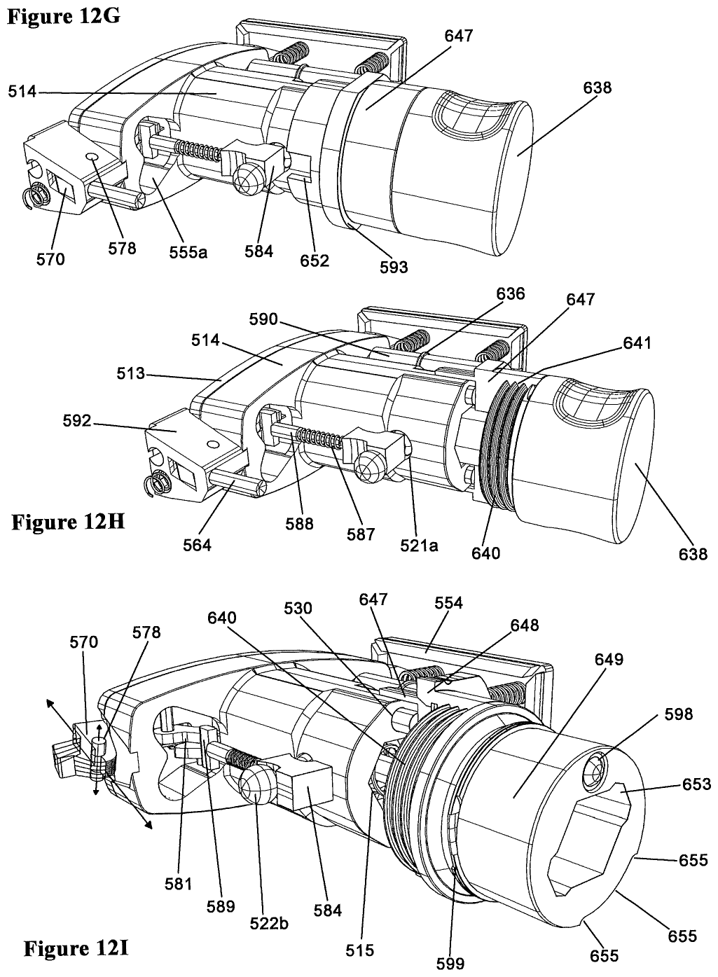

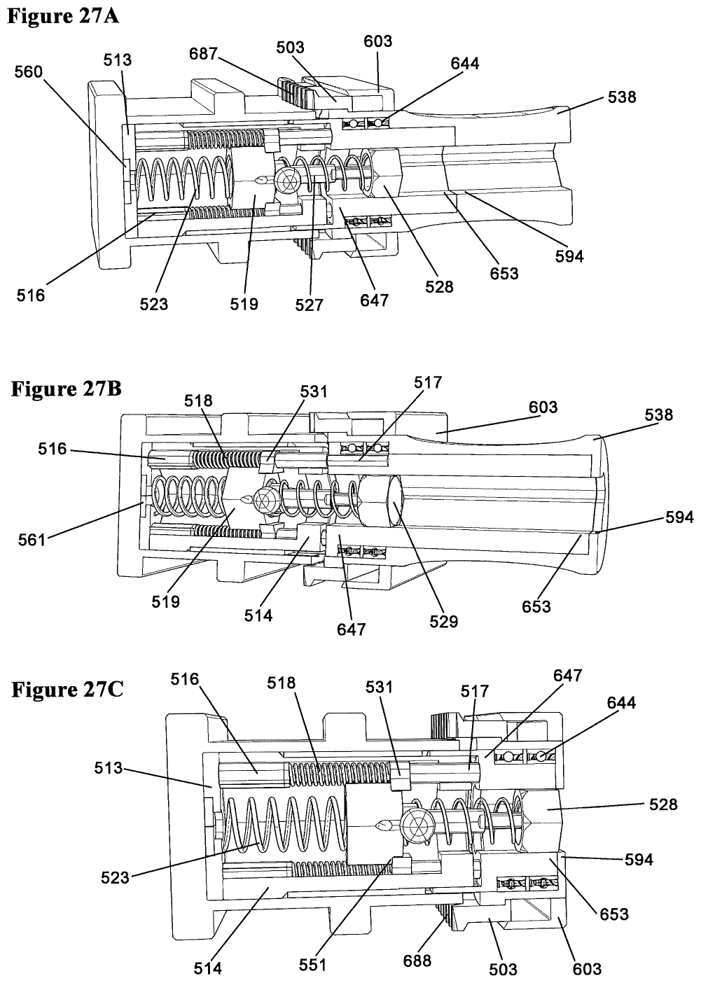

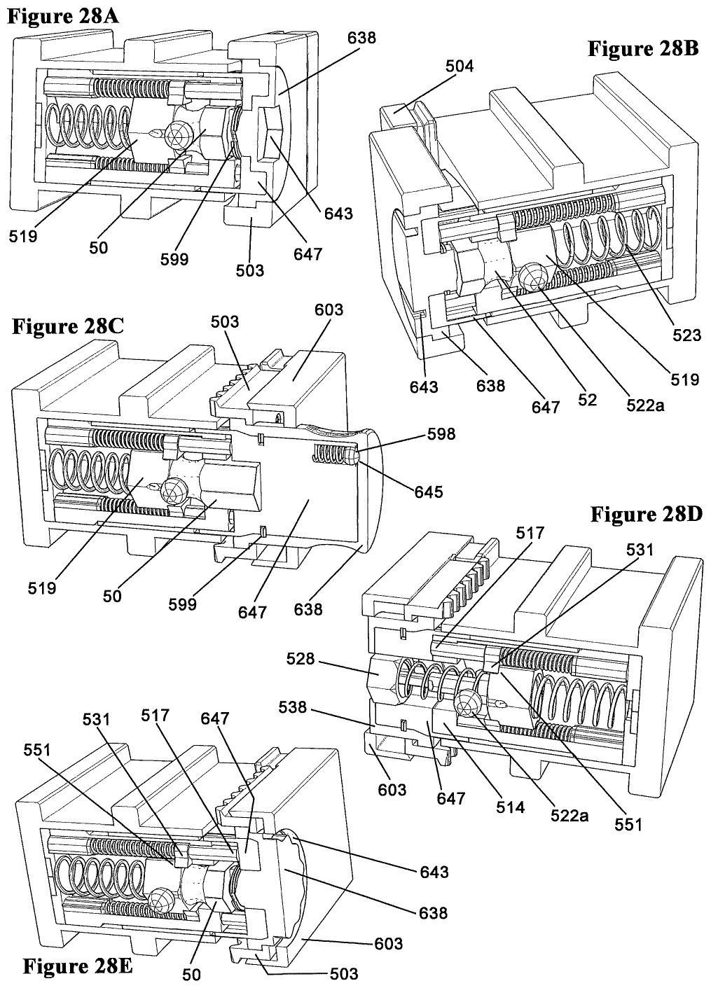

As shown in e.g. FIGS. 12I, 26A to 27C. The cylindrical tube housing 514 may have apertures 530 between the central cavity 515 and the outer surface of the cylindrical tube housing 514. The apertures 530 may each be parallel to relative to the central cavity 515. Each of the apertures 530 are adapted to receive a bit cylinder rod 517. For the embodiment 500 having two bit cylinder rods 517, the bit cylinder rods 517 may be mounted diametrically opposite relative to each other inside the cylindrical tube housing 514. It may be appreciated that the bit cylinder rods 517 may be positioned equidistant relative to each other surrounding the central cavity 515. A rear cup housing 516 may be present at the rear between the rear plate 513, the rear cup 516 holds the end of the cylinder rod 517, the rear cup 516 having an aperture 516a where the end of the cylinder rod shaft extends partially into. A flange arm 531 may extend perpendicularly from a middle portion of each cylinder rod 517. It may be appreciated that in the embodiment 500 the flange/push arm 531 is a separate part and not connected to the cylinder rod 517, the advantages are, a different shaped flange/push arm 531 may be used if necessary and in manufacturing. The flange/push arm 531 may be positioned between a rear portion of the bit cylinder rod and the front portion of the bit cylinder rod. The piston 519 may be moveable between the rear portion and the flange arm 531 of the cylinder rod. The cylinder rod 517 may be secured or may be diametrically opposed, resting behind the button, not inserted into the back of the front button 538, or the rear button guide 647. When the button assembly is moved back in, from an Out/disengaged position to an IN/engaged position the cylinder rod 517 and the flange arm 531 will move in and abut/engage with the notched cut-out portion 551 at the front end of the piston, whereby pushing the piston 519 back a predetermined distance where the pistons side walls engagement surface 548 will move away from the ball-bearings 522a. As shown in e.g. FIG. 27A to 27C for reference, a bit cylinder spring 518 may be resting on the flange/push arm 531 and the bit cylinder spring 518 may be mounted on the rear portion of the bit cylinder rod 517. The cylinder Springs 518 may force against the rear cup housing 516 with the other side of the spring forcing against flange arm 531, whereby keeping the bit cylinders rods 517 pushed out and at the same time keeping the cylinder shaft piston 519 at a predetermined distance from the front of the device.

As shown in e.g. FIG. 31D illustrates a perspective view of the rear cup housing 516, positioned at the rear of the device having a tubular like shape running parallel with the longitude axis of the cavity 515. Having a flange 617 like protrusion extending out along the length on either side of the flanks of the tubular shape, with the flanges 617 positioned away from the equatorial plane, and perpendicular north or south of the longitude axis of the tubular shape. The rear housing cup 516 having an aperture 516a within the tubular portion and extending partially into the aperture 516a is the end shaft part of the cylinder rod 517, whereby the end shaft part will reciprocate within the aperture 516a. With the rear bit cylinder rod cavity 530 of the cylindrical tube housing 514, adapted to receive the rear cup housing 516, where at the top and bottom of the cavity 515 there is a circumference like shape extending along the longitude axis of cavity that compliments the outside tubular shape and flange protrusion of the rear cup housing 516. Whereby once inserted, and because of its unique shape and tight fit it cannot fall into the centre of the cavity 515, and thereby not obstructing with the moving cylinder piston assembly.

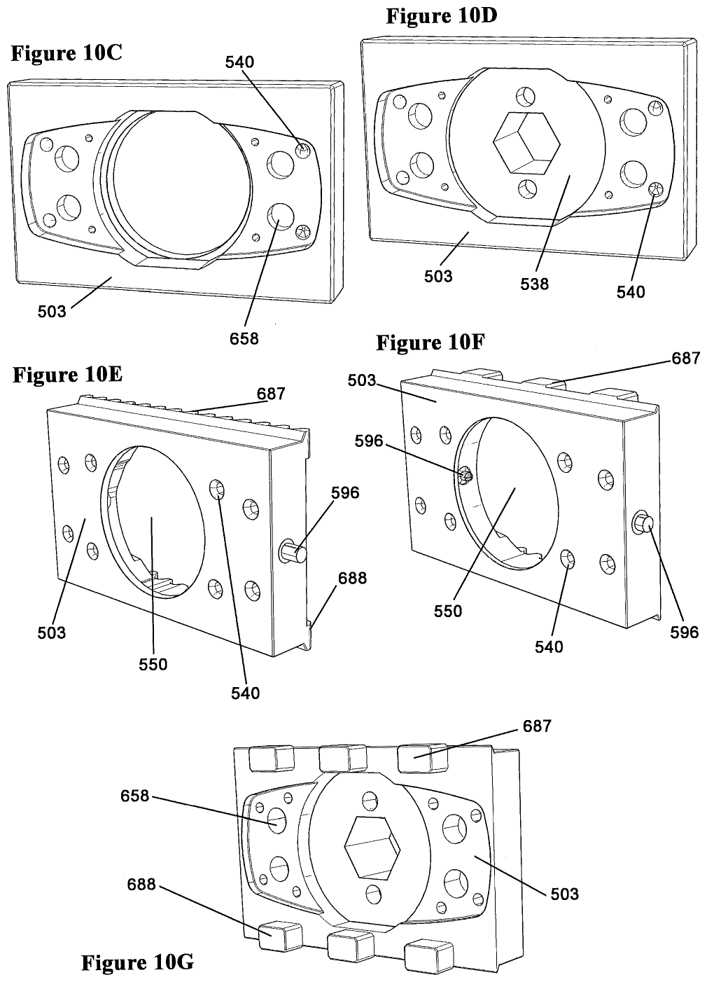

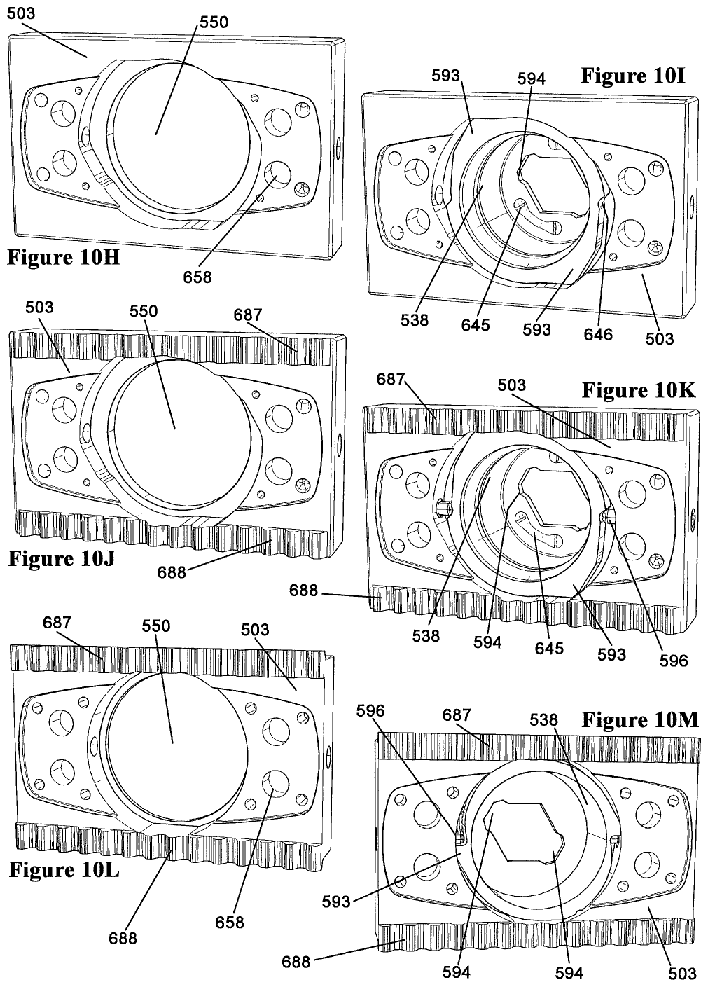

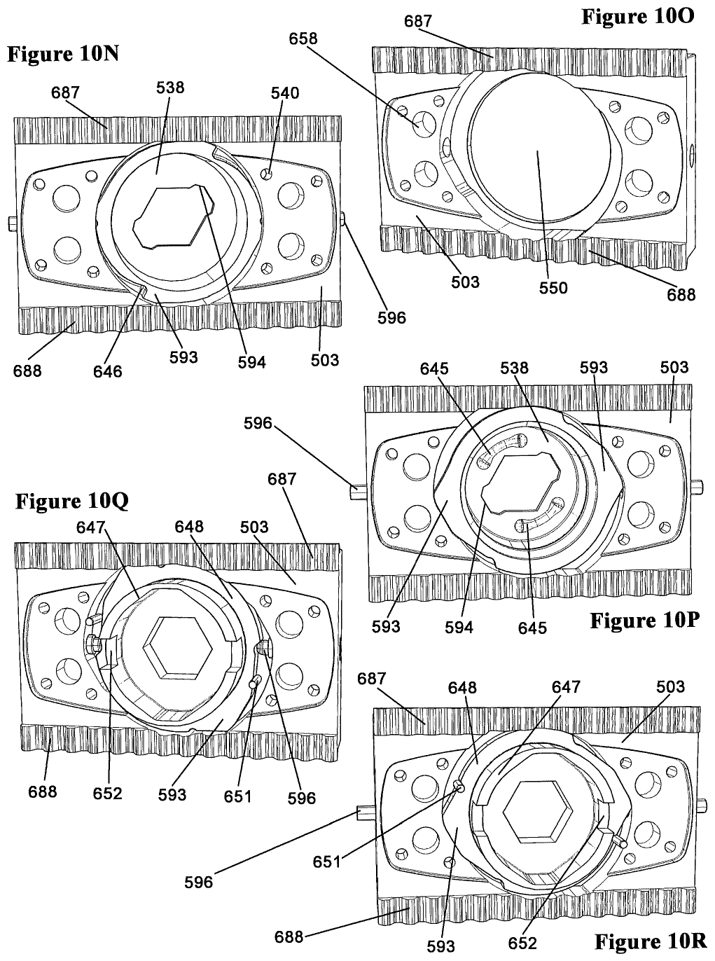

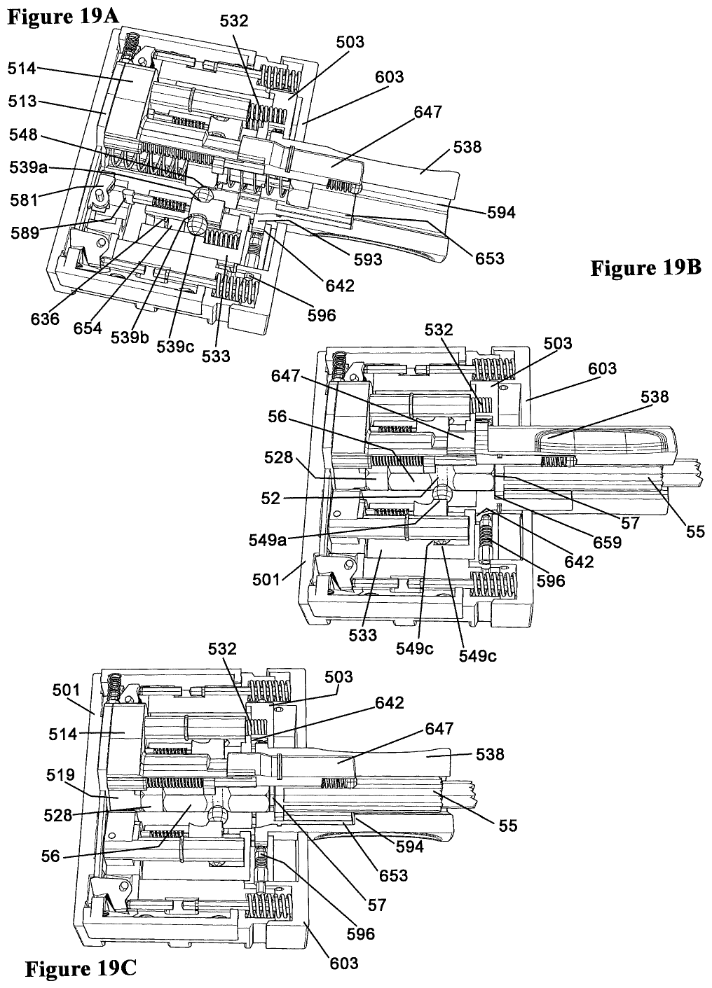

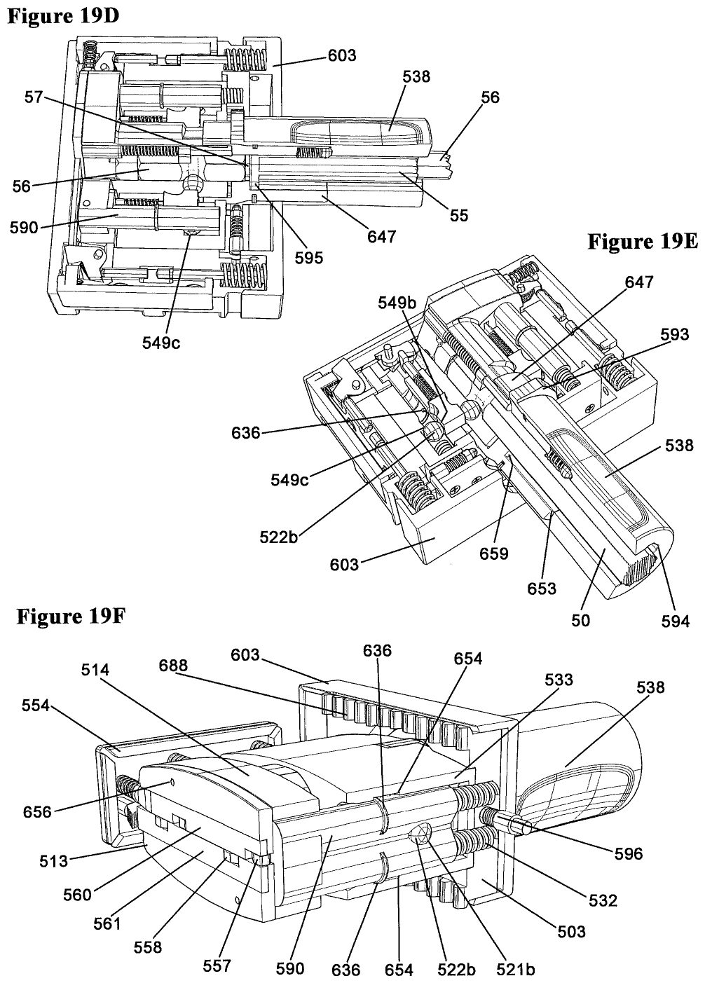

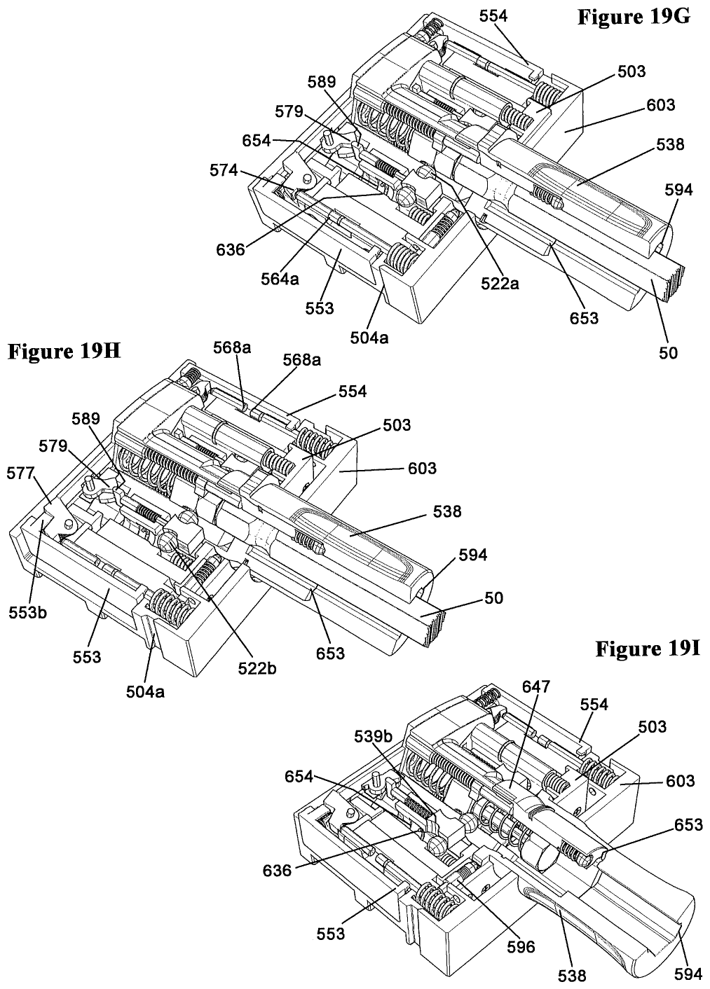

As shown e.g. illustration FIGS. 19F and 30B for reference. The sleeve housing 533 has a central cavity 535, where it slides over the front cylindrical portion of the cylindrical tube housing 514 and secured into place by a retaining C-clips 636, the front of the central cavity 535 is adapted to receive the rear portion of the rear button guide 647, where the rear button guide 647 is able to slide longitudinally backwards and forwards freely within the aperture/cavity 535. The sleeve housing 533 may have at least two further apertures 534, the apertures may be open from the rear end to the front end of the sleeve housing 533, with rear end of the housing having larger aperture openings and the front end having small openings, and equidistant from the centre axes of the central cavity 535. The rear apertures 534 adapted to receive a first and second ball release lever housing 590, where the front end of the sleeve housing may have four apertures 534. The two smaller apertures 534 are for receiving the sleeve housing springs 532, and the two bigger apertures receives the first and second ball release lever housing 590. The front end of the sleeve housing springs 532 are in engagement with the rear of the front cover 503 were, on the rear of the front cover are apertures 658 e.g. on FIG. 10H to receive the sleeve housing springs 532. Within the rear larger apertures 534 of the sleeve housing there is a retention slot 654 adapted to receive a retaining C-clip 636; on the front section of ball release lever housing 590 there is a recess to attach the retaining C-clip 636, once the ball release lever housing 590 has been received within the rear aperture/cavity 534, then the C-clip 636 snaps into the retention slot 654, whereby securing the sleeve housing, but still able to slide longitudinally backwards and forwards over the ball release lever housing 590.

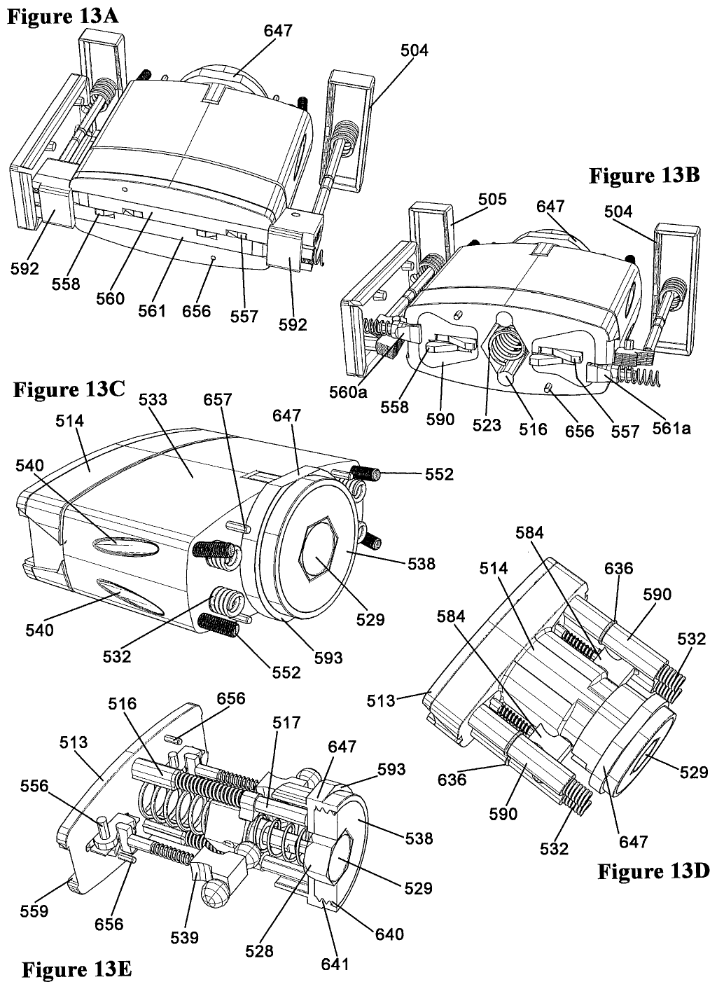

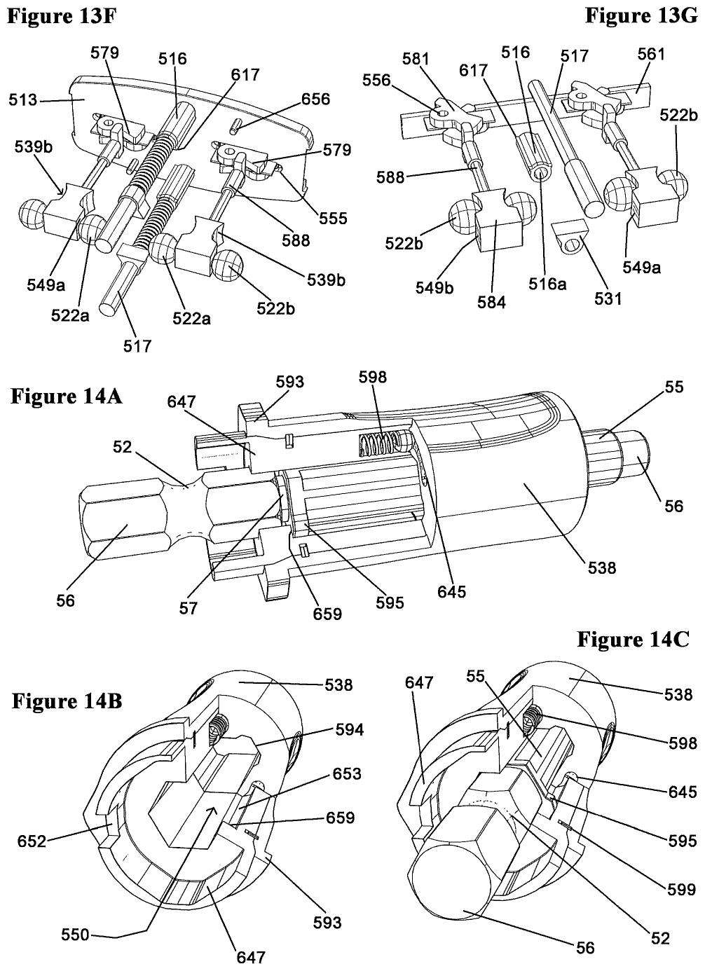

Within these illustrations are just some examples of the release block 584 documented here: FIGS. 7A to 7H, 12G to 12I, 19G to 19I The cylindrical tube housing 514 may have an outer sleeve housing 533, which may be axially moveable relative to the longitudinal axis of the cylindrical tube housing 514. The outer sleeve housing 533 may be adapted to receive within its central cavity a left ball-bearing release block and a right ball-bearing release block, wherein the cavities for the left and right ball-bearing release blocks 584 are between the central cavity/aperture 535 and the ball release lever housing cavity/apertures 534. The cavities 585 for the release blocks 584 are of a rectangular shape and positioned towards the front of the sleeve housing 533, where they extend from the central aperture/cavity 535 through to the side aperture/cavities 534, whereby creating an opening. Behind each rectangular shaped cavity 585, is a round aperture that extends longitudinally towards the rear of the sleeve housing 533, and with a small, flanged section immediately behind the rectangular shaped cavity. Where the rectangular shape cavity holds the release block 584, and the small, flanged section retains the ball release rod 588 in place, the larger round aperture is occupied by the ball release rod spring 587. With the ball release rod spring 587 forcing against the stationary flanged section and mounted over the ball release rod 588, with the other side against the rods rear flanged part 589, whereby the release block 584 connected to the rod, is retained towards the rear wall of the rectangular shaped cavity 585. The release blocks 584 may be able to move independently in the longitudinal direction within their rectangular shaped cavity 585. The space 585 may be longer and extended further forward then the release blocks 584, so to allow the ball-bearing release blocks 584 to move into. The channels or recesses 539a/539b may be exposed or open when the outer sleeve housing 533 has moved forward, away from rear portion of the cylindrical tube housing 514. The channels or recesses 539a/539b may be closed when the outer sleeve housing 533 is closer to the cylindrical tube housing 514 rear portion. With the left and right release blocks 584 each having two concave recess portions 539 and two non-recessed portions 549 adapted for receiving or retaining the first group of ball-bearings 522a and the second group of ball-bearings 522b. Whereby each release block 584 has an inner-side concave recess 539a and an inner-side non-recessed portion 549a, and each has an outer-side concave recess 539b and an outer-side non-recessed portion 549b. Whereby, inner-side meaning that the inner part is facing the central cavity aperture 535 of the sleeve housing 533, and whereby the outer-side meaning that it is facing the outer flanks longitudinal walls of the sleeve housing 533. The inner-side of the left ball-bearing release block 584 may receive a left inner ball-bearing or locking ball, of the first group of locking balls, wherein the left inner ball-bearing 522a may engage with the left release blocks inner-side concave recess 539a when the device 500 is disengaged or released; wherein the left inner ball-bearing 522a may engage with the left release blocks inner-side non-recessed 549a when the device 500 is engaged or unreleased. The inner-side of the right ball-bearing release block 584 may receive a right inner ball-bearing or locking ball, of the first group of locking balls, wherein the right inner ball-bearing 522a may engage with the right release blocks inner-side concave recess 539a when the device 500 is disengaged or released; wherein the right inner ball-bearing 522a may engage with the right release blocks inner-side non-recessed 549a when the device 500 is engaged or unreleased. The outer-side of the left ball-bearing release block 584 may receive a left outer ball-bearing or locking ball, of the second group of locking balls, wherein the left outer ball-bearing 522b may engage with the left release blocks outer-side concave recess 539b when the device 500 is disengaged or released; wherein the left outer ball-bearing 522b may engage with the left release blocks outer-side non-recessed 549b when the device 500 is engaged or unreleased. The outer-side of the right ball-bearing release block 584 may receive a right outer ball-bearing or locking ball, of the second group of locking balls, wherein the right outer ball-bearing 522b may engage with the right release blocks outer-side concave recess 539b when the device 500 is disengaged or released; wherein the right outer ball-bearing 522b may engage with the right release blocks outer-side non-recessed 549b when the device 500 is engaged or unreleased. The cylindrical tube housing 514 may have a hole/aperture 521a on either side of the cylindrical tube housing 514 to allow the ball-bearings 522a of the first group of locking balls to move into the central cavity 515 or out of the central cavity 515. The outer flanks of the sleeve housings 533, internal cavities 534 having a ball-released surface 539c and a ball-retention surface 549c adapted for receiving or retaining the second group of ball-bearings 522b. The sleeve housing 533 ball-bearing 522b engagement surface 539c/549c may receive an outer ball-bearing or locking ball, of the second group of locking balls, wherein the left outer ball-bearing 522b may engage with the left ball-released surface 539c when the device 500 is disengaged or released; wherein the left outer ball-bearing 522b may engage with the left ball-retention surface 549c when the device 500 is engaged or unreleased. Wherein the right outer ball-bearing 522b may engage with the right ball-released surface 539c when the device 500 is disengaged or released; wherein the right outer ball-bearing 522b may engage with the right ball-retention surface 549c when the device 500 is engaged or unreleased. When the ball-bearings 522b are not in the recessed cavity of the left and right outer flanks, the device 500 is disengaged or released, whereby the ball-bearings 522b are between the ball-released surface 539c, where the surface is of a convex like shape; with the convex like shape pushing the second group of locking balls within the ball release housings 590 hole/aperture 521b, and against the release blocks outer-side concave recess 539b. With the ball-bearings 522b in the outer recessed cavity; the second group of locking balls are between the release blocks outer-side non-recessed 549b portion and ball-retention surface 549c, whereby the furthest outer surface of the ball-bearing 522b is engaging with the sleeve housings cavity walls 549c, with ⅓ of the ball-bearing 522b overlapping on the ball-retention corner surface 549c at the side front corner outer flanks of the sleeve housings internal cavities 534. Where the device 500 now is in an engaged or unreleased configuration. The outer sleeve housing may have apertures 540 surrounding the cylindrical tube housing 514, wherein each of the apertures 540 of the outer sleeve housing 533 are parallel to the cylindrical tube housing 514. The apertures are each adapted to receive a dowel pin, grub screw or similar fastening device 552, wherein the fastening device 552 may connect the sleeve housing 533 with the front cover 503. Or alternatively as illustrated in FIG. 13C when it's not possible to put the fastener 552 parallel with the front cover 503 the fastener may be mounted from the apertures 540 at the side walls of the sleeve housing 533, once the sleeve housing 533 and the front cover 503 has been received within the exterior housing 501 the fastener connection is no longer accessible from the outside of the device 500.

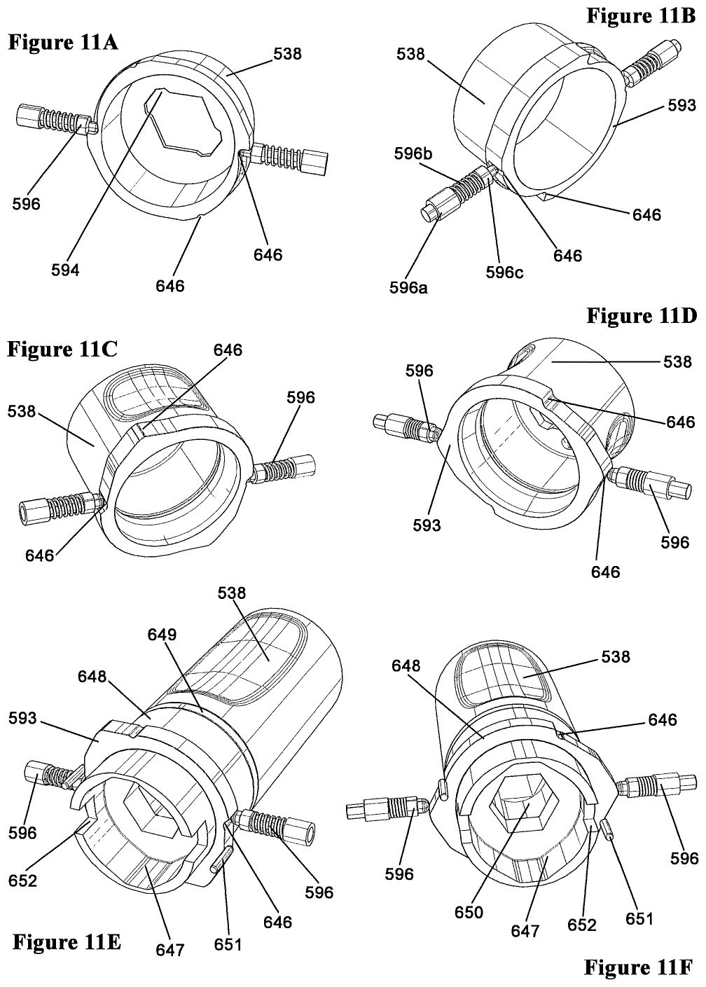

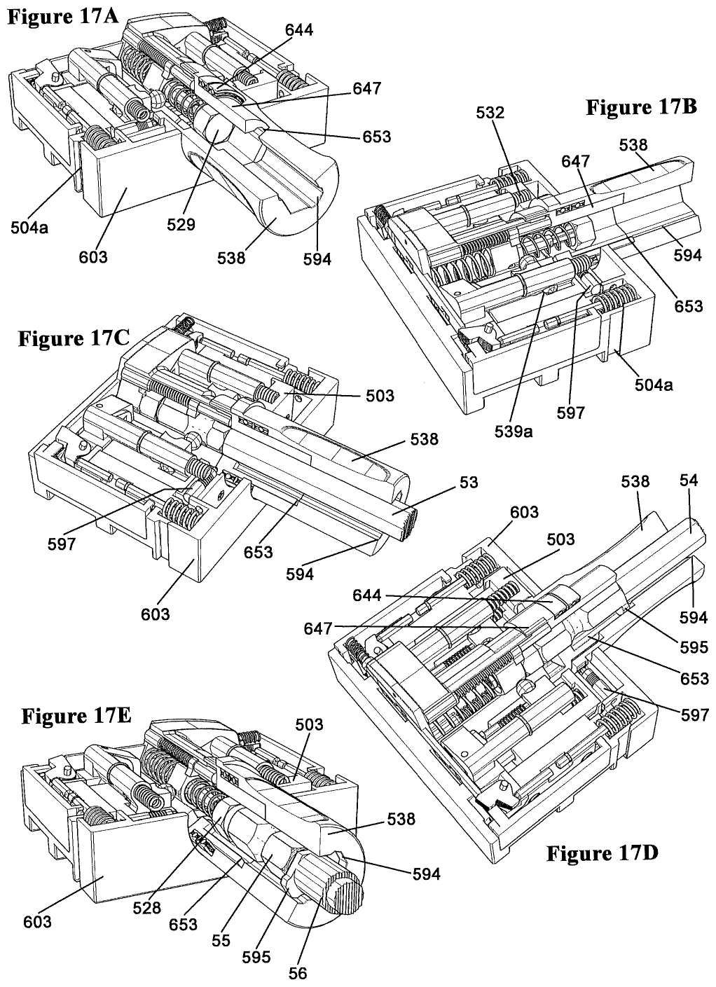

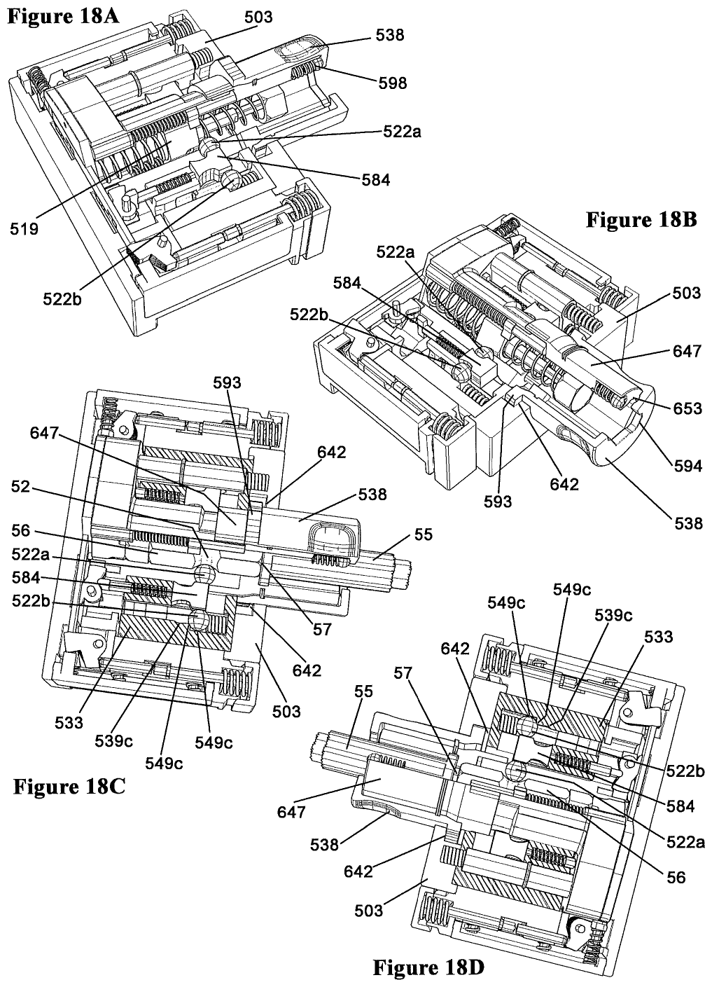

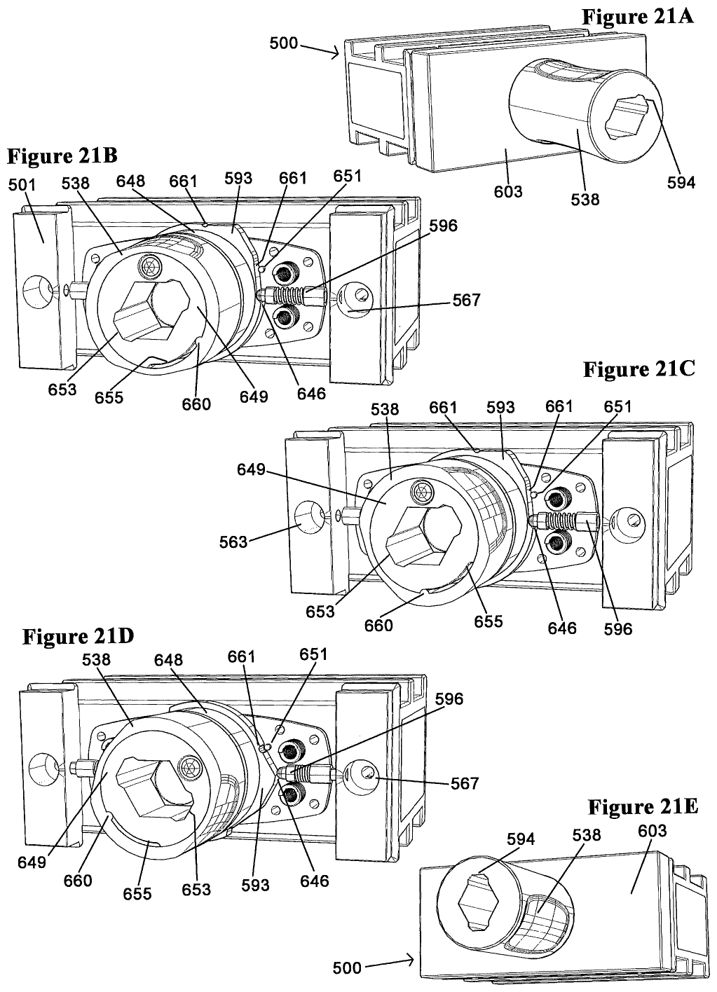

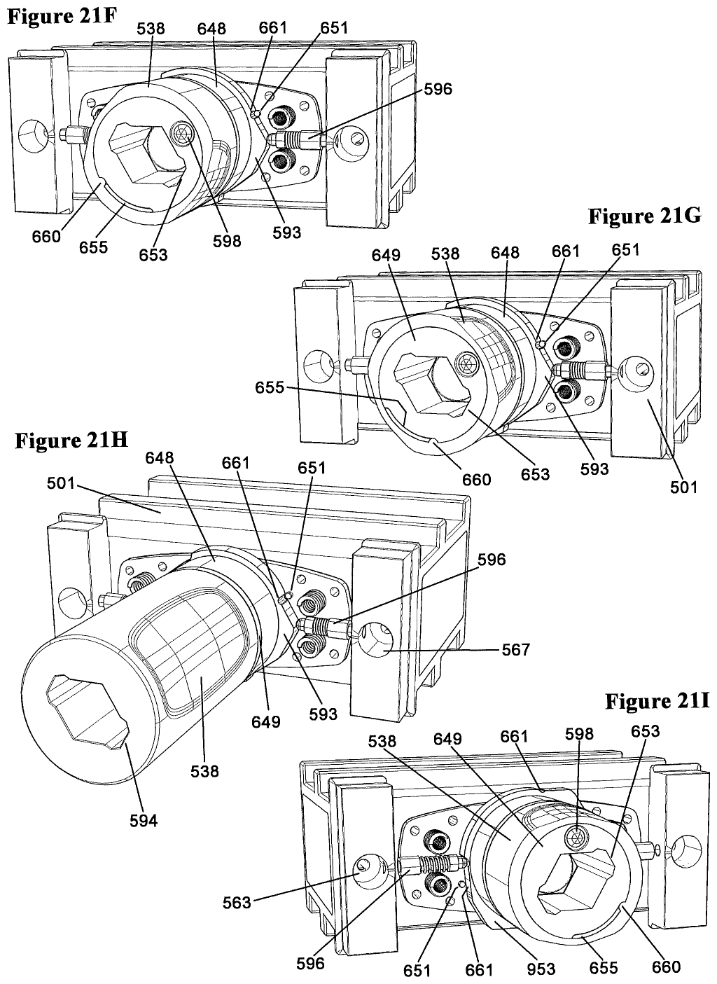

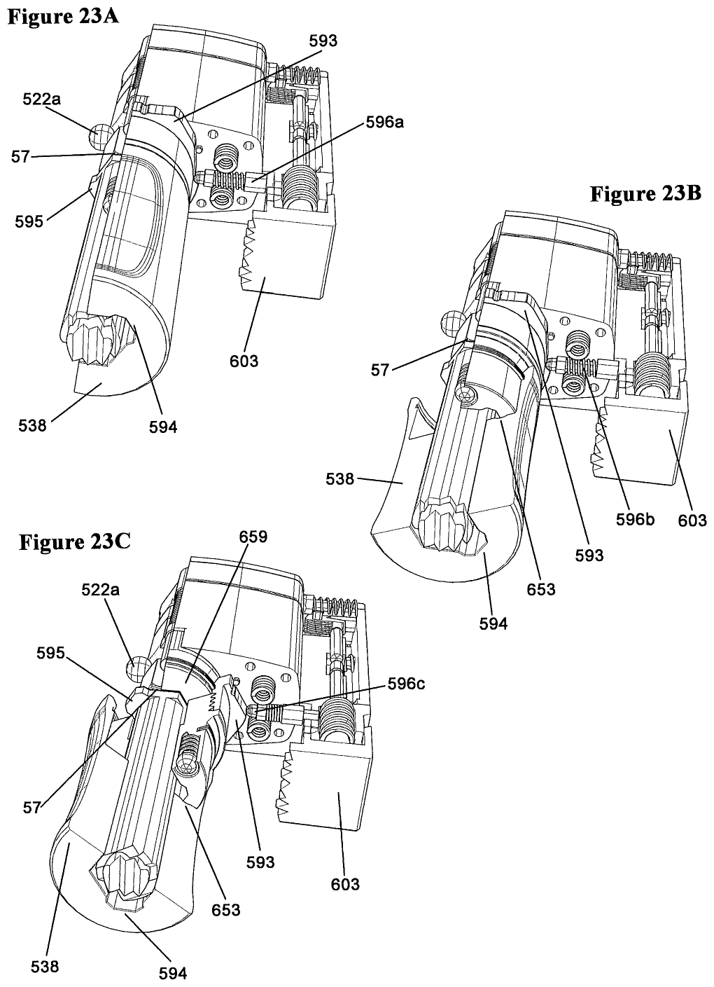

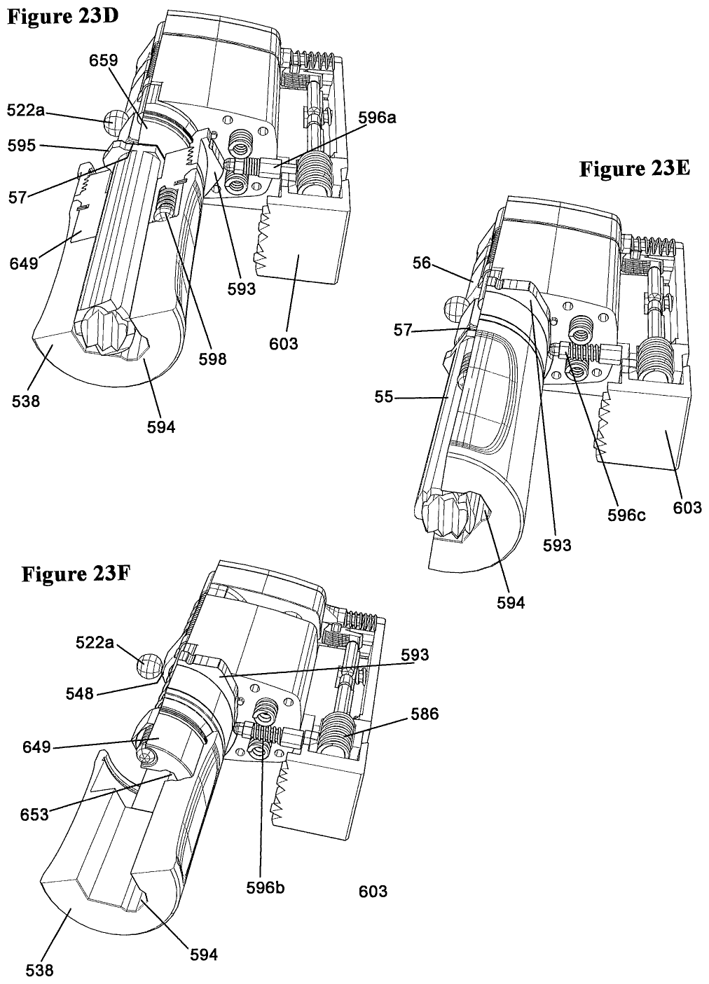

Another preferred embodiment of the device 500 is the locking rod assembly, as shown in FIG. 11A to 11F, the locking rods may be adapted with various types of button assemblies. Where the locking rod assembly 596 may be able to lock the front cover 503, whereby not allowing the front cover to move in a longitude direction from the Out position to the IN position or vice versa. The front cover 503 may comprise of a centred lateral slot, wherein the lateral slot is adapted to receive the locking rod assembly, a rod that will extend out on the lateral sides of the front cover 503 to lock the longitude movement off the front cover on the exterior housing 501. The locking rod assembly may comprise of, a tubular base with an aperture 596a, a spring 596b, and a rod 596c; the front portion of the rod shaft having a flanged portion extending away from the outer surface of the rod 596c, in which the flanged portion is engageable with the spring 596b; the other end of the spring engages with the non-moveable tubular base 596a; preceding the rods flanged portion is a pin or dome shape end; with the rod inserted within the aperture of the spring 596b and the base 596a. Now with the locking rod assembly 596 inserted within the lateral slot of the front cover 503, and the dome having a biasing means towards the centre of the front cover; whereby the base part of the locking rod assembly 596 is nested within the cavity at the outer flanks of the lateral slot. When the pins/rods 596c end portions are protruding out of the side lateral flanks of the front cover 503, the locking rod assembly is considered to be in a Locked position. When in the Locked position it is at the front flanks on the exterior housing 501, adapted for receiving the rod end portion 596c, resting on a slot when Out, or in an aperture when IN, such that when received, the end portion of the rod will lock the movement of the front cover. By preventing the longitudinal movement of the front cover 503, the release mechanism cannot be set off, as such, having the device front cover now in a Locked position. The front cover may be locked in an IN/engaged position or may be locked with the front cover moved out in the Out/disengaged position. When the end portion or the rods 596c are retracted out of the cavity or slot of the exterior housing 501 and flush with the side flanks of the front cover 503 the locking rod assembly 596 is in an Open position. Alternatively, if the tubular base 596a is capped at the outer flanks and cannot extend the rod 596b into the exterior housing it is then considered to be a tensioner assembly 597. The front button 538/638, may be rotated a predetermined distance clockwise or counterclockwise along the longitudinal axis of the cavity 515. The front button may have an aperture along the longitude length adapted to receive a rear button guide 647; with a bolt retention aperture 594 to allow passage or not for a complimentary bespoke device; the front button may have a protrusion, a lip 593 extending laterally out at the perimeter of the base, or rim, where the lip protrusion 593 may extend out greater laterally at the flanks and when rotated a predetermined distance the lip protrusion 593 may be at their narrowest laterally at the flanks. When the lip protrusions are at their greatest at the flanks the button is considered to be in a Locked position; when the lip protrusion are at their narrowest at the flanks the button is considered to be in an unlocked or Open position. The front cover may have a complementary cavity adapted to receive the rotatable lip protrusion 593 of the front button, as may be seen in FIG. 10G to FIG. 10R. Whereby rotating the front button 538/638, the lip 593 will force the dome portion of the locking rod assembly 596 laterally out, moving the rods 596c within the front cover laterally out towards the flanks to the Locked position. On the outer lateral surface of the lip protrusion 593 there may have a retention notch recess 646 or rise, where the dome of the rod 596c engages with the lip 593/646 whereby securing the front button 538/638 within a desired position. Referring to FIG. 11A, where the button and the rods are in an Open position, and FIG. 11B illustrates FIG. 11A, with the button and rod show in a Locked position, also this type of front button 538 may be used within a device such as the one in FIG. 17A. FIG. 11C, shown in an Open position, where in FIG. 11D illustrates FIG. 11C, now in a Locked position, this type of front button 538 may be used e.g. FIG. 18A and FIG. 19A. With the last two illustration showing, FIG. 11E, in the open position and FIG. 11F, in a locked position, also shown is a retention pin 651 where the retention pin is mounted within an aperture of the sleeve housing 533 and engages with the lip 593 of the button assembly; at the rear of the button guide 647 there is a clearance cavity 652, so not to obstruct the movements of the release block. This type of button assembly is of any of the illustrations from FIG. 21A to FIG. 25D.

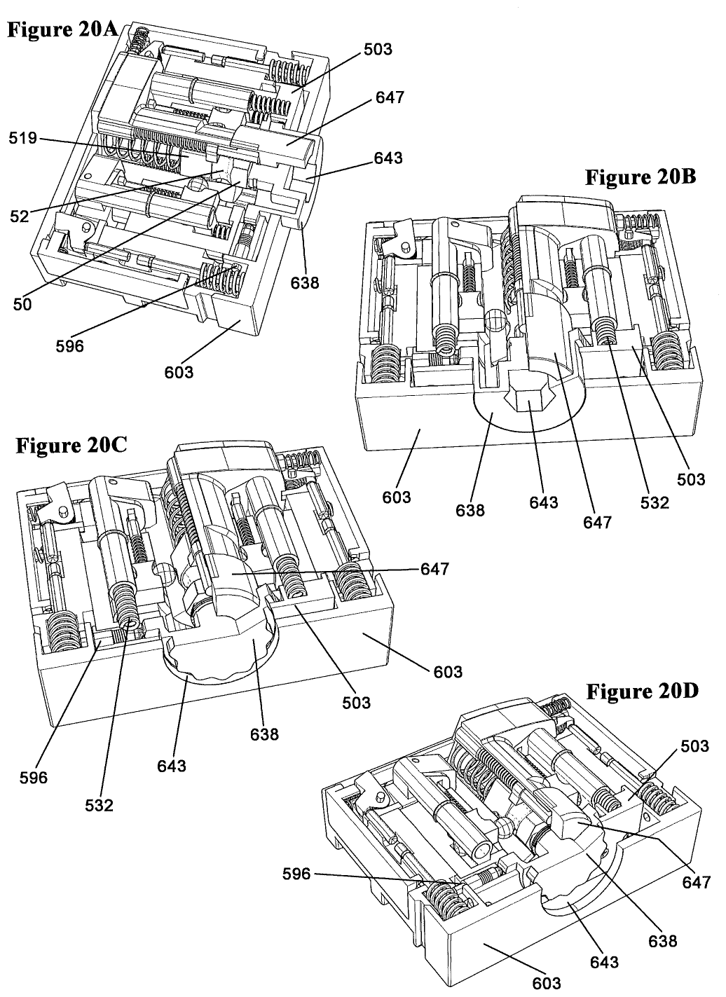

The springs for this embodiment 500 may be an elastic object in which the extended springs e.g. FIG. 19F, 20C will want to contract and return to the original spring shape or which the contracted springs e.g. FIG. 20B will want to expand and return to the original spring shape. In the return to the original spring state, for example, the contracted springs 532 may expand and provide an axial force to the sleeve housing 533 from the rear to the front, which in turn moves the sleeve housing 533 and front cover 503 to an out/disengaged position, whereby moving the sleeve housing 533 towards the device front side 502. When the front cover 503 has been returned to the IN/engaged position, the action would have compressed the springs, where then with the left and right release blocks 584 moved back IN/down, the channels 539a, concave shape would have pushed the ball-bearings 522a, back into the cavity 515, and the 539b, concave shape pushed the ball-bearings 522b, back into the outer recessed cavities 549c, so to allow the retention of the ball-bearings 522a/522b, whereby moving them laterally from a second position to the first position. Whereby the surfaces 549a and 549b, 549c, have now re-engaged the pistons 519 engagement surface 548 and the sleeve housings 533 ball-retention surfaces 549c respectively, with the springs 532 compressed, and the springs 587 extended, the retention forces retain the ball-bearings 522a/522b, in their first positions; with the sleeve housings 533 down and engaged the front cover 503 cannot be pulled up and disengaged, unless one of the Release Plates have been triggered. The first group of locking balls now in the first position and out of the second position, wherein the first position is in the cavity 515, and the second position is in a corresponding first group of locking ball recesses, wherein the left and right release blocks 584, inner-side concave recess 539a comprises the first group of locking ball recesses; and with second group of locking balls now in the first position and out of the second position, wherein the first position is in the ball-retention surface 549c on the left and right outer flanks of the sleeve housing 533, and the second position is in a corresponding second group of locking ball recesses, wherein the left and right release blocks 584, outer-side concave recess 539b comprises the second group of locking ball recesses. It may be appreciated that with the embodiment 500, the springs 532 are contracted when the front cover is engaged, whereby it is diametrically opposite to the embodiment 400 and previous, where the springs 432/332/232/132, are extended when the front cover is engaged. Both/All are an advantage.

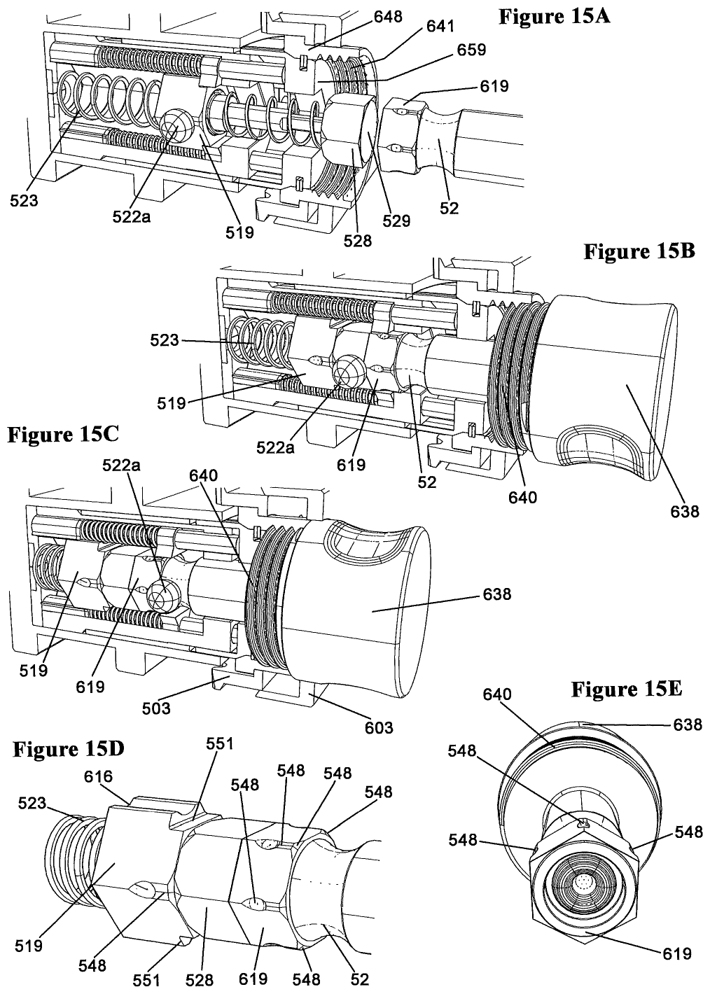

As shown e.g. FIG. 7A to 7H, the front portion of the cylinder shaft piston 519 may have a ball-bearing or locking ball engagement surface 548 for receiving the first group of locking balls. When there is no bolt 50 in the cavity 515 of the device 500, when the device is in a IN/unreleased or engaged configuration the ball-bearings engagement surface 548 maybe in front of the cylinder shaft piston 519 where ⅓ of the ball-bearing 522a maybe overlapping the cylinder shaft piston 519, whereby the engagement surface 548 is at the side front corner flanks of the cylinder shaft piston 519, and with the ball-bearings 522a furthest side from the cavity 515 is in engagement with the non-recessed portion 549a of the left and right release blocks 584, in this position the ball-bearings 522a are unable to exit the cavity 515. When the device is in an out/released or disengaged configuration, the ball-bearings engagement surface 548 maybe on the side walls of the cylinder shaft piston 519, whereby the side walls are parallel to the longitudinal axis of the cavity 515, and with the ball-bearings 522a furthest side from the cavity 515 is now engaged with the concave recess 549a of the left and right release blocks 584. For example as shown in FIG. 15D, the cylinder shaft piston 519 may also have a concave cavity 616 at its top and bottom, with the cylinder rod assembly directly above and below, and with both moving so close to each other. By having a concave cavity 616 shape on the piston, it enables them to function together without one obstructing the movement of the other within a confined space.

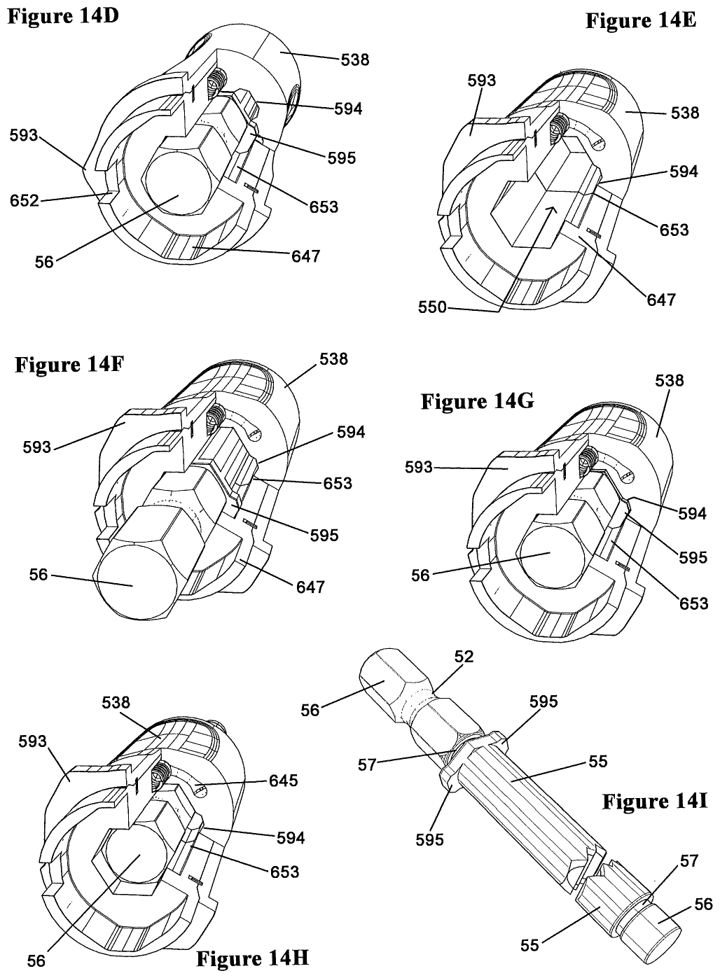

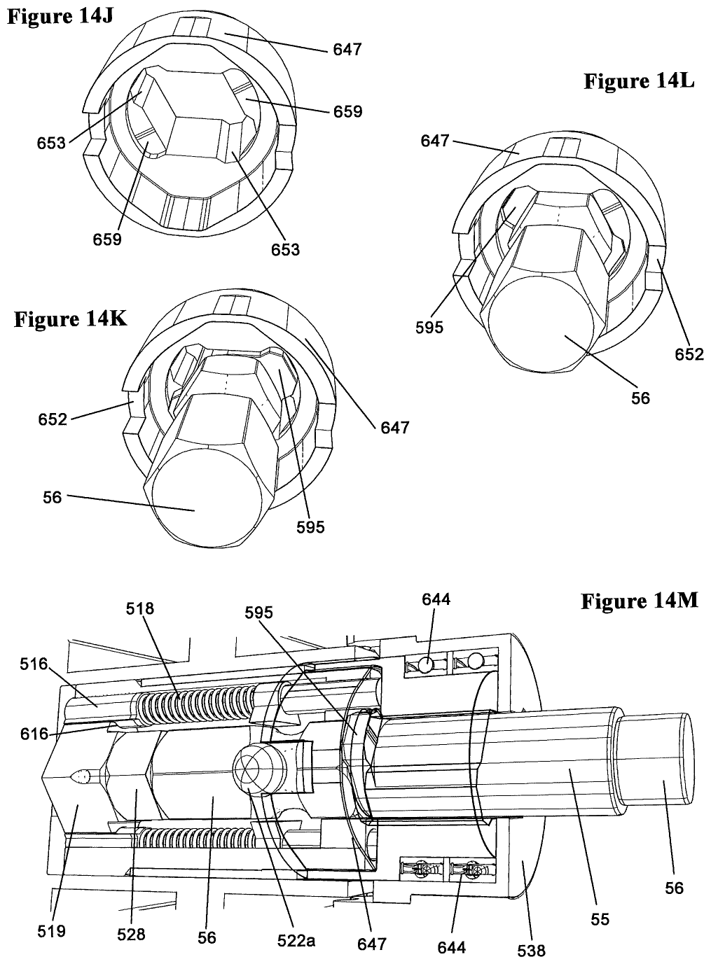

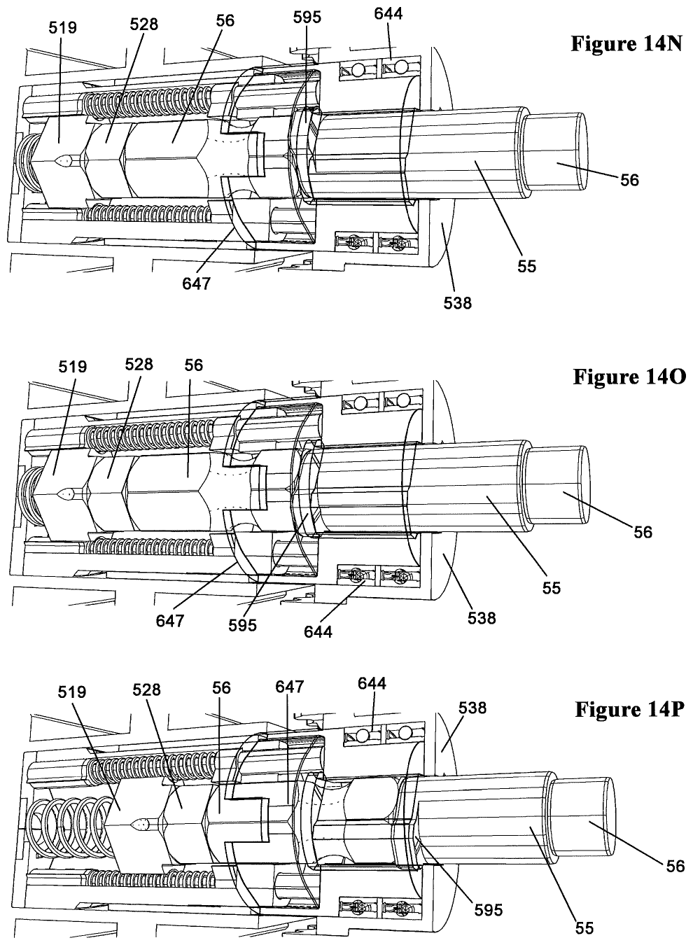

Another preferred embodiment of the device 500 is the button assembly and a First-Type bolt flange retention & receiving cavity, as shown in FIG. 14A to FIG. 14I, are some perspective and cutaway partial views. Referring to FIG. 14I, where a bespoke bolt stem 56 may have a distal portion 55, in which the distal portion has a first protruded portion 595 and a second protruded portion 595 such that the first protruded portion is diametrically opposite to the second protruded portion. As such, in the embodiment, the front button 538 may have a cross-section aperture 594 that matches the cross-section of the distal portion 55, with the protruding portions 595 for receiving this type of bolt 56/55 (as one unit) into the aperture. The protruding portions 595 extend outwardly from the longitudinal axis of the bespoke bolt distal portion 55, whereby the first and second protrusions 595 of the bolt may be retained within the button assembly when the front button 538 has been rotated such that the bolt protruding bits are not-aligned. With the front portion of the button assembly having the front button 538 the rear portion of the button assembly may have a rear button guide 647 or 649 where the rear button guide cross-section aperture 653 matches the same cross-section aperture 594 as the front button 538 when the two apertures 594, 653 are not-aligned a bespoke bolt with the protruding portions 595 cannot exit or enter the cavity of the button assembly; when the two apertures 594, 653 are aligned, the flanged bespoke bolt is able to enter or exit the cavity of the button assembly. The above-mentioned bespoke bolt, rear portion may be referred to as, a shank stem 56 or bolt stem 56, and the front distal portion 55 may be referred as a bolt swivel 55 or flanged swivel 55, the two parts 55/56 may be used apart, or may be used together as one whole unit, as a bolt 56/55. FIG. 14A, shows the back of the protrusion 595 of the swivel 55 engaging with the platform 659, wherein the button assembly has been moved down, once the bolt stem 56, concave 52 portion has engaged with the first locking balls, it then needs to move a further distances, wherein the continued force down will move the swivel 55 abut with the bolt stem 56 where it will close the gap 57, in turn the second locking balls will engage, once the button assembly has been released and moves back up, now with the platform 659 pushing the swivel 55 the distance gap 57 returns. FIG. 14B and FIG. 14C, shows with and without the bespoke bolt 56/55, where the two apertures 594, 653 are not-aligned and the flanged swivel 55 is resting on the base 659. FIG. 14D illustrates 14C, where the bolt 56/55 is moved forward where it is retained within the body of the button assembly and cannot exit. FIG. 14E and FIG. 14F, shows with and without the bolt 56/55, with the two apertures 594, 653 now aligned. In FIG. 14G and FIG. 14H, showing how the bolt 56/55 is now able to eject from the cavity of the button assembly with the apertures 594, 653 now aligned.

Another preferred embodiment of the device 500 is the Second-Type bolt flange retention & receiving cavity, as shown in FIG. 14J to FIG. 14P. Similar to the previous one mentioned this bolt retention and receiving cavity has two sections that may prevent the flanged swivel 55 from exiting the guide 647, as such, it has two Safety Mechanism so to prevent the bolt from exiting the device 500. FIG. 14J, showing the platform 659 and the exiting aperture 653, with the button guide 647 only moving backwards and forwards, the flanged swivel 55 portion of the bespoke bolt 56/55 is able to rotate along the longitudinal axis of the cavity 515. FIG. 14K showing the engaged bolt 56/55 with the protrusions 595 resting between the front of the sleeve housing 533 and the engaging platform 659 of the rear button guide 647, wherein it is not-aligned and cannot exit out. Where in FIG. 14K the flanged swivel 55, protrusions 595 have been rotated and aligned with the exiting aperture 653, wherein now it may be ejected out of the cavity 515. With the next sequence of illustrations from FIG. 14M to FIG. 14P, showing a perspective view and a cutaway of the main body of the device 500 with a wire frame depiction of the rear button guide 647 with the bespoke bolt 56/55, where it is shown being rotated and exiting the cavity 515. With the second Safety Mechanism being the front button aperture 594 aperture 653 which is the First-Type bolt flange retention & receiving cavity, as mentioned in the above statement. It may be appreciated that the front button 538 may be of any reasonably length protruding out of the front side 502; that the above two descriptions of the two different type of retention/receiving cavities, the First-Type and Second-Type, where one may be using a snap ring 599 and a forward platform 659 within the guide 647 and the other may be using a radial bearing 644 with a platform 659 at the rear within the guide 647, even though it may not Illustrated the above mentioned components may be mixed and/or switched round or vice versa.

The device 500 may have a Rear-Lever and Plank-Release-Mechanisms assembly. A first rear outer lever 570 and a second rear lever outer 571, the rear outer lever 570/571 is housed within a first/second outer rear lever housing 592. The first rear outer lever 570 may be positioned at the exterior housings left corner or a first corner 572 and the second rear outer lever 571 may be positioned at the exterior housings right corner or a second corner 573. The first and second rear outer levers 570, 571 may each have a first/second rod engaging arm 574/575 and an upper/lower plank engaging arm 577/576 wherein the rod engaging arm 574, 575 and the plank engaging arm 577, 576 is pivotable about a pivot point 578. The first/second rod engaging arm 574/575 and an upper/lower plank engaging arm 577/576 are integrally connected such that the movement of the rod engaging arm 574, 575 at a longitudinal direction effects a lateral movement in the direction of movement to the upper/lower plank engaging arm 577/576. The movement of the upper release plank 560 effects the movement of the upper plank rear engaging arms 557 of the upper first and second ball release levers 581 towards the right, and movement of the lower release plank 561 effects the movement of the lower plank rear engaging arms 558 of the lower first and second ball release levers 581 towards the left. The first and second ball release levers 581 may each have a upper/lower plank rear engaging arm 557/558 and a ball release rod flange 589, upper/lower front engaging arm 579/580 wherein the rear engaging arm 557, 558 and the front engaging arm 579, 580 is pivotable about a pivot point 556. The upper/lower rear engaging arm 557/558 and an upper/lower front engaging arm 579/580 are integrally connected such that the movement of the rear engaging arm 557/558 at a lateral direction effects the movement in a longitude direction of the front engaging arm 579/580. The upper and lower release levers 581 may have a divider 591 in between them, thereby separating them. They are housed within a first & second ball release lever housing 590, where each housing holds, an upper and a lower release lever 581, a divider 591 and two pivot pins 556. The upper and the lower release lever 581 within the housing 590 may have a scissors mechanism in which as the upper rear arm 557 and the lower rear arm 558 are moved relatively towards each other, the upper and lower lever 581 are pivoted on their pivot point 556, which then effects the movement in a longitude direction of the front engaging arms 579, 580. Whereby the levers front engaging arm 579, 580 are moved relatively towards each other, pushing against the ball release rod flange 589, whereby the connected rod 588 moves the ball-bearing release block 584 longitudinally away from the rear of cylindrical tube housing 514. The left ball-bearing release block 584 may be positioned within the central cavity of the sleeve housing 533 and the left side of the central cavity 535; and the right ball-bearing release block 584 may be positioned within the central cavity of the sleeve housing 533 and the right side of the central cavity 535. The left ball-bearing release block 584 and the right ball-bearing release block 584 may move independently relative to the sleeve housing parallel to the longitudinal axis of the central cavity 535. The left and right ball-bearing release blocks 584 may each comprise a ball-bearing recess 539a, 539b and the non-recessed portion 549a, 549b. The sleeve housing 533 may comprise a ball-bearing release block rectangular shaped space 585 for receiving the left and right ball-bearing release blocks 584. The space 585 may be longer and extended further forward then the release blocks 584, so to allow the ball-bearing release blocks 584 to move into so as to allow the ball-bearings 522a/522b to move laterally from the blocks non-recessed portion 549a/549b to the blocks recess 539a/539b concave portion. Forcing the first group of locking balls 522a and the second group of locking balls 522b to retract, moving laterally away from the central cavity 515 into the recess 539a and from the ball-retention surface 549c into the recess 539b. Once the ball-bearings 522a/522b have moved into the blocks recess 539a/539b, and have vacated the cavities 549b/549c, whereby allowing the bolt 50 to be ejected out of central cavity 515 of the cylindrical tube housing 514, forced out by the elastic expanded springs 523 and 520 and exits the aperture 550; whereby allowing the front cover to disengage, with the contracted springs 532 now expanded and having forced the sleeve housing 533 and front cover 503 to an out/released configuration.

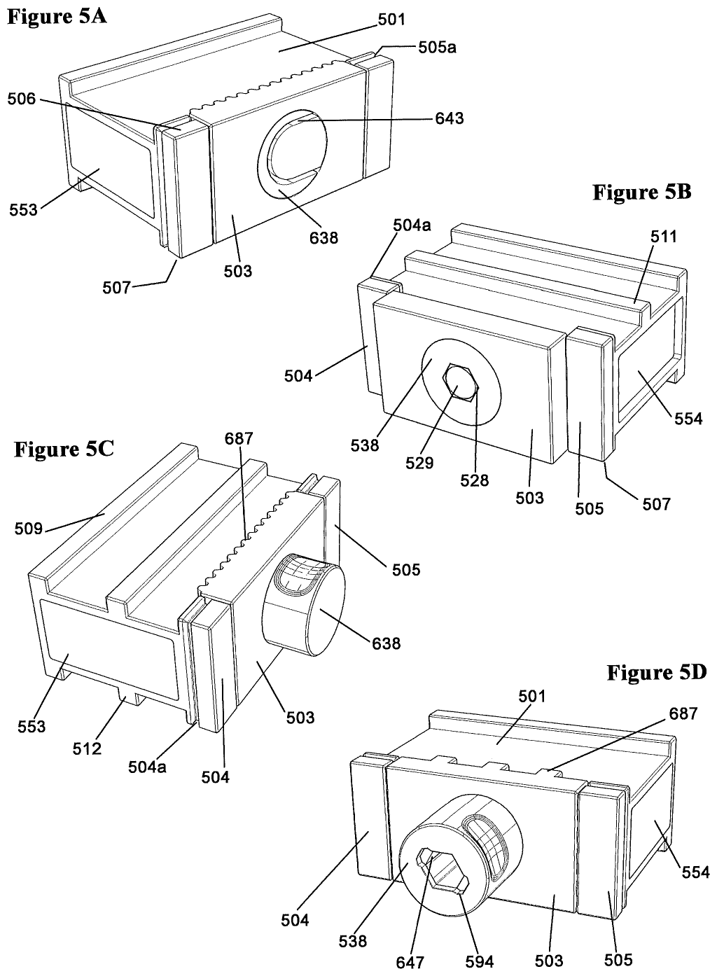

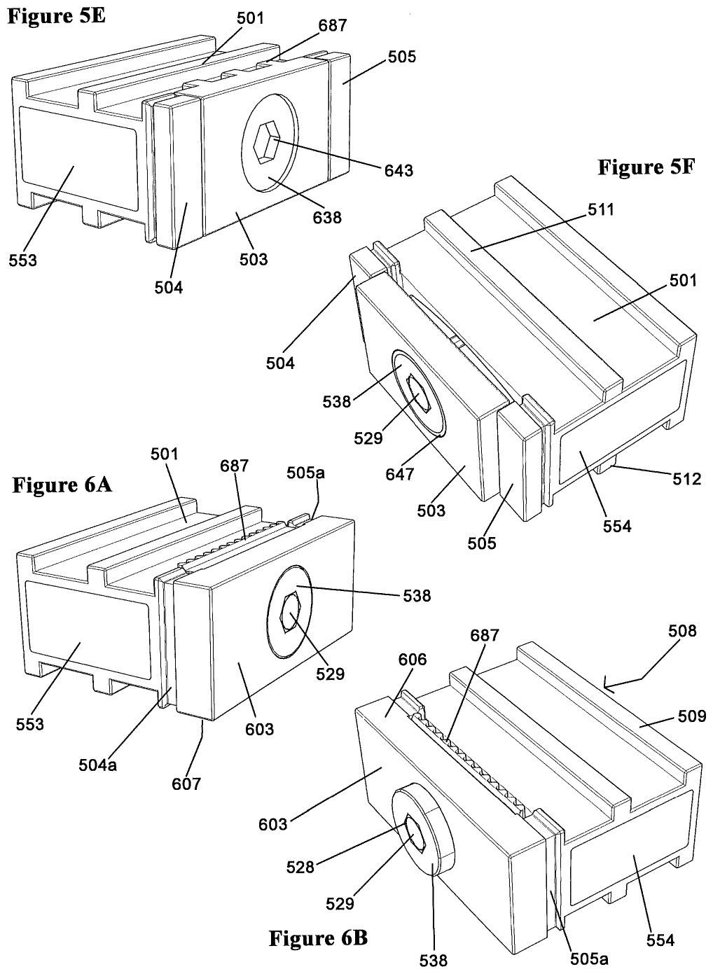

The device 500 may have a First-Top-Plate assembly and a Second-Top-Plate assembly e.g. FIG. 5A to 5F. The top release plates 504, 505 of the exterior housing 501 that flanks the front cover 503 may be moveable from the front end towards the rear end of the exterior housing 501 or moveable with respect to the longitudinal axis of the central cavity 515. Moving at least one of the top release plates 504, 505 from the front to the rear end of the exterior housing 501 may operate as a release plate for the sleeve housing 533, which in turn ejects the engaged bolt 50 out of the aperture 550 of the front cover 503; whereby also putting the sleeve housing 533 and front cover 503 in an out/released configuration. The First-Top-Plate assembly may comprise of the following components, a first plate 504, whereby the first plate may be made up of four walls extending down with an internal aperture, within the inside aperture having a cone like shape that tapers down and connects to the first plate rod 562, at the end of the rod is a cone shape that tapers to an apex. The first plate 504 covers the top left recess of the main exterior 504a, within the centre of 504a is a first top spring aperture 563, which is adapted to receiving a first top plate rod spring 586, the first plate 504 and rod 562 inserted into the spring 586 and aperture 563 then connected to a rod retaining clip 637, that holds the top release plate 504 and rod 562 within a first interior side of the exterior housing 565. Between the rod 562 and a first rear rod 564 is a small narrow gap, a rod span 564a. The cone like shape at the bottom of the first rod 562 is adapted to mate with a complementary shape of the of the first rear rod 564 and with the other end having a round dome, where the dome of the first rear rod 564 engages with the first rod engaging arm 574 of the first rear outer lever 570. The Second-Top-Plate assembly may be a minor duplication of the First, whereby it may comprise of the following components, the second plate 505 may also be made up of four walls extending down with an internal aperture, within the inside aperture having a cone like shape that tapers down and connects to a second plate rod 566, at the end of the rod is a cone shape that tapers to an apex. The second plate 505 covers the top right recess of the main exterior 505a, within the centre of 505a is a second top spring aperture 567, which is adapted to receiving a second top plate rod spring 586, the second plate 505 and rod 566 inserted into the spring 586 and aperture 567 then connected to a rod retaining clip 637, that holds the top release plate 505 and rod 566 within a second interior side of the exterior housing 569. Between the rod 566 and a second rear rod 568 is a small narrow gap, a rod span 568a. The cone like shape at the bottom of the second rod 566 is adapted to mate with the complementary shape of the of the second rear rod 568 and with the other end having a round dome, where the dome of the second rear rod 568 engages with the second rod engaging arm 575 of the second rear outer lever 571. The first plate rod 562 may be parallel to the second plate rod 566, wherein the first plate rod 562 may be positioned between the left interior side or first interior side of the exterior housing 565 and the first side of the sleeve housing 533. The second plate rod 566 may be positioned between the right interior side or second interior side of the exterior housing 569 and the second side of the sleeve housing 533.

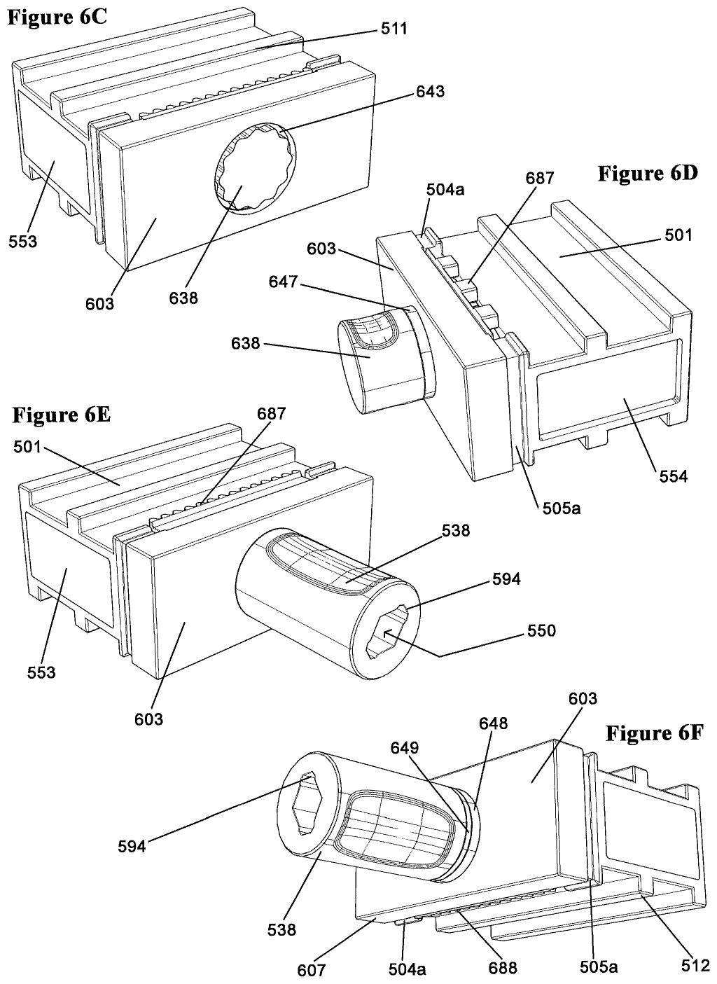

The device 500 may have an External-Top-Plate assembly e.g. FIG. 6A to 6F. This embodiment, having an external top plate 603 covering the front cover 503, in which the external cover 603 may be integrally connected to the top release plates 504, 505, such that it is one external piece, the external top plate 603. With a centre aperture facing the front 502 where the aperture is adapted to receive a front button assembly. The advantages of an external top plate 603 is that unlike the front cover 503 whereby when disengaged moves out a predetermined distance, the external top plate 603 stays the same distance from the rear of the device 508 to the front of the device 502 when in an engaged or disengaged position. With the side flanks of the plate 603 having the same internals as the top release plates 504 and 505 means that the disengaging features are the same, as suck, the same procedure may be applied to an External-Top-Plate assembly that is used on the First-Top-Plate assembly & Second-Top-Plate assembly, whereby the method previously described above may be used to disengage a device 500 configured with an External-Top-Plate assembly.

The device 500 may have a Left-Side-Plate assembly and/or a Right-Side-Plate assembly on the lateral sides. The side release plates 553, 554 of the exterior housing 501 are on the flank side walls, and parallel to the longitudinal axis of the cavity 515. By pushing the side laterally of at least one of the side release plates 553, 554 IN, effects the lateral movement in the direction of movement. Whereby it may operate as a release plate for the sleeve housing 533, which in turn ejects the engaged bolt 50 out of the aperture 550 of the front cover 503. The Left-Side-Plate assembly may comprise of the following components, a left side plate 553, whereby the back of the side plate may have, stud like protrusions 553a for retaining the left return springs 553s, also a lever pushing rod 553b, a protrusion that extends out of the back of the side plate so to engage with the upper plank engaging arm 577, also a small protrusion that retains a lower left plank arm lateral spring 582, and within the aperture of the arm spring 582 on the other side is the rod portion of the lower plank left side arm 561a, whereby the left side arm 561a engages with the left side of the lower plank 561. The Right-Side-Plate assembly may comprise of the following components, a right side plate 554, whereby the back of the side plate may have, stud like protrusions 554a for retaining the right return springs 554s, also a lever pushing rod 554b, a protrusion that extends out of the back of the side plate so to engage with the lower plank engaging arm 576, also a small protrusion that retains a upper right plank arm lateral spring 583, and within the aperture of the arm spring 583 on the other side is the rod portion of the upper plank right side arm 560a, whereby the right side arm 560a engages with the right side of the upper plank 560. The lower/upper plank side arm 561a/560a, the lower/upper plank arm spring 582/583, the first/second outer levers 570/571, and a pivot pin 578 are all combined within the first/second outer rear lever housing 592, where the whole combined assembly slides into the cavity of the exterior housings left/right rear corner 572/571 aperture. The below example demonstrates that by pressing one or both side release plates 553/554 does not affect the position or the function of the other as they are both independent. When a left/right side release plate 553/554 is pressed in, the left/right lever pushing rod 553b/554b engages with upper/lower plank engaging arm 577/576, were it then engages with the upper/lower plank 560/561, were the upper/lower plank 560/561 engages with the two upper/lower plank rear engaging arms 557/558, whereby the end of the upper/lower plank 560/561 on the opposite side of the pressed side release plate 553/554, pushes against the upper/lower plank side arm 560a/561a, were then the upper/lower plank arm spring 583/582 compressors and the upper/lower plank side arm 560a/561a engages with the right/left side release plate 554/553. Once the pressure has been taken off, on the left/right side release plate 553/554 that was pushed in, the upper/lower plank arm spring 583/582 then expands back forcing the upper/lower plank side arm 560a/561a in a lateral direction towards the left/right side release plate 553/554 that was pushed in, pushing against the upper/lower plank 560/561, whereby the upper/lower plank 560/561 returns to its normal position, the compressed ball release rod springs 587 that now have re-expanded, forcing down on the ball release rods 588, and the rods rear engagement flanges 589, where they engage and push down the upper/lower front engaging arms 579/580 and with the upper/lower plank rear engaging arms 557/558 pushed back down, the upper/lower plank engaging arm 577/576 returns back to its normal position, and the left/right side release plate 553/554 that was pressed, now returns to its released position.

One of the methods of disengaging the front cover 503, is with the device 500 adapted with a Standard Front Cover configuration. By pressing any/all of the Release Assemblies e.g. the First-Top-Plate, Second-Top-Plate, Left-Side-Plate and/or the Right-Side-Plate, where it actuates the Rear-Lever and Plank-Release-Mechanisms assembly. With the above action taken it will then actuate the front cover 503 to move away from the exterior housing 501 which also moves the sleeve housing 533 away from the cylindrical tube housing 514, which forces the ball-bearings to retract into the recess 539a and 539b, the first group of locking balls 522a move laterally away from the central cavity 515 into the recess 539a and the second group of locking balls 522b move laterally away from the ball-retention surface 549c into the recess 539b. Once the ball-bearings 522a/522b have moved into the blocks recess 539a/539b, and have vacated the cavities 549b/549c, whereby allowing the front cover to disengage. With the compressed sleeve housing springs 532 now expanded and having forced the sleeve housing 533 and front cover 503 to an out/released position; with the piston 519 moving out, and the piston 519 pushing out the preceding, expanded front portion of the piston assembly 520, 527, 528, and at the same time the expanding first spring 523 also pushing the notched cut-out 551 of the piston and the engaged flange arm 531 of the bit cylinder rod 517 out, the button assembly has now exited out as well. With the springs 532 extended, and the springs 587 as well extended, the retention forces retain the ball-bearings 522a/522b, within their second positions and the sleeve housings 533 held out to its outer most position, and retained there by the C-clip 636. The cylinder shaft piston 519 is similar or like the device 400 piston 419; with notched cut-out 551 of the piston engaging with the flange arm 531 of the bit cylinder rod 517, and with the expansion of the compressed springs 523, 518, 518, now the combined spring force exerting outward on to the end of the bit cylinder rods 517, whereby engaging and holding the button assembly out. With the buttons 538 or 647/648, lip 593 kept constantly out and abut with the back of the front covers 503 complementary button cavity, where it is adapted to receive the lip protrusion 593, as such the narrow gap 642 is now not present, with the added assistants of the housing spring 532, unitedly keeping the front cover 503 out.

Another method of disengaging the front cover 503 from a device 500 is with an External Top Plate configuration. When it is adapted with an external top plate 603 the front cover 503 is behind and not visibly. Similar to the previous embodiment the front cover 503 still reacts the same as on a standard front cover configuration but where now the first top release 504 plate and the second top release plate 505 are now incorporated within the external top plate 603. By pressing any/all of the Release Assemblies e.g. the External-Top-Plate, Left-Side-Plate and/or the Right-Side-Plate, where it actuates the Rear-Lever and Plank-Release-Mechanisms assembly, then the rest is the same as with the previous, whereby following the procedure to disengage the front cover 503 on a Standard Front Cover configuration will give the same results, whereby putting the device 500 with a 603 cover in an out/disengaged configuration.

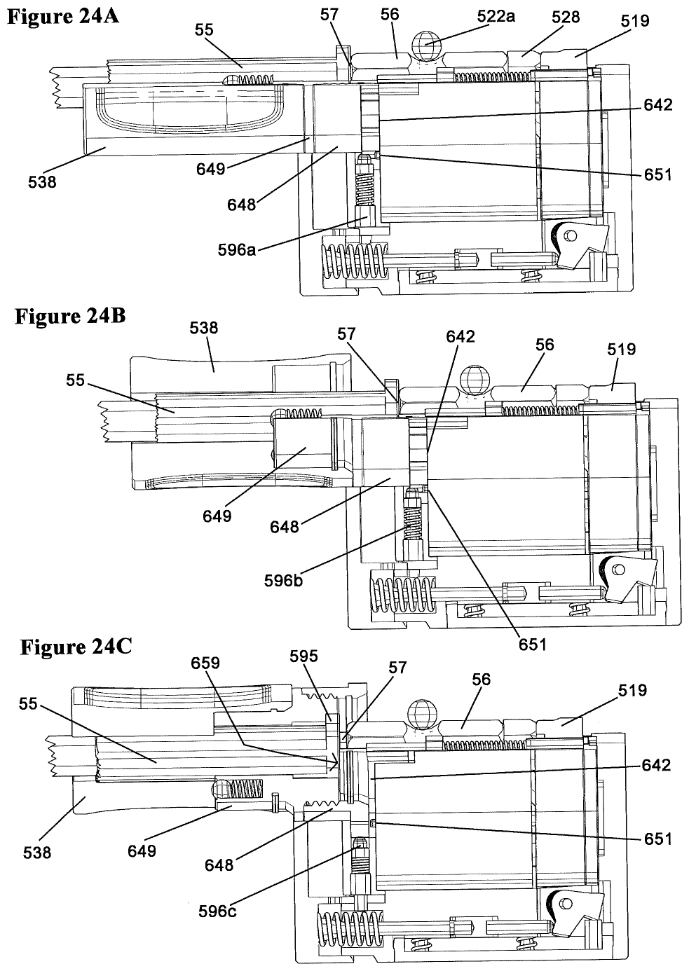

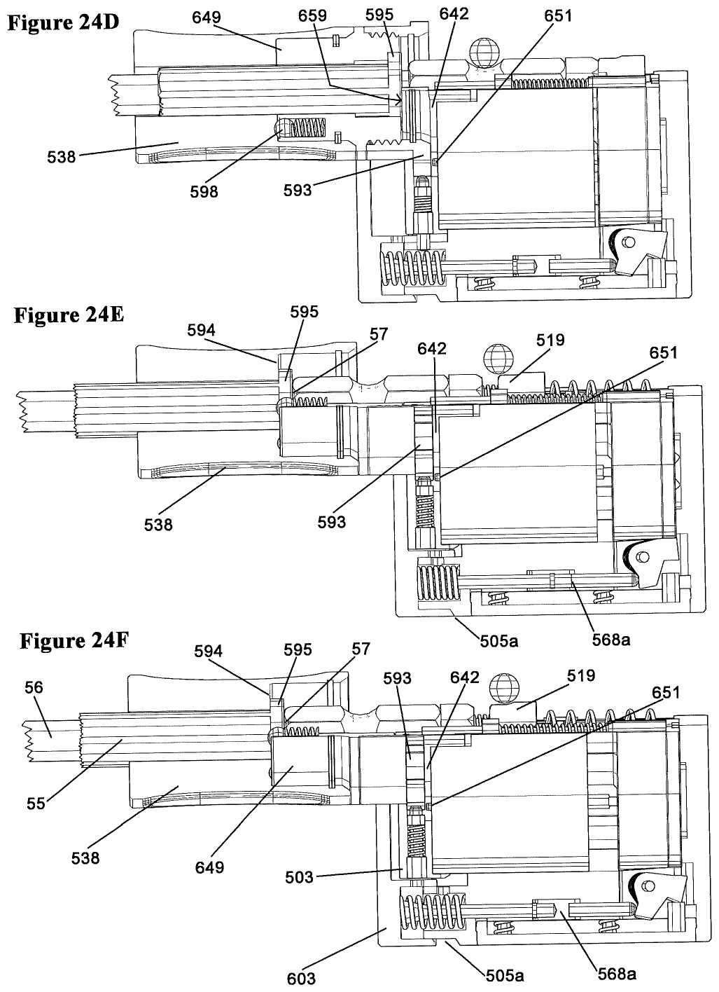

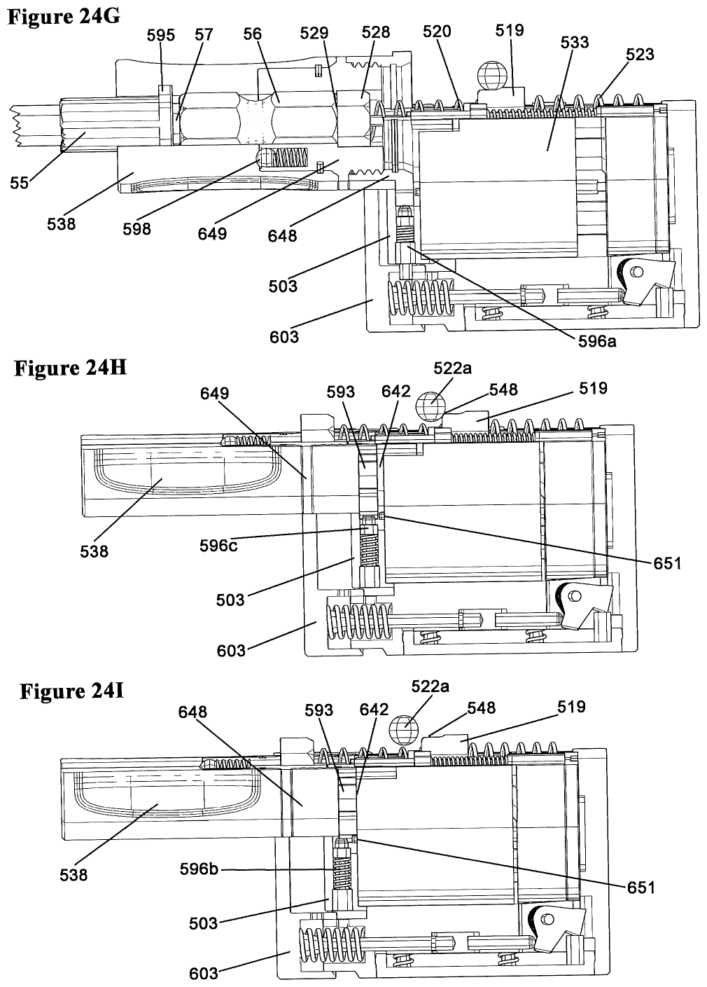

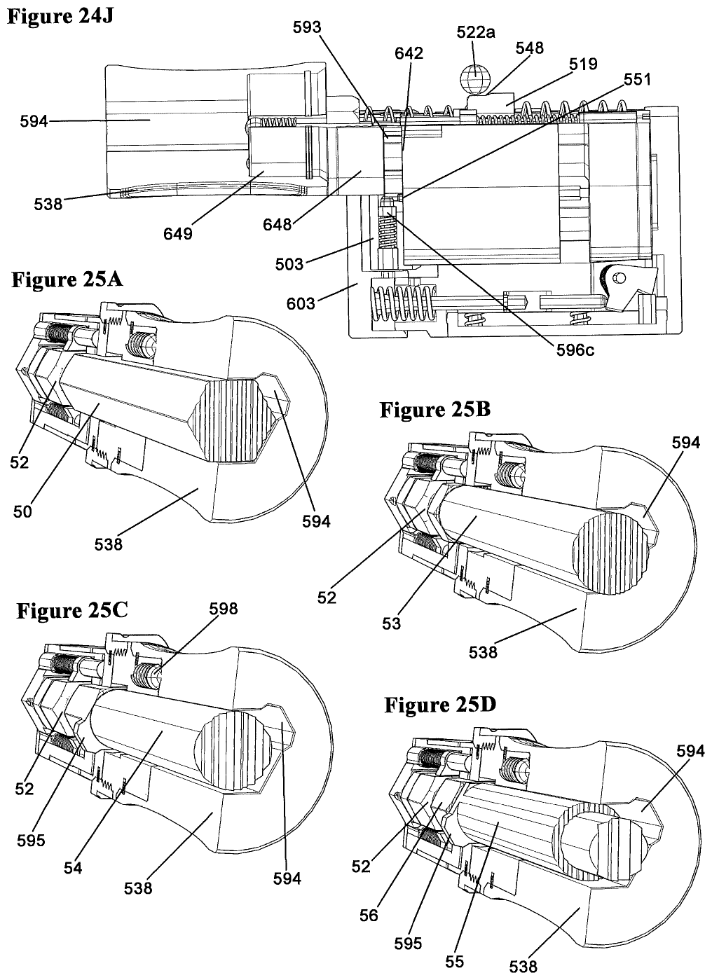

With this embodiment there are a few ways to re-engage the device 500, when it is adapted with a Standard Front Cover configuration. 1) The first method is, as Illustrated in FIG. 7B, is to push the front cover 503 down; with the cover going down towards the rear of the device 500 and where the rear of the front cover 503 reaches and abuts against the internal section of the external device 501, wherein at this time, as Illustrated in FIG. 7A, the first and second group of locking balls re-engage in their first positions, the cavity 515, and retention surface 549a, whereby locking the front cover 503 down and the device now is IN/engaged. 2) The second method is to push down on the front button 538, whereby the button assembly moves down, with the lip 593 of the button assembly moving down closes the narrow gap 642, wherein the rear of the lip protrusion 593 is butted against the front perpendicularly face of the sleeve housing 533, together they assist in pushing the connected front cover 503 down, when the front cover has reached and abuts with the external cover 501, the second group of locking balls 522b may now retract into their cavity 549c. At the same time this is happening the bit cylinder rods 517 are pushed down towards the rear of the device by the pressure exerted on the front button 538. As can be seen on example illustrations FIG. 7C and FIG. 24G to 24I even though these illustrations have a 603 top plate, the internal mechanisms are still the same; with the wall of the surface 548 engaging with the ball-bearing 522a and as the piston 519 starts to descend down, the first group of locking balls, as seen on FIG. 24H are able to return back into the cavity 515, once the front button 538 has been released and the force of the springs 523, 518 returns the button to its forward most position with the narrow gap 642 abut/behind the lip protrusion 593 and with the device IN/engaged. 3) A third methods to assist in engaging the front cover 503 is to use an external device for example, a bolt or bespoke where it may be adapted with a lip 595 or a flanged swivel 55, as can be seen in FIGS. 25C and 25D. As well, a device 500 may be engaged with a bespoke adapted with/without a concave mounting portion 52, e.g. in FIG. 14I where the bespoke may come in two parts, the rear stem shank 56 and the front bolt swivel 55. When a front button 538 that is adapted with a bolt flange cavity 594 so to receive a bespoke tool 55, 56, once inserted into the device 500 by the aperture or the cavity 550 at the front button. The flanges 595 of the bespoke device abuts/engages with an internal button assembly surface 659 as can be seen e.g. in FIGS. 12D and 12F. Once the rear of the flange 595 has engaged with the front surface 659 it precedes pushing the button assembly down. As Illustrated in the second method above, the lip protrusion 593 then engages with the front surface of the sleeve house 533 wherein now, similar to the above methods the front cover 503 is engaged; also, if a bespoke was used that had the concave portion 52, the shank as well would be engaged. With this method an external device may engage the embodiment 500 with/without the need to engage the external device. It may also be appreciated with the above mentioned methods, alternatively instead of using a front button 538 adapted with an aperture 550, a solid front button 638 type e.g. FIG. 5E, 6C, 6D, may be used to lock/engaged the device 500.

With this embodiment when the device 500 is adapted to be used with an External Top Plate configuration, there may be two ways to re-engage the front cover 503. This embodiment has an external top cover 603 whereby the front cover 503 is not directly accessible as can be seen on the examples illustrations FIG. 7C to 7H, as such to re-engage the device with a 603 top plate, is by using the front button assembly or an external device or bolt/bespoke. With the method 2) and method 3) that was described in the previous comments on how to re-engaging a device 500 adaptor with a standard front cover configuration, may be used with this embodiment with a top plate 603, as the procedure is the same to re-engage the device and put it in an IN/engaged position.

Another method of disengaging the bolt 50 from the device 500 on a Standard Front Cover configuration, may be by pressing the first or second plate 504/505 assemblies, meaning by pressing the First-Top-Plate assembly or Second-Top-Plate assembly. By pressing the first or second plate 504/505, longitudinally from the front end of the exterior housing towards the rear end of the exterior housing, when pressed, the top plate rod spring 586 in the left and right recessed portion of the exterior housing 504a, 505a within the left and right top spring aperture 563/567 will compress in, whereby the right or left plate 504/505 and the connected first/second plate rod 562/566 will move a predetermined distance 564a towards the first/second rear rod 564/568, whereby it engages with the first or second rear outer levers 570/571 flange of the levers rod engaging arm 574/575. The left or right rear outer lever 570/571 needs to pivot a predetermined distance to move longitudinally the left or right rod engaging arm 574/575 so to move laterally the left or right plank engaging arm 577/576. The length of the device 500 in a longitude direction can be of any length and not limited, and the distance that the first or second plate 504/505 may need to travel down so the connected first or second plate rod 562/566 can engage with the bottom first or second rear rod 564/568 is not limited and can be of any length. Thereby the rod span 564a/568a is determined by how far the top plate 504/505 needs to travel down and the outer levers 570/571 predetermined distance to pivot and engage the plank 560/561. Once the rear rods 564/568 dome portion has engaged with the rod engaging arm 574/575, it then actuates the Rear-Lever and Plank-Release-Mechanisms assembly. When the user or an external apparatus is no longer pressing the first or second top plate 504/505 down, the elastic springs 586 will force the top plate to return back to its original location.

A further method to disengage the bolt 50 from the device 500 on an External Top Plate configuration, as previously described above, disengaging an external top plate assembly is similar to disengaging a first top plate assembly or a second top plate assembly. Whereby pressing the external top plate 603, longitudinally from the front end of the exterior housing towards the rear end of the exterior housing, when pressed, the top plate rod spring 586 in the left and right recessed portion of the exterior housing 504a, 505a within the left and right top spring aperture 563/567 will compress in, whereby the right or left plate 504/505 and the connected first/second plate rod 562/566 will move a predetermined distance 564a towards the first/second rear rod 564/568, whereby it engages with the first or second rear outer levers 570/571 flange of the levers rod engaging arm 574/575. Once the rear rods 564/568 dome portion has engaged with the rod engaging arm 574/575, it then actuates the Rear-Lever and Plank-Release-Mechanisms assembly. When the user or an external apparatus is no longer pressing the external top plate 603 down, the elastic springs 586 will force the top plate to return back to its original location.

A further method of disengaging the bolt 50 from the device 500 may be by press the left or right side of the exterior housing release assemblies, meaning by pressing the Left-Side-Plate assembly or Right-Side-Plate assembly. Pressing one or both side release plates 553/554 laterally towards the side of the sleeve housing 533 may provide a lateral force on either one or both, side release plates 553/554 of the exterior housing 501. Once the side release plate 553/554 has travelled a predetermined distance IN, the connected left or right lever pushing rod 553b/554b engages with the upper/lower plank engaging arm 577/576 whereby it then actuates the Rear-Lever and Plank-Release-Mechanisms assembly. The return of the Side-Plate to its out position, at the back of each side release plate 553/554 are stud like protrusions 553a/554a where they engage with the return springs 553s/554s for the side release plate 553/554 the other side of the return springs are within an aperture on the outer lateral side-walls of the exterior housings 501 within a first/second interior side 565/569, where the side-wall may be parallel with the longitude axis of cavity 515, and with the return springs 553s/554s apertures may be perpendicular to the side-wall. When a side release plate 553/554 has been pushed IN, and when released the return springs 553s/554s assist in pushing the side plate back to its normal resting position.

For locking a standard bolt or a shaft 50, in a device 500 with a Standard Front Cover configuration. The bolt or shaft 50 is suitably sized with at least one concave mounting portion 52 for receiving the first group of locking balls or ball-bearings 522a. With the device in a disengaged, and Out position, the bolt or shaft 50 may be inserted into the device 500 via the aperture or cavity 550 at the front. At the same time, a user can start pushing down on the front cover 503, or use an external force to push down on the front cover 503, with the bolt or shaft 50 engaging with the platform 529 wherein it starts to go back in towards the rear of the device; the bit shank ram cup 528 and the combined piston assembly 520, 527, 519, 523, starts to go back down towards the rear of the cylindrical tube housing 514. With the piston 519 moving in, the first spring 523 is compressed, the pistons side front corners of the engagement surface 548 disengages with the ball-bearings 522a. Because the side walls of the bolt or shaft 50 occupy the cavity 515 the ball-bearings 522a cannot yet return back to the first position within the cavity 515. By continuing to push down on the front cover 503, will also assist in locking the bolt 50 within the concave portions 52 of the bolt. With the bolts concave portion 52 now reaching, and in line laterally with the ball-bearings 522a, the concave recess 539a starts to open, where they then fall into the cavity of the concave portion 52 of the bolt; with the first group of locking balls now in the first position. At the same time, the concave recess 539b as well starts to open, the front cover 503 now engaged; with the second group of locking balls also in their first position. With the bolt 50 and the device 500 in an IN/engaged configuration now. Alternatively, instead of pushing down on the front cover 503 a user or external device may push down on the front button 538 or button assembly to achieve the same results, engage device.

For locking a bespoke bolt e.g. 54, 56, 55, or an external apparatus in a device 500 with an External Top Plate configuration. A bolt or bespoke with a shaft 50 that is suitably sized with at least one concave mounting portion 52 for receiving the first group of locking balls or ball-bearings 522a; where it may be adapted with a lip/flange 595 e.g. in FIG. 14I so it may be received into a button assembly adapted with a bolt flange cavity 594 aperture, some example Illustrations can be seen in FIGS. 6E, 25C and 25D. When a front button 538 with a bolt flange cavity 594 has received a bespoke bolt, such as 55, 56 (as one unit), once inserted into the cavity 550/594 at the front. The flanges 595 of the bespoke device engages with an internal button assembly surface 659, as can be seen e.g. in FIGS. 12D and 12F. While pushing the bolt down the rear surface of the flanges 595 engage with the front surface 659 it then pushes the button assembly down. With the lip protrusion 593 then engaging with the outer front surface of the sleeve house 533, now the internal front cover 503 and the sleeve house 533 together descending, as the concave mounting portion 52 reaching the engagement surfaces, the ball-bearing 522a, 522b retract into the first group and second group cavities 515, 549c, whereby locking/engaging the front cover 503 and the bespoke bolt. The button assembly returns back up to its resting position, where its then held there by the two bit cylinder springs 518. For locking a standard bolt 50 in a device 500 with an External Top Plate configuration, while pressing down on the bolt 50 and pressing down on the front button 538, thereby triggers the release mechanism such that the bolt 50 and front cover 503 will then engage in the device 500.

Different Kind of Buttons Assemblies

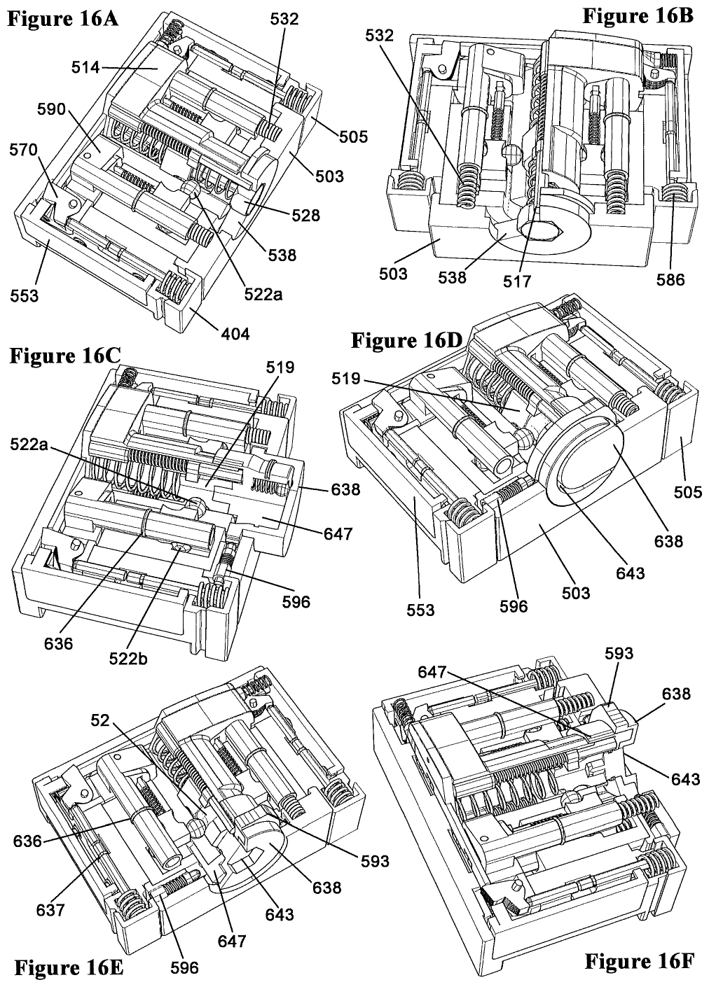

In another preferred embodiment, as shown in FIG. 16A to FIG. 16F, are of a Standard Front Cover configuration type. FIG. 16A shows the device 500 in an engaged position with a non-rotating front button 538 where FIG. 16B, the device is now in an disengaged position wherein both Side-Plate assemblies have been pressed in and pushing the locking balls in their second position and the sleeve housing springs 532 extended. FIG. 16C to FIG. 16F, are of a rotatable type front button 638 with the front cover 503 having a central lateral slot to receive a pin, a locking rod assembly. Referring to FIG. 16C, having a solid front button 638; with the front covers locking rod assembly 596 is in a locked position and cannot move longitudinally, wherein the end pins at the flanks are protruding into an aperture of the exterior housing 501. Similar to FIG. 16D, but where the rod assembly 596 is in an open position and the front button 638 having a uniquely shaped tool placement cavity 643 such to receive a matching bespoke tool. FIG. 16F showing the device in a disengaged position with the solid front button 638 rotated so the lip protrusion 593 and the retention notch recess 646 are at the narrowest whereby putting the locking rod assembly 596 in an open position, and as can be seen the rear of the button 638 inserted into the adapted piston 519. With FIG. 16E illustrating FIG. 16F, showing how the front cover 503 has been pushed down using a pushing force on the solid button 638 whereby the button assembly, working together with the piston 519 returns back down; as can be seen the lip protrusion 593 engages with the sleeve face 533 where the device now has been put in an engaged position, wherein the button assembly will return backup and flush with the front cover 503.

In another preferred embodiment, as shown in FIG. 16D to FIG. 16F, and in FIG. 20A to FIG. 20D, the front button 638 may have a cavity 643 instead of an aperture in which the cavity may be adapted to receive an Allen key or another bolt of the same cross-section profile shape as the aperture. With these type of device 500 embodiments show a solid front button 638 where the rear of the buttons centre section protrudes out and slots into an aperture within the front of the piston 519 as such, integrally joining them together whereby allowing the piston 519 and the button assembly to move as one backwards and forwards within an engaged/disengaged position, but still allow the button assembly to rotate within the pistons aperture. The advantage with this type of device 500 where the front of the device 502 may stay flush and not protruded out, where the solid front button 638 may only be accessible, or rotatable with a bespoke tool having the same bespoke cross-sectional cavity 643. Referring to FIG. 16D to FIG. 16F, where the front cover 503, once engaged and the locking rod assembly 596 in a locked position whereby preventing the longitudinal movement of the top plates 504/505, the release mechanism cannot be set off via the top plates 504/505. Referring to FIG. 20A, with the locking rod 596a locked in, where it passes through an aperture hole at the flanks within the rear of the external top plate 603 and then extending out and above the front face of the external housings sides 504a and 505a, the device is in a disengaged and locked position, whereby preventing the movement of the top plate 603. With FIG. 20C, similar to FIG. 20A where it is as well disengaged and locked, but where the solid button 638 and the cavity 643 are not protruding out but flush with external top plate 603, in FIG. 20D, with the rods 596 locked, the front cover 503 IN, and engaged the front button has moved in, away from the external top plate 603.

With another preferred embodiment, as shown in FIG. 17A to FIG. 17E, is of an External Top Plate configuration type. The front button 538 may be protruding out of the external top plate 603. The protruded portion may have a textured surface for gripping, such that a user can easily turn the front button 538 clockwise or counterclockwise. The tensioner 597 is similar to the previous embodiment where it has a locking rod assembly within the lateral cavity of the front cover 503, where this embodiment uses a tensioner assembly 597, the tensioner does not have the end pin protruding out at the flanks, as such, is not able to lock the front cover 503. The advantages of having a tensioner 597, preferably within the front cover 503 is that it may be used to prevent the front button 538/638 from moving from its allocated desired position accidentally; when there is a limited space and a ball plunger 598 is not able to be placed within the button assembly as in FIG. 12C, it is an advantage of using the tensioner 597 which is incorporated within the front cover 503. On this preferred embodiment, there is a radial bearing 644 positioned between the rear button guide 647 and the front button 538. The radial bearing 644 is to allow the front button to rotate freely against the internally fixed rear button guide. The hole or aperture of the button assembly may be adapted to receive a bolt 50 as well as a bespoke bolt which has the flange protrusions 595. FIG. 17A shows the front cover 503 engaged and the button assembly in a locked position, whereby the apertures 594, 653 are not-aligned and, as such is not able to receive a flanged bespoke bolt, but it can receive standard hex bit such as a bolt 50 within the cavity 515. FIG. 17B, where now the buttons assembly apertures 594, 653 are now aligned and may receive a flanged bespoke bolt or bolt 50. FIG. 17C shows the device with a standard hex bit or bolt 53, if the front shank round portion is not obstructing, the button assembly may still be able to be rotated. FIG. 17D, where the front cover 503 is disengaged and out, with the front button 538 in a locked position, with a bespoke bolt, or bolt 54, similar to the previous in FIG. 17C but where it now has protruding flanges 595, as such cannot exit the device. With the rear portion of the bolt 54 hexagonal section, within the body of the button assembly, the button assembly may still be rotated, thereby able to be put in an open position, wherein then the bolt 54 can exit. FIG. 17E showing the device with a bespoke bolt 56/55 exiting the front aperture 594. With this type of bespoke bolt when the bolts concave portion 52 is engaged with the ball-bearings 522a in the first position; because the bolts front section, the bolt swivel 55, with the protruding flanges 595, may still rotated, as such the front button assembly may be rotated and placed in an open or locked position. The standard hex bit or bolt may refer to a bolt without the flange or protrusions and the flanged hex bit or bolt or bespoke bolt may refer to a bolt with the flange or protrusions. A standard hex bit or bolt 50 may be engaged or disengaged within this type of embodiment, when the button assembly is in an open and/or locked position.

In another preferred embodiment, as shown in FIG. 18A to FIG. 18D, is of a Standard Front Cover configuration type. The front button 538 may be rotatable and may have an extended portion away from the front cover 503, in which the extended portion may have a textured surface for a user to grip and turn the front button 538. Within the rotatable button assembly, may incorporate a rear button guide 647 where it is movable in a longitude direction, where the rear portion of the button guide 647 slides over the cylindrical tube housing 514, the front portion houses the ball plunger 598, where the ball of the plunger engages with the rear inside portion of the front button 538, where a button recess guide 645 to receive the ball of the ball plunger 598, with the pressure exerted from the spring pushing the ball out towards the rear of the button keeps the button 538 in an allocated desired position similar to the tensioner 597. This embodiment may use a snap ring 599 within the button assembly. The advantage of using a snap ring 599 opposed to using a radial bearing 643 as in FIG. 17A, is by using less space it then allows more features to be incorporated in a limited area of the device. As with the previous embodiment, this embodiments button assembly may have a hole or aperture to receive a bolt 50 as well as a bespoke bolt which has the flange protrusions 595. Referring to FIGS. 18A and 18B, depending on the alignment, rotation position of the front button 538 the cross-section of the apertures 594, 653 may either be aligned or not-aligned, as such the rotation of the front button 538 may allow the bespoke bolt with the first and second protruded portions 595 to be retained within the front button 538 or ejection out when the cross-section of the apertures 594, 653 are the same as the cross-section of the bespoke bolt with the protruded portions 595. FIG. 18C showing how the protrusion 595 of the bolt swivel 55 has been pushed down towards the rear where the back of the protrusion 595 engaging with the platform 659 of the button guide 647 and at the same time the protrusion 595 engaging with the front surface 57 of the shank stem 56. This action pushes the button assembly down and engages the device. FIG. 18D illustrates 18C, Where the bit cylinder springs 518 pushing the bit cylinder rods 517 against the rear button guide 647 has pushed the bolt swivel 55 backup, as can be seen by the narrow gap 57; at the same time returns the front button to the normal resting position.

With another preferred embodiment, as shown in FIG. 19A to FIG. 19I, is of an External Top Plate configuration type. With this embodiment having some similarities with the previous few embodiment of the device 500. Besides sharing the same internal release mechanisms the main advantages with this device 500, for example, are, having a locking rod assembly 596 within the cavity of the front cover 503; having an external top plate 603, whereby the device may be locked while in an engaged position and as well locked while in a disengaged position; having a rotatable front button 538, using a snap ring 599; with a ball plunger 598, and with the assistance of the locking rods 596 helping in keeping the button assembly tensioned in the desired position; having a bespoke flange retention and receiving cavity 594 where the cross-section aperture 594, 653 may retain the bespoke bolt within the cavity of the button assembly and not allow it to shoot out; having a safety mechanism. Referring to FIG. 19A, where the device is disengaged with the front cover 503 out, and the locking rod assembly 596 in a locked position, and the button assembly cross-section aperture 594, 653 is not-aligned. FIG. 19B, now with the locking rod assembly 596 in an open position, and the cross-section aperture 594, 653 aligned, the bespoke bolt has been inserted into the device, and the button assembly pushed down so to engage the bespoke bolt. FIG. 19C, with the front cover 503 now engaged and down the locking rod assembly 596 in a locked position and with the front button assembly cross-section aperture 594, 653 now not-aligned. The front button assembly may have a cavity with a first internal cross-sectional shape for receiving the flanged bolt, and a second internal cross-sectional shape for retaining the flanged bolt; wherein the rotation of the front button changes between the first internal cross-sectional shape and the second internal cross-sectional shape. FIG. 19D, with the front cover 503 still engaged and down now with the locking rod assembly 596 in an open position, wherein the button assembly cross-section aperture 594, 653 once again is aligned, and the bespoke bolt is able to exit the cavity 515. FIG. 19E, showing a standard hex bit, or bolt 50 engaged within the device, and with the body of the bolt being all equal along its hexagonal longitudinal length, as such, the front button 538 cannot be rotated. FIG. 19G, with the hex bit, or bolt 50 exiting the cavity 515, wherein the external top plate 603 was pressed down to disengage the device, showing the plates sides making contact with the bottom of the recess 504a, 505a. FIG. 19H, similar to FIG. 19G, but where now showing that the side plates 553, 554 were pressed in, so to disengage the device. FIG. 19I, similar to FIG. 19A, where the locking rod assembly 596 is in a locked position and the button assembly cross-section aperture 594, 653 is not-aligned, but with the front cover 503 now, down and engaged. It may be appreciated that this embodiment may have an advantage over a previous mentioned embodiment, and where the one mentioned in, for example, FIGS. 21A to 25D may have an advantage over this one.

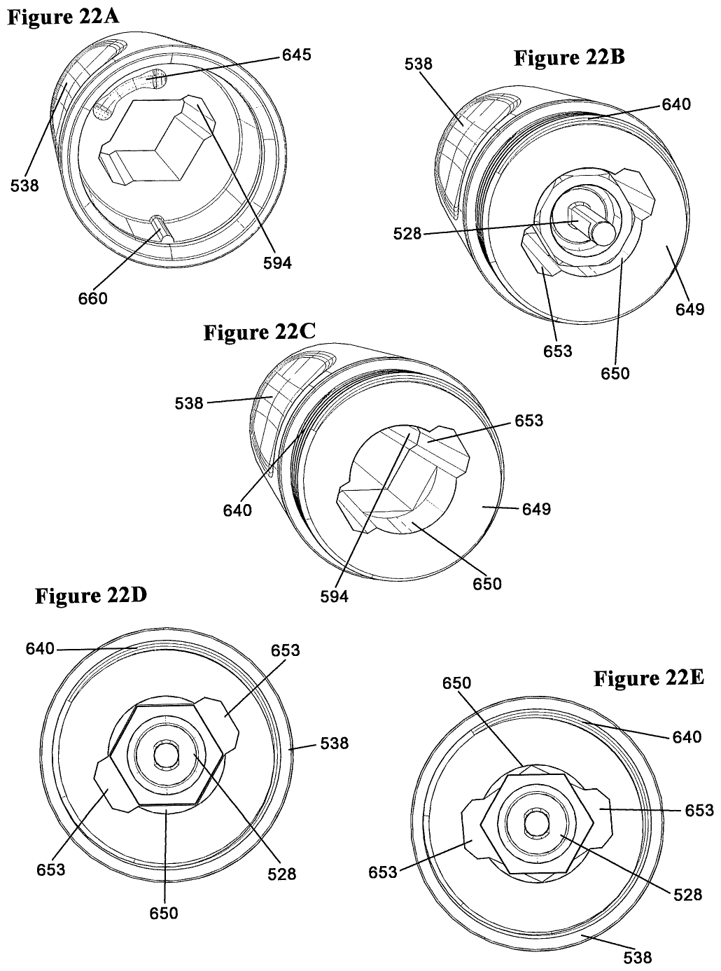

With another preferred embodiment, as shown in the related example illustration/Figures mentioned below. With this embodiment having similarities with the above-mentioned embodiment, whereby it shares the same internal release mechanisms and as well all the advantages mentioned above, this device 500 may have added advantages, for example, when the locking rod assembly is in a Locked position or/and in an Open position the button assembly cross-section apertures may be aligned or not-aligned, meaning there are no restrictions in whatever locking configuration the user wants to put this device 500 in. The other advantage is that the front button assembly may be screwed-on, and may be screwed-off, and replaced with an alternative button assembly or an external apparatus that is adapted to be used with this device 500. With this device not having a permanent button assembly affixed to the front side 502 of the device, where instead it may have a device body having, e.g. FIG. 12G, 12H, and FIG. 13A to 13E, a fixed rear button guide 647 that has at the front an internal groove 641, where the lip protrusion 593 of the non-rotatable rear button guide 647 rests within the complementary aperture of the front button 538; or may have, e.g. FIG. 12D to 12F, a rear button guide 647 having a snap ring 599 where a middle button guide 648 mounts over the snap ring 599, where the lip protrusion 593 of the middle button guide 648 rests within the rear of the front cover 538, that has a complementary cavity adapted to receive the rotatable middle button guide 648, that has at the front an internal groove 641. Referring to FIGS. 12I and 22A, the button attachment 649 may have at the front bottom right side, relative to the longitudinal axis of the cavity 515, an elongated recessed surface 655 to accommodate an elongated mount 660 of the front button 538; with the button attachment 649 front portion, mounted within the rear sleeve of the front button 538 and retained there by a snap ring 599; where the front button 538 then may be rotated along its central longitude axis, clockwise or counterclockwise, and the buttons elongated mound 660 is able to move within the recessed surface 655 from a first position to a second position. Where the first position is when the elongated mound 660 is engaging with the recessed surface 655 furthest most position when rotated counterclockwise, relative to the front button 538 and the cavity 515 central longitudinal axis; and when in the second position, it is on the furthest most position when rotated clockwise, for example, in FIG. 21B and FIG. 21C respectively. With the rear of button attachment 649 having a circle aperture 650 cut into the rear part of the cross-section aperture 653 so to accommodate and not interfere with the function of the bit shank ram cup 528, and around its outer perimeter has an external groove so to receive the button guide 647/648. Mounted on the front face of the sleeve housing 533 there may be two retention pins 651, where they engage with an engaging surface 661, or a notched section 661, for example on most FIGS. 21B to 21I illustrations, that are on the outer lateral face of the lip 593 of the middle button guide 648. When the button assembly is pushed down and engages with the sleeve houses 533, the retention pins 651 engage with the surface or notched 661, where then prevents the middle button guide 648 from rotating. Once the button assembly has been released and has come back up, in which has moved away from the retention pins 651, and the middle button guide 648 may be able to rotate. This type of device may be used on a Standard Front Cover or an External Top Plate configuration. A description on the positions that this type of button assembly may be put in, with/without a bolt, is in FIG. 21A to 25D of the Brief Description of The Figures.

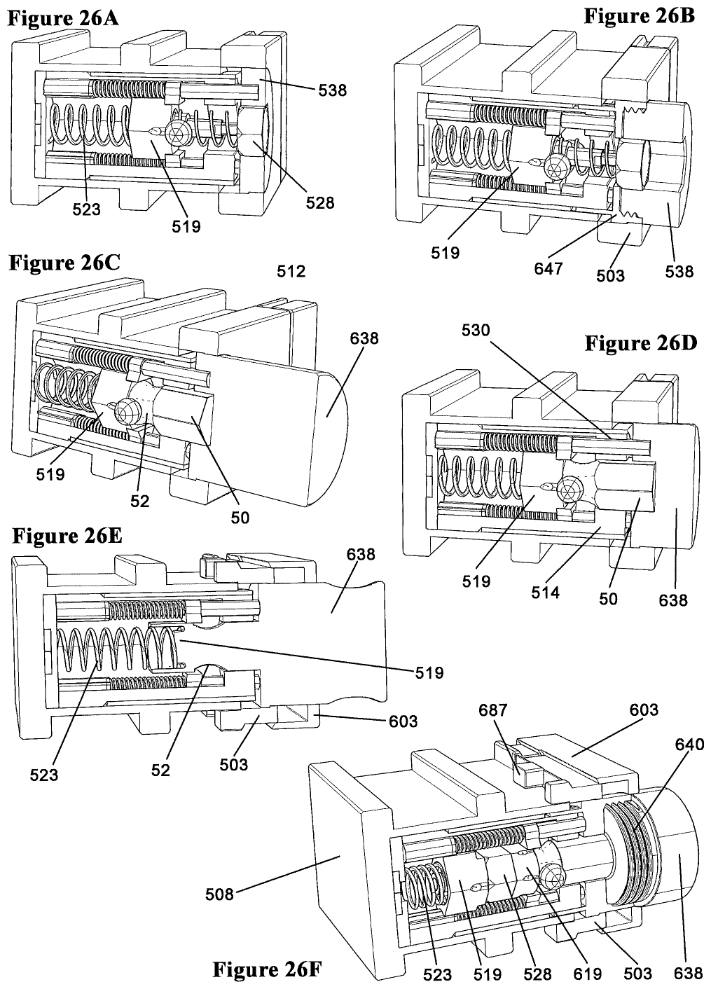

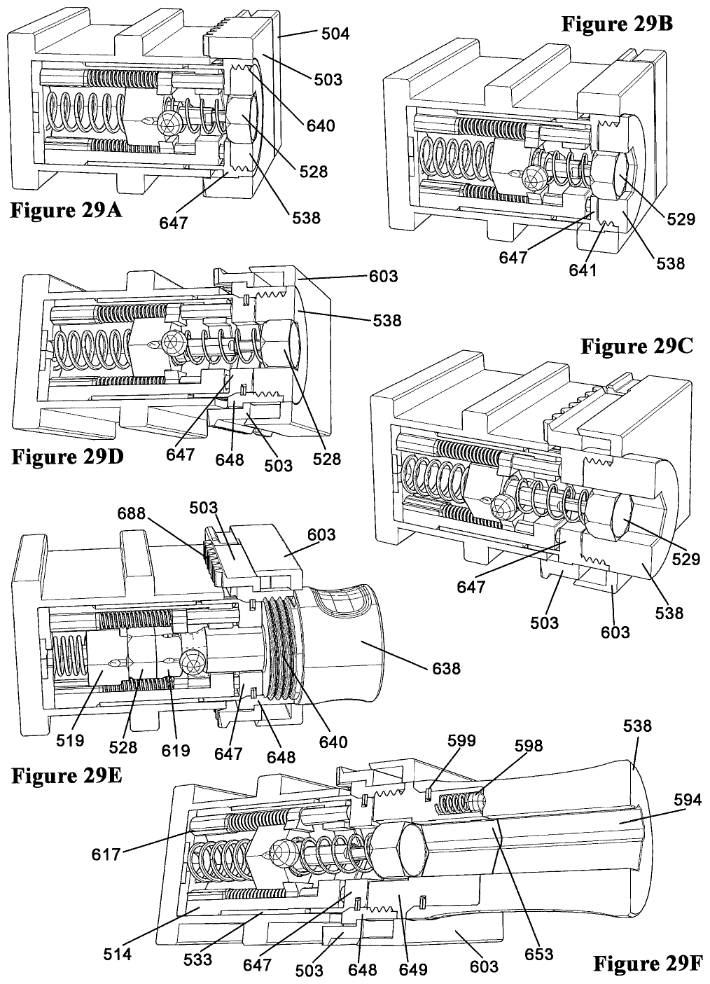

With another preferred embodiment, as shown in FIG. 15A to FIG. 15E, having similarities with the above-mentioned embodiment, where it is adapted to be used with a device with no permanent button assembly affixed to the front side 502. With this detachable button assembly having a solid front button 638, and attached to its base is a bolt with the concave mount 52, attached to the bolt is a substitute piston 619, having a first group of locking balls 522a engagement surface 548. Where, the substitute piston 619, on the outer perimeter of the hexagonal shape having on each corner, an engagement surface 548. With the piston 619 secured to the bolt portion but still able to rotate, and the solid front button 638 with the external grooves 640 on the rear portion of the button is screwed into a device 500, adapted with the complementary internal grooves 641, wherein the substitute piston 619 pushes down on the platform 529, where then the piston assembly 519 descends down, with the substitute piston 619 not able to rotating once within the cavity 515 of the device, but the bolt portion and the solid button 638 rotates clockwise until finally thread onto the device. Together when attached, they function the same as any other device 500 that is adapted with a solid button 638 configuration. This type of button may be used with a Standard Front Cover or an External Top Plate configuration device, as well it may become a non-rotatable button when attached to a device, such as in FIG. 26F, or for example if attached to a device like in FIG. 29E, then it becomes a rotatable solid button, where then it may be able to lock a device 500.

Four different advantages within one device. The first advantage, having two different release methods in the one device, that is, 1) pushing longitudinally at least one of the top plates 504/505 flanking the front cover 503 or pushing the external top plate 603, or 2) pushing laterally at least one of the left or right side plates 553/554 of the external housing 501; is that depending on the orientation and placement of the device 500, there is a convenient and accessible way for which a user can release the front cover 503 out. The second advantage, having three different methods to engage a bolt 50 or a bespoke bolt with a concave 52 mount, in the one device, that is, 1) engaging the bolt while pushing down on the front cover 503 and the bolt, wherein the front retracts in triggered by the internal mechanism, or 2) engaging the bolt while pushing the button assembly in and where the bolt and button retracts in and engages the mechanism, 3) engaging a bespoke bolt or object by pushing down on the bespoke bolt where the flanges 595 may engage with the platform 659 or the sleeve housing 533, where it pushes the button assembly in and engages the device. By having different methods a user can push to engage and push to disengage or an external apparatus adapted to be inserted into the cavity 515 may be used to engage and disengage; the device 500 may not need to be retriggered or handled. The third advantage, having a safety mechanism, by engaging a safety mechanism it can prevent a bespoke bolt entering or exiting the device 500, whether for safety reasons or for any other reason; where an external apparatus may use the built-in safety mechanism as well. The fourth advantage, having an apertures with a cross-section that may be aligned or not-aligned within the body of the button assembly, that matches the cross-section of the distal portion on a bespoke bolt or adapted to suit, for example, a standard hex bit or bolt 50, a bolt 53 that still allows the button assembly to be rotated, or a bolt 54 or bespoke bolt 56/55 that may be rotated and locked within the device 500.

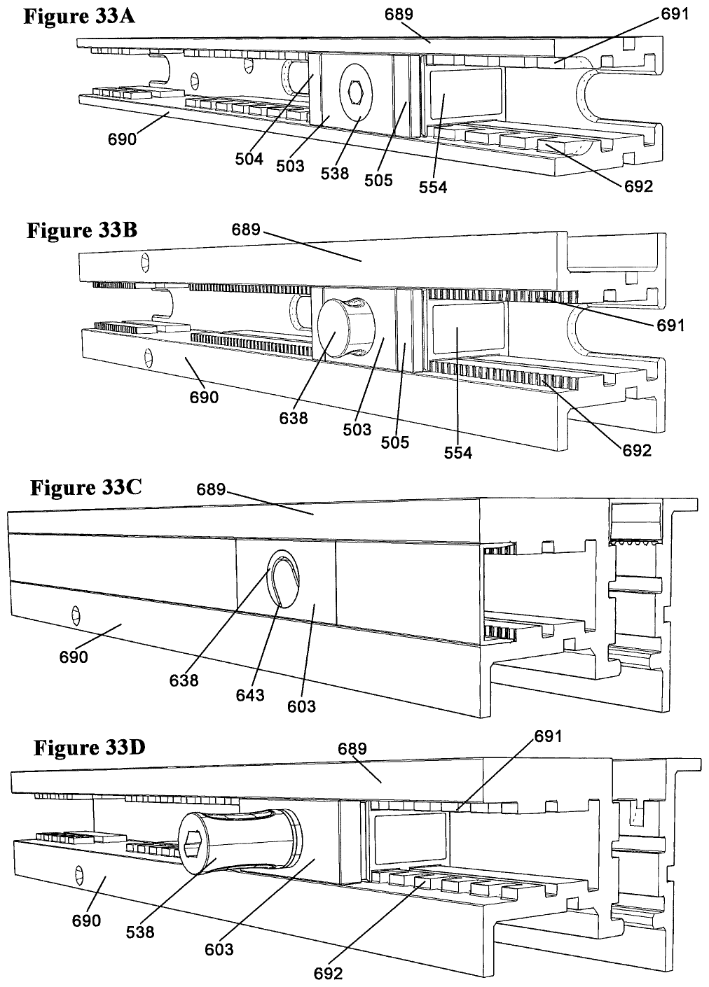

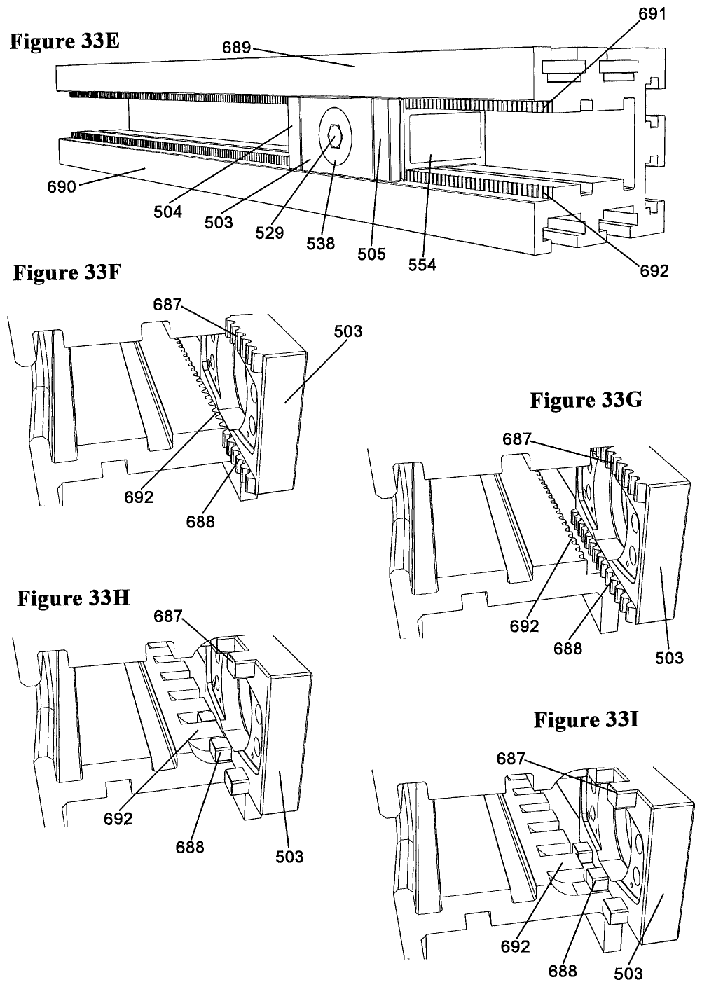

With FIGS. 32A to 32D, showing a side cross-sectional view, and FIGS. 33A to 33E showing a perspective view of a rail system, where a preferred embodiment of the device may be suitable to mount to a beam or a rail system. The beam may have an upper surface and lower surface, the beam may be adapted for use with the device, in which the device of any of the above embodiments may be mounted in the beam. The upper surface and the lower surface may each have a rear groove, and a front groove. Optionally, for extra stability and for mounting the embodiment of the device with a middle rib, there may be a middle groove positioned between the rear groove and the front groove for both the upper surface and the lower surface. The grooves of the surfaces may run parallel with respect to each other. The rear groove of the lower surface may engage with the rear lower ribbing, and the rear groove of the upper surface may engage with the rear upper ribbing. The front groove of the lower surface may engage with the front lower ribbing, and the front groove of the upper surface may engage with the front upper ribbing. The front groove may comprise a rack with teeth 691, 692, wherein the direction of the teeth is perpendicular to the longitudinal axis of the front groove. The inner surface of the front cover may also have complementary teeth portions at the lower portion 688 and the upper portion 687 of the inner surface, wherein the complementary teeth portions are adapted to engage and interlock with the teeth of the upper surface 691 and the lower surface 692 of the beam. Once the front cover has been interlocked and retained, the device cannot slide along the grooves of the beam. Depending on the type of device used, the front cover may interlock with the teeth when the front cover is flush with the side rails 689, 690 of the rail system or if the device has an external top cover, the front cover that is below may interlock or not interlock with the teeth of the beam, as the external top cover/plate stays flush with the side rails 689, 690 of the beam/rail system. As the beam may also be flush with the front cover, there may not be sufficient gripping area for a user to release the front cover. To disengage the interlocking system, preferably, the front cover may be released via the External-Top-Plate or First-Top-Plate and Second-Top-Plate mechanism and/or the Left-Side-Plate and Right-Side-Plate mechanism. Following the disengagement of the interlocking system, the device may be movable or slidable along the grooves of the beam to position the device at a desirable position in the beam.

As shown in FIGS. 33F to 33I, the teeth of the rack may have a corrugated profile or a square wave. If the square wave is used, to interlock between the teeth rack and the complementary teeth portions of the front cover, the positive half of the teeth rack may engage with the negative half of the complementary teeth portion, and the negative half of the teeth rack may engage with the positive half of the complementary teeth portion. It may be appreciated that depending on the embodiment of the device, the front of the front cover and the back of the front cover, in which the back of the front cover have the complementary teeth portion.

V7

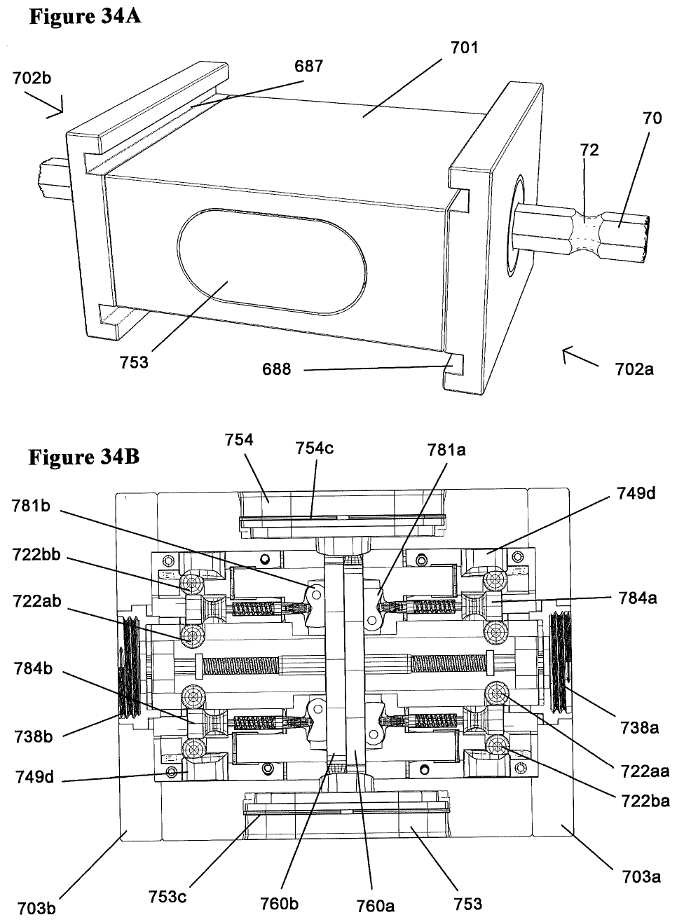

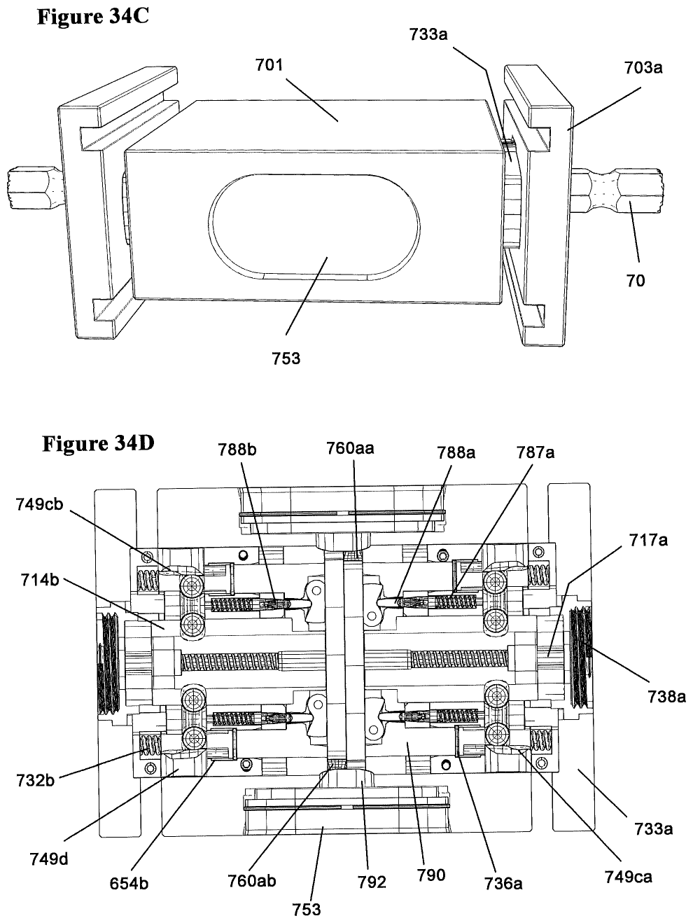

In another preferred embodiment of the invention, as shown in FIGS. 34A to 39A the device 700 may be similar to the parts used in device 500. The device 700 may have an exterior housing 701. The exterior housing 701 may be a box of six sides, in which one of the front sides 702 is coverable by a moveable front cover 703a, in which one of the back sides 702 is coverable by a moveable back cover 703b. The left and right sides of the exterior housing 701 may also be coverable by a moveable left cover 753 and a moveable right cover 754, respectively. The exterior housing 701 may have a side profile shape similar to a box section. The exterior housing 701 may be in any form or size to suit.

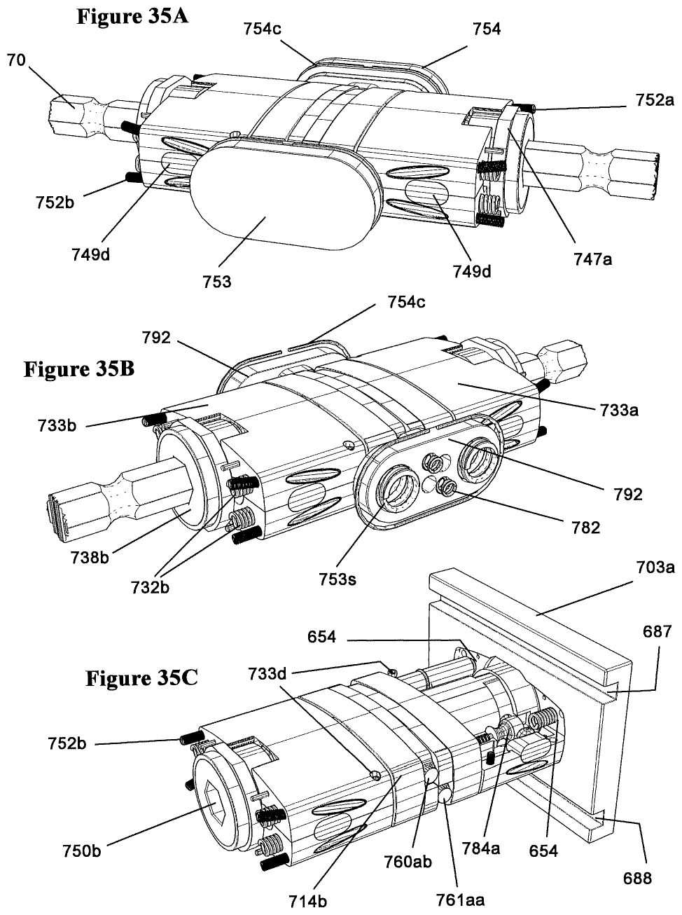

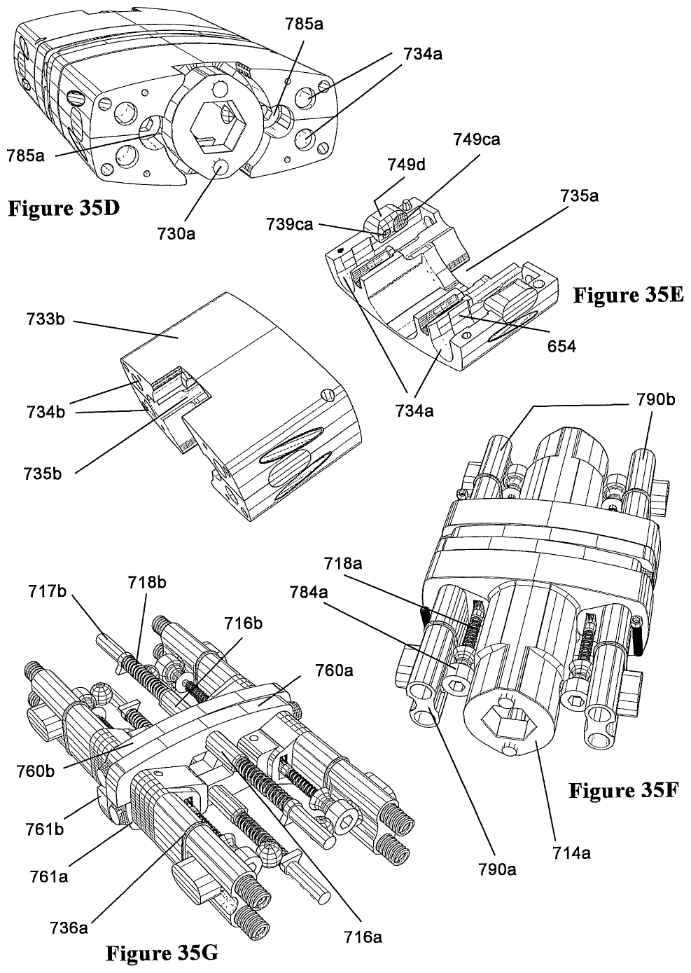

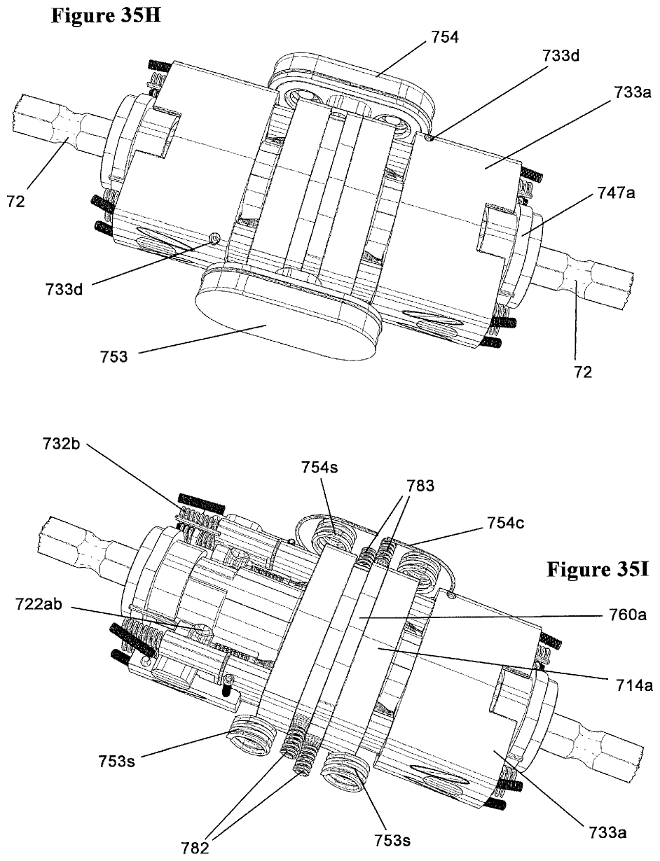

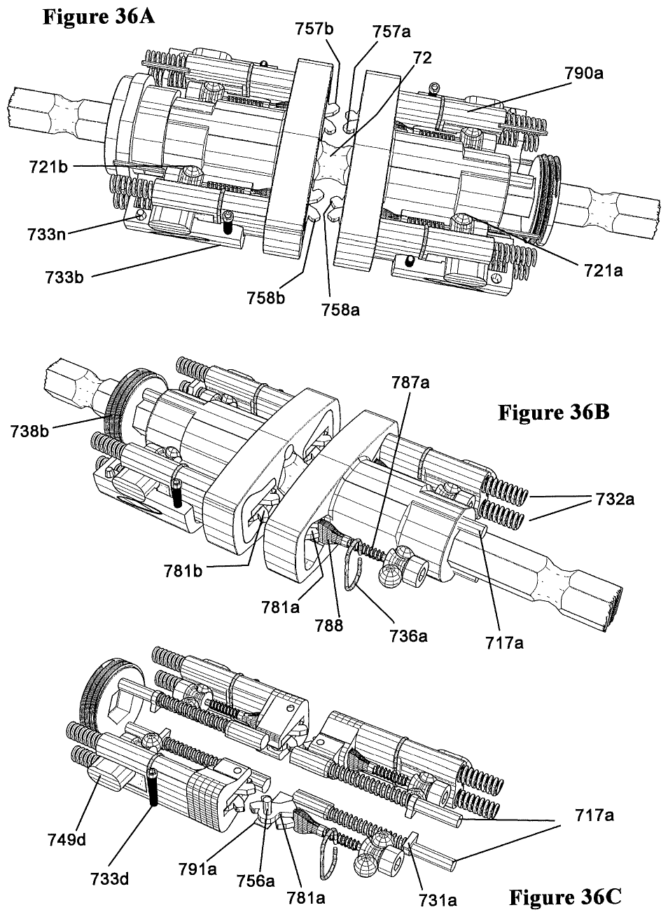

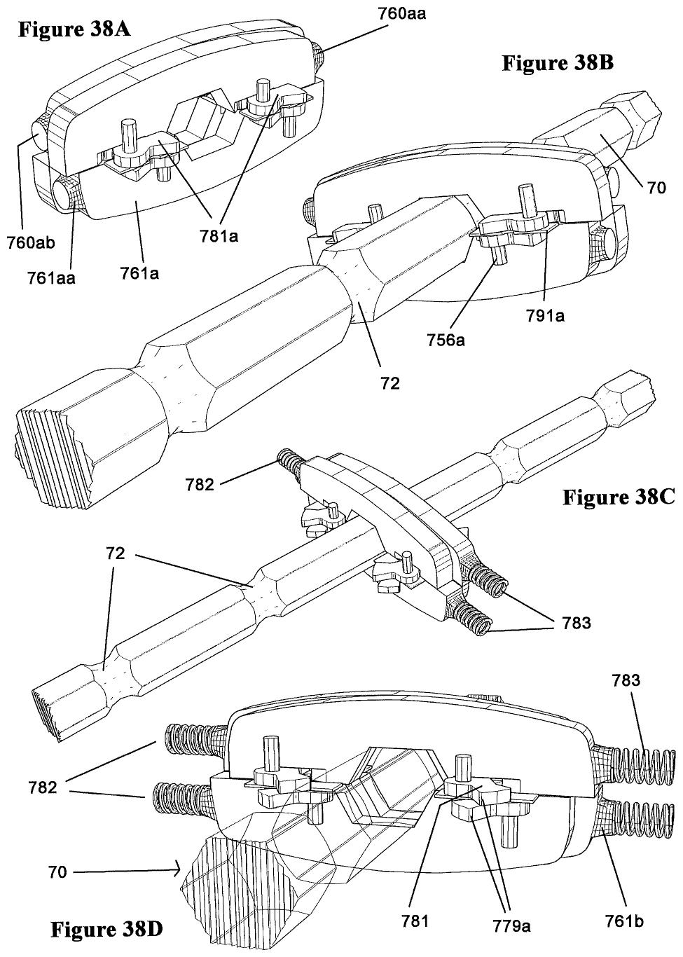

The internal surface of the back side or moveable back cover 703b may be similar to the moveable front cover 703a. As shown in FIG. 35E the device 700 may have two cylindrical tube housings 714a, 714b; and each of the cylindrical tube housings 714a, 714b may also each have two apertures 755a, 755b that are inline or adjacent with the planks 760a, 760b, 761a, 761b FIG. 38A to 38D. The two apertures of the cylindrical tube housings 714a, 714b may house the first & second ball release lever housing 790a, 790b FIG. 35G, the ball release lever housings 790a, 790b are positioned on either side of the cavity 715a, 715b respectively; and are equidistant from the centre axes of the cavity 715a, 715b respectively. As shown in FIG. 36C within each of the ball release lever housings 790a, 790b, each having an aperture at the rear to receive an upper & lower ball release lever 781a, 781b respectively with a pivot pin 756 for each lever, and the front portion adapted to receive ball-bearings 722a and the back portion adapted to receive ball-bearings 722b within apertures 721a, 721b respectively, and also may house four sleeve housing springs 732a at the front, and may house four sleeve housing springs 732b at the back. Release levers 781a, 781b each having an upper plank rear engaging arm 757a, 757b respectively, and a lower plank rear engaging arm 758a, 758b respectively. Movement of the upper plank rear engaging arms 757a, 758a, and 758a, 758b simultaneously may effect the movement of the ball release levers 781a, 781b respectively. The release levers 781a, 781b may each be adapted to receive an upper release plank 760a, 760b, and a lower release plank 761a, 761b, wherein the upper release plank 760a, 760b is each in engagement with an upper rear engaging arm 757a, 757b of the first and second upper release lever 781a, 781b. The lower release plank 761a, 761b may be in engagement with the lower rear engaging arm 758a, 758b of the first and second lower release lever 781a, 781b.

The cylindrical tube housings 714a, 714b may each be a stationary part, which may be uniquely shaped to fit tightly in the interior of the exterior housing 701. The cylindrical tube housings 714a, 714b may each have a lumen or a central cavity 715a, 715b each with a cross-section suited for receiving a shank or a bolt 70 or bespoke with the same cross-section. The central cavities 715a, 715b may be in connection, such that the shank or a bolt 70 may be received in the central cavities 715a, 715b therethrough. Alternatively, it may be appreciated that a first bolt 70 may be received in one central cavity 715a, and a different or second bolt 70 may be received in the second central cavity 715b. The cylindrical tube housings 714a, 714b may each house the following parts: bit cylinder top and bottom rod shaft rear cup housing 716a, 716b, bit cylinder top and bottom rods 717a, 717b, top and bottom washer/spacer 731a, 731b, bit cylinder top and bottom springs 718a, 718b. The cylindrical tube housing 714a, 714b may each have a hole 721a, 721b on either side of the cylindrical tube housing 714a, 714b respectively to allow the ball-bearings 722a of the first group of locking balls to move into the central cavity 715a or out of the central cavity 715a, and to allow the ball-bearings 722b of the second group of locking balls to move into the central cavity 715b or out of the central cavity 715b. The outer cylindrical tube housing 714a, 714b may or may not be stepped towards the lumen or central cavity 715a, 715b respectively. With the outer rear stepped portion, or the flange part that is mainly protruding out laterally at the rear flanks of the cylindrical tube housing 714a, 714b each having two apertures 755a, 755b that are adapted to house the first & second ball release lever housing 790a, 790b, the ball release lever housing 790a, 790b are each positioned on either side of the cavity 715a, 715b and are each equidistant from the centre axes of the cavity 715a, 715b.

As shown in e.g. FIG. 35D. The cylindrical tube housing 714a, 714b may each have apertures 730a, 730b between the central cavity 715a, 715b and the outer surface of the cylindrical tube housing 714a, 714b. The apertures 730a, 730b may each be parallel to relative to the central cavity 715a, 715b. Each of the apertures 730a, 730b are each adapted to receive a bit cylinder top and bottom rod 717a, 717b. For the embodiment 700 having two bit cylinder top and bottom rods 717a, 717b, the bit cylinder top and bottom rods 717a, 717b may be mounted diametrically opposite relative to each other inside the cylindrical tube housing 714a, 714b respectively. It may be appreciated that the bit cylinder top and bottom rods 717a, 717b may each be positioned equidistant relative to each other surrounding the central cavity 715a, 715b. A rear cup housing 716a, 716b may be in connection with cylindrical tube housing 714a, 714b at the rear respectively. The rear cup 716a, 716b may hold the end of the cylinder rod 717a, 717b, the rear cup 716a may have an aperture 716aa, and the rear cup 716b may have an aperture 716ab, where the end of the cylinder rod shaft extends partially into. A washer/spacer 731a, 731b may extend perpendicularly from a middle portion of each cylinder rod 717a, 717b. It may be appreciated that in the embodiment 700, the washer/spacer 731a, 731b is a separate part and not connected to the cylinder rod 717a, 717b, the advantages are, a different shaped washer/spacer 731a, 731b may be used if necessary and in manufacturing. The washer/spacer 731a, 731b may be positioned between a rear portion of the bit cylinder rod and the front portion of the bit cylinder rod. The cylinder rod 717a, 717b may be secured or may be diametrically opposed, resting behind the button, not inserted into the back of the front button 738a or into the back of the rear button 738b, or the rear button guide 747a, 747b respectively. When the button assembly is moved back in, from an Out/disengaged position to an IN/engaged position, the cylinder rod 717a, 717b and the washer/spacer 731a, 731b will each move in. As shown in e.g. FIGS. 35G and 36C for reference, a bit cylinder spring 718a, 718b may each be resting on the washer/spacer 731a, 731b and the bit cylinder spring 718a, 718b may each be mounted on the rear portion of the bit cylinder rod 717a, 717b respectively. The cylinder Springs 718a, 718b may each force against the rear cup housing 716a, 716b with the other side of the spring forcing against washer/spacer 731a, 731b respectively, whereby keeping the respective bit cylinders top and bottom rods 717a, 717b pushed out.

As shown in e.g. FIGS. 35G and 36C illustrates a perspective view of the rear cup housing 716a, 716b, positioned at the rear of the device 700 having a tubular like shape running parallel with the longitude axis of the cavity 715a, 715b. Each having a flange 717a, 717b like protrusion extending out along the length on either side of the flanks of the tubular shape, with the flanges 717a, 717b each positioned away from the equatorial plane, and perpendicular north or south of the longitude axis of the tubular shape. The rear housing cup 716a, 716b each having an aperture 716aa, 716ab within the tubular portion and extending partially into the aperture 716aa, 716ab is the end shaft part of the cylinder rod 717a, 717b, whereby the end shaft part will reciprocate within the aperture 716aa, 716ab. With the rear bit cylinder rod cavity 730a, 730b of the cylindrical tube housing 714a, 714b, adapted to receive the rear cup housing 716a, 716b, where at the top and bottom of the cavity 715a, 715b, there is each a circumference like shape extending along the longitude axis of cavity that compliments the outside tubular shape and flange protrusion of the rear cup housing 716a, 716b. Whereby once inserted, and because of its unique shape and tight fit, it cannot fall into the respective centre of the cavity 715a, 715b, and thereby not obstructing with the moving of the shank or bolt 70 itself.

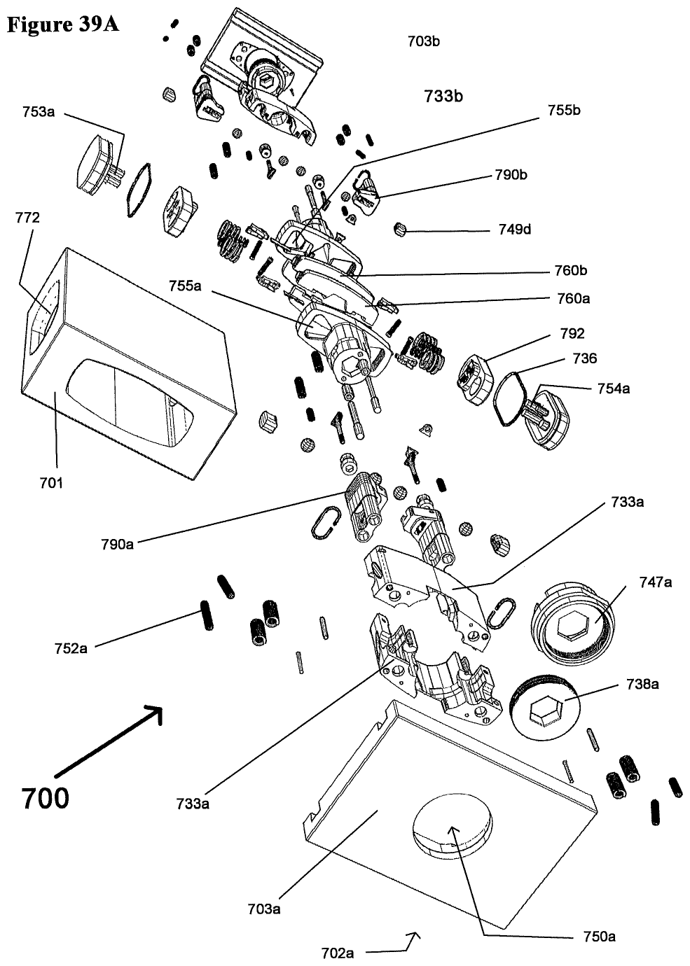

As shown e.g. illustration FIGS. 35A to 35G and 39A for reference. The sleeve housing 733a, 733b may each have a central cavity 735a, 735b, where it slides over the front cylindrical portion of the cylindrical tube housing 714a, 714b and secured into place by a retaining C-clips 736a, 736b. The front of the central cavity 735a, 735b is each adapted to receive the rear portion of the rear button guide 747a, 747b respectively, where the respective rear button guide 747a, 747b is each able to slide longitudinally backwards and forwards freely within the aperture/cavity 735a, 735b. The sleeve housing 733a, 733b may each have at least two further apertures 734a, 734b, the apertures 734a, 734b may each be open from the respective rear end to the front end of the sleeve housing 733a, 734b, with rear end of the housing having larger aperture openings and the front end having small openings, and equidistant from the centre axes of the central cavity 735a, 735b. The rear apertures 734a, 734b may each be adapted to receive a first and second ball release lever housing 790a, 790b, where the front end of the sleeve housing may each have four apertures 734a, 734b, in which two of the apertures are larger than the other two. The two smaller apertures 734a, 734b are each for receiving the sleeve housing springs 732a, 732b, and the two bigger apertures receives the first and second ball release lever housing 790a, 790b. The front end of the sleeve housing spring 732a is in engagement with the rear of the front cover 703a and the front end of the sleeve housing spring 732b is in engagement with the rear of the rear cover 703b. Wherein, on the rear of the front cover are apertures 658a to receive the sleeve housing springs 732a, and wherein on the rear of the rear cover FIG. 35C are apertures 658b to receive the sleeve housing springs 732b. Within the rear larger apertures 734a, 734b of the sleeve housing, there is a respective retention slot 654a, 654b adapted to receive a respective retaining C-clip 736a, 736b. On the front section of ball release lever housing 790a, 790b, there is each a recess to attach the respective retaining C-clip 736a, 736b. Once the ball release lever housing 790a, 790b has each been received within the rear aperture/cavity 734a, 734b, then the respective C-clip 736a, 736b may each respectively snaps into the retention slot 654a, 654b, whereby securing the sleeve housing, but still able to slide longitudinally backwards and forwards over the ball release lever housing 790a, 790b respectively. As shown in FIGS. 35D, 35E the sleeve housing 733a, 733b comes in two identical parts, a 733 for the top and a 733 for the bottom and where now the ball-retention surface 749c is now attached to a separate part, ball-retention block 749d.

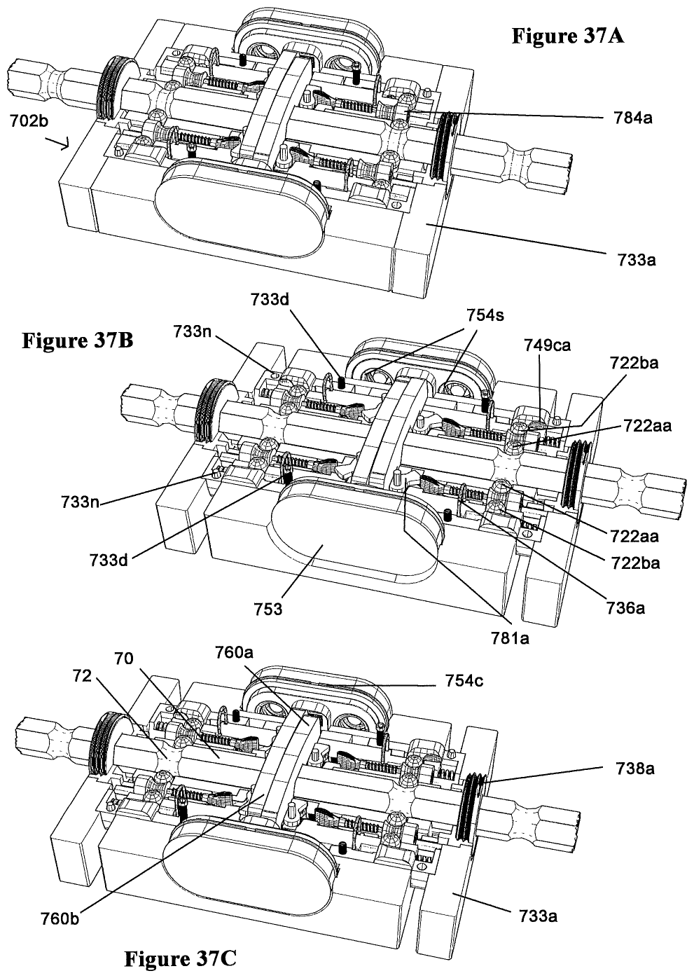

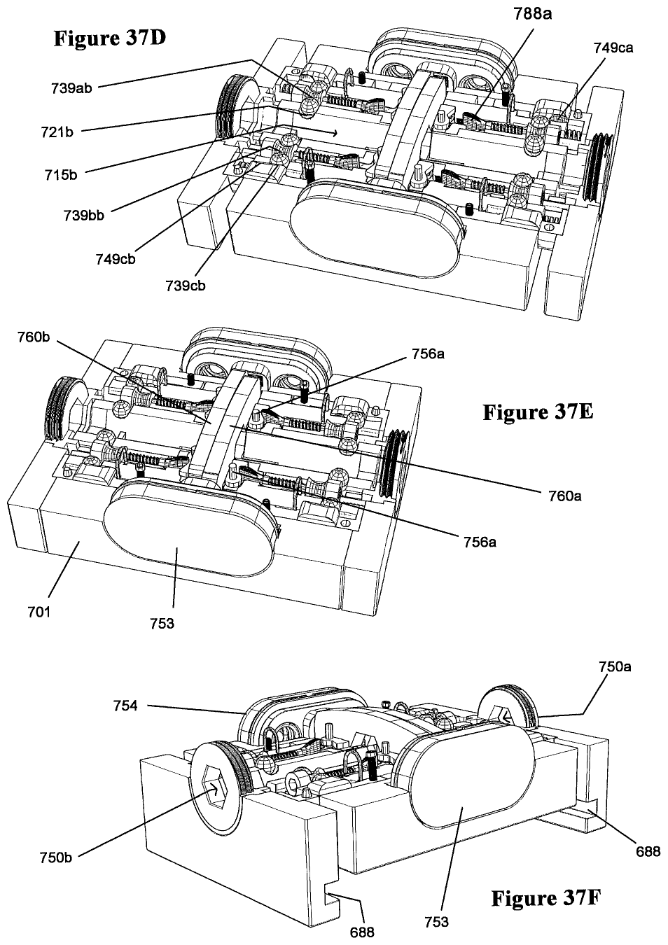

Within these illustrations are just some examples of the release block 784a, 784b documented here: FIGS. 35F, 35G, 37A to 37F. The cylindrical tube housing 714a, 714b may each have an outer sleeve housing 733a, 733b respectively, which may be axially moveable relative to the longitudinal axis of the cylindrical tube housing 714a, 714b. The outer sleeve housing 733a, 733b may each be adapted to receive within its respective central cavity a left ball-bearing release block and a right ball-bearing release block, wherein the cavities for the left and right ball-bearing release blocks 784a, 784b are each between the central cavity/aperture 735a, 735b and the ball release lever housing cavity/apertures 734a, 734b. The respective cavities 785a, 785b for the release blocks 784a, 784b are of a cylindrical shape and positioned towards the front of the sleeve housing 733a, 734b, where they extend from the central aperture/cavity 735a, 735b through to the side aperture/cavities 734a, 734b, whereby creating an opening. Behind each cylindrical shaped cavity 785a, 785b, is a round aperture that extends longitudinally towards the rear of the sleeve housing 733a, 733b, and with a small, flanged section immediately behind the cylindrical shaped cavity. Where the cylindrical shape cavity holds the release block 784a, 784b respectively, and the small, flanged section retains the respective ball release rod 788a, 788b in place, the larger round aperture is occupied by the ball release rod spring 787a, 787b respectively. With the respective ball release rod spring 787a, 787b forcing against the stationary flanged section and mounted over the ball release rod 788a, 788b respectively, with the other side against the respective rods rear flanged part 789a, 789b, whereby the respective release block 784a, 784b may each be connected to the rod, is each retained towards the rear wall of the cylindrical shaped cavity 785a, 785b. The respective release blocks 784a, 784b may each be able to move independently in the longitudinal direction within their respective cylindrical shaped cavity 785a, 785b. The cylindrical space/cavity 785a, 785b may be longer and extended further forward than the release blocks 784a, 784b, so to allow the respective ball-bearing release blocks 784a, 784b to move into that cavity. The channels or recesses 739aa/739ba, 739ba/739bb may each be exposed or open when the outer sleeve housing 733a, 733b has each moved forward, away from rear portion of the cylindrical tube housing 714a, 714b. The channels or recesses 739aa/739ba, 739ba/739bb may each be closed when the outer sleeve housing 733a, 733b is each closer to the respective rear portion of the cylindrical tube housing 714a, 714b. With the respective left and right release blocks 784a, 784b each having two concave recess portions 739a, 739b and two non-recessed portions 749a, 749b, each adapted for receiving or retaining the first group of ball-bearings 722aa, 722ab, and the second group of ball-bearings 522ba, 522bb. Whereby each release block 784a, 784b each has an inner-side concave recess 739aa, 739ab, and an inner-side non-recessed portion 749aa, 749ab, and each has an outer-side concave recess 739ba, 739bb and an outer-side non-recessed portion 749ba, 749bb. Whereby, inner-side meaning that the inner part is facing the respective central cavity aperture 735a, 735b of the sleeve housing 733a, 733b respectively, and whereby the outer-side meaning that it is facing the outer flanks longitudinal walls of the sleeve housing 733a, 733b respectively. The inner-side of the left ball-bearing release block 784a, 784b may each receive a left inner ball-bearing or locking ball, of the first group of locking balls, wherein the left inner ball-bearing 722aa, 722ab may each engage with the left release blocks inner-side concave recess 739aa, 739ab when the device 700 is disengaged or released; wherein the left inner ball-bearing 722aa, 722ab may each engage with the left release blocks inner-side non-recessed 749aa, 749ab when the device 700 is engaged or unreleased. The inner-side of the right ball-bearing release block 784a, 784b may each receive a right inner ball-bearing or locking ball, of the first group of locking balls, wherein the right inner ball-bearing 722aa, 722ab may each engage with the right release blocks inner-side concave recess 739aa, 739ab when the device 700 is disengaged or released; wherein the right inner ball-bearing 722aa, 722ab may each engage with the right release blocks inner-side non-recessed 749aa, 749ab when the device 700 is engaged or unreleased. The outer-side of the left ball-bearing release block 784a, 784b may each receive a left outer ball-bearing or locking ball, of the second group of locking balls, wherein the left outer ball-bearing 722ba, 722bb may each engage with the left release blocks outer-side concave recess 739ba, 739bb when the device 700 is disengaged or released; wherein the left outer ball-bearing 722ba, 722bb may each engage with the left release blocks outer-side non-recessed 749ba, 749bb when the device 700 is engaged or unreleased. The outer-side of the right ball-bearing release block 784a, 784b may each receive a right outer ball-bearing or locking ball, of the second group of locking balls, wherein the right outer ball-bearing 722ba, 722bb may engage with the right release blocks outer-side concave recess 739ba, 739bb when the device 700 is disengaged or released; wherein the right outer ball-bearing 722ba, 722bb may each engage with the right release blocks outer-side non-recessed 749ba, 749bb when the device 700 is engaged or unreleased. The cylindrical tube housing 714a, 714b may each have a hole/aperture 721aa, 721ab on either side of the cylindrical tube housing 714a, 714b to allow the respective ball-bearings 722aa, 722ab of the first group of locking balls to move into the respective central cavity 715a, 715b or out of the respective central cavity 715a, 715b. The outer flanks of the sleeve housings 733a, 733b, internal cavities 734a, 734b each having a ball-retention block 749d that each has a ball-released surface 739ca, 739cb and a ball-retention surface 749ca, 749cb each adapted for receiving or retaining the second group of ball-bearings 722ba, 722bb. The sleeve housing 733a, 733b ball-bearing 722ba, 722bb engagement surface 739ca/749ca, 739cb/749cb may each receive an outer ball-bearing or locking ball, of the second group of locking balls, wherein the left outer ball-bearing 722ba, 722bb may each engage with the left ball-released surface 739ca, 739cb when the device 700 is disengaged or released; wherein the left outer ball-bearing 722ba, 722bb may each engage with the left ball-retention surface 749ca, 749cb when the device 700 is engaged or unreleased. Wherein the right outer ball-bearing 722ba, 722bb may each engage with the right ball-released surface 739ca, 739cb when the device 700 is disengaged or released; wherein the right outer ball-bearing 722ba, 722bb may each engage with the right ball-retention surface 749ca, 749cb when the device 700 is engaged or unreleased. When the ball-bearings 722ba, 722bb are each not in the recessed cavity of the left and right outer flanks, the device 700 is disengaged or released, whereby the ball-bearings 722ba, 722bb are each between the ball-released surface 739ca, 739cb of the ball-retention block 749d, where the surface is of a convex like shape; with the convex like shape pushing the second group of locking balls within the ball release housings 790a, 790b hole/aperture 721ba, 721bb, and against the release blocks outer-side concave recess 739ba, 739bb. With the ball-bearings 722ba, 722bb in the outer recessed cavity; the second group of locking balls are between the release blocks outer-side non-recessed 749ba, 749bb portion and ball-retention surface 749ca, 749cb respectively, whereby the furthest outer surface of the ball-bearing 722ba, 722bb is each engaging with the respective sleeve housings ball-retention block 749d 749ca, 749cb, with a portion or a third of the ball-bearing 722ba, 722bb overlapping on the ball-retention corner surface 749ca, 749cb at the side front corner outer flanks of the respective sleeve housings internal cavities 734a, 734b. Where the device 700 now is in an engaged or unreleased configuration, the outer sleeve housing 733a, 733b may each have apertures 740a, 740b surrounding the cylindrical tube housing 714a, 714b respectively, wherein each of the apertures 740a, 740b of the outer sleeve housing 733a, 733b are each parallel to the cylindrical tube housing 714a, 714b. The apertures are each adapted to receive a dowel pin, grub screw or similar fastening device 752a, wherein the fastening device 752a, may connect the sleeve housing 733a with the front cover 703a, and the apertures are each adapted to receive a dowel pin, grub screw or similar fastening device 752b, wherein the fastening device 752b, may connect the sleeve housing 733b with the front cover 703b. Or alternatively as illustrated in e.g. FIG. 35C when it's not possible to put the fastener 752a, 752b parallel with the front cover 703a and the rear cover 703b respectively, the fastener may each be mounted from the apertures 740a, 740b at the side walls of the sleeve housing 733a, 733b, once the sleeve housing 733a, 733b and the front cover 703a/rear cover 703b has each been received within the exterior housing 701 the fastener connection is no longer accessible from the outside of the device 700.

It may be appreciated that removeable buttons and flange type buttons similarly used in the embodiment of device 500 as described before may be applicable for use with device 700. If the 500 type buttons are used for the device 700, they then can be turned clockwise or anticlockwise, when the button is screwed/secured with the front cover 703a or screwed/secured with the rear cover 703b and if the front button and/or rear button has a button locking mechanism then the button can be locked similar to device 500 to hold the bespoke bolt 70.

The springs for this embodiment 700 may be similarly used as described in embodiment 500. In the return to the original spring state, for example, the contracted springs 732a may expand and provide an axial force to the sleeve housing 733a from the rear to the front, which in turn moves the sleeve housing 733a and front cover 703a to an out/disengaged position, whereby moving the sleeve housing 733a towards the device 700 front side 702a, Similarly, the contracted springs 732b may expand and provide an axial force to the sleeve housing 733b from the front to the rear, which in turn moves the sleeve housing 733b and rear cover 703b to an out/disengaged position, whereby moving the sleeve housing 733b towards the device 700 rear side 702b. When the front cover 703a and rear cover 703b has each been returned to the IN/engaged position, the action would have compressed the springs, where then with the left and right release blocks 784a, 784b moved back IN/down, the respective channels 739aa, 739ab, concave shape would have pushed the ball-bearings 722aa, 722ab, back into the respective cavity 715a, 715b, and the concave shape 739ba, 739bb pushed the ball-bearings 722ba, 722bb, back into the outer recessed cavities 749ca, 749cb, so to allow the retention of the ball-bearings 722aa/722ba, 722ab/722bb whereby moving them each laterally from a second position to the first position. Whereby the surfaces 749aa, 749ab and 749ba, 749bb, 749ca, 749cb, have each now re-engaged the sleeve housings 733a, 733b ball-retention block 749d, ball-retention surfaces 749ca, 749cb respectively, with the springs 732a, 732b compressed, and the springs 787a, 787b extended, the retention forces retain the ball-bearings 722aa/722ba, 722ab/722bb, in their first positions respectively; with the sleeve housings 733a, 733b down and engaged the front cover 703a and the rear cover 703b respectively and the covers 703a, 703b cannot be pulled up and disengaged, unless one of the Side Release Plates 753/754 have been triggered. The first group of locking balls now in the first position and out of the second position, wherein the first position is in the cavity 715a, 715b, and the second position is in a corresponding first group of locking ball recesses, wherein the left and right release blocks 784a, 784b, inner-side concave recess 739aa, 739ab comprises the first group of locking ball recesses; and with second group of locking balls now in the first position and out of the second position, wherein the first position is in the ball-retention surface 749ca, 749cb on the left and right outer flanks of the sleeve housing 733a, 733b, and the second position is in a corresponding second group of locking ball recesses, wherein the left and right release blocks 784a, 784b, outer-side concave recess 739ba, 739bb comprises the second group of locking ball recesses respectively. It may be appreciated that with the embodiment 700, the springs 732a, 732b are each contracted when the respective front cover 703a or rear cover 703b is engaged. It may be appreciated that the device 700 may have sleeve housings that are separated as well, and as shown in the Figures, there are two identical part 733 for the front top and bottom and two identical rear top and bottom. Meaning that they can be manufactured as one unit and just minor imaged, placed and secured by the bolts 733d.

The device 700 may have a Rear-Lever and Plank-Release-Mechanisms assembly. There may be rear lever housing 792 that house the springs 782/783, 753s/754s. The first and second release plates 753/754 may each move an upper/lower plank engaging arm 760a, 760b, 761a, 761b wherein the stud effects the relative lateral movement between the upper/lower planks 760a,760b and the relative lateral movement of the upper/lower planks 761a, 761b such that the first and second lower release lever 781a, 781b effects the movement of ball release rods 788a, 788b towards their respective covers 703a, 703b as shown in FIG. 36C. The movement of the upper release plank 760a, 760b effects the movement of the upper plank rear engaging arms 757a, 757b of the upper first and second ball release levers 781a, 781b towards the right, and movement of the lower release plank 761a, 761b effects the movement of the lower plank rear engaging arms 758a, 758b of the lower first and second ball release levers 781a, 781b towards the left. The first and second ball release levers 781a, 781b may each have a upper/lower plank rear engaging arm 757a/758a, 757b/758b and a ball release rod flange 789a, 789b, upper/lower front engaging arm 779a/780a, 779b/780b wherein the rear engaging arm 757a, 758a, 757b, 758b and the front engaging arm 779a, 780a, 779b, 780b is pivotable about a pivot point 756a, 756b. The upper/lower rear engaging arm 757a/758a, 757b, 758b and an upper/lower front engaging arm 779a/780a, 779b/780b are integrally connected such that the movement of the rear engaging arm 757a/758a, 757b/758b at a lateral direction effects the movement in a longitude direction of the front engaging arm 779a/780a, 779b/780b. The upper and lower release levers 781a, 781b may have a divider 791a, 791b in between them, thereby separating them. They are housed within a first & second ball release lever housing 790a, 790b, where each housing holds, an upper and a lower release lever 781a, 781b, a divider 791a, 791b respectively and two pivot pins 756a, 756b. The upper and the lower release lever 781a, 781b within the housing 790a, 790b may each have a scissors mechanism in which as the upper rear arm 757a, 757b and the lower rear arm 758a, 758b are each moved relatively towards each other respectively, the upper and lower lever 781a, 781b are each pivoted on their pivot point 756a, 756b, which then effects the movement in a longitude direction of the front engaging arms 779a, 780a, 779b, 780b respectively. Whereby the levers front engaging arm 779a, 780a, 779b, 780b are each moved relatively towards each other, pushing against the respective ball release rod flange 789a, 789b, whereby the respective connected rod 788a, 788b each moves the ball-bearing release block 784a, 784b longitudinally away from the rear of cylindrical tube housing 714a, 714b. The left ball-bearing release block 784a, 784b may each be positioned within the central cavity of the sleeve housing 733a, 733b and the left side of the central cavity 735a, 735b respectively; and the right ball-bearing release block 784a, 784b may each be positioned within the central cavity of the sleeve housing 733a, 733b and the right side of the central cavity 735a, 735b respectively. The left ball-bearing release block 784a, 784b and the right ball-bearing release block 784a, 784b may each move independently relative to the sleeve housing parallel to the longitudinal axis of the central cavity 735a, 735b respectively. The left and right ball-bearing release blocks 784a, 784b may each comprise a ball-bearing recess 739aa, 739ba, 739ab, 739bb and the respective non-recessed portion 749aa, 749ba, 749ab, 749bb. The sleeve housing 733a, 733b may each comprise a ball-bearing release block cylindrical shaped space 785a, 785b for receiving the left and right ball-bearing release blocks 784a, 784b respectively. The cylindrical space 785a, 785b may each be longer and extended further forward then the release blocks 784a, 784b, so to allow the ball-bearing release blocks 784a, 784b to move into so as to allow the ball-bearings 722aa/722ba, 722ab/722bb to each move laterally from the blocks non-recessed portion 749aa/749ba, 749ab/749bb to the blocks recess 739aa/739ba, 739ab, 739bb concave portion respectively. Forcing the first group of locking balls 722aa, 722ab and the second group of locking balls 722ba, 722bb to respectively retract, each moving laterally away from the respective central cavity 715a, 715b into the respective recess 739aa, 739ab and from the ball-retention surface 749ca, 749cb into the respective recess 739ba, 739bb. Once the ball-bearings 722aa/722ba, 722ab/722bb have each moved into the respective blocks recess 739aa/739ba, 739ab/739bb, and each have vacated the respective cavities 749ba/749ca, 749bb/749cb, whereby allowing the bolt 70, as shown in FIGS. 38B, 38C, 53A, to be ejected out of respective central cavity 715a, 715b of the cylindrical tube housing 714a, 714b respectively; whereby allowing the front cover to disengage, with the contracted springs 732a, 732b now each expanded and having forced the respective sleeve housing 733a, 733b and front cover 703a, and rear cover 703b respectively to an out/released configuration.

The device 700 may have a Left-Side-Plate assembly and/or a Right-Side-Plate assembly on the lateral sides. The side release plates 753, 754 of the exterior housing 701 are on the flank side walls, and parallel to the longitudinal axis of the cavity 715a, 715b respectively. By pushing the side laterally of at least one of the side release plates 753, 754 IN, effects the lateral movement in the direction of movement. Whereby it may operate as a release plate for the respective sleeve housing 733a, 733b, which in turn ejects the engaged bolt 70 out of the aperture 750a, 750b of the front cover 703a, and the rear cover 703b respectively. The Left-Side-Plate assembly may comprise of the following components, a left side plate 753, whereby the back of the side plate may have, stud like protrusions 753a for retaining the left return springs 753s, also a lever pushing rod 753b, wherein the lever pushing rod 753b pushes the upper/lower plank 760a/761a, 760b/761b directly laterally, also a small protrusion that retains a lower left plank arm lateral spring 782, and within the aperture of the arm spring 782 on the other side is the rod portion of the lower plank left side arm 761a which is now part of the plank, whereby the left side arm 761a engages with the left side of the lower plank 761. The Right-Side-Plate assembly may comprise of the following components, a right side plate 754, whereby the back of the side plate may have, stud like protrusions 754a for retaining the right return springs 754s, wherein a lever pushing rod 754b pushes the upper/lower plank 760a/761a, 760b/761b directly laterally, also a small protrusion that retains a upper right plank arm lateral spring 783, and within the aperture of the arm spring 783 on the other side is the rod portion of the upper plank right side arm 760a which is now part of the plank, whereby the right side arm 760a engages with the right side of the upper plank 760. The lower/upper plank side arm 761a/760a, the lower/upper plank arm spring 782/783, within the first/second outer rear lever housing 792, where the whole combined assembly slides into the cavity of the exterior housings left/right rear corner 772/771 aperture. The below example demonstrates that by pressing one or both side release plates 753/754 does not affect the position or the function of the other as they are both independent. When a left/right side release plate 753/754 is pressed in, the left/right lever pushing rod 753b/754b engages with upper/lower plank engaging arm 777/776, were it then engages with the upper/lower plank 760a/761a, 760b/761b, were the upper/lower plank 760a/761a, 760b/761b respectively engages with the two upper/lower plank rear engaging arms 757a/758a, 757b/758b, whereby the end of the upper/lower plank 760a/761a, 760b/761b on the opposite side of the pressed side release plate 753/754, pushes against the upper/lower plank side arm 760aa/761aa, 760ab/761ab, were then the upper/lower plank arm spring 783/782 compressors and the upper/lower plank side arm 760aa/761aa, 760bb/761bb each engages with the right/left side release plate 754/753 respectively. Once the pressure has been taken off, on the left/right side release plate 753/754 that was pushed in, the upper/lower plank arm spring 783/782 then expands back forcing the upper/lower plank side arm 760a/761a in a lateral direction towards the left/right side release plate 753/754 that was pushed in, pushing against the upper/lower plank 760/761, whereby the upper/lower plank 760/761 returns to its normal position, the compressed ball release rod springs 787 that now have re-expanded, forcing down on the ball release rods 788, and the rods rear engagement flanges 789, where they engage and push down the upper/lower front engaging arms 779/780 and with the upper/lower plank rear engaging arms 757/758 pushed back down, the upper/lower plank engaging arm 777/776 returns back to its normal position, and the left/right side release plate 753/754 that was pressed, now returns to its released position.

One of the methods of disengaging the front cover 703a, or the rear cover 703b, is with the device 700 adapted with a Standard Front Cover configuration. By pressing the Left-Side-Plate and/or the Right-Side-Plate, where it actuates the Rear-Lever and Plank-Release-Mechanisms assembly. With the above action taken it will then actuate the front cover 703a, and/or the rear cover 703b to move away from the exterior housing 701 which also moves the respective sleeve housing 733a, 733b away from the cylindrical tube housing 714a, 714b respectively, which forces the ball-bearings to retract into the respective recess 739aa and 739ba, the first group of locking balls 722aa, 722ab respectively move laterally away from the respective central cavity 715a, 715b into the respective recess 739aa, 739ab and the second group of locking balls 722ba, 722bb each move laterally away from the ball-retention surface 749ca, 749cb into the recess 739ba, 739bb. Once the ball-bearings 722aa/722ba, 722ab/722bb have each moved into the blocks recess 739aa/739ab, 739ba/739bb, and have each vacated the cavities 749ba/749ca, 749bb/749cb, whereby allowing the front cover 703a and the rear cover 703b to disengage. With the compressed sleeve housing springs 732a 732b now expanded and having each forced the sleeve housing 733a, 733b and front cover 703a and the rear cover 703b to an out/released position. With the springs 732a, 732b extended, and the springs 787a, 787b as well extended, the retention forces retain the ball-bearings 722aa/722ba, 722ab/722bb within their second positions and the sleeve housings 733a, 733b each held out to its outer most position, and retained there by the C-clip 736a, 736b.

For locking a standard bolt or a shaft 70, in a device 700 with a Standard Front Cover and/or the rear cover configuration, the bolt or shaft 70 is suitably sized with at least one concave mounting portion 72, as shown in FIG. 38C, for receiving the first group of locking balls or ball-bearings 722aa, 722ab. With the device in a disengaged, and Out position, the bolt or shaft 70 may be inserted into the device 700 via the aperture or cavity 750a at the front or the aperture or cavity 750b at the rear. At the same time, a user can start pushing down on the front cover 703a and the rear cover 703b, or use an external force to push down on the front cover 703a and the rear cover 703b. Because the side walls of the bolt or shaft 70 occupy the cavity 715a, 715b, the ball-bearings 722aa, 722ab cannot yet return back to the first position within the cavity 715a, 715b. By continuing to push down on the front cover 703a and on the rear cover 703b, will also assist in locking the bolt 70 within the concave portions 72 of the bolt. With the bolts concave portion 72 now reaching, and in line laterally with the ball-bearings 722aa, 722ab, the respective concave recess 739aa, 739ab starts to open, where they then fall into the cavity of the concave portion 72 of the bolt 70; with the first group of locking balls now in the first position. At the same time, the concave recess 739ba, 739bb as well starts to open, the front cover 703a and the rear cover 703b are now engaged; with the second group of locking balls also in their first position. With the bolt 70 and the device 700 in an IN/engaged configuration now.

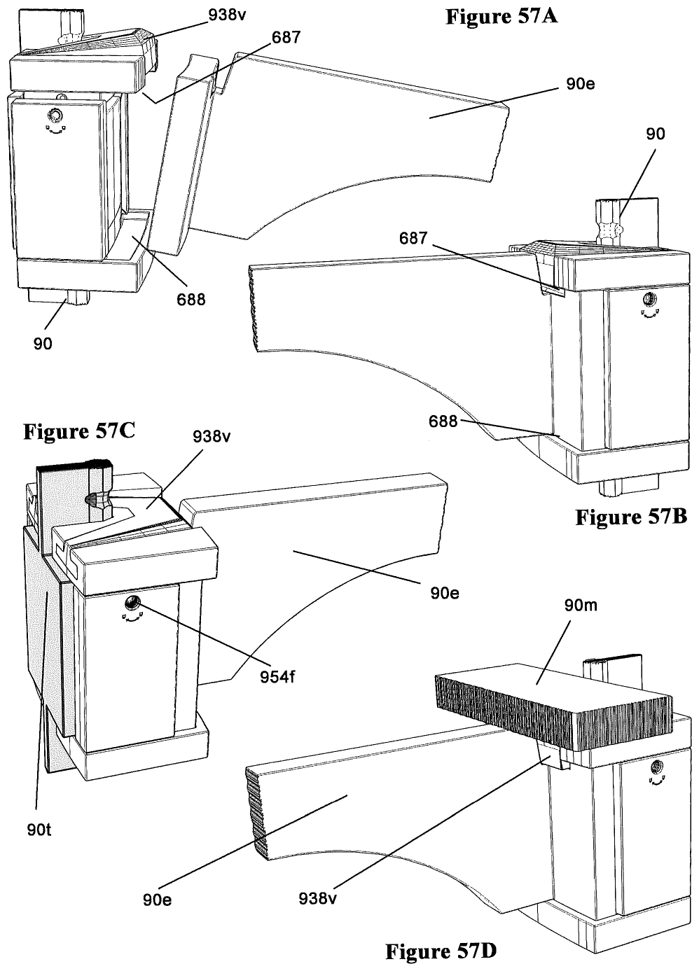

The advantages, of the device 700 are 1) It can be mounted on the bespoke rod and things can be held on to e.g., used as a shelf, as shown in FIGS. 57A to 57D. This is similar to device 800 and device 900 which will be described further below. 2) pushing laterally at least one of the left or right side plates 753/754 of the external housing 701 of the device 700, or pushing laterally the left and right side plates 853/854 of the external housing 801 of the device 800; or pushing laterally the left and right side plates 953/954 of the external housing 901 of the device 900; is that depending on the orientation and placement of the device 700/800/900, there is a convenient and accessible way for which a user can release the front cover 703a and/or the rear cover 703b out. It may be appreciated that for devices 800 and 900, the devices 800 and 900 follow in a similar number system regarding the features or the parts as mentioned or as used for device 700 as described above.

V8

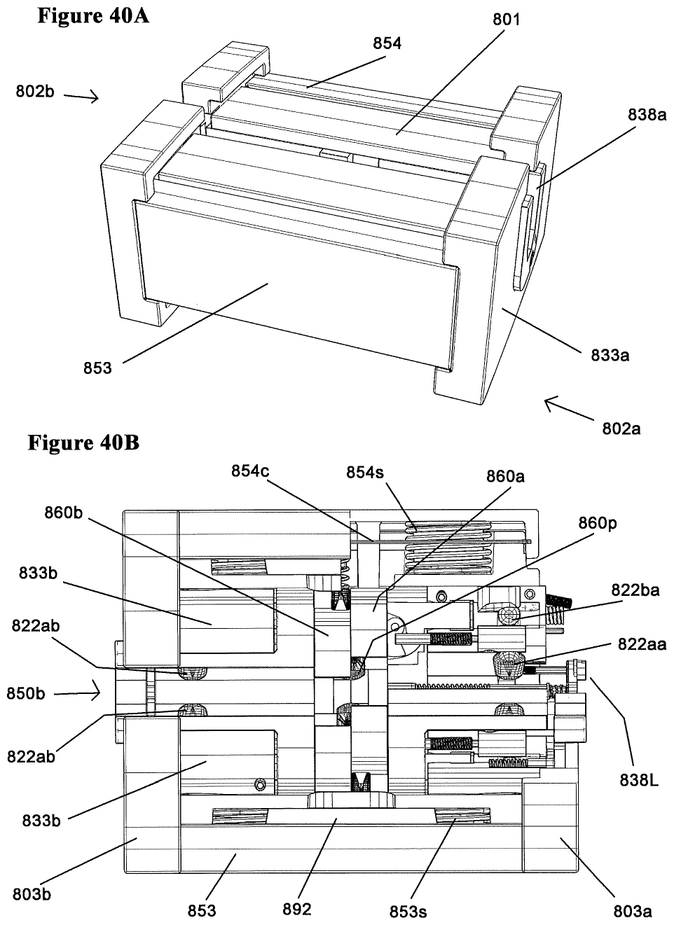

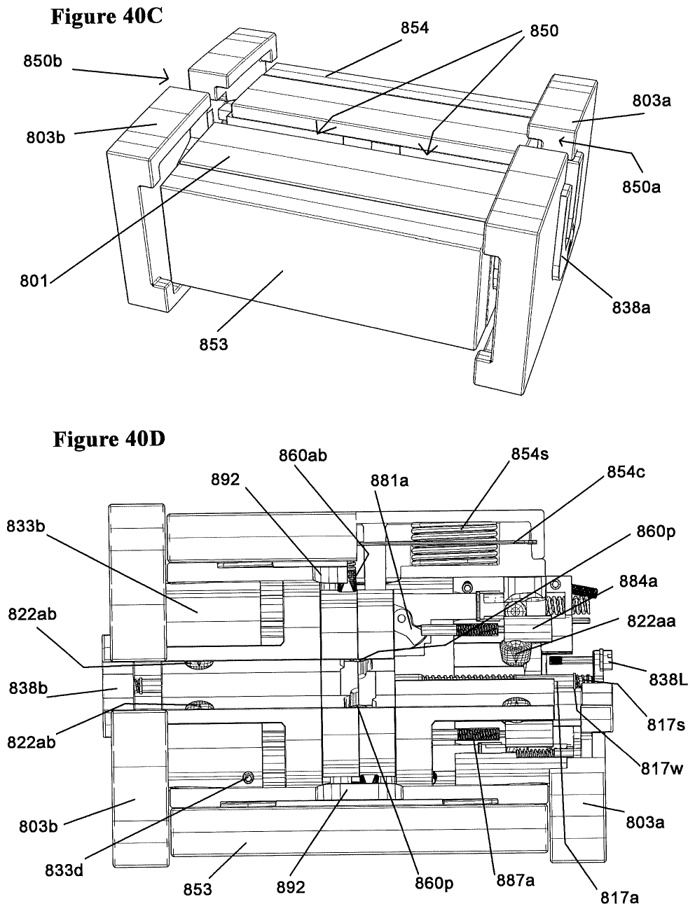

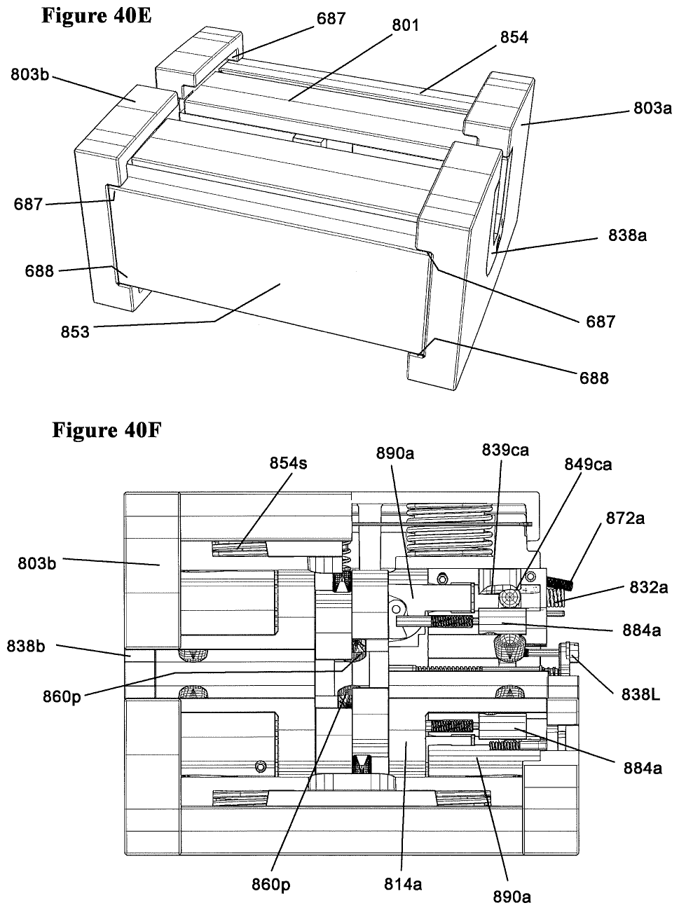

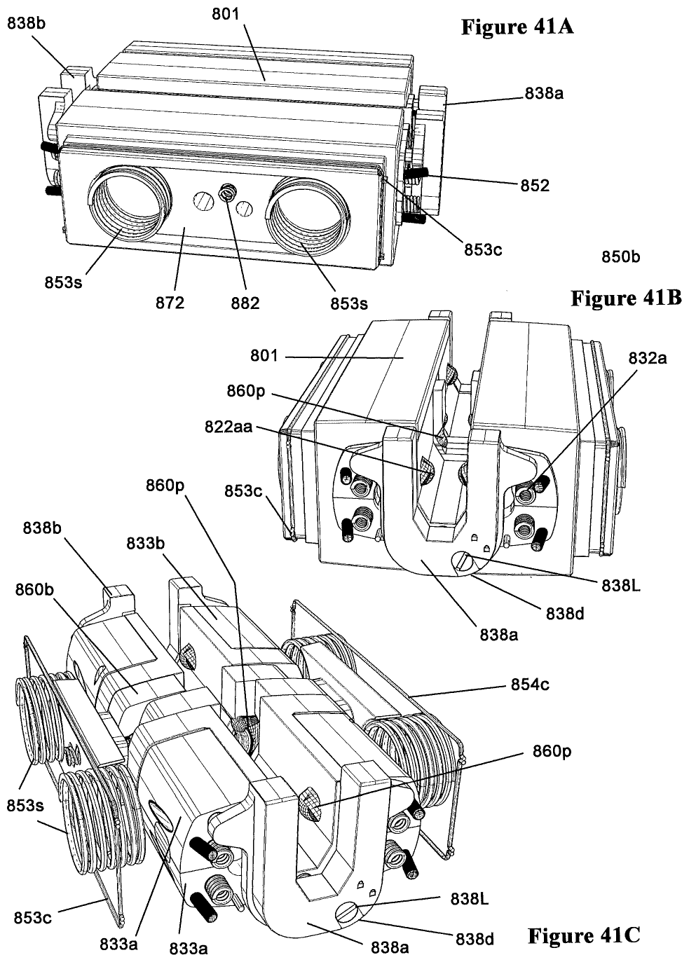

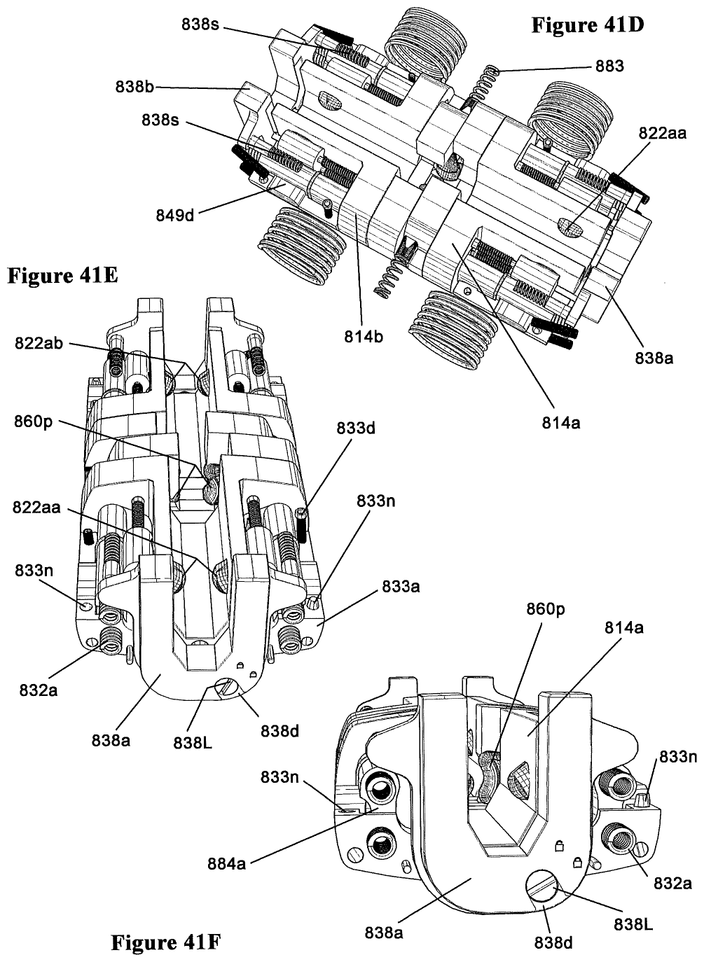

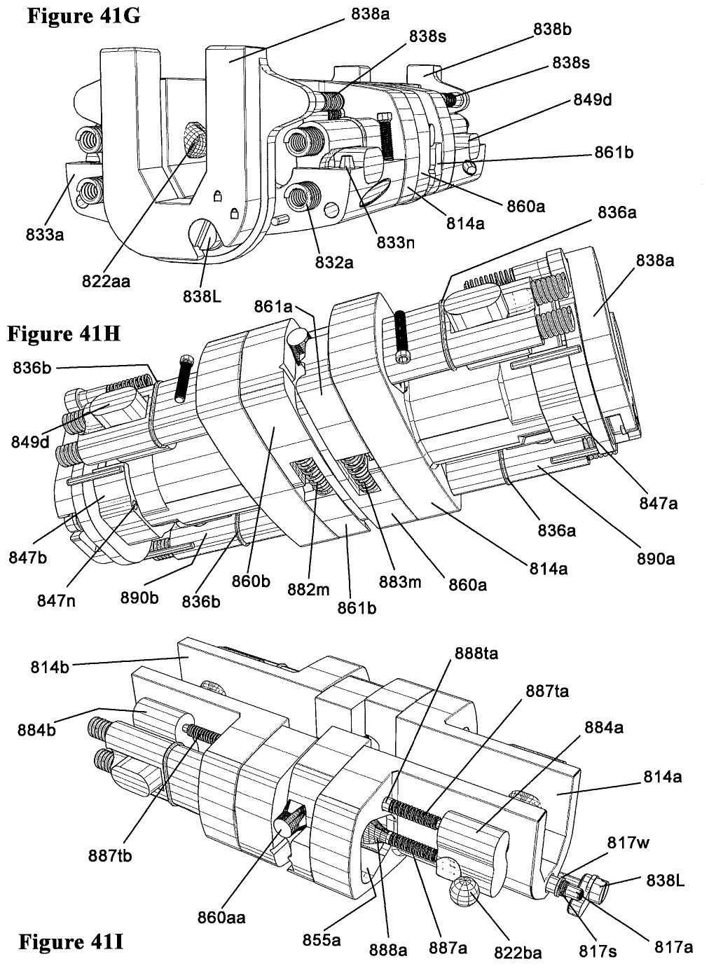

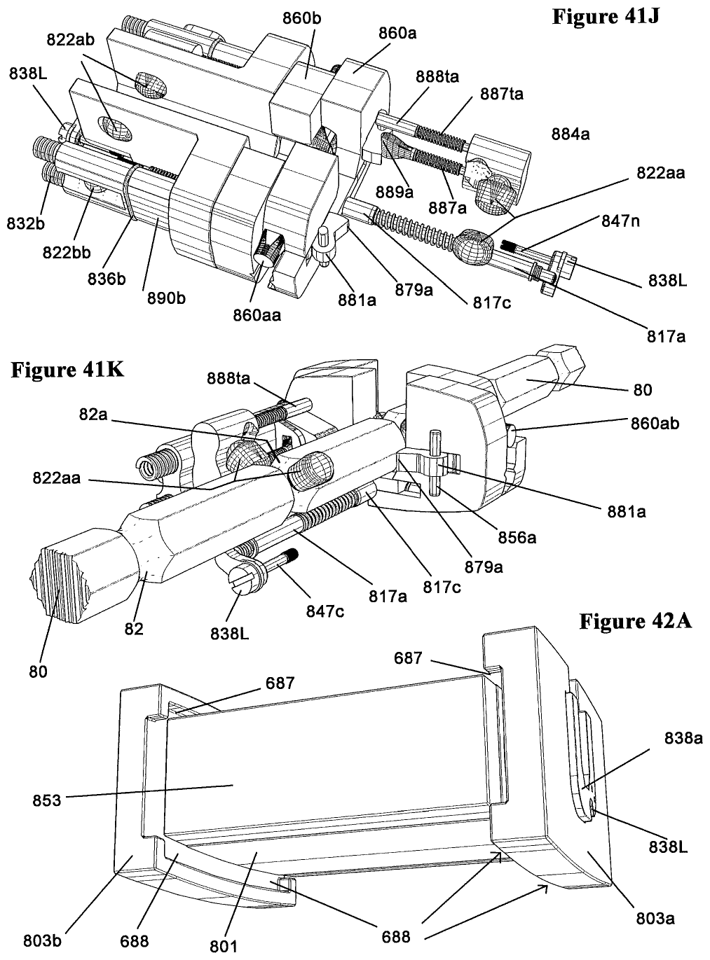

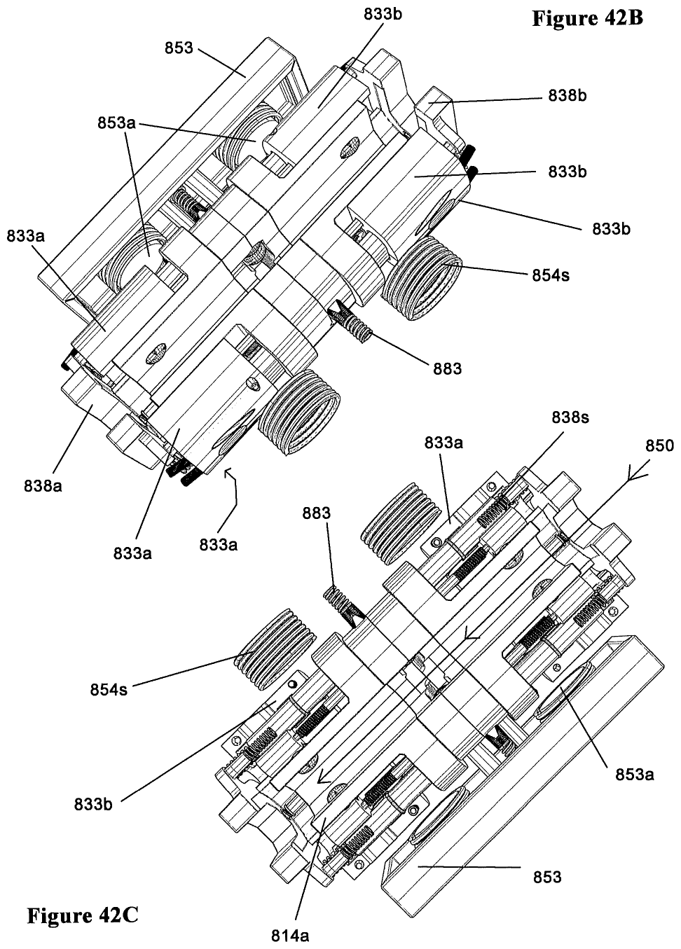

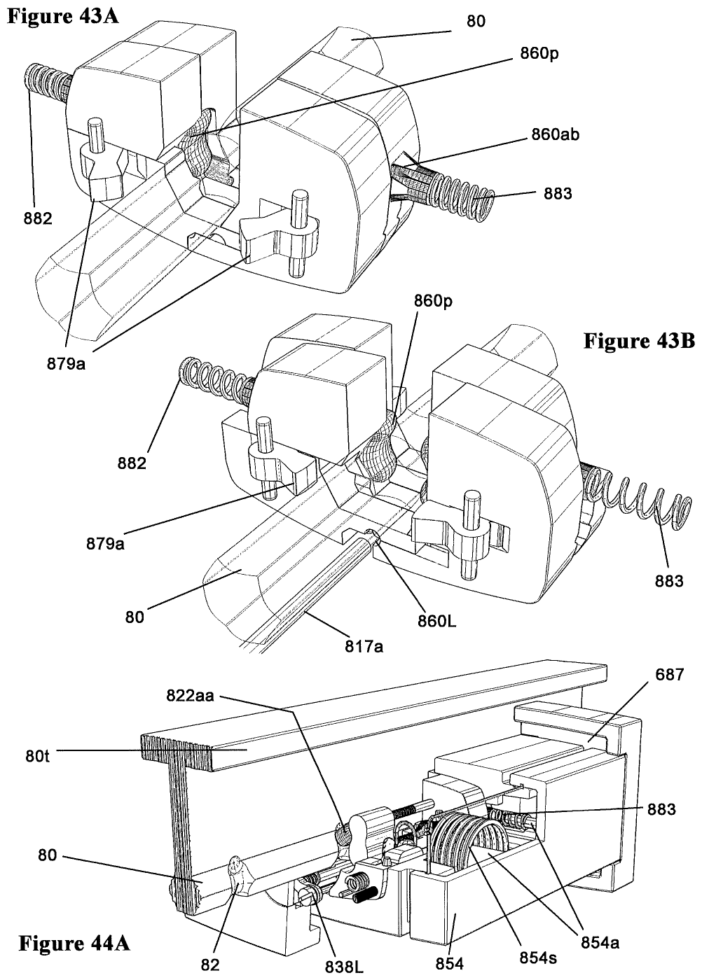

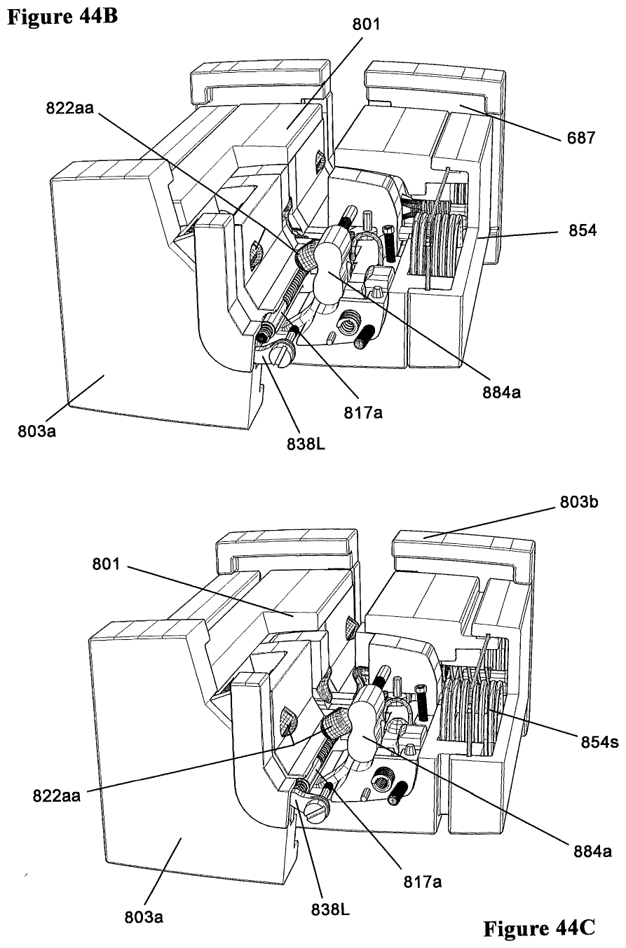

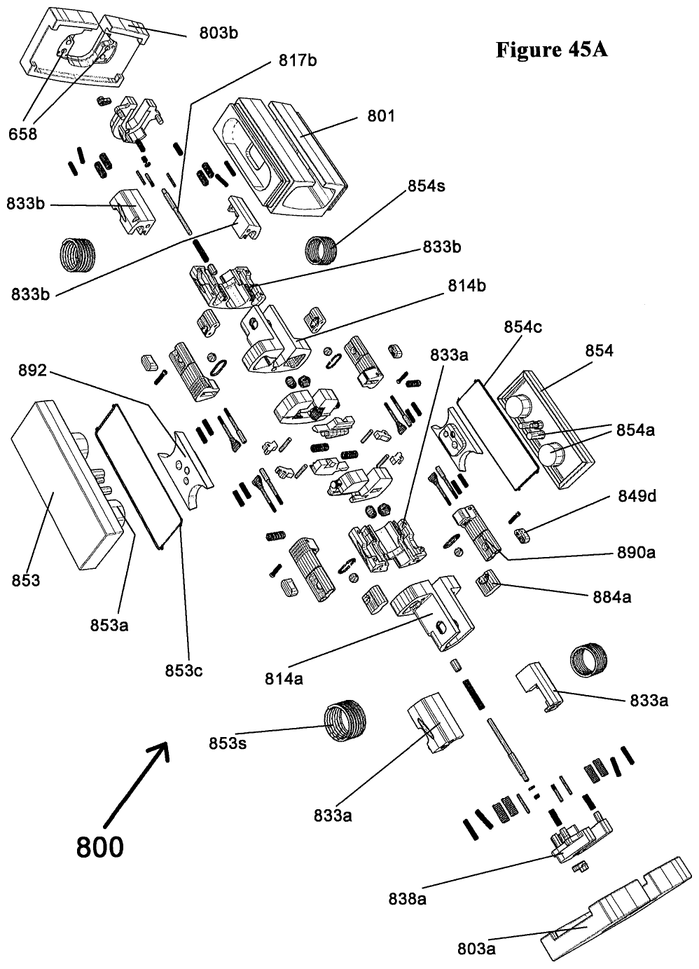

In another preferred embodiment of the invention, as shown in FIGS. 40A to 45A, the device 800 may be similar to the parts used in a preferred embodiment/device 700. As shown in FIG. 40A, the device 800 may have a rear side 802b and a front side 802a, in which the top of the 800 is open to allow a bolt or a bit 80 to be placed within it. The left/first side may be fully occupied by the release plate 853 and the right/second side may be fully occupied by the release plate 854. As shown in top cutaway view FIG. 40B, the device 800 may be in an engaged position with the buttons 838aa and 838ab slightly protruding out or sticking out from the front cover 833a and 833b respectively. The locking mechanism of device 800 may have acorn shaped bearings 822aa and 822ab in and engaged by the locking shape blocks 884a and 884b respectively. As shown in FIG. 40C, the device 800 may have been pressed down on the left and right side release plates 853 and 854. By activating the left and right side plates 853 and 854, it disengages the device 800 to allow the front cover 803a and rear cover 803b to extend out. As shown in FIG. 40D, it shows the device 800 in a disengaged position and the front and rear buttons 838a and 838b slightly sticking out from the front covers. The side release plates 853 and 854 are in a pressed down position with the first and second release levers 881a and 881b forced up by the side release plates 853, 854 and the internal mechanism planks or upper/lower planks 860a, 860b, and 861a, 861b whereby allowing the outer locking shape bearings 822a and 822b to fall in to the cavities of the block 884a and 884b, allowing the front cover 803a and rear cover 803b to extend out and release and thus disengages the unit or device 800. As shown in FIG. 40E, the device 800 may be in an engaged position with the front button and rear button 838a and 838b respectively, pressed down. For example, by the force of an external weight whereby when the locking levers 838L are in an engaged position, the device 800 then cannot be accidentally opened or disengaged. As shown in top cutaway view FIG. 40F, the acorn shaped bearings 822aa and 822ab in a down and engaged position. Also, the internal peanut-shaped engaging arms 860p are also in an engaged position with the side plates returned to their normal position. As shown in FIG. 41A, the device 800 may have two springs on either side of the exterior housing/exterior body 801. The springs 853s and 854s may be evenly spaced to allow the long side release plates 853, 854 to move in and out as necessary. It may be appreciated that the side release plates 853, 854 cannot be removed as they are held in by a respective retaining clip 853c and 854c. As shown in FIG. 41B, the device 800 may have a front ‘U’ shaped button 883a. The front ‘U’ shaped button 883a and the internal body of the device 800 as well as the rear button 883b may allow access for a bespoke bit or bolt 80 to be inserted in. As seen here, the locking lever 838L may be in an unlocked position. As shown in FIG. 41C, the external body has been removed showing the respective two sleeve housings 833a and 833b. It may be noted that on this device 800, the sleeve housings 833a, 833b have been divided top and bottom as well as left and right for the top 3 at the front ‘a’ and 3 at the back ‘b’ and secured together by a retaining bolt 833d. The locking lever 838L in FIG. 41C may be in a locked position. As shown in a partial top view FIG. 41D, the device 800 may be in an engaged position. On each button front and back 833a, 838b, there may be two springs for each button at the top 838s where they rest within an internal aperture of the two top sleeve housings 833a, 833b respectively, allowing the necessary movement of the button in or out, evenly so not to jam up. As shown in FIG. 41E, the sleeve housings may have a matching locating pin and hole 833n, allowing them to line up when placed together. On this device 800, the external part 849c may be now positioned on a separate part 849d, whereby doing so, it allows a greater opportunity to refine the shape so it can hold the bearings 822ba, 822bb firmly in their respectful place, either in engaged or out disengaged position. Also, it may help in the manufacturing of the sleeve housings 833. As shown in FIG. 41F, it may show a front view of the device 800 with the button 833a, shown here with the locking lever 838L in a locked position. The blocks 884a and 884b on this device 800 may be comparatively positioned higher than the previous embodiments whereby it may be an advantage as it may allow the use of an acorn type bearing to be positioned on a diagonal position, whereby it may hold the bolt 80 or a bespoke bolt 80 firmly in place. As shown in FIG. 41G, the locking level 838L may be in an unlocked positioned. The retaining fasteners 872a, 872b that secure the sleeves housings 833a, 833b onto the front cover 803a, 803b with the fasteners 872 now removed, showing the access fastener aperture 840a have a side access hole for securing 833 and 803 together on the sides of the sleeve housing, is an advantage as it then prevents the need to secure the front cover from the front face, whereby having a cleaner look to the device 800. As shown in FIG. 41H, the underside of the device 800 is shown, where in the centre are positioned four release planks two for the front, 860a, 861a, and two for the rear 860b, 861b, where each combination having underside spring to assist in the returning them to their normal resting position once pushed in. As shown here the front of the ball release lever housing 890a, and 890b that are adjacent to the ball retention block 849d, having a concave cylindrical shape whereby allowing a greater ease in manufacturing and as well a better free movement for the bearings 822ba and 822bb. As shown in FIG. 41I, is a better view of the front locking lever 838L whereas can be seen it is in a unlocked position with the bit cylinder rod 817 in a furthest most forward position, where it is not engaging with the plank aperture securing hole 860L as well as can be seen the larger block 884a, 884b showing the recessed position for the ball bearing 882ba. Each block 884 having a top and bottom ball release rod 888, 888t and two ball release rod springs 887, 887t, to assist in the movement necessary for the function of the 884 blocks. As described in previous versions this functions in the same manner. As shown in FIG. 41J, now showing a more exposed view, where it can be seen the bit cylinder rod 817a and the spring 818a forcing the rod towards the front 802a position. The rear of the bit cylinder rod there is a hollow loom tube where the rod precipitates within it, depending on the position of the front locking lever it either engages with the locking aperture 860L for the front planks 860a and 861a. Also shown is the ball release levers 881 where they are no longer a scissor lever but now a one piece for each side, when pressing the two side plates 853, 854 in whereby forcing the planks to abut against 858 portion whereby pivoting 879a and 879b respectively against the ball release rod 888a, 888b resection 889a and 889b respectively forcing the block 884a and 884b to move into the cylindrical shaped forward section 885a and 885b that way allowing the concave cavity 839aa and 839ab to move forward where the inner acorn shaped blocks will fall into allowing the bolt 80 to be released. As shown in 41K, the locking lever 838L is directly in front of a locking lever securing screw 847n where it is inserted within a rear button guide 847a, 847b, securing the lever in position but still allowing it to move in a locked or unlocked position. This FIG. 41K also shows a better view of the acorn shaped bearings 822a and the Unseen bearings 882b where it is in an engaged locked position securing the bolt 80, preventing it from falling out. This device can be rotated or used in any position, so long as the side plates are not pressed in, a bespoke bolt cannot exit the device 800, also if the locking lever 838L is in a locked position whereby pushed into the locking aperture 860La and the rear locking aperture 860Lb and with the front or rear button 838a or 883b respectively, in a position pushed down, as shown in FIGS. 40E and 40F the bespoke 80 blot cannot be released or exit the device 800. As shown in FIG. 42A, it shows the front and rear covers 803a 803b inner cavity securing section 688a, 688b and 687a, 687b where the purpose of this device 800 when in a locked position and external apparatus is inserted between above-mentioned cavity, securing the peace, and preventing it from exiting the device 800. Further example images can be seen similarly on another embodiment of the present invention, the device 900. As shown in FIGS. 42B and 42C, is a top view of the device 800 showing the internal cavity 850 with the device in a disengaged position. As shown in FIGS. 43A and 43B is the plank assembly in a disengaged position FIG. 43A and in an engaged position FIG. 43B, we're on the first image as can be seen the locking aperture 860L is closed and on the second image when the device 800 is in a normal position the locking aperture is in an available open position to allow the bit cylinder rod 817a or 817b respectively to enter the cavity 860La or 860Lb respectively. As shown in FIGS. 44A to 44C, the device 800 is shown with a bespoke T-shaped bolt 80t (further examples will be shown in the 900 device) the second two images 44B is a cutaway view of the device in an engaged position with the acorn shaped 822aa and 822ab and the peanut-shaped 860p in a disengaged position, and with the below image 44C showing them in an engaged position. As shown in FIG. 45A, is an exploded view of the device 800.

V9

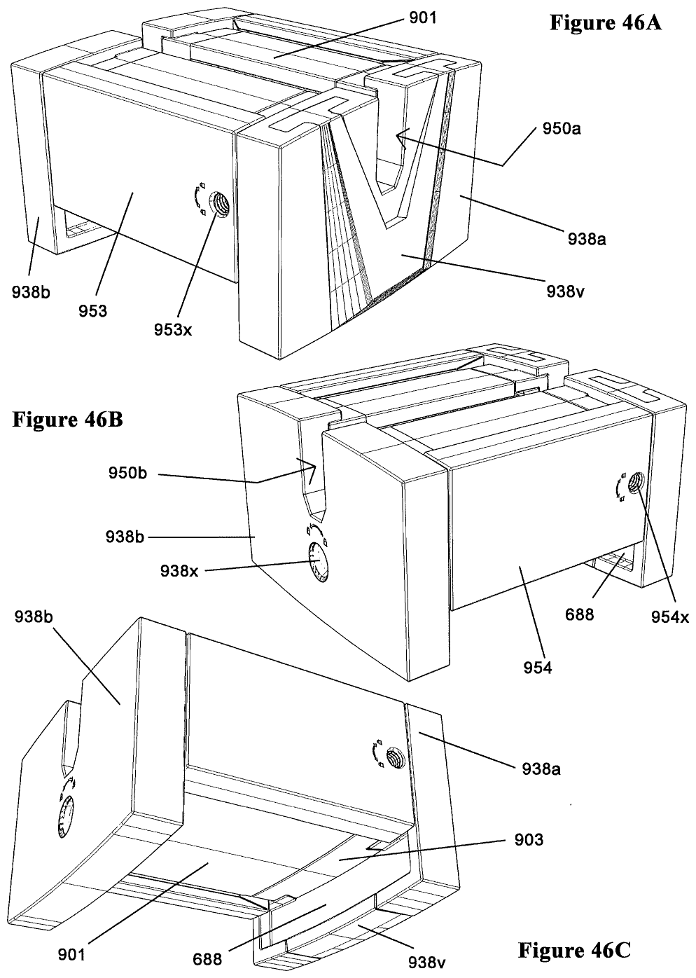

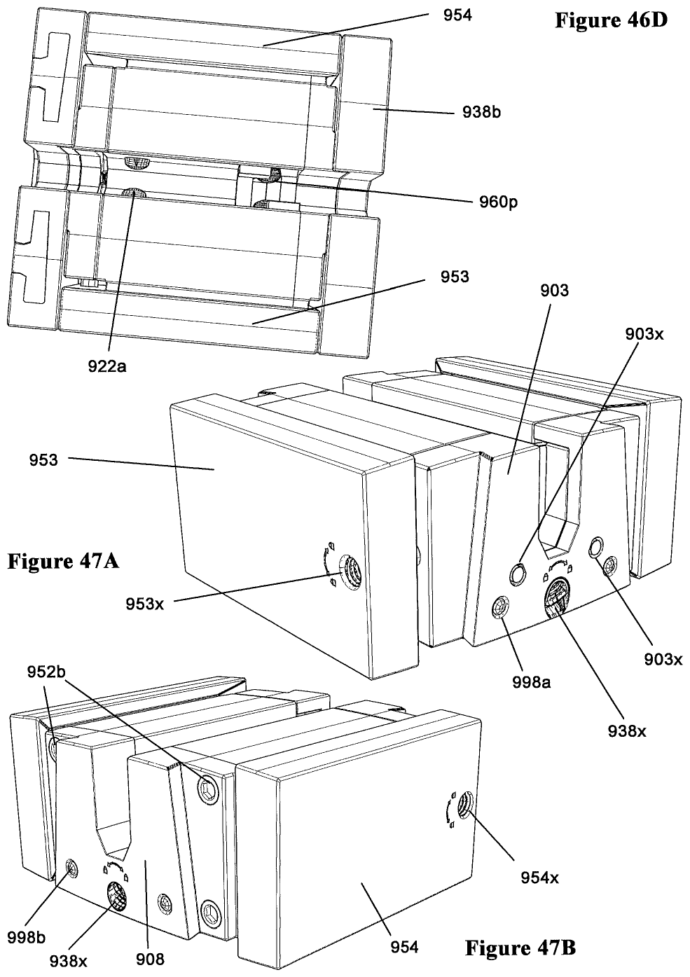

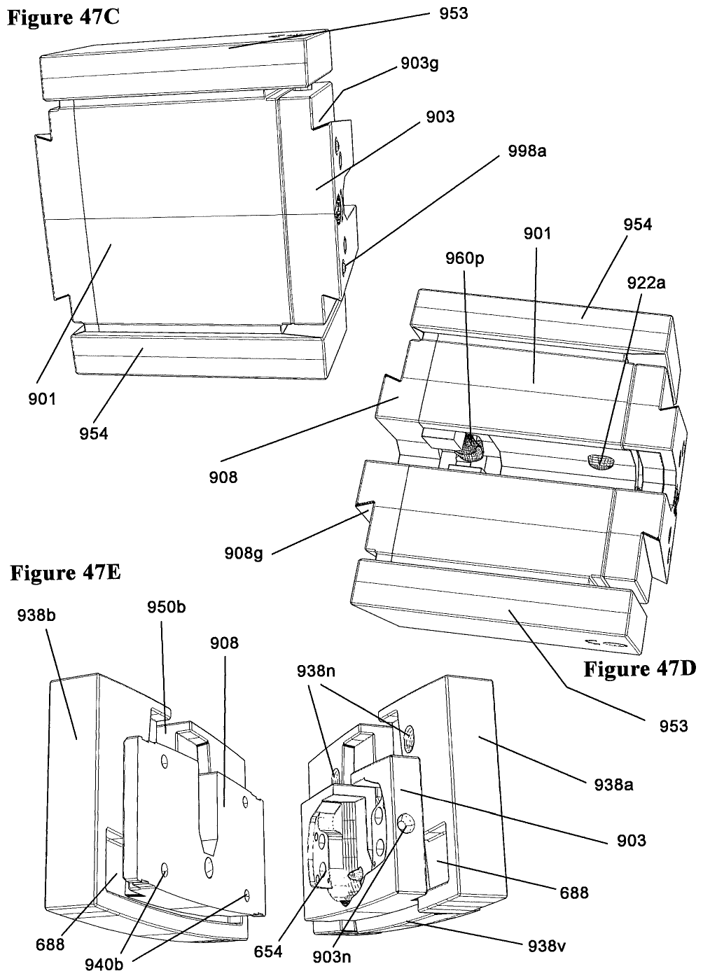

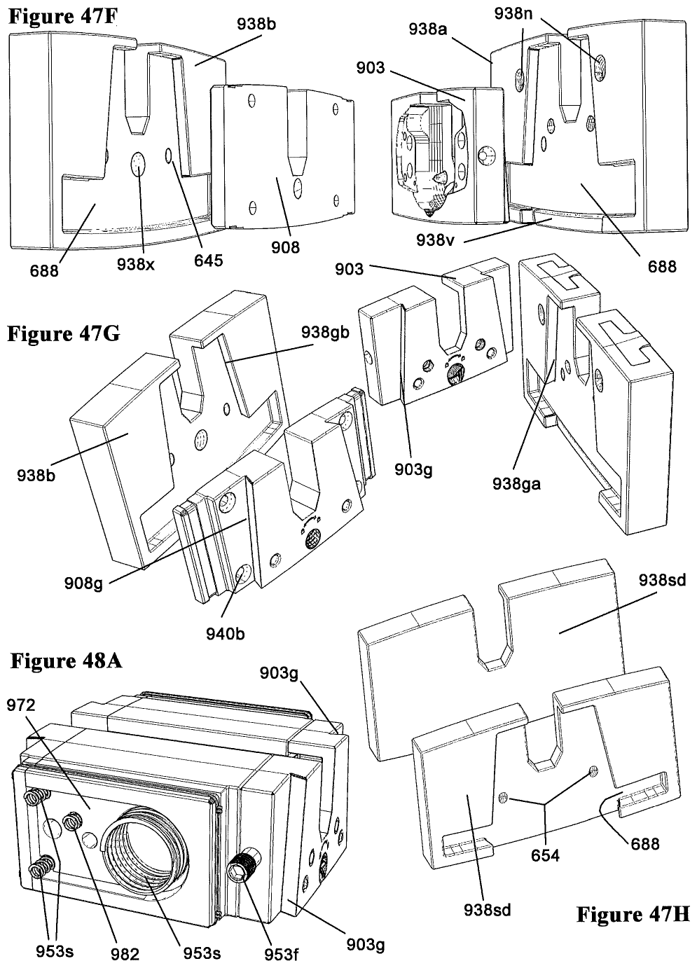

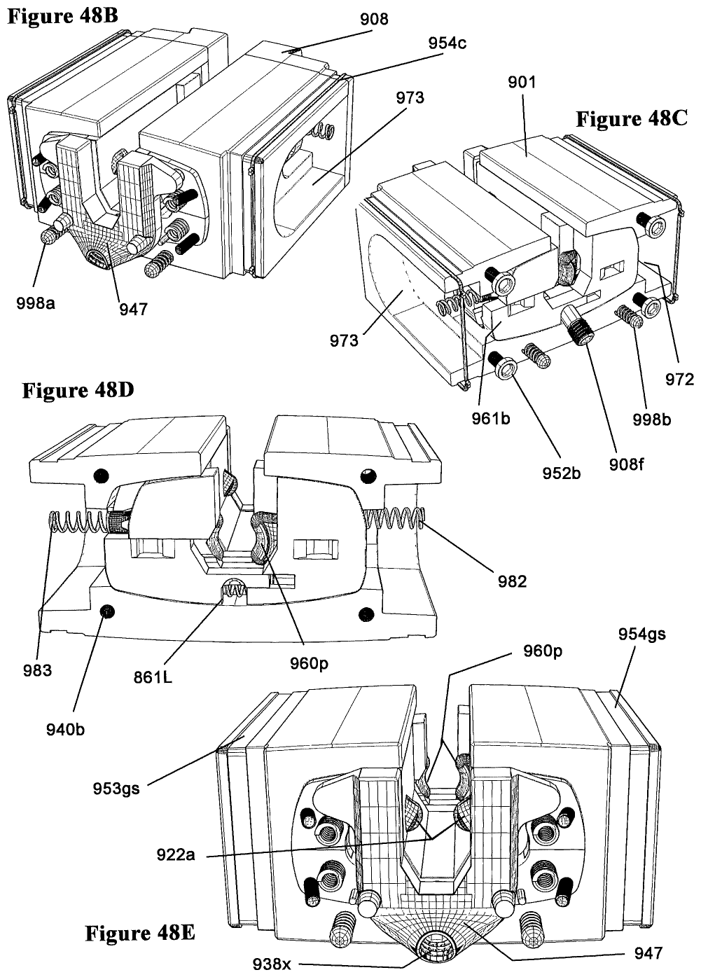

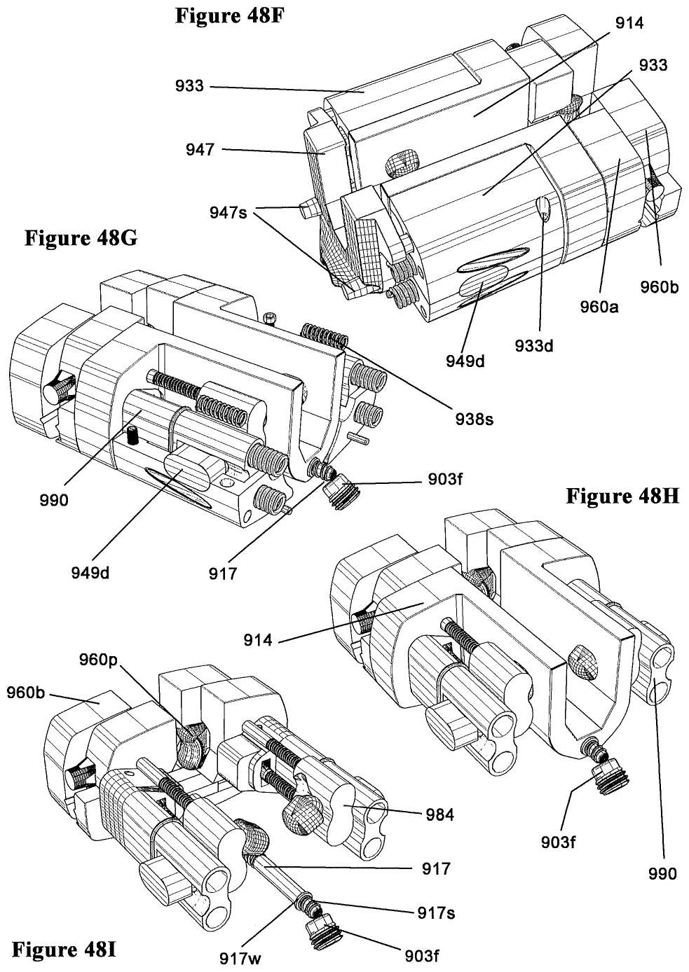

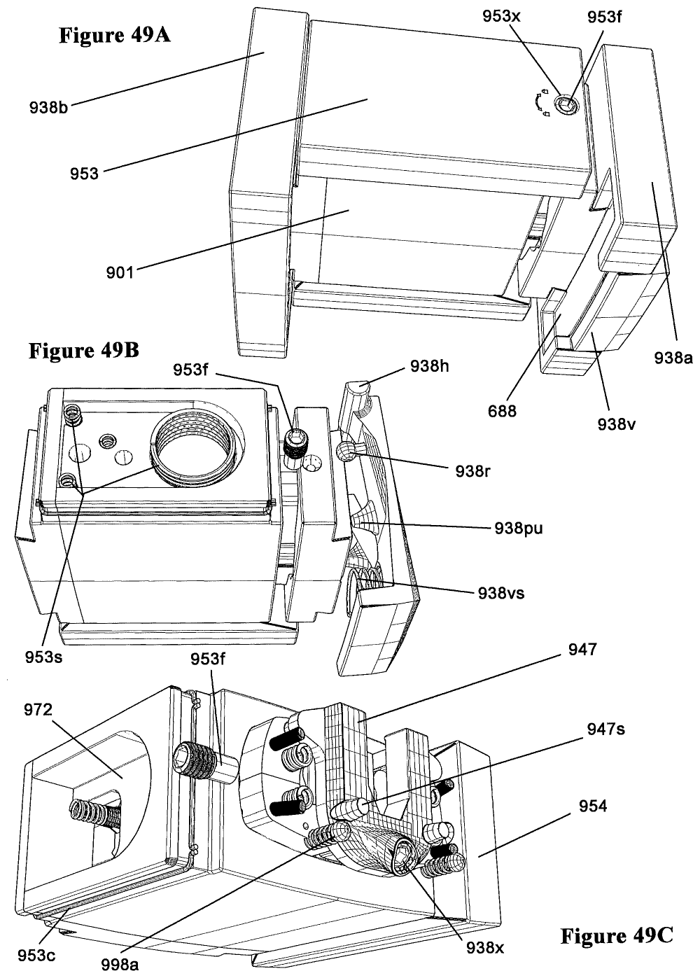

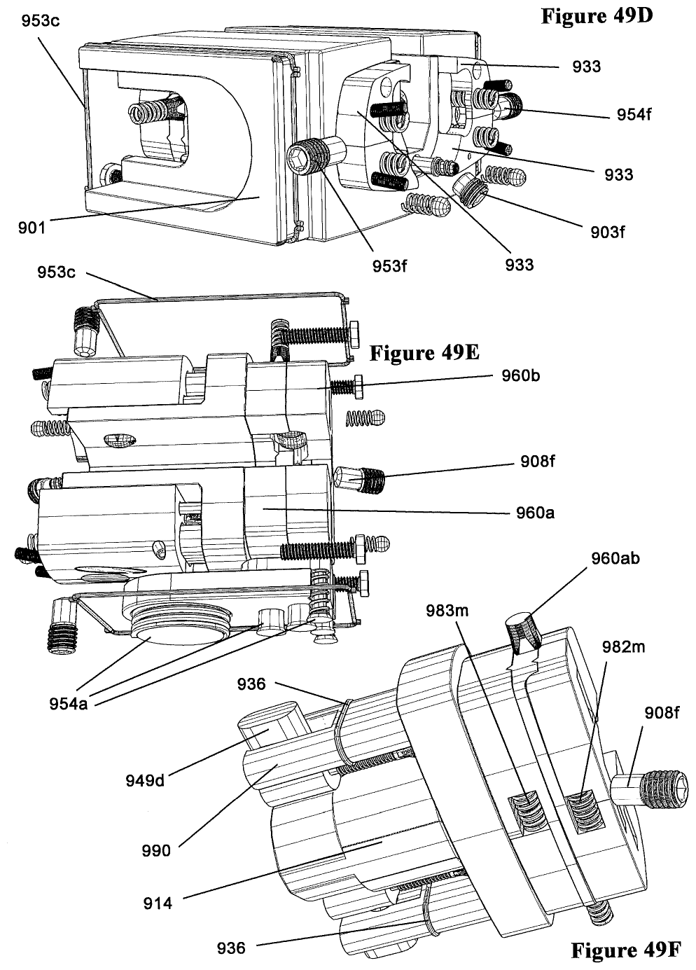

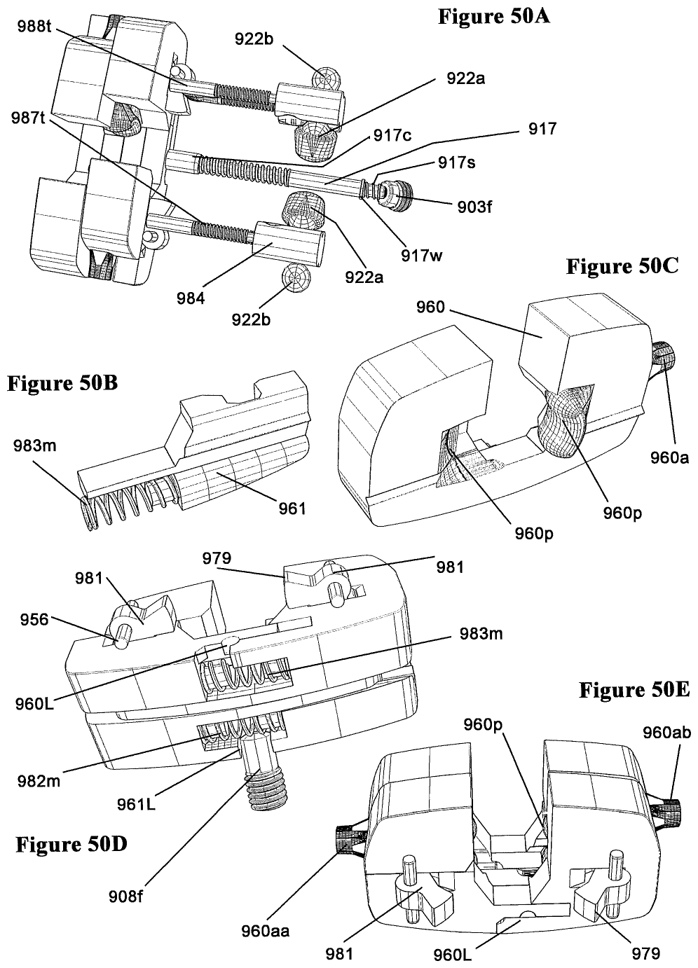

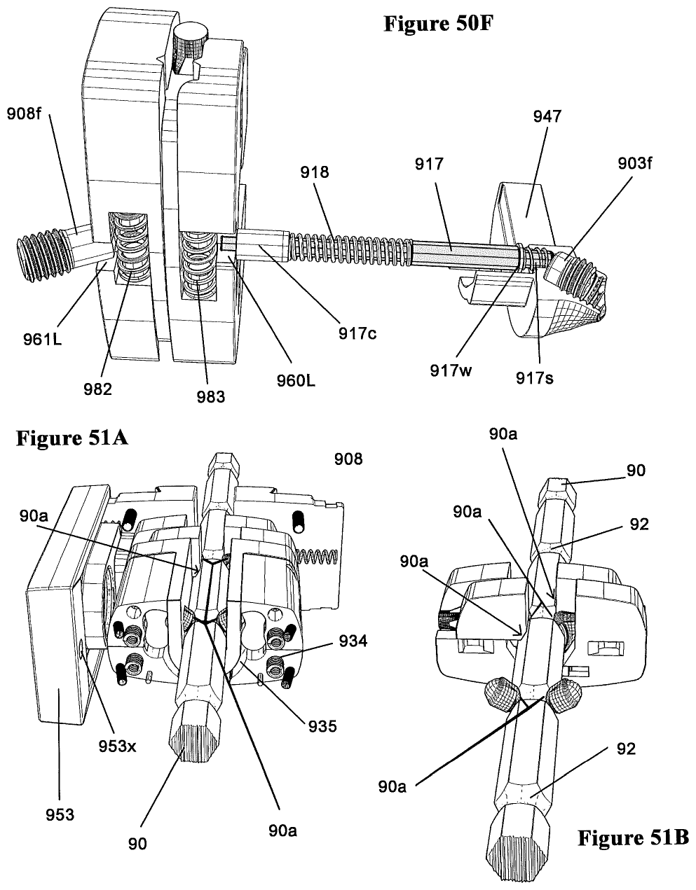

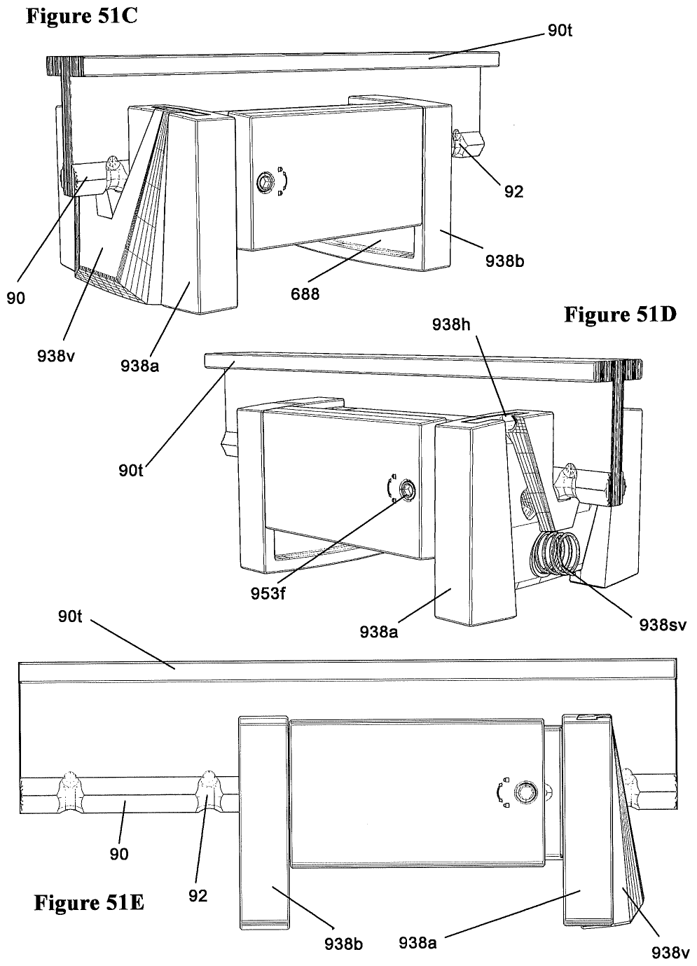

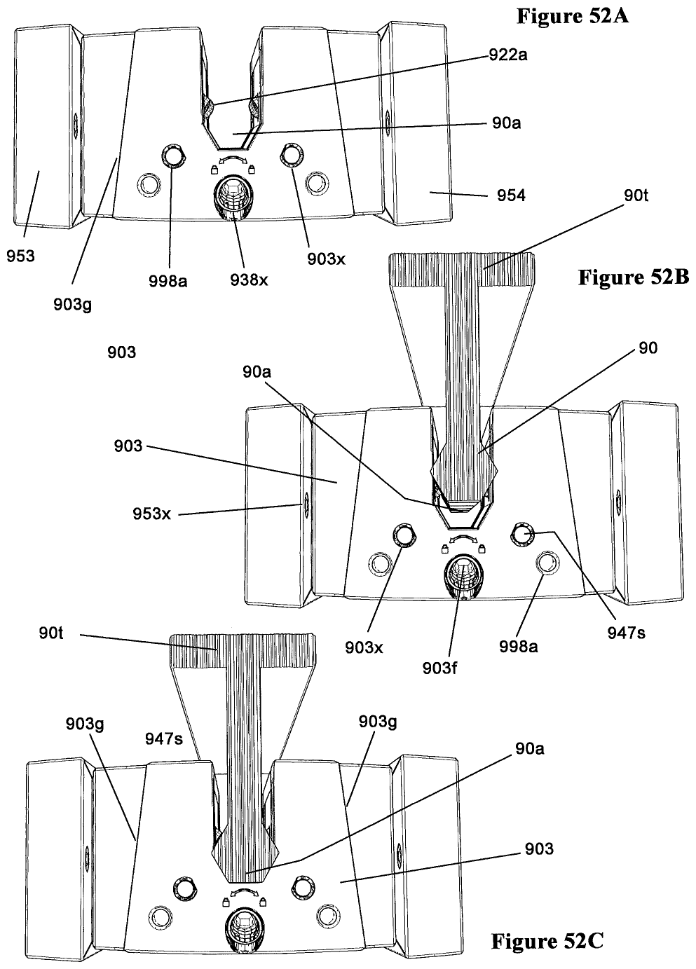

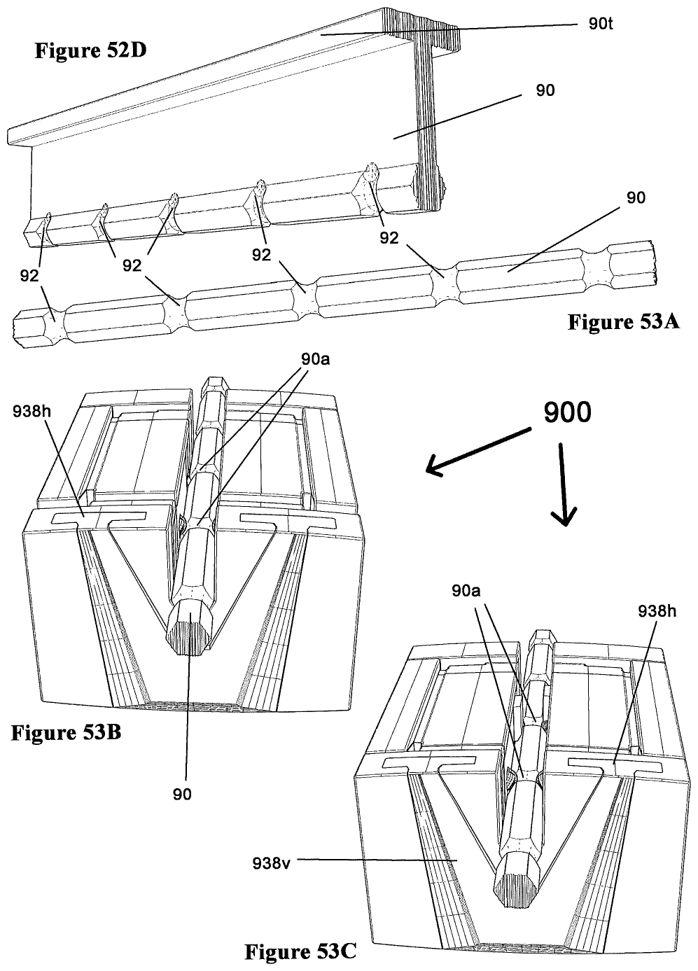

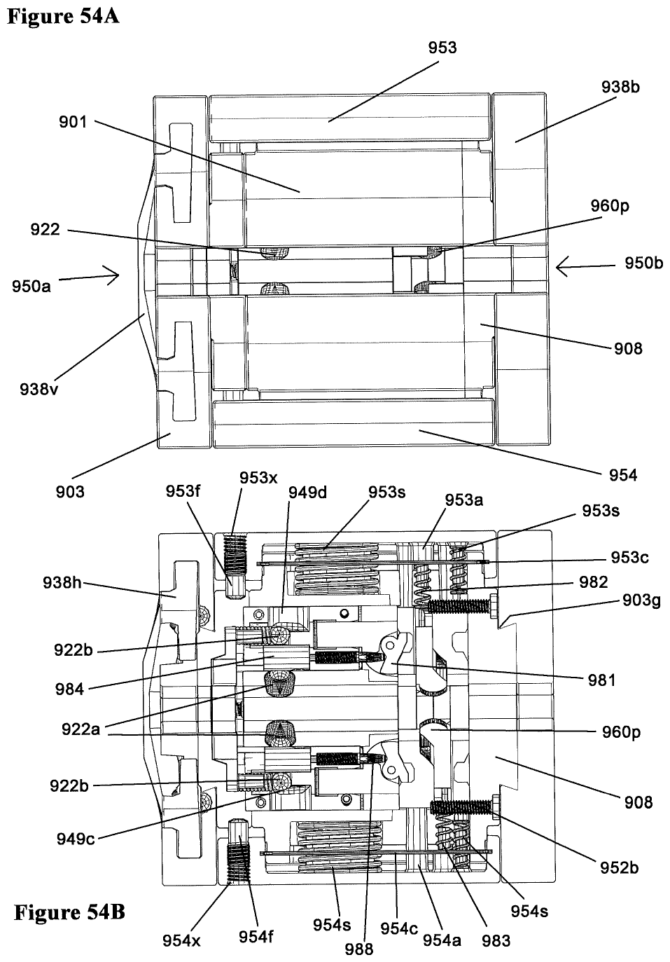

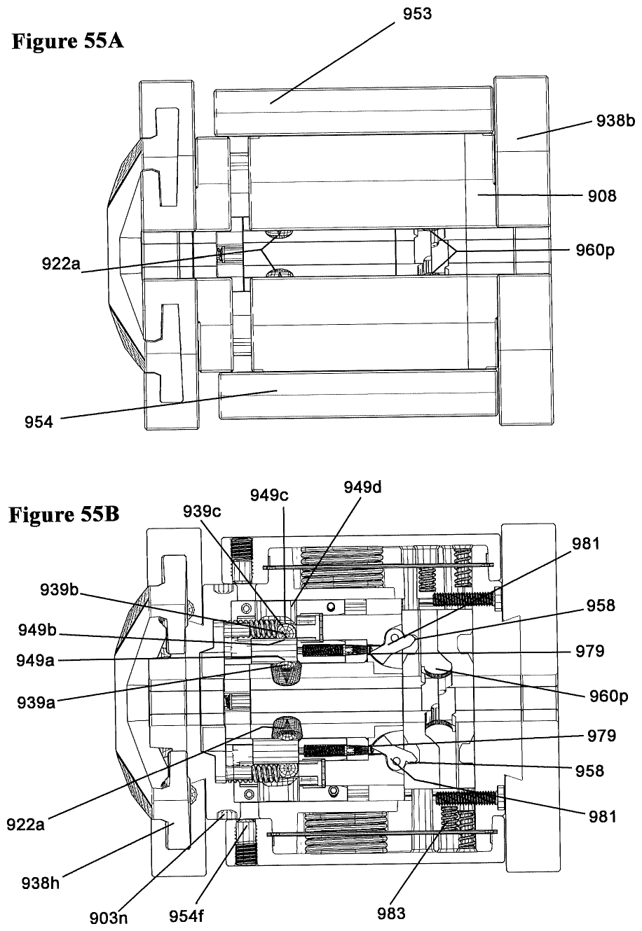

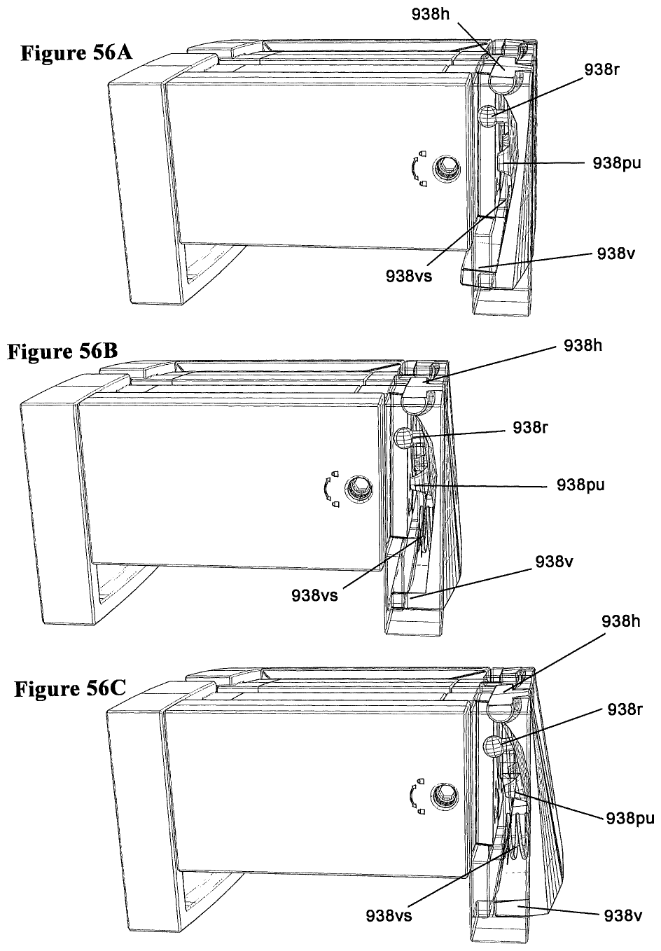

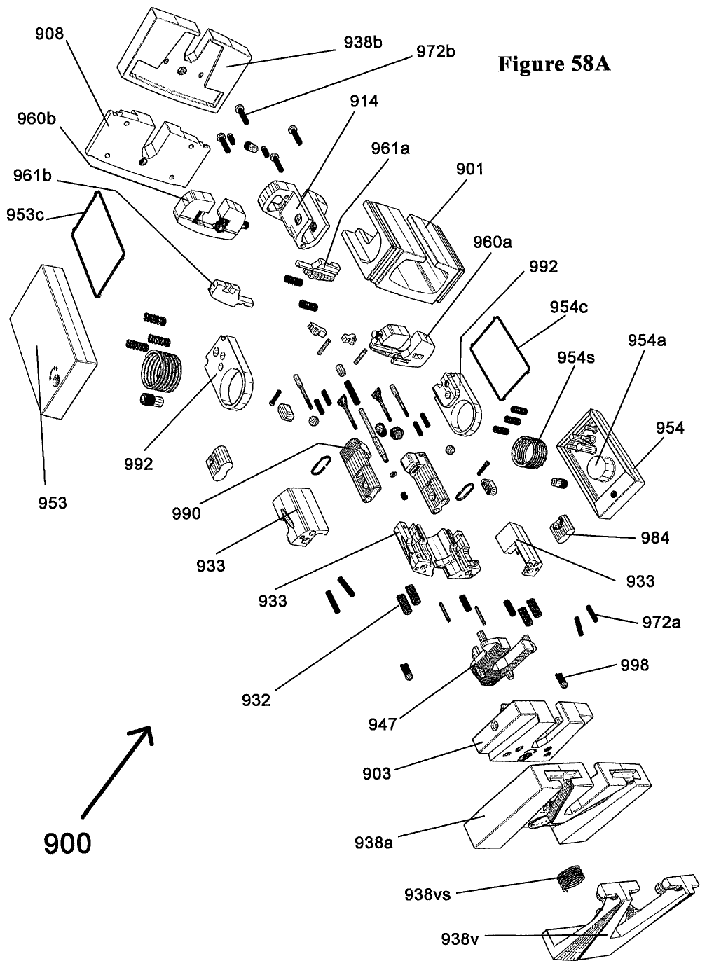

The advantages of the device 900 over the previous two versions is that it's of a more compact unit having only a single internal functioning section as with previous versions like the 500 but this device has a ‘U’ shaped aperture like the previous one but been a more compact unit it actually has more functions within it as will be explained further on. As shown in FIG. 46A, is an exterior view of the device 900 with a front and rear slide-off cover button 938a and 938b, the side release plates 953 and 954 have a locking mechanism built within it, as will be explained further on. As shown in FIG. 46B, is the rear side of the device 900 showing the rear cover 938b, having an access hole 938x to insert a tool to lock or unlock the device. As shown in FIG. 46C, the underside of the device 900 having a greater available space 688a and 688b to secure an external object. As shown in FIG. 46D is a top view of the device 900 where it can be seen having two internal locking positions for a bespoke bolt 90 the front ones are the 922a acorn shaped bearings, similar used as with the previous version and at the rear planks is the 960p, similar to the previous version. As shown in FIG. 47A, the front and rear covers 938a, 938b have been removed showing the internal front cover 903, 908 both having a stepped front section tapered narrower towards the top where the complementary shaped front cover 938a, 938b slides onto the button ball plunger 998a, 998b secure the front/rear cover. Shown here are too small apertures 903x where the front locking lever plate 938v abuts next to. As shown in FIG. 47B, is the rear of the device showing the rear face 908, similar to the front this also has a 998b button ball plunger and an aperture hole 938x to access the rear locking grub screw 908f. As well this cover is tapered in towards the top. The two above Figures also show the locking assembly 953x and 954x where they are Incorporated within the side release plates 953 and 954 respectively. As shown in FIG. 47C, is the underside of the device 900, with the two covers removed the front cover 903 and the rear cover 908 can be seen with the tapered slide-on section greatest at the bottom. Meaning you slide the button covers 938a, 938b from the top of the device 900 and security them down into place. Once a bespoke 90 bolt or similar has been inserted into the device it is impossible for the remove or accidentally sliding off the two covers 903 and 908, as can be seen on a 900 Figures. As shown in 47D, is the top of the device 900 shown in an engaged position. As shown in FIG. 47E, is a cutaway disassembled view of the front and rear components of the device 900 the front section having three major parts 938a, 938v and 903 with the rear 938b cover shown here attached onto the rear cover 908. As shown in FIG. 47F, in this image the components have been pulled apart with the front cover 938a away from the internal cover 903 by means of sliding the unit up and releasing the cover 938a from the device 900. As can be seen at the inside is the securing notches 645. Similarly, the rear cover 938b as well slides up to release and move away from the rear cover 908 and also have the securing notches 645. As shown in FIG. 47G, the components have been rotated to show the mating shapes between the two 938a and 903, and 938b and 908, where it allows them to slide together. As shown in FIG. 47H, these are an alternative slide on cover button without all the extra locking components just the standard flat face with thinner cavity 688 to attach an external device. It can also be noted and appreciated that these is not limited to this shape any shape can be adapted to the device 900. As shown in FIG. 48A, the side release plates now removed showing the internal spring 953s and two smaller springs 953s, that allow the movement of the side plate to return to its normal position. Positioned on the front cover 903 is the locking grub screw 953f and on the other side 954f, where once they are screwed clockwise it's forces against the front cover 903, preventing the side plates to be pushed down whereby not able to disengage the device. As a second security the grub screw 953f and 954f secured against the front cover 903 and into the recess side holes 903n, whereby preventing the front cover 903 being able to move up and disengaging the device 900. As shown in FIG. 48B, it shows the exposed front section where a front button guide 947 can be seen, also on either side laterally are the ball plungers 998a similarly the rear cover 908 also has the ball plungers 998b. As shown in FIG. 48C, the device 900 may have the rear cover 908 removed showing the rear planks 960b and 961b with the locking grub screw 908f secured within them. As shown in FIG. 48D, as the previous, this image is the rear section with the rear planks in the engaged position clearly showing the peanut shaped securing sections that wrap around and secure on to the concave shape 92 of a bespoke device/bolt 90, also shown is the rear aperture hole 861L that a 900 device has. As shown in FIG. 48E, the device 900 shows a front view and a disengaged position of the device 900. Laterally on the sides are two grooves 953gs and 954gs where a retaining C-clips 953c and 954c, which are attached to the inner side of the side plates, when forced into position can no longer be removed but able to move a predetermined distance to allow to disengage the device 900. It can also be noted that this device can be of any shape and size and if necessary the external side plates can extend further away and still be able to disengage the device 900, similar to previous versions. As shown in FIG. 48F, it shows a top perspective view of the sleeve housing 933, with this device there are three parts, a left 933 a right 933 and a bottom 933, where they are secured together with securing bolts 933d. On either lateral sides there is a ball retention block 949d where it replaces the previous version 500 type where it was incorporated within the sleeve housing, by having it as a separate section and making the three sections for the sleeve housing separate allows for greater use across all the devices for example the same bottom part 733, 833 and 933 is used for the 7, 8 and 9 version, and the two top sections 933/833 are used for the 800 and the 900 version. At the front of the button guide 947 are two extend notches 947s which allows the movement of the button 947 to move down into a locked position, forced down by the front locking lever 938v having two notches 938pu that force against the 947s to allow the button to be moved into a locking position. As shown in FIG. 48G is with the sleeve face top sections removed exposing the internal two release lever housings 990 which are similar to the previous version, having also the same larger block 984. At the front is a grub screw 903f shown here butting against the bit cylinder rod 917, in this position it's considered to be in a locking stage if necessary. Meaning if the front cover (and as will be explained later) is pushed down it prevents the device from being accidentally engaged. As shown in FIGS. 48H and 481, a partially disassembled perspective view of the device 900 is shown. As shown in FIG. 49A is the underside of the device 900 where the aperture holes 688a and 688b are adapted to suit an external device. As shown in FIG. 49B, the left side view with the grub screw 953f in a unlocked position whereby the front cover 903 has been moved forward where it also moves the attached front cover 938a and 938v. As shown in FIG. 49C, is a perspective bottom view where the front guide button 947 is adapted with a nose/mouth type shape where in the aperture cavity 938x is the locking grub screw 903f. As shown in FIG. 49D, the front grub screw 903f is moved anticlockwise away from the bit cylinder rod 917, so this would be in an unlocked position and not able to be locked even when the front assembly is pressed down. As shown in FIG. 49E, a top view of a partially disassembled device 900 where it can be seen the retaining C-clips for the side release plates 953c and 954c. And laterally on the sides are the two grub screws for the release plates as well, which are 953f and 954f, were on the back of the device there is a 908f grub screw that locks into the rear plank assembly. As shown in FIG. 49F, is the underside internal section of the device 900 showing the cylinder tube housing and laterally on either side is the blocks 984 and then the sleeve housing 990 and the ball retention blocks 949d, and on the back, on bottom of the plank assemblies, as it is on the previous version they have an extra spring to help assist in returning the planks to a normal position, 983m and 982m which works together with the first and second spring 982, 983 respectively. As shown in FIG. 50A, the device 900 shows an engage configuration where the two outer ball bearings 922b would be resting against the front portion 949c of the ball retention block 949d. As shown in FIG. 50B, it shows a disassembled view of the plank assembly with a lower plank 961 having the lateral spring 983m, (or 982m) attached. As shown in FIG. 50C, is an upper plank, which are now also considered the major dominant plank where it has a notch 960a on the side and the peanut-shaped securing section 960p, and on the opposite side is the cavity aperture 960p that is mated with the adjacent 960 plank peanut-shaped securing section 960p which moves within. Also, each plank has a V-shaped positive and negative type notch/groove that when positioned side-by-side they are kept in line. As shown in FIG. 50D is the underside of the plank assembly with the 981 first & second ball release levers in the down resting position which means that it is engaged. And the rear grub screw 908f is fully inserted into the rear plank assembly 961L meaning it is in a locked position and cannot be accidentally disengaged. As shown in FIG. 50E, the levers 981 are forced up meaning that the side plates would have been pressed, forcing the two together with the left plank moving to the right and the right plank moving to the left allowing the cavity 950 to be fully extended and thus allowing the bespoke 90 device to be removed. As shown in FIG. 50F, the device 900 shows a fully locked plank assembly with the grub screw 908f within the cavity 961L preventing the 2 planks to be move towards each other, and at the front as Illustrated in grey the bit cylinder rod 917 is fully inserted into the front cavity aperture 960L, whereby not allowing the two planks at the front to be brought together. At the front section there is a cutaway view of the button guide 947 showing the front of the bit cylinder rod 917 against the grub screw 903f, in this configuration the front outer locking lever plate 938v would have been pressed all the way in for example as it can be seen on FIG. 57C. If the grub screw 903f was NOT fully screwed clockwise up it would then be in an unlocked position and if the front outer locking lever plate 938v would have been press down it would not engage the bit cylinder rod into the cavity 960L. As shown in FIGS. 51A and 51B, they (illustrate 90a) how a bolt 90 or bespoke bolt 90 is secured within this device 900. At the front there are two acorn type bearings that press down on the concave surface 92 held in there by the blocks 984 preventing them from moving back up and not allowing the concave section of the bespoke to move out. At the back is too peanut shaped sections extending out and attached to the plank assembly when they are moved towards each other and locked in position they will not allow the concave surface 92 to come loose. Also as shown in FIG. 51B, as an added precaution there is a portion of each plank 960 (illustrate 90a) that rests and overlaps on opposite sides of a top flat hexagonal surface of the bolt 90, Just adjacent to the concave surface 92. As shown in FIG. 51C, a bespoke 90t bolt or 90 bolt is engaged in the device 900. As shown in FIG. 51D, it is showing the locking lever 938v pivoting hinged point at the top 938h and the expanded spring 938sv. As shown in FIG. 51E, a side 2D profile view of the device 900 in a disengaged position, but with the bespoke 90t bolt positioned/resting in the device 900. As shown in FIGS. 52A to 52C, an example of how a bespoke 90t bolt would be inserted in; when the device 900 is in a disengaged position the bespoke bolt is positioned and located in line with the front 922a acorn bearings and the rear 960p bearings with the bespoke concave surface (see example FIG. 52D) once they have been aligned, the bolt 90 can be pushed down allowing the bearings to freely move out of the way, once aligned the bolt 90 will go/rest all the way down to the base (as in FIG. 52C) once in that position the device 900 can then be engaged and locked as necessary. As shown in FIG. 52D, is an example bespoke bolt that is envisioned and designed that would be suitable for this device 900 and as well as 800 device. As shown in FIG. 53A, a continuous hexagonal bolt that is envisioned and designed that would be suitable for this device 900 and as well the 800 and 700 devices. Also, it can be used on one 900 or multiple device 900's, meaning it can be mounted on one long hex bolt 90. As shown in FIGS. 53B and 53C, is an example use of a bolt 90 in a 900 device, first in and disengage position and then engaged position. As shown in FIGS. 54A and 54B is first a top view of the device 900 and a cutaway view, both are shown in an engaged, locked position. As shown in FIGS. 55A and 55B is first a top view of the device 900 and a cutaway view, both are shown in an disengaged, unlocked position. As shown in FIGS. 56A to 56C, is an example of the three positions that the front locking lever 938v can be positioned in. The first position in FIG. 56A the locking lever is all the way down overlapping into the bottom side of the device 900 in the second position in FIG. 56B in its standard normal position, where if you were to slide an item on top of it, it would pivot down to the ‘down’ position as in position FIG. 56A. In FIG. 56C It is in its high position, and when the device 900 is disengaged it allows an external object to be placed in between the two covers 938b and 938a by then pushing down on the cover 938a it would then engage and lock the appropriate device within the cavities 688b and 688a. As shown in FIGS. 57A to 57A, is an example of how the device 900 can be used. With the first image FIG. 57A the device 900 is mounted on a bespoke bolt or 90t bolt, as explained on the previous above paragraph for FIG. 52A to 50C, the device would be positioned but not engaged yet. Holding the device secure, an exterior object such as the one shown here 90e, then by placing it on the lower 938b internal cavity 688 then pivoting it back and towards the top cover, once located IN, press down on the top cover 938a. As can be seen on FIG. 57B where it is in a engaged position and cannot fall off. As shown in FIG. 57C, showing the locking lever cover 938v down at its further lowest position. For extra security in preventing it from temporarily/disengaged by an external object or person the device 900 can be locked by turning the three grub screws 953f, 954f and 908f to the locking position. Also, as an added security if a bespoke 90t bolt such as the one Illustrated here on FIG. 57C that is shaded in grey having a square-shaped ledge designed to match the top and bottom covers 938b and 938a, with the back ledge of the covers 938d and 938a extending out, it would then rest on the surface of the 90t bolt, whereby adding extra prevention from disengaging or assistance with a load, a weight on the top of the device 900. As shown in FIG. 57D when a shelf or other external device such as e.g., 90m is placed on the locking lever 938v the locking lever would pivot down to the lowest position. If the grub screw 903f is in a locked position like shown on FIG. 50F then the device would then have one (1) prevention enabled to prevent the device from being disengaged. By locking the other three (3) as mentioned in paragraph FIG. 57C it would be fully secured from any external tampering. FIG. 58A shows an exploded view of device 900.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1-20. (canceled)

21. A device adapted to releasably lock with a bolt, the device comprising:
a moveable front cover having a cavity which extends from the front cover to a rear portion of the device, wherein the cavity is adapted to receive the bolt with mounting concave portions for mounting the bolt in the cavity;
a locking mechanism comprising a first group of locking shape, wherein the first group of locking shapes is moveable between a first position and a second position, wherein the first position is in the cavity, and the second position is in a corresponding first group of locking shape recesses, wherein the first group of locking shape recesses surrounds laterally away from the cavity;
a moveable block covering the cavity, wherein the moveable block comprises the first group of locking shape recesses, wherein the block is moveable parallel to the longitudinal axis of the cavity;
wherein the first group of locking shape recesses is closed, the first group of locking shapes is in engagement with the mounting concave portion of the bolt, which locks the bolt in the cavity;
one or more release plates, wherein the moveable front cover is a release plate;
wherein disengagement of the first group of locking shapes from the mounting concave portions of the bolt is activated by movement of one of the release plates which expands the cavity and activates opening of the first group of locking shape recesses thereby allowing the first group of locking shapes to retract from the cavity into the first group of locking shape recesses.

22. The device according to claim 21, wherein the locking mechanism further comprises a second group of locking shapes, wherein the moveable block is positioned between the first group of locking shapes and the second group of locking shapes; a sleeve housing having recessed portions for engaging with a second group of locking shapes, wherein the sleeve housing covers the block and the cavity; wherein the block comprises a second group of locking shape recesses; wherein when the second group of locking shape recesses is in a closed configuration, the second group of locking shapes is in engagement with recessed portions of the sleeve housing; and wherein disengagement of the second group of locking shapes from the recessed portions of the sleeve housing is activated by movement of the release plate which expands the cavity and activates opening of the second group of locking shape recesses of the block thereby releases the sleeve housing.

23. The device according to claim 22, wherein the first group of locking shapes and the second group of locking shapes are at least one selected from the group of: ball shape, acorn shape, and peanut shape.

24. The device according to claim 23, wherein the front cover comprises a centred lateral slot, wherein the lateral slot is adapted to receive a locking rod assembly with a rod; wherein the locking rod assembly biases the rod to be within a lateral side of the front cover such that the front cover can move longitudinally.

25. The device according to claim 24, wherein the bolt comprises a flanged portion at diametrically opposite sides, laterally away from the longitudinal axis of the bolt.

26. The device according to claim 25, wherein the front cover comprises a front rotatable button with the cavity having a bolt retention groove for receiving the flanged bolt, wherein the front button has protruding portions at diametrically opposite sides for actuating the rod to extend out of the lateral sides of the front cover for locking the longitude movement of the front cover, when the front button is rotated by the flanged bolt.

27. The device according to claim 26, wherein the cavity having the bolt retention groove having a first internal cross-sectional shape for receiving the flanged bolt, and a second internal cross-sectional shape for retaining the flanged bolt; wherein the rotation of the front button changes between the first internal cross-sectional shape and the second internal cross-sectional shape.

28. The device according to claim 21, further comprising a first spring and a piston, wherein the first spring is in connection between the base of the cavity and a rear end of the piston, and wherein the piston having a piston aperture at the front end, wherein the piston aperture is adapted for receiving a cup and a piston spring; wherein the cup has a base and an open end having an inner rim, wherein the base is in connection with an inner surface of the piston, and wherein the open end is adapted to receive a rear end of a connecting rod with an inner rim engagement means.

29. The device according to claim 28, wherein the piston further comprises a notched portion at an outer surface, wherein the notched portion is adapted to engage with a flange from a middle portion of a cylinder rod; wherein the front end of the cylinder rod is in connection with the front button or a button guide, and wherein the rear end of the cylinder rod is in connection with a rear cup housing, wherein the rear cup housing is in connection with the rear plate, wherein the rear plate is in connection with the base of the cavity.

30. The device according to claim 29, wherein an outer surface of the piston further comprises a locking shape engagement surface adapted for receiving the first group of locking shapes when the bolt is disengaged.

31. The device according to claim 21, wherein moving the front cover longitudinally away from the rear portion of the device is a front cover release mechanism, which also effects the movement of a sleeve housing in the same direction thereby compressing a sleeve housing spring and activating opening of the first group of locking shape recesses, which allows for the disengagement of the locking shapes from the mounting concave portion of the bolt, such that the bolt disengages from the device.

32. The device according to claim 31, the device comprising at least one further front cover release mechanism, wherein the further release mechanism is actuated by pressing a release plate selected from at least one of: a left side plate, a right side plate, a first plate, a second plate, and an external top plate; wherein the front cover is positioned between the first plate and the second plate, wherein the faces of the front cover, the first plate and the second plate are facing in the same direction.

33. The device according to claim 32, wherein the movement of a first predetermined distance of the first plate or the movement of a second predetermined distance of the second plate towards the rear portion of the device actuates locking shape-release levers, which move the locking shape release blocks relative towards the front portion of the sleeve housing, such that the first group of locking balls moves laterally from the first position to the second position.

34. The device according to claim 33, wherein the locking shape release levers each have an upper arm and a lower arm, wherein the upper arm and the lower arm moves via a scissor mechanism.

35. The device according to claim 34, wherein the rear plate comprises a lateral slot, wherein the lateral slot is adapted to receive both an upper plank and a lower plank, wherein the upper plank and the lower plank is laterally moveable with respect to each other.

36. The device according to claim 35, wherein the upper plank comprises upper apertures and the lower plank comprises lower apertures, wherein the upper apertures are each adapted to receive the upper arm of the locking shape release lever, and wherein the lower apertures are each adapted to receive the lower arm of the locking shape release lever.

37. The device according to claim 36, wherein the first plate moves the first predetermined distance, a first plate rod in connection to the first plate actuates a first plate rod engaging arm of a first rear lever, wherein longitudinal movement of the first plate rod engaging arm pivotally effects a lateral movement to a upper plank engaging arm of the first rear lever, which laterally moves the upper plank; wherein the second plate moves the second predetermined distance, a second plate rod in connection to the second plate actuates a second plate rod engaging arm of a second rear lever, wherein longitudinal movement of the second plate rod engaging arm pivotally effects a lateral movement to a lower plank engaging arm of the second rear lever, which laterally moves the lower plank.

38. The device according to claim 37, wherein the first rear lever and the second rear lever are each tilted relative to the longitudinal axis of the cavity.

39. The device according to claim 38, wherein the lateral movement of the left plate towards the right side of the device actuates the upper plank engaging arm, which laterally moves the upper plank; and wherein the lateral movement of the right plate towards the left side of the device actuates the lower plank engaging arm, which laterally moves the lower plank, such that the locking shape release blocks move relative towards the front portion of the sleeve housing, such that the first group of locking shapes moves laterally from the first position to the second position.

40. The device according to claim 21, wherein a back of the front cover comprises an upper and lower rack with teeth, and wherein the device is adapted to be mounted to a track having an upper and lower rack with complementary teeth, wherein the complementary teeth is adapted to engage with the teeth of the front cover such that the device is fixedly mounted to the track and that the device can be mounted in a direction to support an exterior surface on the surface of the front cover.
